(19) United States
(12) Patent Application Publication
(10) Pub. No.: US 2026/0113521 A1
(43) Pub. Date: Apr. 23, 2026

(54) CAMERA DEVICE, AND OPTICAL DEVICE COMPRISING SAME

(71) Applicant: LG INNOTEK CO., LTD., Seoul (KR)

(72) Inventor: Deok Yong LEE, Seoul (KR)

(21) Appl. No.: 19/117,335

(22) PCT Filed: Sep. 27, 2023
(86) PCT No.: PCT/KR2023/015028

§ 371 Date: Mar. 31, 2025

(30) Foreign Application Priority Data
Sep. 30, 2022 (KR) 10-2022-0125044
Oct. 17, 2022 (KR) 10-2022-0133305

(51) Int. Cl. H04N 23/52

(52) U.S. Cl. CPC H04N 23/52

(57) ABSTRACT

An embodiment comprises: a fixed part; and a moving part that includes a first circuit board, a second circuit board disposed below the first circuit board, and an image sensor, and moves, in a direction perpendicular to an optical axis direction, with respect to the fixed part. The first circuit board includes a plurality of conductive layers and a terminal soldered to the second circuit board, and the terminal is positioned higher than the lowest conductive layer among the plurality of conductive layers of the first circuit board.

### CROSS-REFERENCE TO RELATED APPLICATIONS

This application is the U.S. national stage application of International Patent Application No. PCT/KR2023/015028, filed Sep. 27, 2023, which claims the benefit under 35 U.S.C. § 119 of Korean Application Nos. 10-2022-0125044, filed Sep. 30, 2022, and 10-2022-0133305, filed Oct. 17, 2022, the disclosures of each of which are incorporated herein by reference in their entirety.

### TECHNICAL FIELD

Embodiments relate to a camera device and an optical instrument including the same.

### BACKGROUND ART

It is difficult to apply technology of a voice coil motor (VCM) used in existing general camera devices to a subminiature, low-power camera device, and therefore research related thereto has been actively conducted.

Demand for and production of electronic products, such as smartphones and mobile phones equipped with cameras have increased. Cameras for mobile phones are trending toward increased resolution and miniaturization. As a result, an actuator has also been miniaturized, increased in diameter, and been made multifunctional. In order to realize a high-resolution camera for mobile phones, improvement in performance of the camera for mobile phones and addition of functions thereto, such as autofocus, hand tremor correction, and zoom, are required.

### DISCLOSURE

### Technical Problem

Embodiments provide camera devices and optical instruments including the same, which are capable of improving reliability of electrical connection between a terminal of a first circuit board and a terminal of a second circuit board of a moving unit.

Furthermore, embodiments provide camera devices and optical instruments including the same, which are capable of improving efficiency of radiation of heat generated by a heat generation source of an OIS moving unit.

The embodiments provide camera devices and optical instruments including the same, which are capable of realizing simplification of an assembly process, of reducing manufacturing cost, and of inhibiting deterioration of reliability of an autofocus operation caused by defective soldering.

### Technical Solution

A camera device according to an embodiment includes a stationary unit, and a moving unit including a first circuit board, a second circuit board disposed under the first circuit board, and an image sensor, and being movable in a direction perpendicular to an optical axis direction with respect to the stationary unit, wherein the first circuit board includes a plurality of conductive layers, the first circuit board includes a terminal coupled to the second circuit board via a solder, and the terminal is positioned higher than the lowermost conductive layer among the plurality of conductive layers of the first circuit board.

The terminal may be positioned between the lowermost conductive layer and the uppermost conductive layer among the plurality of conductive layers of the first circuit board.

The terminal may be formed at another conductive layer disposed on the lowermost conductive layer among the plurality of conductive layers.

The terminal may be formed at the second lowermost conductive layer among the plurality of conductive layers.

The lowermost surface of the solder may be disposed higher than the lowermost surface of the second circuit board.

The plurality of conductive layers may be disposed so as to be spaced apart from each other in the optical axis direction, and the first circuit board may include a plurality of insulating layers disposed between the plurality of conductive layers.

A camera device according to another embodiment includes a stationary unit, and a moving unit including a first circuit board, a second circuit board disposed under the first circuit board, and an image sensor, and being movable in a direction perpendicular to an optical axis direction with respect to the stationary unit, wherein the first circuit board includes a seating groove depressed from a lower surface thereof, the second circuit board is disposed in the seating groove in the first circuit board, and the first circuit board includes a first terminal disposed in the seating groove and coupled to the second circuit board via a solder.

The second circuit board may include a second terminal disposed at at least a portion thereof in the seating groove and coupled to the first terminal via the solder.

At least a portion of the solder may be disposed in the seating groove in the first circuit board.

The first circuit board may include a plurality of conductive layers arranged in the optical axis direction, and the first terminal may be positioned higher than a lowermost conductive layer among the plurality of conductive layers of the first circuit board.

The first terminal may be positioned between the lowermost conductive layer among the plurality of conductive layers of the first circuit board and the uppermost conductive layer among the plurality of conductive layers of the first circuit board.

The first terminal may be formed at another conductive layer disposed on the lowermost conductive layer among the plurality of conductive layers of the first circuit board.

The second terminal may be formed on a side surface of the second circuit board.

The second circuit board may include a plurality of conductive layers arranged in the optical axis direction, and the second terminal may be positioned higher than the lowermost conductive layer among the plurality of conductive layers of the second circuit board.

The second terminal may include a first pad formed on a side surface of the second circuit board and a second pad connected to a lower portion of the first pad.

The second circuit board may include a plurality of conductive layers arranged in the optical axis direction, and the first pad and the second pad may be disposed higher than the lowermost conductive layer among the plurality of conductive layers of the second circuit board. The lowermost conductive layer of the second circuit board may be positioned lower than the lowermost conductive layer of the first circuit board. The solder may be coupled to at least one of the first pad or the second pad.

The moving unit may include a first heat radiating member which is disposed below the second circuit board and on which the image sensor is disposed, and the stationary unit may include a second heat radiating member disposed so as to be spaced apart from the first heat radiating member.

The second heat radiating member may include a first region, which overlaps the first heat radiating member in the optical axis direction, and a second region, which does not overlap the first heat radiating member in the optical axis direction, and the first region may project toward the first heat radiating member based on the second region. The image sensor may be disposed on the second circuit board.

A camera device according to another embodiment includes a stationary unit including a lens module and a position sensor configured to detect displacement of the lens module, a moving unit including an image sensor, and a support board including a first portion coupled to the stationary unit and a second portion coupled to the moving unit and supporting the moving unit such that the moving unit is movable in a direction perpendicular to the optical axis direction, the support board includes an extension region extending from the first portion, and the position sensor is disposed in the extension region.

The moving unit may further include a holder and a first circuit board disposed on the holder and electrically connected to the image sensor, and the stationary unit may include a base and a second circuit board disposed on the base and electrically connected to the support board.

The extension region may include a pad coupled to the position sensor.

The support board may surround the holder, the first portion of the support board may be coupled to the holder, and the second portion of the support board may be coupled to the base.

The extension region may include a first region on which the position sensor is disposed and a second region connecting the first region to the second portion. The second region may include at least one bent portion. The support board may include a wire connecting a terminal connected to the second circuit board to the pad of the extension region. The wire may be constituted by a single conductive layer.

The stationary unit may include a housing and a bobbin disposed in the housing and coupled to the lens module, and at least a portion of the extension region may be disposed on the housing.

The base may include a projection coupled to the second portion of the support board, and the projection may include a groove through which at least a portion of the extension region passes.

The length of the second region in the optical axis direction may be less than the length of the first region in the optical axis direction.

The stationary unit may include a magnet and a coil which are configured to move the bobbin in the optical axis direction, and an elastic member coupled to the housing and the bobbin and connected to the coil, and the elastic member may be electrically connected to the extension region.

The position sensor may be a driver IC including a Hall sensor, and the driver IC may supply a drive signal to the coil.

A camera device according to another embodiment includes a stationary unit including a lens module, a position sensor configured to displacement of the lens module, and a second circuit board, a moving unit including an image sensor, and a support board configured to support the moving unit such that the moving unit is movable in a direction perpendicular to the optical axis direction, wherein the support board includes a pad coupled to the position sensor, a terminal electrically connected to the second circuit board, and a wire connecting the pad to the terminal.

The support board may include a first insulating layer, a second insulating layer, and a single conductive layer disposed between the first insulating layer and the second insulating layer and contacting the first and second insulating layers, and the terminal, the pad and the wire of the support board are formed by patterning the conductive layer.

The support board may include a body including a first portion coupled to the stationary unit and a second portion coupled to the moving unit, and an extension region which extends from the second portion and on which the pad is disposed.

The support board may include an extension which extends to the second circuit board from the second portion of the body and on which the terminal is disposed. The extension may include first and second extensions and third and fourth extensions positioned opposite the first and second extensions with the lens module interposed therebetween, and the terminal of the support board may be disposed on one of the first and second extensions.

### Advantageous Effects

The embodiments are able to increase the distance between the solder coupled to the terminal of the first circuit board and the stationary unit by positioning the terminal of the first circuit board of the OIS moving unit lower than the lowermost conductive layer of the first circuit board.

The embodiments are able to inhibit occurrence of a crack in the solder caused by collision between the solder and the stationary unit by virtue of the increase in the distance between the solder and the stationary unit.

The embodiments are able to improve reliability of electrical connection between the terminal of the first circuit board and the terminal of the second circuit board by inhibiting occurrence of a crack in the solder.

The embodiments are able to increase the distance between the OIS moving unit and the stationary unit by disposing the second circuit board in the seating groove formed in the first circuit board.

The embodiments are able to reduce the height of the camera device in the optical axis direction within the range of the increased distance between the OIS moving unit and the stationary unit.

The embodiments are able to increase the thickness of the heat radiating member disposed on the stationary unit within the range of the increased distance and thus to improve heat radiation efficiency of the heat radiation source of the OIS moving unit.

The embodiments eliminate the need for an additional board design to dispose the AF position sensor because the portion of the board on which the first position sensor is disposed is formed integrally with the support board.

The embodiments eliminate management of component tolerance and assembly tolerance in manufacture of the additional board.

The embodiments are able to simplify an assembly process of the camera device and manufacturing cost of the camera device.

Furthermore, the embodiments are able to inhibit deterioration of reliability of electrical connection caused by defective soldering between the AF position sensor and the additional board and thus to inhibit malfunction of AF operation or deterioration of reliability of autofocus operation caused by the defective soldering.

In addition, the embodiments are able to inhibit foreign substances from being introduced into the camera device because there is no need for an opening in the cover member for soldering between the AF position sensor and the additional board.

### DESCRIPTION OF DRAWINGS

FIG. 1 is a perspective view of a camera device according to an embodiment;

FIG. 2 is a perspective view of the camera device from which a cover member is removed;

FIG. 3 is an exploded perspective view of the camera device shown in FIG. 1;

FIG. 4A is a cross-sectional view of the camera device taken along line A-B in FIG. 1;

FIG. 4B is a cross-sectional view of the camera device taken along line C-D in FIG. 1;

FIG. 4C is a cross-sectional view of the camera device taken along line E-F in FIG. 1;

FIG. 5 is an exploded perspective view of the AF operation unit shown in FIG. 3;

FIG. 6 is a perspective view of a bobbin, a sensing magnet, a balancing magnet, a first coil, a circuit board, a first position sensor, and a capacitor;

FIG. 7A is a perspective view of the bobbin, a housing, the circuit board, an upper elastic member, the sensing magnet, and the balancing magnet;

FIG. 7B is another perspective view of FIG. 7A which is additionally provided with the wire;

FIG. 8 is a bottom perspective view of the housing, the bobbin, a lower elastic member, a magnet, and the circuit board;

FIG. 9 is a perspective view of an image sensor unit;

FIG. 10A is a first exploded perspective view of the image sensor unit shown in FIG. 9;

FIG. 10B is a second exploded perspective view of the image sensor unit shown in FIG. 9;

FIG. 10C is an enlarged view of the groove in the holder shown in FIG. 10A;

FIG. 10D is an enlarged view of the terminal member show in FIG. 10A;

FIG. 10E is an enlarged view of the groove in the base shown in FIG. 10A;

FIG. 10F is an enlarged view of the groove in the holder in which the terminal member shown in FIG. 10B is disposed;

FIG. 11 is a bottom perspective view of the holder, the terminal member, the first board unit, the support board, the base, and the second board unit shown in FIG. 10A;

FIG. 12 is a plan view of the holder, the first board unit, the image sensor, the second coil, and the OIS position sensor;

FIG. 13 is a rear perspective view of the holder and the first board unit;

FIG. 14 is a perspective view of the base, the terminal member and the wire;

FIG. 15 is a bottom view of the first board unit, the support board, and the heat radiating member;

FIG. 16 is a perspective view of the first board unit, the support board, and the radiating member;

FIG. 17A is a first perspective view of the support board coupled to the holder and the base;

FIG. 17B is a second perspective view of the holder and the base;

FIG. 18A illustrates movement of the OIS moving unit in the X-axis direction;

FIG. 18B illustrates movement of the OIS moving unit in the Y-axis direction;

FIG. 18C illustrates clockwise rotation of the OIS moving unit in the case of driving through four channels;

FIG. 18D illustrates counterclockwise rotation of the OIS moving unit in the case of driving through four channels;

FIG. 19A illustrates an embodiment of the magnet shown in FIG. 5;

FIG. 19B illustrates another embodiment of the magnet shown in FIG. 5;

FIG. 20A illustrates disposition of the first to third regions of the second board unit, the extension region, the AF moving unit, the OIS moving unit, and the controller according to an embodiment;

FIG. 20B is a schematic cross-sectional view of the lens module, the first board unit, the image sensor, the first board unit, and the heat radiating member;

FIG. 21 is a block diagram illustrating the configuration of the controller and first to third sensors;

FIG. 22 is a perspective view of the first circuit board, the support board, the second circuit board, and the heat radiating member;

FIG. 23 is a fragmentary enlarged view of FIG. 4B;

FIG. 24 is a fragmentary cross-sectional view of connectors of the first circuit board and the support board;

FIG. 25 is a cross-sectional view of the first circuit board, the second circuit board, and the solder;

FIG. 26 is a cross-sectional view of the second circuit board, the first circuit board, and the solder according to another embodiment;

FIG. 27 is a cross-sectional view of the second circuit board, the first circuit board, and the solder according to a further embodiment;

FIG. 28 is a perspective view of the first circuit board and the second circuit board according to another embodiment;

FIG. 29A is a cross-sectional view of the first circuit board, the second circuit board, and the solder shown in FIG. 28;

FIG. 29B is a cross-sectional view of the solder according to another embodiment;

FIG. 30 illustrates a crack produced in an impact experiment for the solder according to a comparative example;

FIG. 31 is a perspective view of the camera device according to another embodiment;

FIG. 32 is a perspective view of the camera device shown in FIG. 31 from which the cover member is removed;

FIG. 33 is an exploded perspective view of the camera device shown in FIG. 31;

FIG. 34A is a cross-sectional view of the camera device taken along line A-B in FIG. 31;

FIG. 34B is a cross-sectional view of the camera device taken along line C-D in FIG. 31;

FIG. 34C is a cross-sectional view of the camera device taken along line E-F in FIG. 31;

FIG. 35 is an exploded perspective view of the AF operation unit shown in FIG. 33;

FIG. 36 is a perspective view of the bobbin, the sensing magnet, the balancing magnet, the first coil, the first position sensor, and the capacitor;

FIG. 37 is a perspective view of the bobbin, the housing, the upper elastic member, the wire, the damper, the sensing magnet, and the balancing magnet;

FIG. 38 is a bottom perspective view of the housing, the bobbin, the lower elastic member, the magnet, and the lower elastic member;

FIG. 39 is a perspective view of the image sensor unit shown in FIG. 33;

FIG. 40A is a first exploded perspective view of the image sensor unit shown in FIG. 39;

FIG. 40B is a second exploded perspective view of the image sensor unit shown in FIG. 39;

FIG. 41 is a bottom perspective view of the holder, the terminal member, the first board unit, the support board, the heat radiating member, the base, and the second board unit, which are shown in FIG. 40A;

FIG. 42 is a plan view of the holder, the first board unit, the image sensor, the second coil, and the OIS position sensor;

FIG. 43 is a rear perspective view of the holder and the first board unit;

FIG. 44 is a perspective view of the base, the terminal member, and the wire;

FIG. 45 is a bottom view of the first board unit, the support board, and the heat radiating member;

FIG. 46 is a perspective view of the first board unit, the support board, and the heat radiating member;

FIG. 47A is a first perspective view of the support board coupled to the holder and the base;

FIG. 47B is a second perspective view of the support board coupled to the holder and the base;

FIG. 48A is a first perspective view of the support board, the first position sensor, and the capacitor;

FIG. 48B is a second perspective view of the support board 310, the first position sensor, and the capacitor;

FIG. 49A is another perspective view of the camera device;

FIG. 49B is a perspective view of the camera device shown in FIG. 49A from which the cover member and the housing are removed;

FIG. 50 illustrates the terminals of the extensions of the support board;

FIG. 51 is a bottom view of the support board and the first board unit;

FIG. 52 illustrates the pads and wires in the extension regions of the support board;

FIG. 53 is a perspective view of the camera device including the cover member according to another embodiment;

FIG. 54A is a perspective view illustrating an optical instrument according to an embodiment;

FIG. 54B is a perspective view of an optical instrument according to another embodiment;

FIG. 54C is a perspective view of an optical instrument according to a further embodiment;

FIG. 55 is a view illustrating the configuration of the optical instrument illustrated in FIGS. 54A to 54C.

### BEST MODE

Hereinafter, embodiments of the present invention will be described in detail with reference to the accompanying drawings.

The technical idea of the present invention may be embodied in many different forms, and should not be construed as being limited to the following embodiments set forth herein. One or more of components of the embodiments may be selectively combined with each other or replaced without departing from the technical spirit and scope of the present invention.

Unless otherwise particularly defined, terms (including technical and scientific terms) used in the embodiments of the present invention have the same meanings as those commonly understood by one of ordinary skill in the art to which this invention belongs. It will be further understood that commonly used terms, such as those defined in dictionaries, should be interpreted as having meanings consistent with their meanings in the context of the relevant art.

The terminology used in the embodiments of the present invention is for the purpose of describing particular embodiments only, and is not intended to limit the present invention. As used in the disclosure and the appended claims, the singular forms are intended to include the plural forms as well, unless the context clearly indicates otherwise. The phrase “at least one of A, B or C” or “one or more of A, B and C” may be interpreted as including one or more of all combinations of A, B and C.

Furthermore, when describing the components of the present invention, terms such as “first”, “second”, “A”, “B”, “(a)” or “(b)” may be used. Since these terms are provided merely for the purpose of distinguishing the components from each other, they do not limit the nature, sequence or order of the components.

It should be understood that, when an element is referred to as being “linked”, “coupled” or “connected” to another element, the element may be directly “linked”, “coupled” or “connected” to the other element, or may be “linked”, “coupled” or “connected” to the other element via a further element interposed therebetween. Furthermore, it will be understood that, when an element is referred to as being formed “on” or “under” another element, it can be directly “on” or “under” the other element, or can be indirectly disposed with regard thereto, with one or more intervening elements therebetween. In addition, it will also be understood that “on” or “under” the element may mean an upward direction or a downward direction based on the element.

Hereinafter, an AF operation unit may alternatively be referred to as a “lens moving apparatus”, a “lens moving unit”, a “VCM (Voice Coil Motor)”, an “actuator” or a “lens moving device”. Hereinafter, the term “coil” may be interchangeably used with “coil unit”, and the term “elastic member” may be interchangeably used with “elastic unit” or “spring”.

In the follow description, the “terminal” may alternatively be referred to as a “pad”, “electrode”, “conductive layer” or “bonding portion”.

In the following description, the terms “board portion”, “printed circuit board”, “circuit board”, and “board” may be used interchangeably with one another.

For convenience of description, although the camera module according to an embodiment is described using an orthogonal coordinate system (x, y, z), the lens moving apparatus may be described using some other coordinate systems, and the embodiments are not limited thereto. In the respective drawings, the X-axis direction and the Y-axis direction mean directions perpendicular to an optical axis, i.e. the Z-axis. The Z-axis direction, which is the direction of the optical axis OA, may be referred to as a “first direction”, the X-axis direction may be referred to as a “second direction”, and the Y-axis direction may be referred to as a “third direction”. Furthermore, for example, the X-axis direction may be represented as “one of a first horizontal direction and a second horizontal direction”, and the Y-axis direction may be represented as “the other of the first horizontal direction and the second horizontal direction”.

For example, the optical axis may be the optical axis of a lens mounted on a lens barrel. Alternatively, for example, the optical axis may be an axis which is perpendicular to the imaging area of an image sensor and extends through the center of the imaging area.

The first direction may be a direction perpendicular to an imaging area of an image sensor. Furthermore, the optical axis direction may be a direction parallel to the optical axis.

The camera device according to an embodiment of the present invention is capable of performing an “autofocus function”. Here, the “autofocus function” serves to automatically focus an image of a subject on an image sensor surface.

Hereinafter, the camera device may alternatively be referred to as a “camera module”, a “camera assembly”, a “camera unit”, a “camera”, an “imaging device”, or a “lens moving apparatus”.

In addition, the camera device according to the embodiment may perform a function of “hand tremor correction”. Here, the function of “hand tremor correction” may serve to inhibit blurring of the contour line of a captured image due to vibration caused by shaking of the user's hand when capturing a still image.

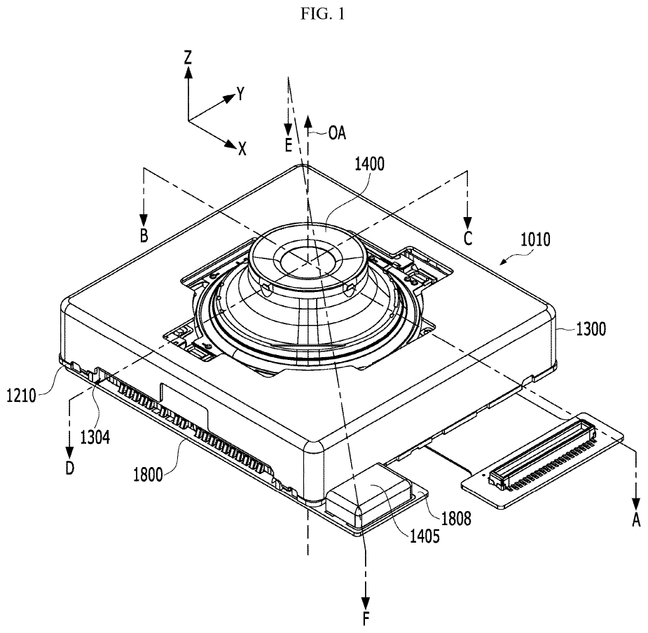

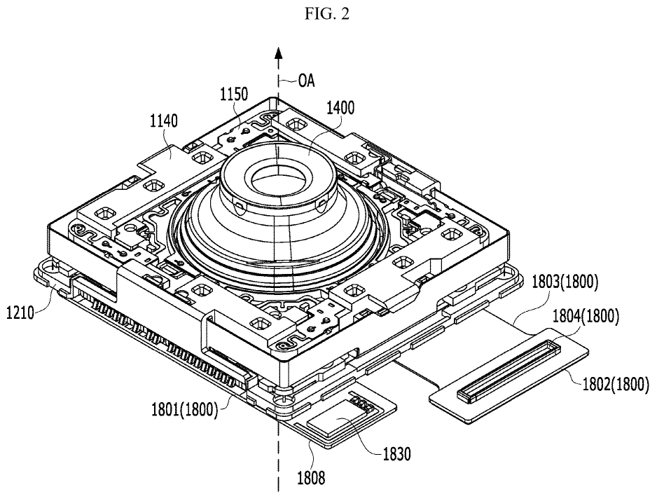

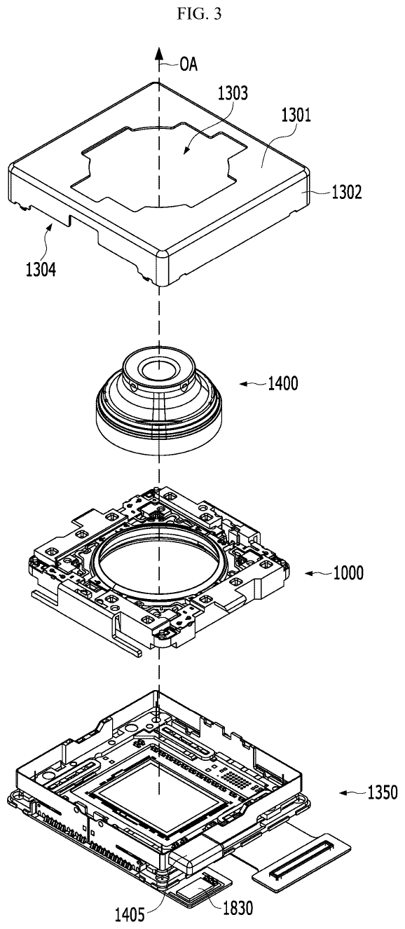

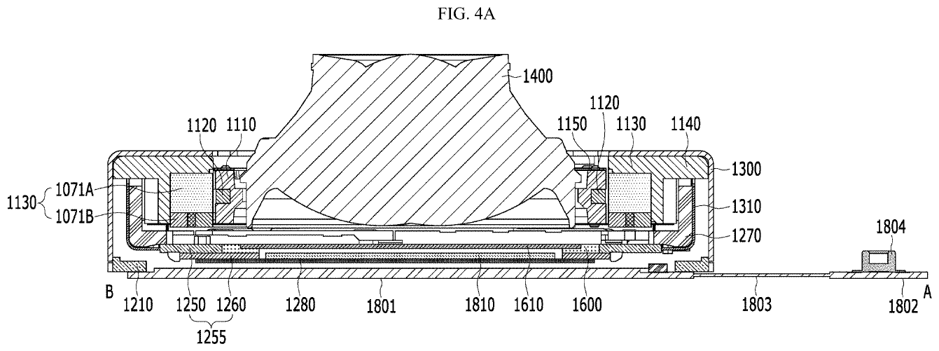

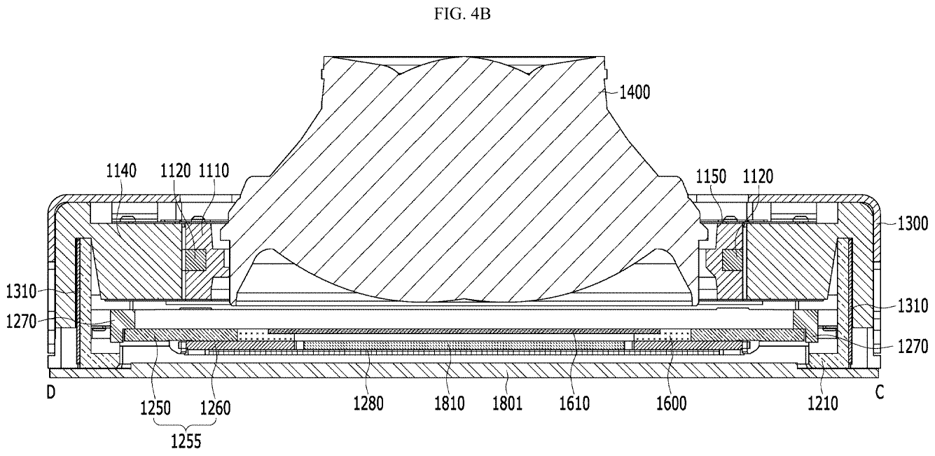

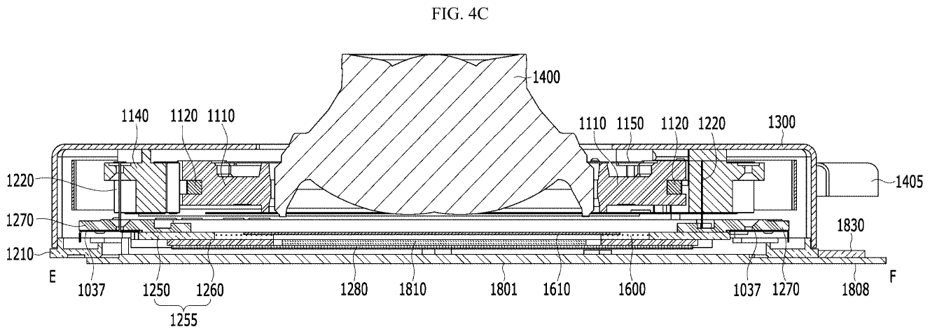

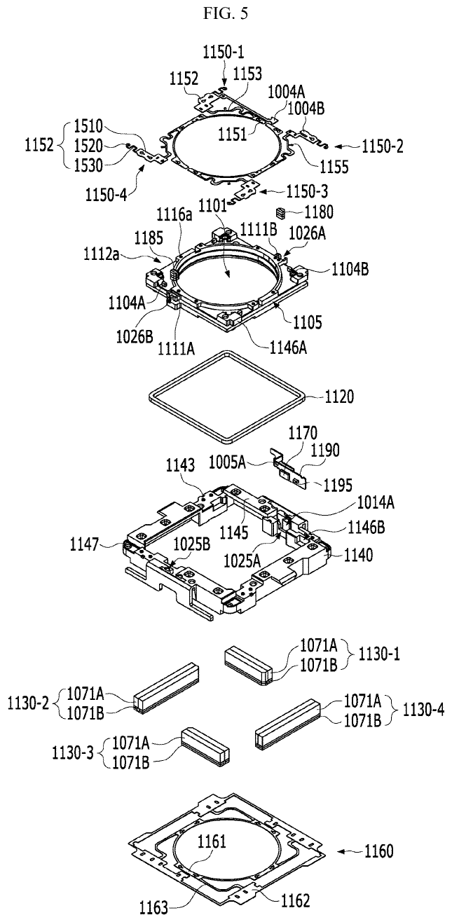

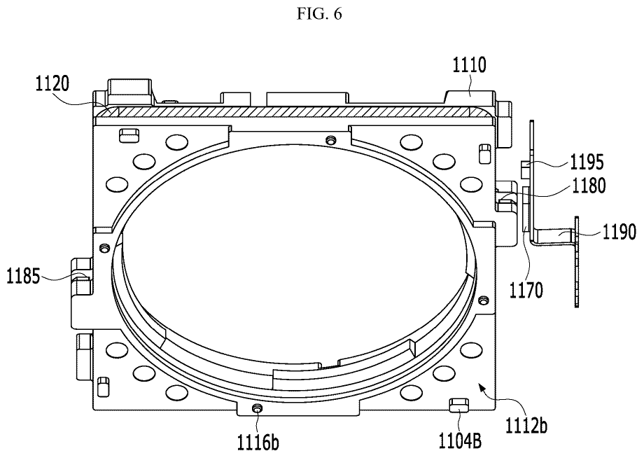

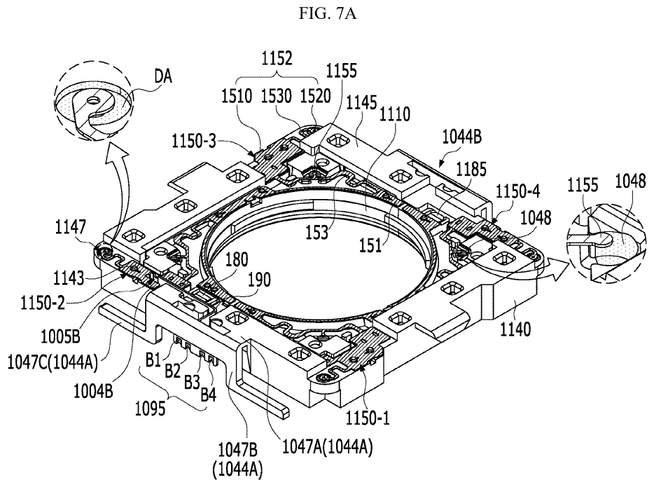

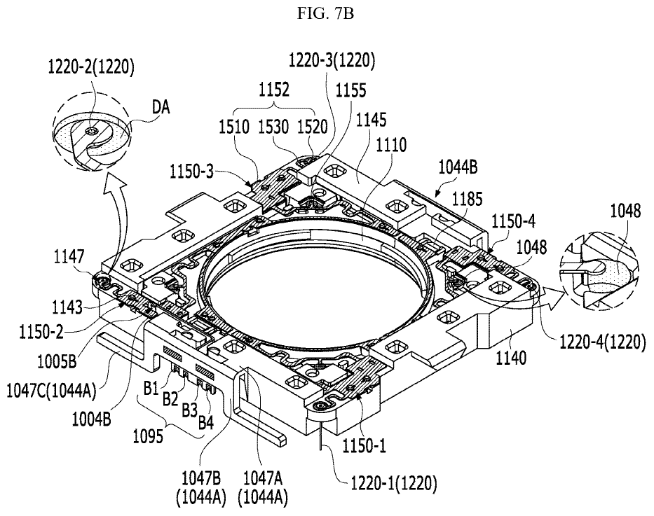

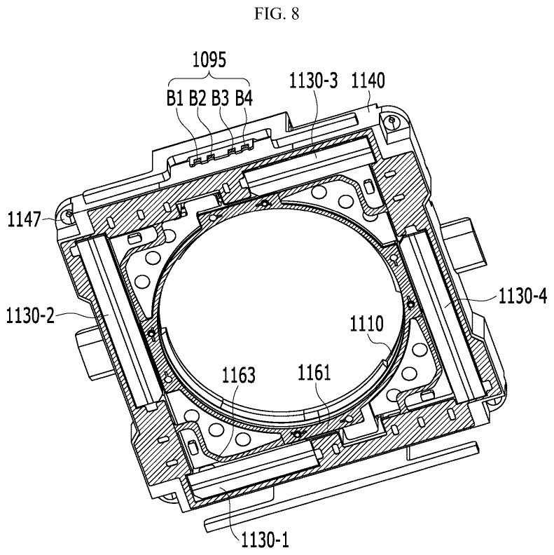

FIG. 1 is a perspective view of a camera device 1010 according to an embodiment. FIG. 2 is a perspective view of the camera device 1010 from which a cover member 1300 is removed. FIG. 3 is an exploded perspective view of the camera device 1010 shown in FIG. 1. FIG. 4A is a cross-sectional view of the camera device 1010 taken along line A-B in FIG. 1. FIG. 4B is a cross-sectional view of the camera device 1010 taken along line C-D in FIG. 1. FIG. 4C is a cross-sectional view of the camera device 1010 taken along line E-F in FIG. 1. FIG. 5 is an exploded perspective view of the AF operation unit 1100 shown in FIG. 3. FIG. 6 is a perspective view of a bobbin 1110, a sensing magnet 1180, a balancing magnet 1185, a first coil 1120, a circuit board 1190, a first position sensor 1170, and a capacitor 1195. FIGS. 7A and 7B are perspective views of the bobbin 1110, a housing 1140, the circuit board 1190, an upper elastic member 1150, the sensing magnet 1180, and the balancing magnet 1185. FIG. 8 is a bottom perspective view of the housing 1140, the bobbin 1110, a lower elastic member 1160, a magnet 1130, and the circuit board 1190.

Referring to FIGS. 1 to 8, the camera device 1010 may include the AF operation unit 1100 and the image sensor unit 1350. The AF operation unit 1100 may include an AF moving unit. The image sensor unit 1350 may include an OIS operation unit. The OIS operation unit may include an OIS moving unit. One of the AF moving unit and the OIS moving unit may be a first moving unit, and the other of the AF moving unit and the OIS moving unit may be a second moving unit.

The camera device 1010 may further include at least one of the cover member 1300 or a lens module 1400. The cover member 1300 and a base 1210, which will be described later, may constitute the case.

The AF operation unit 1100 may be coupled to the lens module 1400 so as to move the lens module in the direction of the optical axis OA or in a direction parallel to the optical axis, and may perform the autofocus function of the camera device 1010.

The image sensor unit 1350 may include an image sensor 1810. For example, the image sensor unit 1350 (or the OIS operation unit) may include the OIS operation unit including the image sensor 1810. For example, the image sensor unit 1350 may move the OIS moving unit (for example, the image sensor 1810) in a direction perpendicular to the optical axis. Furthermore, the image sensor unit 1350 may cause tilting or rotation (or rolling) of the OIS moving unit (for example, the image sensor 1810) relative to or about the optical axis. By virtue of the image sensor unit 1350, the camera device 1010 may perform hand tremor correction.

For example, the image sensor 1810 may include an imaging area configured to sense the light passing through the lens module 1400. Here, the imaging area may alternatively be referred to as an “effective area”, a “light-receiving area”, an “active area”, or a “pixel area”. For example, the imaging area of the image sensor 1810 may be an area on which the light passing through a filter 1610 is incident and thus the image included in the light is formed, and may include at least one unit pixel. For example, the imaging area may include a plurality of unit pixels.

The AF operation unit 1100 may alternatively be referred to a “lens moving unit” or a “lens moving apparatus”. Alternatively, the AF operation unit 1100 may alternatively be referred to as a “first moving unit (or a second moving unit)”, a “first actuator (or a second actuator)” or “AF operation unit”.

Furthermore, the image sensor unit 1350 may alternatively be referred to as an “image sensor moving unit”, an “image sensor shift unit”, a “sensor moving unit”, or a “sensor shift unit”. Furthermore, the image sensor unit 1350 may alternatively be referred to as a “second moving unit” (or “first moving unit”) or a “second actuator” (or “first actuator”).

Referring to FIGS. 5 and 6, the AF operation unit 1100 may move the lens module 1400 in the optical axis direction. For example, the AF operation 1100 may move the bobbin 1110 in the optical axis direction. For example, the AF operation unit 1100 may include the bobbin 1110, the first coil 1120, the magnet 1130, and the housing 1140. The AF operation unit 1100 may further include the upper elastic member 1150 and the lower elastic member 1160.

The AF operation unit 1100 may further include the first position sensor 1170, the circuit board 1190 and the sensing magnet 1180 for the purpose of AF feedback operation. Furthermore, the AF operation unit 1100 may further include at least one of the balancing magnet 1185 or the capacitor 1195.

The bobbin 1110 may be disposed in the housing 1140, and may be moved in the direction of the optical axis OA or in the first direction (for example, in the Z-axis direction) by virtue of the electromagnetic interaction between the first coil 1120 and the magnet 1130.

The bobbin 1110 may include a bore to which the lens module 1400 is coupled or the lens module 1400 is mounted. For example, the bore in the bobbin 1110 may be a through hole formed through the bobbin 1110 in the optical axis direction. Although the bore in the bobbin 1110 may have a circular shape, an elliptical shape or a polygonal shape, the present disclosure is not limited thereto.

For example, the lens module 1400 may include at least one lens and/or a lens barrel. For example, the lens module 1400 may include one or more lenses and a lens barrel receiving the one or more lenses therein. However, a component of the lens module is not limited to the lens barrel, and may be any other component as long as the component has a holder structure capable of supporting the one or more lenses.

For example, the lens module 1400 may be threadedly coupled to the bobbin 1110. Alternatively, for example, the lens module 1400 may be coupled to the bobbin 1110 by means of an adhesive (not shown). The light passing through the lens module 1400 may be radiated to the image sensor 1810 through the filter 1610.

The bobbin 1110 may include one or more projections 1111A and 1111B provided on the outer surface thereof. For example, although the one or more projections 1111A and 1111B may project in a direction parallel to a line perpendicular to the optical axis OA, the present disclosure is not limited thereto. For example, the bobbin 1110 may include two projections 1111A and 1111B which are positioned opposite each other.

The projections 1111A and 1111B of the bobbin 1110 may correspond to grooves 1025A and 1205B in the housing 1140 and may be inserted into or disposed in the grooves 1025A and 1025B in the housing 1140 so as to suppress or inhibit the bobbin 1110 from being rotated about the optical axis beyond a predetermined range.

The bobbin 1110 may include a projection 1146A projecting in a direction perpendicular to the optical axis. For example, the projection 1146A of the bobbin 1110 may be disposed on a corner of the bobbin 1110.

The housing 1140 may include a groove 146B which corresponds to, faces or overlaps the projection 1146A of the bobbin 1110. At least a portion of the projection 1146A may be disposed in the groove 1146B in the housing 1140.

The projection 1146A of the bobbin 1110 may serve as a stopper configured to permit the bobbin 1110 to be moved within a predetermined range in the optical axis direction (for example, in a direction toward the lower elastic member 1160 from the upper elastic member 1150).

The upper surface of the bobbin 1110 may be provided therein with a first escape groove 1113a for avoidance of spatial interference with a first frame connector 1153 of the upper elastic member 1150. Furthermore, the lower surface of the bobbin 1110 may be provided therein with a second escape groove 1112b for avoidance of spatial interference with a second frame connector 1163 of the lower elastic member 1160.

The bobbin 1110 may include a first coupler 1116a which is coupled or fixed to the upper elastic member 1150. For example, although the first coupler 1116a of the bobbin 1110 may have the form of a protrusion, the present disclosure is not limited thereto. In another embodiment, the first coupler 1116a may have the form of a flat surface or a groove. Furthermore, the bobbin 1110 may include a second coupler 1116b which is coupled or fixed to the lower elastic member 1160. For example, although the second coupler 1116b may have the form of a protrusion, the present disclosure is not limited thereto. In another embodiment, the second coupler 1116b may have the form of a flat surface or a groove.

Referring to FIG. 5, the outer surface of the bobbin 1110 may be provided with a groove 1105 in which the first coil 1120 is seated, inserted or disposed. For example, the groove 1105 in the bobbin 1110 may have a shape, that is, a closed curve shape (for example, a ring shape) which coincides with the shape of the first coil 1120.

Furthermore, the bobbin 1110 may be provided with a first seating groove 1026a in which the sensing magnet 1180 is seated, inserted, fixed or disposed. Furthermore, the outer surface of the bobbin 1110 may be provided therein with a second seating groove 1026b in which the balancing magnet 1185 is seated, inserted, fixed or disposed.

For example, the first and second seating grooves 1026a and 1026b in the bobbin 1110 may be formed in outer surfaces of the bobbin 1110 which are opposed to each other. For example, the first seating groove 1026a may be formed in a first projection 1111A of the bobbin 1110, and the second seating groove 1026b may be formed in a second projection 1111B of the bobbin 1110.

The bobbin 1110 may include a guide protrusion 1104A configured to guide a portion of the first frame connector 1153 of the upper elastic member 1150. For example, the guide protrusion 1104A may project from the bottom surface of an escape portion 1112a of the bobbin 1110.

Referring to FIGS. 5, 7A, and 7B, the damper 1048 may be disposed between the bobbin 1110 and the upper elastic member 1150. For example, the damper 1048 may be disposed between the bobbin 1110 and the first frame connector 1153 of the upper elastic member 1150, and may be in contact with, coupled or attached to both the bobbin 1110 and the first frame connector 1153.

For example, the upper elastic member 1150 may include an extension (or a projection) which extends from the first frame connector 1153. The extension 1155 may be spaced apart from each of an outer frame 1152 and an inner frame 1151. The extension 1155 may be spaced apart both from one end of the first frame connector 1153 connected to the inner frame 1151 and from the other end of the first frame connector 1153 connected to the outer frame 1152. The extension 1155 may extend toward the upper surface of the bobbin 1110.

For example, a portion (or the end) of the extension 1155 may be disposed on the damper 1048 disposed on the upper surface of the bobbin 1110, and may overlap the damper 1048. For example, the bobbin 1110 may include a reception portion 1104B in which the damper 1048 is received or disposed. For example, the reception portion 1104B may be a groove. The reception portion 1104B may be depressed from the bottom surface of the escape portion 1112a of the bobbin 1110.

For example, the damper 1048 may be disposed between the reception portion 1104B of the bobbin 1110 and the extension 1155 of the upper elastic member 1150, and may be in contact with, coupled or attached to both the reception portion 1104B and the extension 1155. Because the damper 1048 is in contact with or attached to both the extension 1155 and the reception portion 1104B, the damper 1048 may serve to damper or absorb vibration of the bobbin 1110. For example, the damper 1048 may be made of a damping member (for example, silicone).

The first coil 1120 may be disposed or coupled to the bobbin 1110. For example, the first coil 1120 may be disposed or coupled to the outer surface of the bobbin 1110. For example, although the first coil 1120 may surround the outer surface of the bobbin 1110 in a rotational direction about the optical axis OA, the present disclosure is not limited thereto.

Although the first coil 1120 may be directly wound around the outer surface of the bobbin 1110, the present disclosure is not limited thereto. In another embodiment, the first coil 1120 may be provided as a coil ring wound around the bobbin 1110, or may be provided as an angled coil block.

Power or a drive signal may be supplied to the first coil 1120. The power or drive signal supplied to the first coil 1120 may be a DC signal, an AC signal, or a signal containing both DC and AC components, and may be of a voltage type or a current type.

When a drive signal (for example, a drive current) is supplied to the first coil 1120, electromagnetic force may be created by the electromagnetic interaction between the first coil 1120 and the magnet 1130, and the bobbin 1110 may be moved in the optical axis direction OA by the created electromagnetic force.

At the initial position of the AF operation unit, the bobbin 1110 may be moved upwards or downwards from the initial position of the AF operation unit, which is referred to as bidirectional driving of the AF operation unit. Alternatively, at the initial position of the AF operation unit, the bobbin 1110 may be moved upwards, which is referred to as unidirectional driving of the AF operation unit.

At the initial position of the AF operation unit, the first coil 1120 may correspond to or overlap the magnet 1130 disposed on the housing 1140 in a direction parallel to a line that is perpendicular to the optical axis OA and extends along the optical axis.

For example, the AF operation unit may include the bobbin 1110 and the components (for example, the first coil 1120, the sensing magnet 1180, and the balancing magnet 1180 and 1185) coupled to the bobbin 1110. The AF operation unit may further include the lens module 1400.

The initial position of the AF operation unit may be the original position of the AF operation unit in the state in which no electric power is applied to the coil 120 or the position at which the AF operation unit is located as the result of the upper and lower elastic members 1150 and 1160 being elastically deformed due only to the weight of the AF operation unit. In addition, the initial position of the bobbin 110 may be the position at which the AF operation unit is located when gravity acts in the direction from the bobbin 110 to the base 210 or when gravity acts in the direction from the base 210 to the bobbin 110.

The sensing magnet 180 may provide a magnetic field, which is detected by the first position sensor 1170, and the balancing magnet 1185 may serve to cancel out the influence of the magnetic field of the sensing magnet 1180 and to establish weight equilibrium with respect to the sensing magnet 1180.

The sensing magnet 1180 may alternatively be referred to as a “sensor magnet” or a “second magnet”. The sensing magnet 1180 may be disposed on the bobbin 1110 or may be coupled to the bobbin 1110. The sensing magnet 1180 may be disposed so as to face the first position sensor 1170. The balancing magnet 1185 may be disposed on the bobbin 1110 or may be coupled to the bobbin 1110. For example, the balancing magnet 1185 may be disposed opposite the sensing magnet 1180. The balancing magnet 1185 may alternatively be referred to as a “balancing member” or a “weight member”. In another embodiment, the balancing member may be a non-magnetic body.

For example, although each of the sensing magnet and the balancing magnet 1180 and 1185 may be a monopolar magnetized magnet having one N pole and one S pole, the disclosure is not limited thereto. In another embodiment, each of the sensing magnet and the balancing magnet 1180 and 1185 may be a bipolar magnetized magnet, which has two N poles and two S poles, or a tetrapolar magnetized magnet.

The sensing magnet 1180 may be moved together with the bobbin 1110 in the optical axis direction, and the first position sensor 1170 may detect the intensity or magnetic force of the magnetic field of the sensing magnet 1180, which is moved in the optical axis direction, and may output an output signal corresponding to the result of the detection.

For example, in accordance with displacement of the bobbin 1110 in the optical axis direction, the intensity or magnetic force of the magnetic field detected by the first position sensor 1170 may vary. Consequently, the first position sensor 1170 may output an output signal proportional to the detected intensity of the magnetic field, and the displacement of the bobbin 1110 in the optical axis direction may be detected using the output signal from the first position sensor 1170.

The housing 1140 may be disposed in the cover member 1300. For example, the housing 1140 may be disposed on the image sensor unit 1350.

The housing 1140 may receive therein the bobbin 1110, and may support the magnet 1130, the first position sensor 1170, and the circuit board 1190.

Referring to FIGS. 5 and 7A-8, the housing 1140 may have a hollow columnar shape. For example, the housing 1140 may have a polygonal (for example, a rectangular or octagonal) or circular bore, and the bore in the housing 1140 may be a through hole, which is formed through the housing 1140 in the optical axis direction.

The housing 1140 may include side portions, which correspond to or face the side plate 1302 of the cover member 1300, and corners, which correspond to or face the corners of the cover member 1300.

In order to inhibit direct collision with the inner surface of the upper plate 1301 of the cover member 1300, the housing 1140 may include a stopper 1145 provided at the upper portion, the upper surface or the upper end thereof.

Referring to FIG. 5, the housing 1140 may have a mounting groove (or a groove) 1014a configured to receive the circuit board 1190 therein. The mounting groove 1014a may have a shape corresponding to the shape of the circuit board 1190.

Referring to FIGS. 7A and 7B, the housing 1140 may include projections 1044A and 1044B surrounding at least one of the circuit board 1190 or the support board 1310. For example, the projections 1044A and 1044B may be disposed or formed on the outer surface of the housing 1140. For example, the projections 1044A and 1044B may be disposed or formed on the outer surface of the side portion of the housing 1140. The projections 1044A and 1044B may alternatively be referred to as “protectors”, “supports”, “extensions”, or “guides”.

The projections 1044A and 1044B of the housing 1140 may surround at least a portion of the circuit board 1190 and at least a portion of the support board 1310. For example, the housing 1140 may include a first projection 1044A disposed on the first side portion of the housing, and a second projection 1044B disposed on the second side portion of the housing 1140. The first projection 1044A and the second projection 1044B may be positioned opposite to each other based on the optical axis OA or the bobbin 1110. In another embodiment, the second projection 1044B may be omitted.

For example, the circuit board 1190 may be disposed in the first projection 1044A. For example, the mounting groove 1014A may be formed in the first projection 1044A.

For example, each of the first projection 1044A and the second projection 1044B may include a first portion 1047A connected to the upper surface of the housing 1140, and a second portion 1047B which is connected to the first portion 1047A and is spaced apart from the side portion of the housing 1140. For example, the first portion 1047A of the first projection 1044A may be connected to the upper surface of the first side portion of the housing 1140, and the first portion 1047A of the second projection 1044B may be connected to the upper surface of the second side portion of the housing 1140. For example, the first portion 1047A may project from the upper surface of the housing 1140 in the optical axis direction or in a direction toward the inner surface of the upper plate 1301 of the cover member 1300.

For example, at least a portion of the circuit board 1190 may be positioned between the first portion 1047A and the second portion 1047B of the first projection 1044A. Furthermore, for example, at least a portion of the support board 1310 may be positioned between the first portion 1047A and the second portion 1047B of the first projection 1044A.

The housing 1140 may include an opening through which the terminals B1 to B4 of a terminal member 1095 of the circuit board 1190 are exposed. The opening may be formed in the side portion of the housing 1140.

Each of the first projection 1044A and the second projection 1044B of the housing 1140 may include a third portion 1037C extending from the second portion 1047B. For example, the third portion 1037C may extend or project from the lower portion or the lower end of the second portion 1047B in a direction (for example, in a second horizontal direction) parallel to the outer surface of the first side portion (or the second side portion) of the housing 1140.

For example, the third portion 1037C may include a first of third portion extending from one end of the second portion 1047B, and a second of third portion extending from another end of the second portion. The first of third portion and the second of third portions may extend or project in opposite directions.

An adhesive or a sealing member may be disposed between the projections 1044A and 1044B of the housing 1140 and the cover member 1300. For example, the adhesive (or the sealing member) may be disposed between the projections 1044A and 1044B of the housing 1140 and the side plate 1302 of the cover member 1300 for bonding therebetween. The projections 1044A and 1044B may increase the coupling area between the projections and the side plate of the cover member 1300, and may stably couple the housing 1140 to the cover member 1300 without interference with the support board 1310.

The upper portion, the upper end or the upper surface of the housing 1140 may be provided with at least one first coupler, which is to be coupled to a first outer frame 1152 of the upper elastic member 1150. The lower portion, the lower end or the lower surface of the housing 1140 may be provided with a second coupler, which is to be coupled and fixed to a second outer frame 1162 of the lower elastic member 1160. For example, each of the first and second couplers of the housing 1140 may have the shape of a flat surface, a protrusion, or a groove.

A corner of the housing 1140 may be provided therethrough with a hole 1147 which is a path through which the wire 1220 extends. The hole 1147 may be a through hole which is formed through the housing 1140 in the optical axis direction. In another embodiment, the hole may be a structure depressed from the outer surface of the corner portion of the housing 1140, and at least a portion of the hole may be open at the outer surface of the corner portion. The number of holes 1147 in the housing 1140 may be equal to the number of support members.

The magnet 1130 may be disposed, coupled or fixed to the housing 1140 which is the stationary unit. For example, the magnet 1130 may be disposed, coupled or fixed to the side portion of the housing 1140. The magnet 1130 may include an AF operation magnet 1071A for AF operation. Furthermore, the magnet 1130 may include an OIS operation magnet 1071B for OIS operation. Hereinafter, the AF operation magnet 1071A may be represented as one of a first magnet and a second magnet, and the OIS operation magnet 1071B may be represented as the other of the first magnet and the second magnet.

In another embodiment, the magnet 1130 may be disposed, coupled or fixed to the corner portion of the housing.

For example, the magnet 1130 may include a plurality of magnet units. For example, the magnet 1130 may include first to fourth magnet units 1130-1 to 1130-4 disposed on the housing 1140. In another embodiment, the magnet 1130 may include two or more magnet units.

The magnet 1130 may be disposed on at least one of the side portion or the corner portion of the housing 1140. For example, at least a portion of the magnet 1130 may be disposed on the side portion or the corner portion of the housing 1140. Alternatively, for example, at least a portion of the magnet 1130 may be disposed on the side portion of the housing 1140, and the remaining portion of the magnet 1130 may be disposed at the corner portion of the housing 1140.

For example, each of the magnet units 1130-1 to 1130-4 may include a first portion disposed at a corresponding one of the four corners of the housing 140. Furthermore, each of the magnet units 1130-1 to 1130-4 may include a second portion disposed at a side portion of the housing 1140 adjacent to the corresponding corner of the housing 1140.

For example, the first magnet unit 1130-1 and the third magnet unit 1130-3 may be positioned opposite to each other in the first horizontal direction (for example, in the Y-axis direction) based on the housing 1140. For example, the second magnet unit 1130-2 and the fourth magnet unit 1130-4 may be positioned opposite to each other in the second horizontal direction (for example, in the X-axis direction) based on the housing 1140.

For example, the first magnet unit 130-1 and the third magnet unit 1130-3 may be disposed parallel to each other in the second horizontal direction (for example, in the X-axis direction), and the second magnet unit 1130-2 and the fourth magnet unit 1130-4 may be disposed parallel to each other in the first horizontal direction (for example, in the Y-axis direction).

At the initial position of the AF operation unit, the magnet 1130 may be disposed on the housing 1140 so as to partially overlap the first coil 1120 in a direction parallel to a line which is perpendicular to the optical axis OA and extends through the optical axis OA.

The magnet 1130 may include a monopolar magnetized magnet or a dipole magnet, which includes one N pole and one S pole. In another embodiment, the magnet 1130 may include a bipolar magnetized magnet or a quadrupole magnet, which includes two N poles and two S poles. In a further embodiment, the magnet 1130 may include both a monopolar magnetized magnet and a bipolar magnetized magnet.

For example, the magnet 1130 may include an AF magnet (or an AF operation magnet) for AF operation and an OIS magnet (or an OIS operation magnet) for OIS operation. In another embodiment, for example, the magnet 1130 may be a common magnet for AF operation and OIS operation.

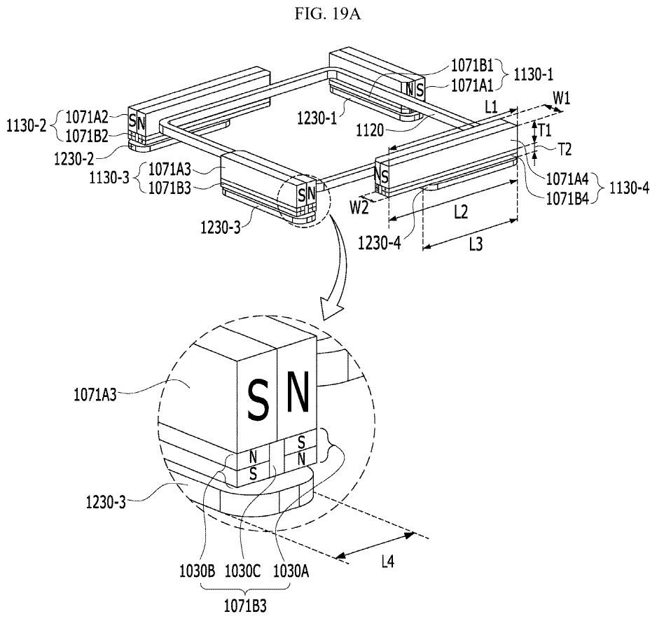

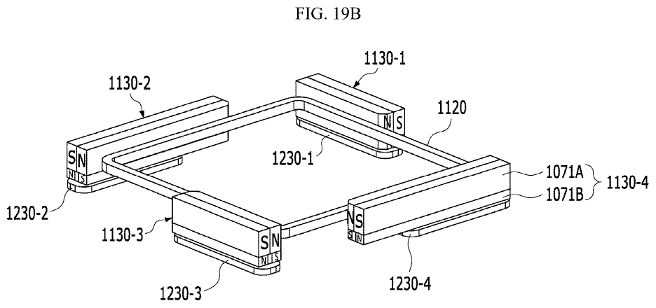

FIG. 19A illustrates an embodiment of the magnet 1130 shown in FIG. 5.

Referring to FIG. 19A, the magnet 1130 may include the first magnet 1071A, which is an AF operation magnet, and the second magnet 1071B disposed below the first magnet 1071A.

The first magnet 1071A may be a dipole magnet including one N pole and one S pole. For example, the N pole and the S pole of the first magnet 1071A may be disposed so as to face or be opposed to each other in a direction perpendicular to the optical axis. In another embodiment, the first magnet 1071A may be a quadrupole magnet including two N poles and two S poles.

The first magnet 1071A may include a plurality of magnet units 1071A1 to 1071A4. As mentioned above, each of the plurality of magnet units 1071A1 to 1071A4 may be a dipole magnet or a quadrupole magnet. For example, the magnet units 1071A1 to 1071A4 may have the same size and shape. For example, two magnet units 1071A1 and 1071A3, which are opposed to each other in a first diagonal direction, may have the same size and shape, and the two remaining magnet units 1071A2 and 1071A4, which are opposed to each other in a second diagonal direction, may have the same size and shape.

In another embodiment, the size and the shape of each of the two magnet units 1071A1 and 1071A3 may be different from the size and the shape of each of the two remaining magnet units 1071A2 and 1072A4. For example, the length of the long side of each of the two magnet units 1071A1 and 1071A3 may be greater than the length of the long side of each of the two remaining magnet units 1071A2 and 1071A4. For example, the length of the short side of each of the two magnet units 1071A and 1071A3 may be equal to the length of the short side of each of the two remaining magnet units 1071A2 and 1071A4.

The second magnet 1071B may be a quadrupole magnet including two N poles and two S poles. For example, the second magnet 1071B may include a first magnet portion 1030A, a second magnet portion 1030B, and a partition wall 1030C disposed between the first magnet portion 1030A and the second magnet portion 1030B. Here, the partition wall 1030C may be a non-magnetic material or air, and may be referred to as a “neutral zone”. In another embodiment, the second magnet 1071B may be a dipole magnet including one N pole and one S pole.

For example, the first magnet portion 1030A and the second magnet portion 1030B may be spaced apart from each other in a direction perpendicular to the first direction (or the optical axis direction). For example, the first magnet portion 1030A may include a first N pole and a first S pole which are opposed to or face each other in the optical axis direction. The second magnet portion 1030B may include a second N pole and a second S pole which are opposed to or face each other in the optical axis direction. Furthermore, the first N pole (or the first S pole) of the first magnet portion 1030A and the second S pole (or the second N pole) of the second magnet portion 1030B may be opposed to or face each other in a direction perpendicular to the optical axis.

The second magnet 1071B may include a plurality of magnet units 1071B1 to 1071B4. As mentioned above, each of the plurality of magnet units 1071B1 to 1071B4 may be a quadrupole magnet. In another embodiment, each of the magnet units 1071B1 to 1071B4 may be a dipole magnet. Each of the magnet units 1071B1 to 1071B4 may face or overlap a corresponding one of the second coil units 1230-1 to 1230-4.

For example, the magnet units 1071B1 to 1071B4 may have the same size and shape. For example, two magnet units 1071B1 and 1071B3, which are opposed to each other in the first diagonal direction, may have the same size and shape, and the two remaining magnet units 1071B2 and 1071B4, which are opposed to each other in the second diagonal direction, may have the same size and shape.

In another embodiment, the size and shape of each of the two magnet units 1071B1 and 1071B3 may be different from the size and shape of each of the two remaining magnet units 1071B2 and 1071B4. For example, the length of the long side of each of the two magnet units 1071B1 and 1071B3 may be greater than the length of the long side of each of the two remaining magnet units 1071B2 and 1071B4. For example, the length of the short side of each of the two magnet units 1071B1 and 1071B3 may be equal to the length of the short side of each of the two remaining magnet units 1071B2 and 1071B4.

The second magnet 1071B may be disposed below the first magnet 1071A. The second magnet 1071B may be disposed on the lower surface of the first magnet 1071A. For example, the upper surface of the second magnet 1071B may be in contact with the lower surface of the first magnet 1071A or may be fixed or coupled to the lower surface of the first magnet 1071A by means of an adhesive. For example, at least a portion of the first magnet 1071A may overlap at least a portion of the second magnet 1071B in the first direction (or in the optical axis direction).

In another embodiment, the second magnet may be spaced apart from the first magnet. Here, a portion of the housing 1140 may be disposed between the first magnet and the second magnet. In another embodiment, a partition wall or a Yoke may be disposed between the first magnet and the second magnet. Here, the description of the partition wall 1030C may be applied to the partition wall with or without modification.

For example, the length T2 of the second magnet 1071B in the optical axis direction may be less than the length T1 of the first magnet 1071A in the optical axis direction (T2<T1). In another embodiment, the length T2 may be equal to the length T1.

The length L2 of the long side of the second magnet 1071B may be equal to or less than the length L1 of the long side of the first magnet 1071A (L2≤L1). In another embodiment, the length L2 may be greater than the length L1.

Furthermore, the width W2 (or the length of the short side) of the second magnet 1071B may be equal to or less than the width W1 (or the length of the short side) of the first magnet 1071A (W2≤W1). In another embodiment, the width W2 may be greater than the width W1.

At the initial position of the AF moving unit, the first coil 1120 may face or overlap the first magnet 1071A in a direction perpendicular to the first direction (or the optical axis direction). Although the N pole of the first magnet 1071A may be disposed so as to face the first coil 1120 or may be positioned closer to the first coil 1120 than the S pole in FIG. 19A, the disposition may be reversed in another embodiment.

For example, at the initial position of the OIS moving unit, at least a portion of the first magnet 1130 may overlap at least a portion of the second coil 1230 in the first direction (or in the optical axis direction). For example, at the initial position of the OIS moving unit, at least a portion of the second magnet 1071B may overlap at least a portion of the second coil 1230 in the first direction (or in the optical axis direction).

The length L2 of the long side of the second magnet 1071B may be greater than the length L3 of the long side of the second coil 1230 (L2>L3). In another embodiment, the length of the long side of the second magnet 1071B may be equal to or less than the length of the long side of the second coil 1230.

The width W2 (or the length of the short side) of the second magnet 1071B may be greater than the length L4 of the short side of the second coil 1230 (W2>L4). In another embodiment, the length of the long side of the second magnet 1071B may be equal to or less than the length of the long side of the second coil 1230.

For example, the length of the long side of each of two magnet units 1081B1 and 1071B3 of the second magnet 1071B may be less than the length of the long side of each of the coil units 1230-1 and 1230-3 of the second coil 1230. In another embodiment, the length of the long side of each of the two magnet units 1071B1 and 1071B3 may be equal to or greater than the length of the long side of each of the coil units 1230-1 and 1230-3.

Furthermore, the length of the long side of each of the two remaining magnet units 1071B2 and 1071B4 of the second magnet 1071B may be greater than the length of the long side of each of the coil units 1230-2 and 1230-4 of the second coil 1230. In another embodiment, the length of the long side of each of the magnet units 1071B2 and 1071B4 may be equal to or less than the length of the long side of each of the coil units 1230-2 and 1230-4 of the second coil 1230.

For example, the length of the short side of each of the first to fourth magnet units 1071B1 to 1071B4 of the second magnet 1071B may be less than the length of the short side of each of the first to fourth coil units 1230-1 to 1230-4 of the second coil 1230. In another embodiment, the length of the short side of each of the first to fourth magnet units 1071B to 1071B4 may be greater than the length of the short side of each of the first to fourth coil units 1230-1 to 1230-4.

FIG. 19B illustrates another embodiment of the magnet 1130 shown in FIG. 5.

Referring to FIG. 19B, the second magnet 1071BB shown in FIG. 19B may be a dipole magnet including one N pole and one S pole. The description of the lengths T2, L2 and W2 of the second magnet 1071B shown in FIG. 19A may be applied to the second magnet 1071BB shown in FIG. 19B with or without modification.

The circuit board 1190 may be disposed on the housing 1140, and the first position sensor 1170 may be disposed or mounted on the circuit board 1190 and may be electrically connected to the circuit board 1190. For example, the circuit board 1190 may be disposed in the mounting groove 1014A in the housing 1140, and the terminal member 1095 of the circuit board 1190 may be exposed to the outside of the housing 1140.

The circuit board 1190 may include the terminal member (or terminal unit) 1095 including a plurality of terminals B1 to B4 electrically connected to an external terminal or an external device. The plurality of terminals B1 to B4 of the circuit board 1190 may be electrically connected to the first position sensor 1170.

The first position sensor 1170 may be disposed on the housing 1140 and/or the circuit board 1190. For example, the first position sensor 1170 may be disposed on the first surface of the circuit board 1190, and the plurality of terminals B1 to B4 may be disposed on the second surface of the circuit board 1190. Here, the second surface of the circuit board 1190 may be the opposite surface of the first surface of the circuit board 1190. For example, the first surface of the circuit board 1190 may be a surface of the circuit board 1190 which faces the bobbin 1110 or the sensing magnet 1180. For example, the circuit board 1190 may be a printed circuit board or a flexible printed circuit board.

The first position sensor 1170 may be electrically connected to the circuit board 1190. For example, the first position sensor 1170 may be electrically connected to the first to fourth terminals B1 to B4 of the circuit board 1190. For example, the circuit board 1190 may include a circuit pattern or a wire (not shown) configured to electrically connect the first to fourth terminals B1 to B4 to the first position sensor 1170.

For example, at the initial position of the AF operation unit, at least a portion of the first position sensor 1170 may face or overlap the sensing magnet 1180 in a direction parallel to a line which is perpendicular to the optical axis OA and extends through the optical axis OA. In another embodiment, at the initial position of the AF operation unit, the first position sensor may not face or overlap the sensing magnet.

The first position sensor 1170 may serve to detect movement, displacement or position of the bobbin 1110 in the optical axis direction. In other words, the first position sensor 1170 may detect a magnetic field or intensity of a magnetic field of the sensing magnet 1180 mounted on the bobbin 1110 caused by movement of the bobbin 1110, and may output an output signal corresponding to the result of detection. Accordingly, movement, displacement or position of the bobbin 1110 may be detected using the output of the first position sensor 1170.

The first position sensor 1170 may be a driver IC including a Hall sensor and a driver. The position sensor 1170 may include first to fourth terminals for transmitting and receiving data to and from an external device through data communication using a protocol, such as I2C communication, and fifth and sixth terminals for directly supplying a drive signal to the coil 1120.

For example, each of the first to fourth terminals of the first position sensor 1170 may be electrically connected to a corresponding one of the first to fourth terminals B1 to B4 of the circuit board 1190 using solder or a conductive adhesive.

For example, the fifth and sixth terminals of the first position sensor 1170 may be electrically connected to the first coil 1120. For example, the first position sensor 1170 may be electrically connected to the first coil 1120 via at least one of the upper elastic member 1150 and the lower elastic member 1160 so as to supply a drive signal to the first coil 1120.

For example, a portion of the first upper elastic unit 1150-1 may be connected to one end of the first coil 1120, and another portion of the first upper elastic unit 1150-1 may be electrically connected to the circuit board 1190. A portion of the second upper elastic unit 1150-2 may be connected to the other end of the first coil 1120, and another portion of the second upper elastic unit 1150-2 may be electrically connected to the circuit board 1190. The circuit board 1190 may include a first pad 5A electrically connected to another portion of the first upper elastic unit 1150-1, and a second pad 5B electrically connected to another portion of the second upper elastic unit 1150-2. Each of the fifth and sixth terminals of the first position sensor 1170 may be electrically connected to a corresponding one of the first and second pads 5A and 5B of the circuit board 1190.

In another embodiment, the first coil 1120 may be electrically connected to the circuit board 1190 and the fifth and sixth terminals of the first position sensor 1170 via two lower elastic members.

For example, in an embodiment in which the first position sensor 1170 is a driver IC, the first and second terminals B1 and B2 of the circuit board 1190 may be power terminals for supplying power, the third terminal B3 may be a terminal for transmitting and receiving a clock signal, and the fourth terminal B4 may be a terminal for transmitting and receiving a data signal.

In another embodiment, the first position sensor 1170 may be a Hall sensor. Here, the first position sensor 1170 may include two input terminals, to which drive signals or power are supplied, and two output terminals, through which a sensing voltage (or an output voltage) is output. For example, drive signals may be supplied to the first position sensor 1170 through the first and second terminals B1 and B2 of the circuit board 1190, and the output of the first position sensor 1170 may be output to the outside through the third and fourth terminals B3 and B4. Furthermore, the first coil 1120 may be electrically connected to the circuit board 1190. The circuit board 1190 may further include two additional terminals in addition to the first to fourth terminals B1 to B4 such that an external drive signal may be supplied to the first coil 1120 via the two additional terminals.

For example, a ground terminal among the power terminals of the first position sensor 1170 may be electrically connected to the cover member 1300.

The capacitor 1195 may be disposed or mounted on the first surface of the circuit board 1190. The capacitor 1195 may be configured to have a chip shape. Here, the chip may include a first terminal, which corresponds to one end of the capacitor 1195, and a second terminal, which corresponds to the other end of the capacitor 1195. The capacitor 1195 may alternatively be referred to as a “capacitive element” or “condenser”.

The capacitor 1195 may be electrically connected in parallel to first and second terminals B1 and B2 of the circuit board 1190 through which power (or a drive signal) is supplied to the first position sensor 1170 from the outside. Alternatively, the capacitor 1195 may be electrically connected in parallel to the terminals of the first position sensor 1170, which is electrically connected to the first and second terminals B1 and B2 of the circuit board 1190.

Since the capacitor 1195 is electrically connected in parallel to the first and second terminals B1 and B2 of the circuit board 1190, the capacitor 1195 is capable of serving as a smoothing circuit for eliminating ripple components included in the power signals GND and VDD, which are supplied to the first position sensor 1170 from the outside, and is thus capable of supplying stable and consistent power signals to the first position sensor 1170.

In another embodiment, the sensing magnet 1180 may be disposed on the housing 1140, and the first position sensor 1170 may be disposed on the bobbin 1110. In another embodiment, the balancing magnet 1185 may be omitted.

The upper elastic member 1150 and the lower elastic member 1160 may be coupled to the bobbin 1110 and the housing 1140. For example, the upper elastic member 1150 may be coupled to the upper portion, the upper end or the upper surface of the bobbin 1110 and the upper portion, the upper end or the upper surface of the housing 1140, and the lower elastic member 1160 may be coupled to the lower portion, the lower end or the lower surface of the bobbin 1110 or the upper portion, the upper end or the upper surface of the housing 1140. The upper elastic member 1150 and the lower elastic member 1160 may elastically support the bobbin 1110 with respect to the housing 1140.

The upper elastic member 1150 may include a plurality of upper elastic units (for example, 1150-1 to 1150-4) which are electrically separated or spaced apart from each other. Although the lower elastic member 1160 is embodied as a single elastic unit, the lower elastic member 1160 may include a plurality of lower elastic units which are electrically separated or spaced apart from each other in another embodiment. In another embodiment, at least one of the upper elastic member or the lower elastic member may be embodied as a single unit or a single structure.

The upper elastic member 1150 may further include a first inner frame 1151 coupled or fixed to the upper portion, the upper surface or the upper end of the bobbin 1110, a second inner frame 1152 coupled or fixed to the upper portion, the upper surface or the upper end of the housing 1140, and a first frame connector 1153 connecting the first inner frame 1151 to the first outer frame 1152. Furthermore, the upper elastic member 1150 may include the above-mentioned extension 1155.

The lower elastic member 1160 may include a second inner frame 1161 coupled or fixed to the lower portion, the lower surface or the lower end of the bobbin 1110, a second outer frames 162-1 to 162-3 coupled or fixed to the lower portion, the lower surface or the lower end of the housing 1140, and a second frame connector 1163 connecting the second inner frame 1161 to the second outer frame 1162. The inner frame may alternatively be referred to as an inner portion, the outer frame may alternatively be referred to as an outer portion, and the frame connector may alternatively be referred to as a connector.

Each of the first and second frame connectors 1153 and 1163 may be bent or curved (or may be formed into a curved line) at least once so as to define a predetermined pattern.

Each of the upper elastic member 1150 and the lower elastic member 1160 may be made of a conductive material, for example, a metal material. Furthermore, each of the upper elastic member 1150 and the lower elastic member 1160 may be made of an elastic member, for example, a leaf spring or the like.

Referring to FIGS. 5, 7A and 7B, for example, the second outer frame 1152 of the first upper elastic unit 1150-1 may include a first bonding portion 1004A coupled or electrically connected to the first pad 5A of the circuit board 1190, and the second outer frame 1152 of the second upper elastic unit 1150-2 may include a second bonding portion 1004B electrically connected to the second pad 5B of the circuit board 1190.

In another embodiment, at least one of the upper elastic member 1150 or the lower elastic member 1160 may include two elastic members. For example, each of two elastic members of one of the upper elastic member 1150 and the lower elastic member 1160 may be coupled or electrically connected to a corresponding one of the first and second pads of the circuit board 1190. The first coil 1120 may be electrically connected to the two elastic members.

The first outer frame 1152 of the upper elastic member 1150 may include a first coupler 1510 coupled to the housing 1140, a second coupler 1520 coupled to the wire 1220, and a connector 1530 connecting the first coupler 1510 to the second coupler 1520. The first coupler 1510 may have a through hole or a hole to be coupled to the first coupler 1143 of the housing 1140. The second coupler 1520 may have a through hole or a hole to be coupled to the wire 1220. For example, the second coupler 1520 may be coupled to the wire 1220 using a conductive adhesive or solder. For example, although the connector 1530 may include a bent portion, which is bent at least once, or a curved portion, which is curved at least once, the disclosure is not limited thereto. In another embodiment, the connector 1530 may have a linear shape.

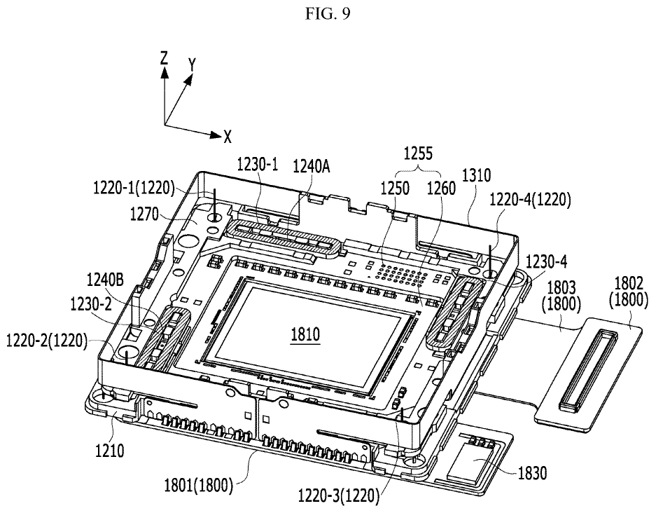

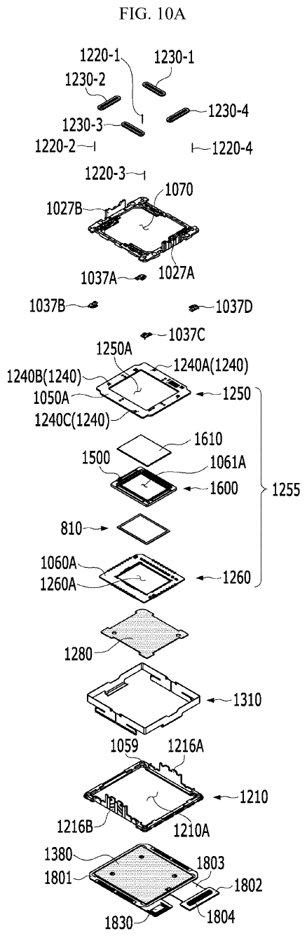

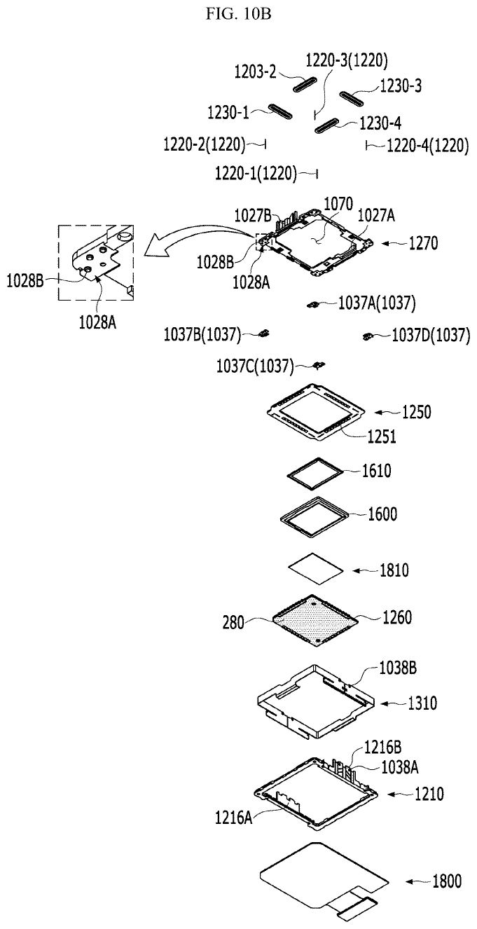

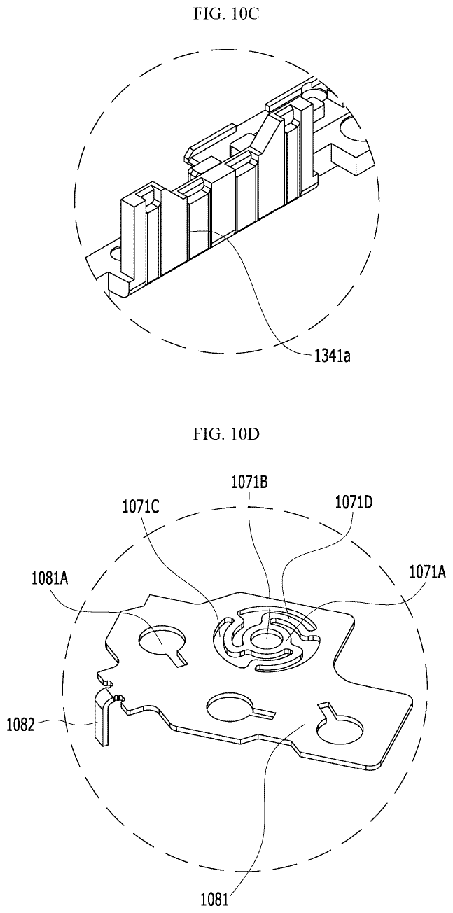

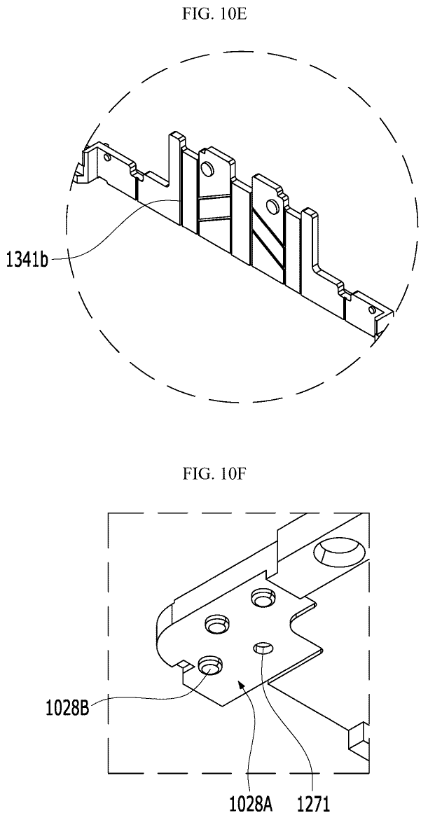

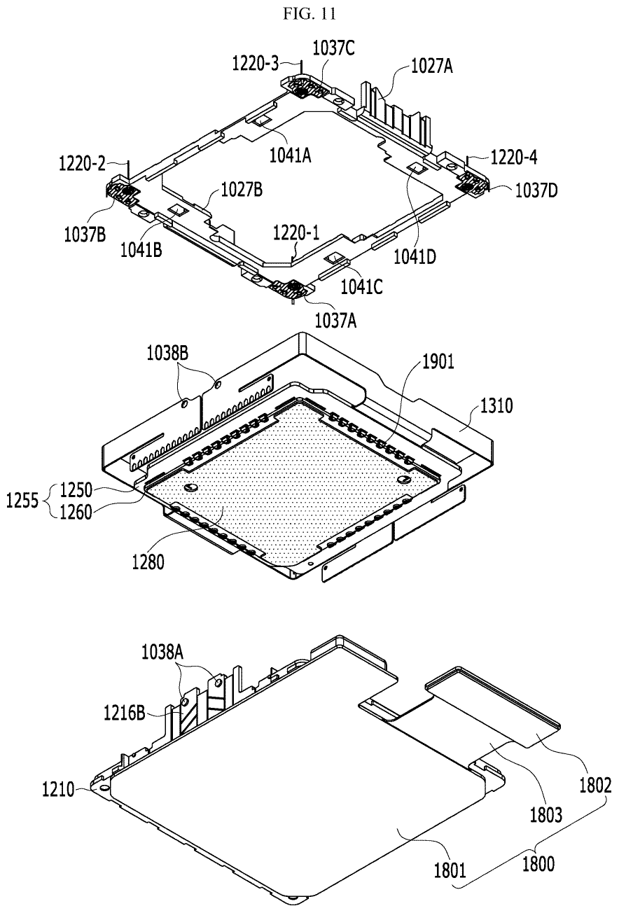

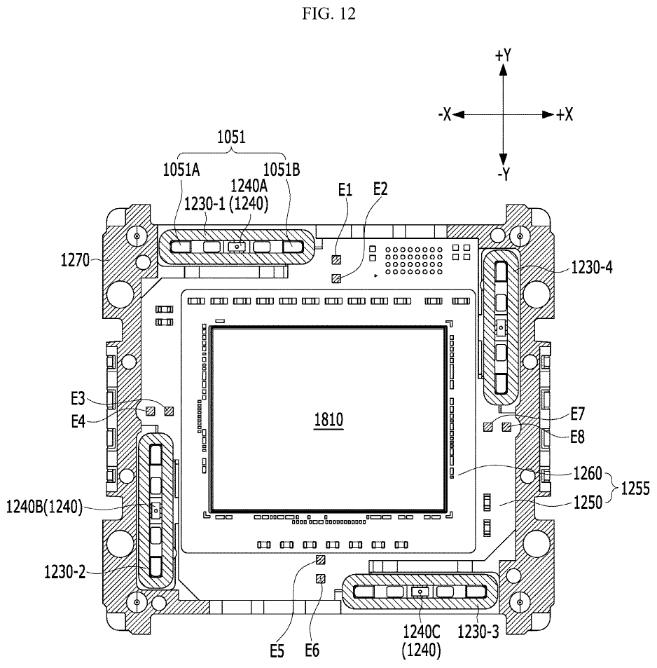

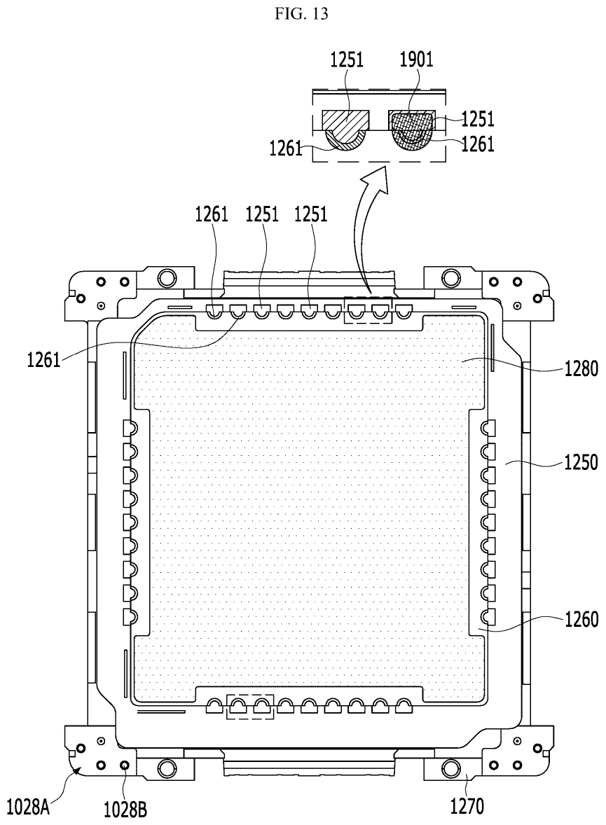

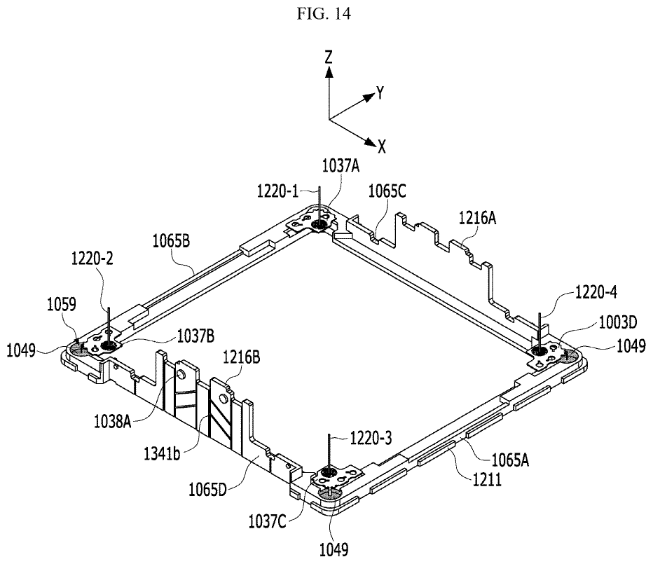

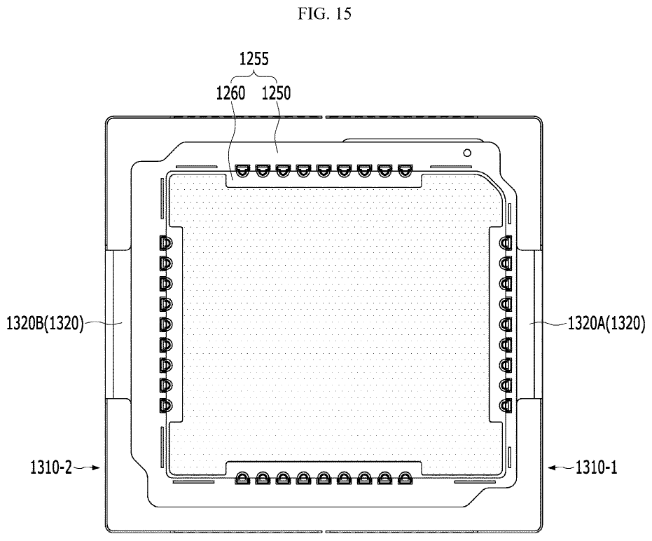

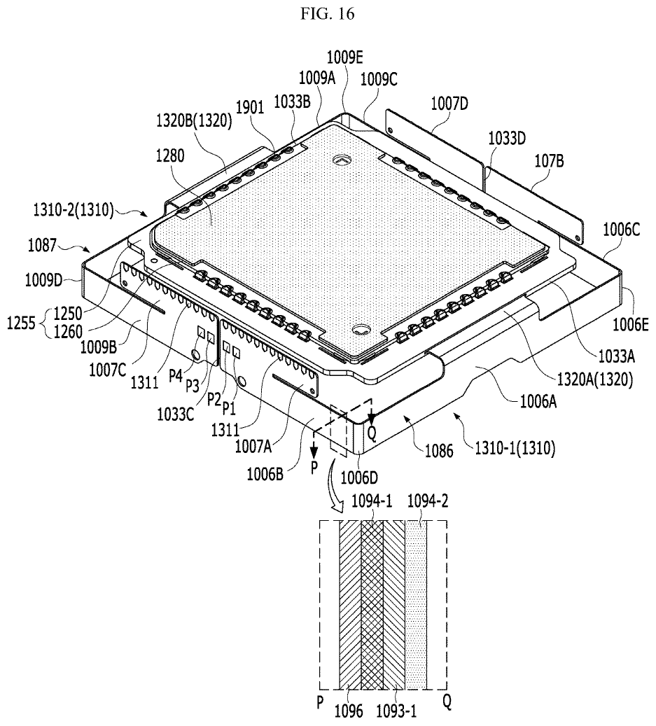

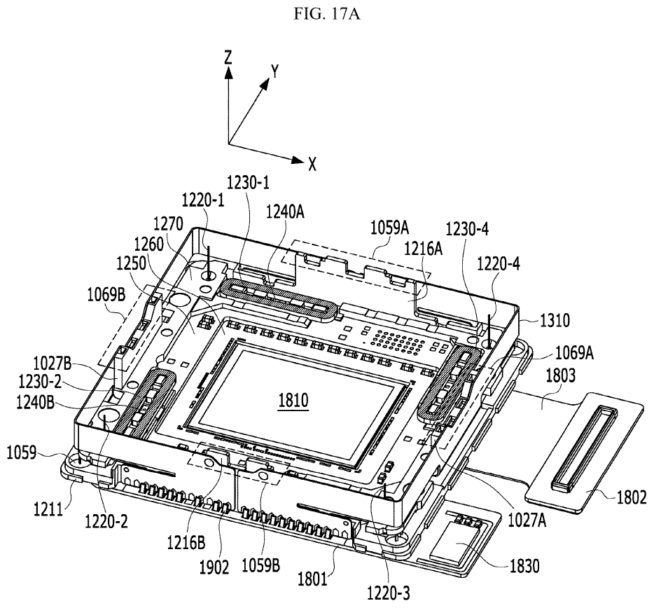

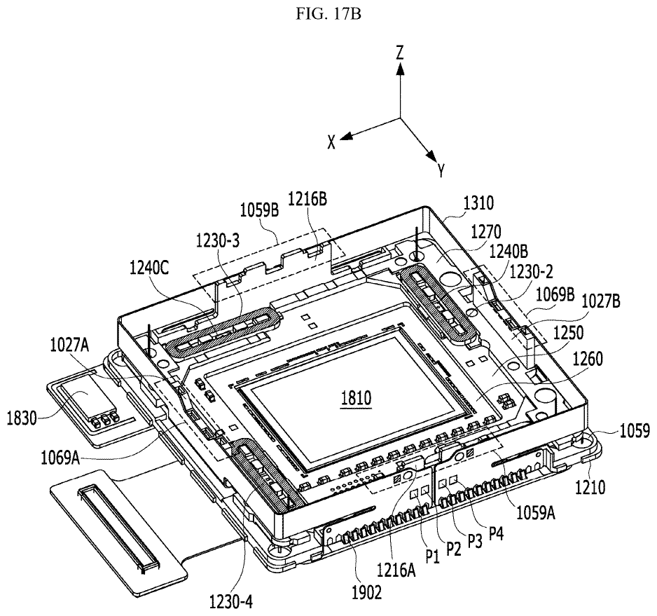

FIG. 9 is a perspective view of the image sensor unit 1350. FIG. 10A is a first exploded perspective view of the image sensor unit 1350 shown in FIG. 9. FIG. 10B is a second exploded perspective view of the image sensor unit 1350 shown in FIG. 9. FIG. 10C is an enlarge view of the groove 1341a in the holder 1270 shown in FIG. 10A. FIG. 10D is an enlarged view of the terminal member 1037 shown in FIG. 10A. FIG. 10E is an enlarged view of the groove 1341b in the base 1210 shown in FIG. 10A. FIG. 10F is an enlarged view of the groove 1028A in the holder 1270 in which the terminal member 1037 shown in FIG. 10B is disposed. FIG. 11 is a bottom perspective view of the holder 1270, the terminal member 1037, the first board unit 1255, the support board 1310, the heat radiating member 1280, the base 1210, and the second board unit 1800, which are shown in FIG. 10A. FIG. 12 is a plan view of the holder 1270, the first board unit 1255, the image sensor 1810, the second coil 1230, and the OIS position sensor 1240. FIG. 13 is a rear perspective view of the holder 1270 and the first board unit 1255. FIG. 14 is a perspective view of the base 1210, the terminal member 1037, and the wire 1220. FIG. 15 is a bottom view of the first board unit 1255, the support board 1310, and the heat radiating member 1280. FIG. 16 is a perspective view of the first board unit 1255, the support board 1310, and the heat radiating member 1280. FIG. 17A is a first perspective view of the support board 1310 coupled to the holder 1270 and the base 1210. FIG. 17B is a second perspective view of the support board 1310 coupled to the holder 1270 and the base 1210.

Referring to FIGS. 9 to 17B, the image sensor unit 1350 may include a stationary unit and the OIS moving unit which is disposed so as to be spaced apart from the stationary unit. The image sensor unit 1350 may include a support unit connecting the stationary unit to the OIS moving unit.

For example, the support unit may include the support board 1310. Alternatively, for example, the support unit may be the support board 1310. In another embodiment, the support unit may include an elastic member, for example, a leaf spring or a suspension wire in place of the support board 1310.

The stationary unit may be a portion of the camera device 1010 which is immovable during OIS operation. For example, the stationary unit may include the board unit 1800. For example, the stationary unit may include a component coupled to the second board unit 1800. The board unit 1255 or 1800 may alternatively be referred to as a “board” or a “circuit board”.

For example, the stationary unit may include the base 1210 coupled to the second board unit 1800. For example, the stationary unit may include the housing 1140 of the AF operation unit, and components disposed on the housing 1140, for example, the magnet 1130, the first position sensor 1170 and the circuit board 1190. Furthermore, the stationary unit may include the cover member 1300 coupled to the base 1210. The OIS moving unit may be disposed in the cover member 1300. For example, the cover member 1300 may accommodate therein the OIS moving unit and the support board 1310.

The OIS moving unit may include the image sensor 1810. The OIS moving unit may further include the first board unit 1255, which is spaced apart from the second board unit 1800 and is electrically connected to the second board unit 1800. For example, the OIS moving unit may include components disposed on the first board unit 1255, for example, at least one of the heat radiating member 1280, the holder 1270, the second coil 1230, and the second position sensor 1240. The holder 1270 may alternatively be referred to as a “spacer member”. In another embodiment, the holder 1270 may be omitted, and the second coil 1230 may be disposed on the first board unit 1255, for example, the first circuit board 1250.

For example, the camera device 1010 may include the stationary unit, the moving unit including the first heat radiating member 1280 disposed on the stationary unit and the image sensor 1810 disposed in the first heat radiating member 1280, and the support unit (for example, 1310) configured to support the moving unit while allowing the moving unit to be movable in a direction perpendicular to the optical axis direction. The support unit (for example, 1310) may be connected between the moving unit and the stationary unit.

The moving unit may include the first board unit 1255 on which the image sensor 1810 is disposed, the stationary unit may include the second board unit 1800 which is disposed so as to be spaced apart from the first board unit 1255, and the support unit may connect the first board unit 255 to the second board unit 1800.

The support unit may include a conductive layer 1093-1, a first insulating layer 1094-1 disposed below the conductive layer 1093-1, and a second insulating layer 1094-2 disposed on the conductive layer 1093-1. The support unit may be constructed such that a portion of the first insulating layer 1094-1 is removed so as to expose an area of the conductive layer 1093-1 through the removed portion.

The first board unit 1255 may include the first circuit board 1250, a second circuit board 1260 electrically connected to the image sensor 1810, and a solder 1901 electrically connecting the first circuit board 1250 to the second circuit board 1260.

The camera device 1010 may include an elastic member 1220 (referred to hereinafter as a “wire”) configured to flexibly support the OIS moving unit. The elastic member 1220 may have the form of a wire or a spring.

For example, one end of the wire 1220 may be coupled to the upper elastic member 1150 (or the housing 1140), and the other end of the wire 1220 may be coupled to the holder 1270. For example, one end of the wire 1220 may be coupled to the first outer frame 1152 (for example, the second coupler 1520) of the upper elastic member 1150 using solder or a conductive adhesive. For example, the other end of the wire 1220 may be coupled to the terminal member 1037, and the terminal member 1037 may be disposed on or coupled to the holder 1270 using solder or a conductive adhesive.

Referring to FIGS. 7A and 7B, a damper DA may be disposed between one end of the wire 1220, which extends through the hole 1147 in the housing 1140, and the hole 1147 in the housing 1140. For example, at least a portion of the damper DA may be disposed in the hole 1147 in the housing 1140, and may be coupled or attached both to at least a portion of the wire 1220 and to the housing 1140.

For example, the wire 1220 may be disposed parallel to the optical axis direction. For example, the wire 1220 may be disposed at the corner of the housing 1140 and/or the corner of the holder 1270. For example, the wire 1220 may include four wires 1220-1 to 1220-4. Each of the four wires 1220-1 to 1220-4 may be disposed on a corresponding one of the four corners of the housing 1140 and/or the four corners of the holder 1270.

Referring to FIGS. 10A to 10F, the holder 1270 may have formed therein a hole 1271 through which at least a portion of the wire 1220 extends. For example, the corner of the holder 1270 may have formed therethrough the hole 1271 through which the other end of the wire 1220 extends. For example, each of the four corners of the holder 1270 may have formed therein the hole 1271. For example, although the hole 1271 may be a through hole which is formed through the holder 1270 in the optical axis direction, the hole 1271 may have the form of an escape groove in another embodiment.

For example, the terminal member 1037 may be disposed on or coupled to the upper surface or the lower surface of the holder 1270. For example, the terminal member 1037 may be disposed on or coupled to the lower surface of the corner of the holder 1270. The holder 1270 may have formed therein a groove 1028A in which the terminal member 1037 is disposed. For example, the groove 1028A may be formed in the lower surface of the corner of the holder 1270.

The holder 1270 may include at least one protrusion 1028B, and the terminal member 1037 may have at least one hole 1081A to be coupled to the at least one protrusion 1028B of the holder 1270. The terminal member 1037 and the holder 1270 may be coupled to each other using an adhesive or through heat fusion. The terminal member 1037 may have a hole 1071B to which the other end of the wire 1220 is inserted or coupled. For example, each of the holes 1081A and 1071B may be a through hole.

For example, the terminal member 1037 may include a body 1081 coupled to the holder 1270. The body 1081 may include a coupler 1071 coupled to the wire 1220. The coupler 1071 may include a coupling region 1071A coupled to the wire 1220 and a hole 1071B formed in the first coupling region 1071A. The coupling region 1071A may be a region of the body 1081 which is coupled to the wire 1220 using solder or a conductive adhesive. For example, the other end of the wire 1220 that has passed through the hole 1071B may be coupled to the lower portion or the lower surface of the coupling region 1071A using solder or a conductive adhesive.

For example, the body 1081 may have at least one hole10 1071C formed around the coupling region 1071A. For example, the body 1081 may have a plurality of holes 1071C surrounding the coupling region 1071A. For example, the plurality of holes 1071C may be spaced apart from the hole 1071B.

The body 1081 may include a support portion which is positioned between the plurality of holes 1071C so as to support the coupling region 1071A. The support portion 1071D may alternatively be referred as a “connector” or a “bridge”. The support portion 1071D may include a plurality of support portions which are spaced apart from each other. The support portion 1071D may be connected to the coupling region 1071A.

The at least one hole 1071C may serve to enable solder to be mainly formed only in the coupling region 1071A by virtue of interfacial tension (for example, surface tension) at the peripheral area of the coupling region 1071A during soldering.

The coupling region 1071A must be heated in order to perform soldering. Here, the at least one hole 1071C may suppress or block transmission of heat of the coupling region 1071A to another region while inhibiting a soldered portion from being formed in the remaining region of the body 1081. In other words, the at least one hole 1071C is able to improve soldering efficiency.

The terminal member 1037 may include an extension 1082 which extends from the body 1081. The extension 1082 may be bent downwards at the body 1081 and may extend downwards. For example, the extension 1082 may extend toward a hole 1059 in the base 1210. The extension 82 may alternatively be referred to as a “bent portion”.

For example, the terminal member 1037 may include four terminals 1037A to 1037D corresponding to the four wires 1220-1 to 1220-4 of the terminal member 1037. Each of the terminals 1037A to 1037D may be disposed on a corresponding one of the corners of the holder 1270, and may be coupled to a corresponding one of the wires 1220-1 to 1220-4. The description of FIG. 10A may be applied to the structure of each of the terminals 1037A to 1037D with or without modification. The terminal member 1037 may be made of a conductive material, for example, metal. In another embodiment, the terminal member 1037 may be omitted, and the wire 1220 may be directly coupled to the holder 1270.

Referring to FIG. 14, a damper or adhesive 1049 may be disposed between the terminal member 1037 and the base 1210, and may be in contact with or coupled or attached both to the terminal member 1037 and to the base 1210. For example, the base 1210 may have the hole 1059 (or the groove) formed at a location which corresponds to or faces the terminal member 1037. For example, the hole 1059 (or the groove) may be formed in the corner of the base 1210.

For example, the damper 1049 may be disposed in the hole 1059 in the base 1210. Alternatively, at least a portion of the extension 1082 of the terminal member 1037 may be disposed in the hole 1059 in the base 1210, and the damper 1049 may be in contact with or coupled or attached to the extension 1082. The damper 1049 may serve to absorb or mitigate vibration of the OIS moving unit, thereby inhibiting or suppressing oscillation of the OIS moving unit during OIS operation.

In another embodiment, the extension 1082 may be omitted from the terminal member 1037, and the camera device 1010 may not include the damper 1049 shown in FIG. 14.

The support board 1310 may support the OIS moving unit with regard to the stationary unit such that the OIS moving unit is moved in a direction perpendicular to the optical axis, is tilted relative to the optical axis, or is rotated within a predetermined range.

For example, one end of the support board 1310 may be connected or coupled to the first board unit 1255, and another end of the support board 1310 may be connected or coupled to the second board unit 1800.

The holder 1270 may be disposed below the AF operation unit. For example, the holder 1270 may be made of a non-conductive member. For example, the holder 1270 may be made of an injectable material which is easily shaped through an injection molding process. Furthermore, the holder 1270 may be made of an insulative material. Furthermore, for example, the holder 1270 may be made of resin or plastic.

Referring to FIGS. 10A, 10F and 12, the holder 1270 may include an upper surface, a lower surface which is opposed to the upper surface, and a side surface (for example, an outer surface) connecting the upper surface to the lower surface. For example, the lower surface of the holder 1270 may be opposed to or face the second board unit 1800.

The holder 1270 may support the first board unit 1255, and may be coupled to the first board unit 1255. For example, the first board unit 1255 may be disposed below the holder 1270. The lower portion, the lower surface or the lower end of the holder 1270 may be coupled to the upper portion, the upper surface or the upper end of the first board unit 1255. For example, the holder 1270 may be coupled to the first board unit 1255 using an adhesive. In another embodiment, for example, the first board unit 1255 may be disposed above the holder 1270.

The holder 1270 may accommodate or support the second coil 1230. The holder 1270 may support the second coil 1230 in the state of being spaced apart from the first board unit 1255. For example, at least a portion of the holder 1270 may be disposed between the second coil 1230 and the first board unit 1255.

The holder 1270 may have a bore 1070 corresponding to one area of the first board unit 1255. For example, the bore 1070 in the holder 1270 may be a through hole which is formed through the holder 1270 in the optical axis direction. For example, the bore 1270 in the holder 1270 may correspond to, face or overlap the image sensor 1810 in the optical axis direction.

Although the bore 1070 in the holder 1270 may have a polygonal shape, for example, a quadrangular shape, a circular shape, or an elliptical shape when viewed from above, the disclosure is not limited thereto. The bore 1070 may have any of various shapes.

For example, the bore 1070 in the holder 1270 may be configured to have such a shape or a size as to expose the image sensor 1810, a portion of the upper surface of the first circuit board 1250, a portion of the upper surface of the second circuit board 1260, and the elements. For example, the surface area of the bore 1070 in the holder 1270 may be larger than the surface area of the image sensor 1810, and may be smaller than the surface area of the bore 1250A in the first circuit board 1250.

Referring to FIG. 11, the holder 1270 may have therein the holes 1041A, 1041B and 1041C corresponding to the second position sensors 1240. For example, the holder 1270 may have therein the holes 1041A, 1041B and 1041C, which are formed at positions respectively corresponding to the first to third sensors 1240A, 1240B and 1240C.

For example, the holes 1041A, 1041B and 1041C may be positioned adjacent to the corners of the holder 1270. The holder 1270 may further have a dummy hole 1041D formed adjacent to the corner of the holder 1270, which does not correspond to any of the second position sensors 1240. The dummy hole 1041D may be intended to achieve weight equilibrium of the OIS moving unit during OIS operation. The dummy hole 1041D may be a through hole. In another embodiment, the dummy hole 1041D may not be formed. The holes 1041A, 1041B and 1041C may be formed through the holder 1270 in the optical axis direction. In another embodiment, the holes 1041A, 1041B and 1041C in the holder 1270 may be omitted.

The upper surface of the holder 1270 may be provided with at least one coupling protrusion 1051, configured to be coupled to the second coil 1230. The coupling protrusion 1051 may project from the upper surface of the holder 1270 in an upward direction or in a direction toward the AF operation unit. For example, the coupling protrusion 1051 may be formed adjacent to each of the holes 1041A to 1041D in the holder 1270.

For example, two coupling protrusions 1051A and 1051B may be disposed or arranged at the holder 1270 so as to correspond to each of the holes 1041A to 1041D in the holder 1270. For example, each of the holes 1041A, 1041B, 1041C and 1041D in the holder 1270 may be positioned between the two coupling protrusions 1051A and 1051B.

The holder 1270 may include one or more projections 1027A and 1027B. The projections 1027A and 1027B may project from the upper surface of the holder 1270. For example, the projections 1027A and 1027B may project from the outer surface of the holder 1270 in the optical axis direction or in an upward direction.

For example, the holder 1270 may include two projections 1027A and 1027B which face or overlap each other in the second horizontal direction (for example, in the X-axis direction).

For example, the holder 1270 may include four side portions (or side plates), and the projections 1027A and 1027B may be respectively formed at two side portions among the four side portions. For example, each of the projections 1027A and 1027B may be disposed or positioned in the center of a corresponding side portion (or side plate) of the holder 1270.

The holder 1270 may include the groove 1341a. The groove 1341a may be an adhesive-receiving groove. The groove 1341a may be formed in the outer surface of each of the projections 1027A and 1027B. The groove 1341a may be formed in the upper surface of each of the projections 1027A and 1027B of the holder 1270. The groove 1341a may be formed from the upper surface to the lower surface of each of the projections 1027A and 1027B of the holder 1270. An adhesive configured to attach the support board 1310 to the holder 1270 may be disposed in the groove 1341a. The groove 1341a may include a plurality of grooves. For example, the groove 1341a may extend in the optical axis direction. In another embodiment, the groove in the holder 1270 may extend in a direction perpendicular to the optical axis.

The first board unit 1255 may include the first circuit board 1250 and the second circuit board 1260 which are electrically connected to each other. The second circuit board 1260 may alternatively be referred to as a “sensor board”. In another embodiment, the heat radiating member 1280 may be included in the first board unit 1255.

The first board unit 1255 may be disposed on the lower surface of the holder 1270. For example, the first board unit 1255 may be coupled to the lower surface of the holder 1270. For example, the first circuit board 1250 may be disposed on and/or coupled to the lower surface of the holder 1270. For example, a first surface of the first circuit board 1250 may be coupled or attached to the lower surface of the holder 1270 using an adhesive member.

Here, the first surface of the first circuit board 1250 may be opposed to or face the AF operation unit, and may be a surface on which the second position sensor 1240 is disposed. The second surface of the first circuit board 1250 may be a surface opposite the first surface of the first circuit board 1250.

The first circuit board 1250 may alternatively be referred to as “a sensor board”, a “main board”, a “main circuit board”, a “sensor circuit board”, a “moving circuit board” or the like. In all the embodiments, the first circuit board 1250 may alternatively be referred to as a “second board” or a “second circuit board”, and the second circuit board 1260 may alternatively be referred to as a “first board” or a “first circuit board”.

The second position sensor 1240 (1240A, 1240B and 1240C) may be disposed on the first circuit board 1250 in order to detect movement of the OIS moving unit in a direction perpendicular to the optical axis and/or rotation, tilting or rolling of the OIS moving unit relative to the optical axis. Furthermore, a controller 1830 and/or a circuit element (for example, a capacitor) may be disposed on the first circuit board 1250.

The first circuit board 1250 may include first terminals E1 to E8 to be electrically connected to the second coil 1230. Here, the first terminals E1 to E8 may alternatively be referred to as “first pads” or “first bonding portions”. The first terminals E1 to E8 of the first circuit board 1250 may be disposed or arranged on a first surface 1060A of the first circuit board 1250. For example, the first circuit board 1250 may be a printed circuit board or a flexible printed circuit board (FPCB).

The first circuit board 1250 may have the bore 1250A which corresponds to or faces the bores of the lens module 1400 and the bobbin 1110. For example, the bore 1250A in the first circuit board 1250 may be a through hole or a cavity which is formed through the first circuit board 250 in the optical axis direction, and may be formed in the center of the first circuit board 1250.

When viewed from above, the shape of the first circuit board 1250, for example, the outer peripheral shape of the first circuit board 1250 may be a shape which coincides with or corresponds to the holder 1270, for example, a quadrilateral shape. When viewed from above, the bore 1250A in the first circuit board 1250 may have a polygonal shape, for example, a quadrilateral shape, a circular shape or an elliptical shape. For example, the bore 1250a in the first circuit board 1250 may open or expose the image sensor 1810 and/or the bore 1260A in the second circuit board 1260.

The first circuit board 1250 may include at least one terminal 1251 to be electrically connected to the second circuit board 1260. The terminal 1251 of the first circuit board 1250 may alternatively be referred to as a “pad” or a “bonding portion”. The terminal 1251 of the first circuit board 1250 may be disposed or arranged on the lower surface of the first circuit board 1250.

For example, the terminal 1251 may include a plurality of terminals, and the plurality of terminals 1251 may be disposed and arranged in a region between the bore 1250A in the first circuit board 1250 and one side of the first circuit board 1250 in a direction parallel to the one side. For example, the plurality of terminals 1251 may be arranged so as to surround the bore 1250A.

The second circuit board 1260 may be disposed below the first circuit board 1250. The second circuit board 1260 may be electrically connected to the image sensor 1810.

When viewed from above, although the second circuit board 1260 may have a polygonal shape (for example, a quadrilateral shape, a square shape, or a rectangular shape), the disclosure is not limited thereto. In another embodiment, the second circuit board 1260 may have a circular shape or an elliptical shape.

For example, the surface area of the outer periphery of the second circuit board 1260 may be larger than the surface area of the bore 1250A in the first circuit board 1250. For example, the lower side of the bore 1250A in the first circuit board 1250 may be shielded or blocked by means of the second circuit board 1260.

For example, when viewed from above or underneath, the outer surface (or outer side) of the second circuit board 1260 may be positioned between the outer surface (or side) of the first circuit board 1250 and the bore 1250A in the first circuit board 1250.

For example, the second circuit board 1260 may have the bore 1260A corresponding to the bore 1250A in the first circuit board 1250 and/or the image sensor 1810. The bore 1260A in the second circuit board 1260 may be a hole or a cavity which is formed through the second circuit board 1260, and may be formed in the center of the second circuit board 1260.

For example, the bore 1260A in the second circuit board 1260 may open or expose the image sensor 1810. For example, the image sensor 1810 may be disposed in the bore 1260A in the second circuit board 1260, and may be electrically connected to the second circuit board 1260. For example, the image sensor 1810 may be electrically connected to the second circuit board 1260 via a wire.

In another embodiment, the bore 1260A may not be formed in the second circuit board 1260, and the image sensor 1810 may be disposed on the upper surface of the second circuit board 1260.

In another embodiment, the heat radiating member 1280 may be omitted. In the embodiment in which the heat radiating member 1280 is omitted, the bore 1260A may not be formed in the second circuit board 1260 and the image sensor 1810 may be disposed on the upper surface of the second circuit board 1260.

In the embodiment in which the heat radiating member 1280 is omitted, for example, the image sensor 1810 may be disposed on the upper surface of a single board in which the first circuit board and the second circuit board are integrally formed.

The second circuit board 1260 may include at least one terminal 1261 which is electrically connected to the at least one terminal 1251 of the first circuit board 1250. For example, the terminal 1261 of the second circuit board 1260 may include a plurality of terminals.

For example, at least one terminal 1261 of the second circuit board 1260 may be formed on the side surface or the outer surface of the second circuit board 1260 which connects the upper surface and the lower surface of the second circuit board 1260 to each other. The upper surface of the second circuit board 1260 may be a surface that faces the first circuit boar 1250, and the lower surface of the second circuit board 1260 may be a surface opposite the upper surface of the second circuit board. For example, the terminal 1261 may have the form of a groove having a structure that is depressed from the side surface of the second circuit board 1260. Alternatively, for example, the terminal 1261 may have the form of a circular or semielliptical via formed in the side surface of the second circuit board 1260. In another embodiment, at least one terminal of the second circuit board 1260 that is electrically connected to the second terminal 1251 of the first circuit board 1250 may be formed on the upper surface of the second circuit board 1260.

For example, the terminal 1261 of the second circuit board 1260 may be coupled to the terminal 1251 of the first circuit board 1250 using the solder or conduction path portion 1901 (see FIG. 11). Although the enlarged dotted line portion in FIG. 13 illustrates only one terminal of the second circuit board 1260 and one terminal 1251 of the first circuit board, a solder configured to couple another terminal of the second circuit board 1260 to a corresponding terminal of the first circuit board 1250 may be provided.

For example, each of the first and second circuit boards 1250 and 1260 may be a printed circuit board or a flexible printed circuit board (FPCB). At least one of the first and second circuit boards 1250 and 1260 may be an organic substrate or a ceramic board.

The heat radiating member 1280 may be disposed on or coupled to the first board unit 1255. For example, the heat radiating member 1280 may be disposed on or coupled to the second circuit board 1260. For example, the heat radiating member 1280 may be disposed below the second circuit board 1260. For example, the heat radiating member 1280 may be coupled or fixed to the lower surface of the second circuit board 1260. For example, at least a portion of the upper surface of the heat radiating member 1280 may be coupled or fixed to the lower surface of the second circuit board 1260.

The term “heat radiating member” may be used interchangeably with “heat radiating sheet”, “heat radiating tape”, “heat radiating layer”, “heat radiating film”, “heat radiating board”, “heat radiating plate”, or “heat radiating body”.

In another embodiment, the heat radiating member 1280 may be included in the first board unit 1255, and the image sensor 1810 may be disposed on the first board unit 1255.

The bore 1260A in the second circuit board 1260 may open or expose at least a portion of the heat radiating member 1280. The image sensor 1810 may be disposed on or attached or coupled to at least a portion of the heat radiating member 1280 that is exposed through the bore 1260A. For example, the image sensor 1810 may be fixed, attached or coupled to the heat radiating member 1280 using an adhesive. For example, the image sensor 1810 may be disposed on the first board unit 1255.

For example, at least an area of the upper surface of the heat radiating member 1280 may be exposed through the bore 1260A, and the image sensor 1810 may be disposed on or attached or coupled to the at least an area of the upper surface of the heat radiating member 1280 that is exposed through the bore 1260A.

In another embodiment, the second circuit board 1260 may include a groove formed in the lower surface thereof in order to receive or dispose the heat radiating member 1280 therein.

In another embodiment, the second circuit board 1260 may not have formed therein the bore 1260A, and the heat radiating member 1280 may be fixed, attached or coupled to the lower surface of the second circuit board 1260. In a further embodiment, the heat radiating member 1280 may be omitted.

For example, the heat radiating member 280 may be a plate-shaped member having predetermined thickness and hardness. The heat radiating member 1280 may improve an effect of radiating heat, generated from the heat source of the first board unit 1255, toward the outside. Here, the heat source of the first board unit 1255 may be an electronic element (or a circuit element) disposed on the first board unit 1255, for example, the image sensor 1810, the controller 1830, the second position sensor 1240 and/or the capacitor.

For example, the heat radiating member 1280 may include a metal material which has high thermal conductivity and high heat radiation efficiency, for example, at least one of stainless steel, aluminum, nickel, phosphorus, bronze, or copper.

The heat radiating member 1280 may serve to stably support the image sensor 1810, and may serve as a reinforcing material for suppressing breakage of the image sensor 1810 attributable to external shock or contact.

In another embodiment, the heat radiating member 1280 may be made of a heat radiating member having high thermal conductivity, for example, exothermic epoxy, exothermic plastic (for example, polyimide), or exothermic synthetic resin.

In an embodiment, for example, the term “heat radiating member” may be used interchangeably with “heat radiating body”, “heatsink”, “heat radiating plate”, “heat radiating sheet”, “plate”, “metal plate”, “reinforcing material”, or “stiffener”.

In order to improve heat radiation efficiency, the heat radiating member 1280 may include a predetermined pattern having at least one groove or at least one unevenness. For example, a groove or an unevenness having a predetermined pattern may be formed in the lower surface of the heat radiating member 1280.

For example, the predetermined pattern may include a plurality of grooves which are spaced apart from each other at a predetermined interval. For example, the predetermined pattern may have the shape of a stripe. In another embodiment, the predetermined pattern may have the shape of a net or a mesh. In a further embodiment, the predetermined pattern may have a shape having dots which are spaced apart from each other. For example, each of the dots may have a circular shape, an elliptical shape or a polygonal shape (for example, a quadrilateral shape).

In another embodiment, the predetermined pattern may be formed on at least one of the upper surface, the lower surface or the outer surface of the heat radiating member 1280. In a further embodiment, the radiating member 1280 may include a hole or a through hole in place of the groove or the unevenness. Because the heat radiating member 1280 moves together with the OIS moving unit, the heat radiating member 1280 may be spaced apart from the stationary unit, for example, the second board unit 1800. The heat radiating member 1280 may include at least one escape groove 1281 (see FIG. 10A) for avoidance of spatial interference with the solder 1901.

Although the first circuit board 1250 and the second circuit board 1260 are electrically coupled to each other using the conduction path portion 1901 in FIG. 13, the first board and the second board may be embodied as a single integrated circuit board in another embodiment.

The second coil 1230 may be disposed on or coupled to the OIS moving unit. For example, the second coil 1230 may be disposed on the holder 1270. The second coil 1230 may be disposed on the upper surface of the holder 1270. The second coil 1230 may be disposed below the magnet 1130.

The second coil 1230 may be coupled to the holder 1270. For example, the second coil 1230 may be coupled or attached to the upper surface of the holder 1270. For example, the second coil 1230 may be coupled to the coupling protrusion 1251 of the holder 1270. The second coil 1230 may move the OIS moving unit by virtue of the interaction with the magnet 1130.

For example, the second coil 1230 may correspond to, face or overlap the magnet 1130 disposed on the stationary unit in the direction of the optical axis OA. In another embodiment, the stationary unit may include a dedicated OIS magnet independent of the magnet of the AF operation unit, and the second coil may correspond to, face or overlap the dedicated OIS magnet. Here, the OIS magnet may include the same number of OIS magnets as the number of coil units included in the second coil 1230.

In a further embodiment, the OIS magnet may be disposed on the stationary unit of the second coil 1230, and the OIS magnet 1071B of the magnet 1130 may be disposed on the OIS moving unit. Here, the second coil 1230 may be electrically connected to the support board 1310 and/or the second board unit 1800 via a conductive member.

For example, the second coil 1230 may include a plurality of coil units 1230-1 to 1230-4. For example, the second coil 1230 may include four coil units 1230-1 to 1230-4 disposed on the four corners of the holder 1270. For example, at least a portion of each of the coil units 1230-1 to 1230-4 may be disposed on a corresponding one of the corners of the holder 1270. A portion of each of the coil units 1230-1 to 1230-4 may be disposed on a side portion adjacent to a corresponding one of the corners of the holder 1270.

Each of the coil units 1230-1 to 1230-4 may have the form of a coil block having a closed loop or ring shape. For example, each of the coil units may have a cavity or a hole. For example, each of the coli units may be composed of a fine pattern (FP) coil, a wound coil or a coil block. For example, the cavity or the hole in each of the coil units 1230-1 to 1230-4 may be fitted over or coupled to the protrusion 1251 of the holder 1270.

In another embodiment, the second coil 1230 may be disposed on the first circuit board 1250, and may be coupled to the first circuit board 1250.

The second coil 1230 may be electrically connected to the first circuit board 1250. For example, the first coil unit 1230-1 may be conductively connected to two terminals E1 and E2 of the first circuit board 1250, and the second coil unit 1230-2 may be electrically connected to two other terminals E3 and E4. Furthermore, the third coil unit 1230-2 may be electrically connected to two other terminals E5 and E6 of the first circuit board 250, and the fourth coil unit 1230-4 may be electrically connected to the two other terminals E7 and E8 of the first circuit board 1250.

Power or drive signals may be supplied to the first to fourth coil units 1230-1 to 1230-4 through the first circuit board 1250. The power or drive signal supplied to the second coil 1230 may be a DC signal, an AC signal or a signal containing both DC and AC components, and may be of a voltage type or a current type.

By virtue of the interaction between the first to fourth magnet units 1130-1 to 1130-4 and the first to fourth coil units 1230-1 to 1230-4, the OIS moving unit may be moved in the first horizontal direction or in the second horizontal direction or may be rolled relative to the optical axis.

For example, current may be independently applied to at least three coil units among the four coil units 1230-1 to 1230-4. In another embodiment, current may be independently applied to at least two coil units among the four coil units 1230-1 to 1230-4.

For example, an independent drive signal, for example, independent drive current may be supplied to each of the four coil units 1230-1 to 1230-4.

The controller 1830 and 780 may supply at least one drive signal to at least one of the first to fourth coil units 1230-1 to 1230-4, and may move the OIS moving unit in the X-axis direction and/or in the Y-axis direction or may rotate the OIS moving unit within a predetermined angle range about the optical axis by controlling the at least one drive signal. Hereinafter, the “controller” may be at least one of the controller 1830 of the camera device 1010 or the controller 780 of the optical instrument 200A.

When the second coil 1230 is driven through three channels, three independent drive signals may be supplied to the second coil 1230. For example, among the four coil units, two coil units (for example, 1230-2 and 1230-4 or 1230-1 and 1230-3), which are diagonally opposed to each other, may be connected to each other in series, and one drive signal may be supplied to the two coil units, which are connected to each other in series. Independent drive signals may be respectively supplied to the two other coil units among the four coil units.

Alternatively, when the second coil 1230 is driven through four channels, independent drive signals may be respectively supplied to the four coil units 1230-1 to 1230-4, which are separated from each other.

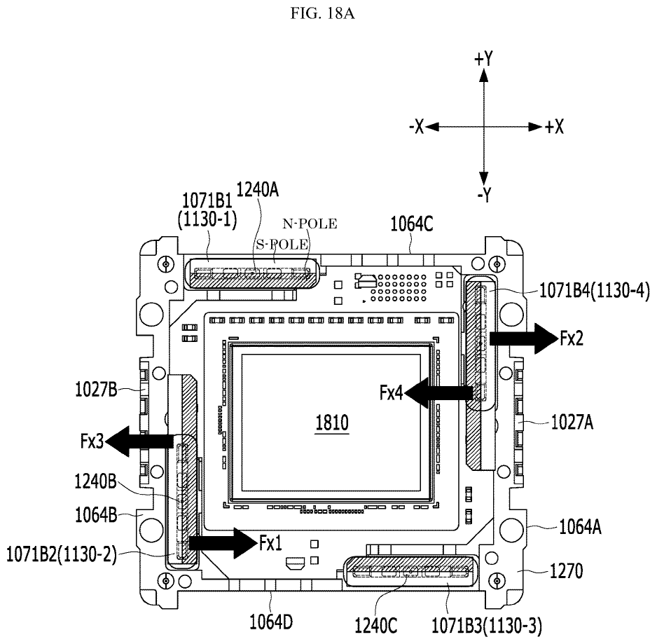

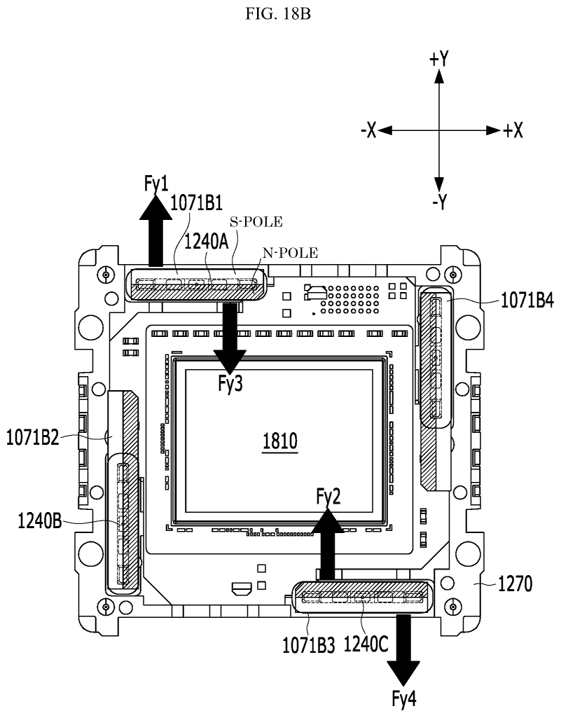

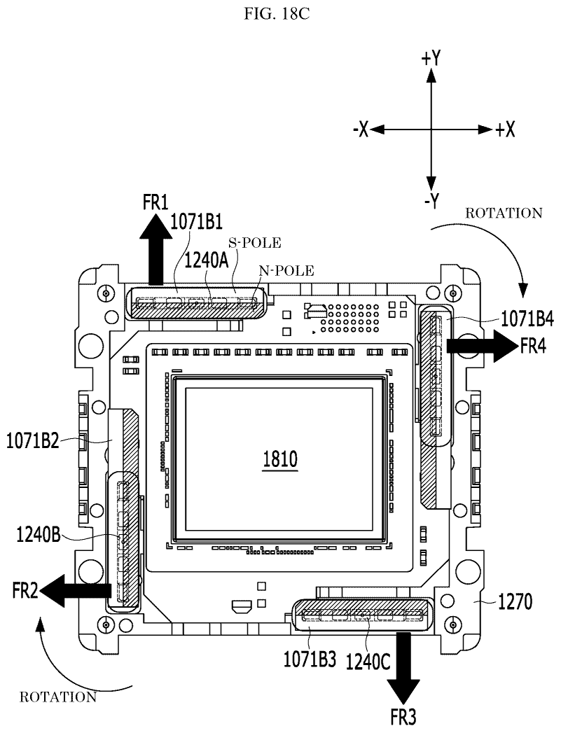

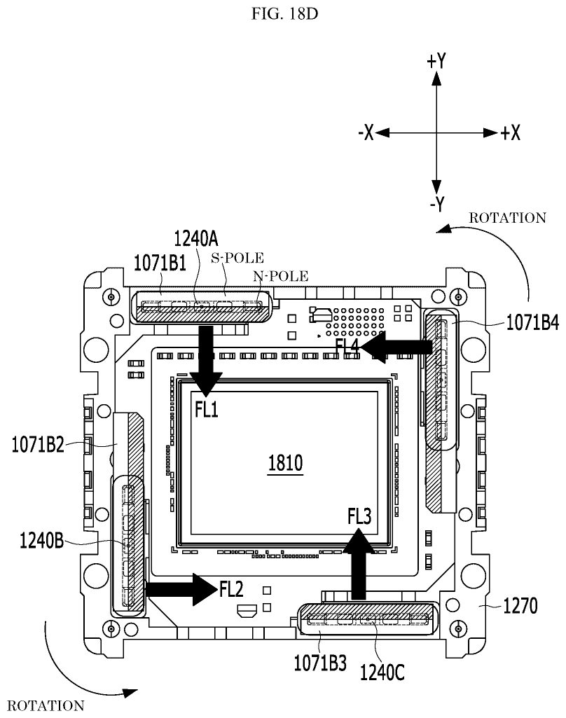

FIG. 18A is a view explaining movement of the OIS moving unit in the X-axis direction. FIG. 18B is a view explaining movement of the OIS moving unit in the Y-axis direction.

The N pole and the S pole of each of the first and third magnet units 1071B1 and 1071B3, which face each other in the first diagonal direction, may be disposed so as to face each other in the first horizontal direction (for example, in the Y-axis direction). Furthermore, the N pole and the S pole of each of the second and fourth magnet units 1071B2 and 1071B4, which face each other in the second diagonal direction perpendicular to the first diagonal direction, may be disposed so as to face each other in the second horizontal direction (for example, in the X-axis direction).

In other words, the direction in which the N pole and the S pole of the first magnet unit 1071B1 face each other may be identical or parallel to the direction in which the N pole and S pole of the third magnet unit 1071B3 face each other. Furthermore, the direction in which the N pole and the S pole of the second magnet unit 1071B2 face each other may be identical or parallel to the direction in which the N pole and S pole of the fourth magnet unit 1071B4 face each other.

In another embodiment in which the second magnet 1071B is a dipole magnet, the N pole of each of the first to fourth magnet units 1071B1 to 1071B4 may be positioned at an inner side, and the S pole may be positioned at an outer side, based on the boundary line (or the boundary plane) between the N pole and the S pole. In another embodiment, the S pole of each of the first to fourth magnet units 1071B1 to 1071B4 may be positioned at an inner side, and the N pole may be positioned at an outer side, based on the boundary line between the N pole and the S pole. The boundary line (or the boundary plane) may be a portion that is almost completely non-magnetic and has almost no polarity.

Referring to FIG. 18A, the OIS moving unit may be moved or shifted in the X-axis direction by virtue of the first electromagnetic force Fx1 (or Fx3) resulting from the interaction between the second coil unit 1230-2 and the second magnet unit 1071B2 and the second electromagnetic force Fx2 (or Fx4) resulting from the interaction between the fourth coil unit 1230-4 and the fourth magnet unit 1071B4. For example, the directions of the first electromagnetic force Fx1 (or Fx3) and the second electromagnetic force Fx2 (or Fx4) may be the same.

Referring to FIG. 18B, the OIS moving unit may be moved or shifted in the Y-axis direction by virtue of the third electromagnetic force Fy1 (or Fy3) resulting from the interaction between the first coil unit 1230-1 and the first magnet unit 1071B1 and the fourth electromagnetic force (Fy2 (Fy4) resulting from the interaction between the third coil unit 1230-3 and the third magnet unit 1071B3. For example, the directions of the third electromagnetic force Fy1 (or Fy3) and the fourth electromagnetic force Fy2 (or Fy4) may be the same.

FIG. 18C illustrates clockwise rotation of the OIS moving unit in the case of driving through four channels. FIG. 18D illustrates counterclockwise rotation of the OIS moving unit in the case of driving through four channels.

Referring to FIG. 18C, by virtue of the first electromagnetic force FR1 resulting from the interaction between the first coil unit 1230-1 and the first magnet unit 1071B1, the second electromagnetic force FR2 resulting from the second coil unit 1230-2 and the second magnet unit 1071B2, the third electromagnetic force FR3 resulting from the interaction between the third coil unit 1230-3 and the third magnet unit 1071B3, and the fourth electromagnetic force FR4 resulting from the interaction between the fourth coil unit 1230-4 and the fourth magnet unit 1071B4, the OIS moving unit may be rotated clockwise about the optical axis or may be tilted or rolled relative to the optical axis.

Referring to FIG. 18D, by virtue of the first electromagnetic force FL1 resulting from the interaction between the first coil unit 1230-1 and the first magnet unit 1071B1, the second electromagnetic force FL2 resulting from the second coil unit 1230-2 and the second magnet unit 1071B2, the third electromagnetic force FL3 resulting from the interaction between the third coil unit 1230-3 and the third magnet unit 1071B3, and the fourth electromagnetic force FL4 resulting from the interaction between the fourth coil unit 1230-4 and the fourth magnet unit 1071B4, the OIS moving unit may be rotated counterclockwise about the optical axis or may be tilted or rolled relative to the optical axis.

For example, the direction of the first electromagnetic force FR1 (or FL1) and the direction of the third electromagnetic force FR3 (or FL3) may be opposite each other. Furthermore, for example, the direction of the second electromagnetic force FR2 (or FL2) and the direction of the fourth electromagnetic force FR4 (or FL4) may be opposite each other. Furthermore, for example, the direction of the first electromagnetic force RF1 (or FL1) and the direction of the second electromagnetic force FR2 (or FL2) may be perpendicular to each other.

In the case of driving through three channels, a drive signal may not be supplied to two coil units (for example, 1130-1 and 1130-3 or 1130-2 and 1130-4), which are connected to each other in series, and thus the electromagnetic force caused by the two coil units, which are connected to each other in series, may not be generated. For example, in the case of driving through three channels, the electromagnetic forces FR2 and FR4 may be omitted, and the electromagnetic forces FR1 and FR3 may be present in FIG. 18C. Alternatively, in the case of driving through three channels, the electromagnetic forces R2 and FR4 may be present and the electromagnetic forces FR1 and FR3 may be omitted in FIG. 18C. Furthermore, in the case of driving through three channels, the electromagnetic forces FL2 and FL4 may be omitted and the electromagnetic forces FL1 and FL3 may be present in FIG. 18D. Alternatively, in the case of driving through three channels, the electromagnetic forces FL2 and FL4 may be present and the electromagnets FL1 and FL3 may be omitted in FIG. 18D.

In comparison with the driving through three channels, according to the driving through four channels shown in FIGS. 18C and 18D, it is possible to increase the electromagnetic force required for rotation of the OIS moving unit and thus to reduce drive current required to drive the first to fourth coil units 1230-1 to 1230-4, thereby reducing power consumption.

Although OIS operation for hand tremor correction is performed using the second magnet 1071B and the second coil 1230 in the embodiment shown in FIG. 2, the OIS operation for hand tremor correction may be performed using a shape-memory alloy member in another embodiment. For example, the shape-memory alloy member may be coupled to the stationary unit and the OIS moving unit and may be electrically connected to the first board unit 1255. The controller 1830 and 780 may supply a drive signal to the shape-memory alloy member, and may move the OIS moving unit in a direction perpendicular to the optical axis or may cause rotation, tilting or rolling of the OIS moving unit relative to the optical axis by virtue of the shape-memory alloy member.

In another embodiment, the OIS operation may be performed using the second magnet 1071B and the second coil 1230, and the camera device 1010 may include a ball member (not shown) disposed between the base 1210 and the holder 1270 in order to support the OIS moving unit. Here, the ball member may support the OIS moving unit such that the OIS moving unit is moved in a direction perpendicular to the optical axis or is rotated, tilted or rolled relative to the optical axis using the frictional force and/or rolling force between the base 1210 and the holder 1270. In an embodiment, for example, the ball member may be disposed in the hole 1059 in the base 210 and may be in contact therewith. In another embodiment, the ball member may be provided, and the terminal member 1037 and the wire 1220 may be omitted.

The second position sensor 1240 may be disposed, coupled or mounted to the first surface (for example, the upper surface) of the first board unit 1255. The second position sensor 1240 may detect movement or displacement of the OIS moving unit in a direction perpendicular to the optical axis direction, for example, shift or movement of the OIS moving unit in a direction perpendicular to the optical axis direction. Furthermore, the second position sensor 1240 may detect rotation, rolling or tilting of the OIS moving unit relative to or about the optical axis within a predetermined range. The first position sensor 1170 may alternatively be referred to as an “AF position sensor”, and the second position sensor 1240 may alternatively be referred to as an “OIS position sensor”.

The second position sensor 1240 may face or overlap the magnet 1130 in the optical axis direction. For example, the second position sensor 1240 may include three or more sensors (for example, 240A to 240C), which correspond to or overlap three or more magnet units among the first to fourth magnet units 1130-1 to 1130-4 in the optical axis direction, in order to detect movement of the OIS moving unit.

For example, the second position sensor 1240 may be disposed under the second coil 1230.

For example, the second position sensor 1240 may not overlap the second coil 1230 in a direction perpendicular to the optical axis. For example, a sensing element of the second position sensor 1240 may not overlap the second coil 1230 in a direction perpendicular to the optical axis. The sensing element may be an element configured to detect a magnetic field.

For example, the center of the second position sensor 1240 may not overlap the second coil 1230 in a direction perpendicular to the optical axis. For example, the center of the second position sensor 1240 may be the spatial center in X-axis and Y-axis directions on the x-y coordinate plane perpendicular to the optical axis. Alternatively, the center of the second position sensor 240 may be the spatial center in X-axis, Y-axis and Z-axis directions.

In another embodiment, at least a portion of the second position sensor 1240 may overlap the second coil 1230 in a direction perpendicular to the optical axis.

For example, the second position sensor 1240 may overlap the holes 1041A to 1041C in the holder 1270 in the optical axis direction. For example, the second position sensor 1240 may overlap the cavity in the second coil 1230 in the optical axis direction. For example, at least a portion of the holes 1041A to 1041C in the holder 1270 may overlap the cavity in the second coil 1230 in the optical axis direction.

For example, at least a portion of the second position sensor 1240, for example, the center of the second position sensor 1240 may not overlap the second coil 1230.

For example, the second position sensor 1240 may include the first sensor 1240A, the second sensor 1240B, and the third sensor 1240C, which are disposed so as to be spaced apart from one another.

For example, each of the first to third sensors 1240A, 1240B and 1240C may be a Hall sensor. In another embodiment, each of the first to third sensors 1240A, 1240B and 1240C may be a driver IC including a Hall sensor and a driver. The description of the first position sensor 1170 may be applied to the first to third sensors 1240A, 1240B and 1240C with or without modification. For example, each of the first to third sensors 1240A, 1240B and 1240C may be a displacement-detecting sensor in which output voltage thereof varies according to the relative position or the relationship with respect to a corresponding magnet unit.

Each of the first sensor 1240A, the second sensor 1240B and the third sensor 1240C may be electrically connected to the first circuit board 1250.

The second position sensor 1240 may be disposed below the cavity in the second coil 1230. In another embodiment, the second position sensor 1240 may be disposed outside the second coil 1230 when viewed in the optical axis direction or from above.

The second position sensor 1240 may not overlap the second coil 1230 in a direction perpendicular to the optical axis direction. For example, the second position sensor 1240 may overlap the holder 1270 in a direction perpendicular to the optical axis direction.

For example, the first sensor 1240A may be disposed below the cavity in the first coil unit 1230-1. The first sensor 1240A may be disposed in a corresponding one 1041A among the holes 1041A to 1041C in the holder 1270. The second sensor 1240B may be disposed below the cavity in the second coil unit 1230-2. The second sensor 1240B may be disposed in another hole 1041B among the holes 1041A to 1041C in the holder 1270. The third sensor 1240C may be disposed below the cavity in the third coil unit 1230-3. The third sensor 1240C may be disposed in the other hole 1041C among the holes 1041A to 1041C in the holder 1270.

For example, each of the first to third sensors 1240A, 1240B and 1240C may not overlap a corresponding one of the coil units 1230-1 to 1230-3 in a direction perpendicular to the optical axis. The first to third sensors 1240A, 1240B and 1240C may overlap the holder 1270 in a direction perpendicular to the optical axis.

By disposing the first to third sensors 1240A, 1240B and 1240C so as not to overlap the OIS coil 1230 in a direction perpendicular to the optical axis, it is possible to reduce influence of the magnetic field of the OIS coil 230 on the output of the OIS position sensor 1240 and thus to perform accurate OIS feedback operation, thereby assuring reliability of OIS operation.

The second position sensor 1240 may face, correspond to or overlap the magnet 1130 in the optical axis direction. For example, at the initial position of the OIS moving unit, at least a portion of the first sensor 1240A may overlap the first magnet unit 1071B1 of the second magnet 1071B in the optical axis direction. The first sensor 1240A may output a first output signal (for example, a first output voltage) corresponding to the result of detection of the magnetic field of the first magnet unit 1071B1.

For example, at the initial position of the OIS moving unit, at least a portion of the second sensor 1240B may overlap the second magnet unit 1071B2 of the second magnet 1071B in the optical axis direction, and the second sensor 1240B may output a second output signal (for example, a second output voltage) corresponding to the result of detection of the magnetic field of the second magnet unit 1071B2.

For example, at the initial position of the OIS moving unit, at least a portion of the third sensor 1240C may overlap the third magnet unit 1071B3 of the second magnet 1071B in the optical axis direction, and the third sensor 1240C may output a third output signal (for example, a third output voltage) corresponding to the result of detection of the magnetic field of the third magnet unit 1071B3.

The initial position of the OIS moving unit may be the original position of the OIS moving unit in the state in which no power or drive signal is applied to the second coil 1230 from the controllers 1830 and 780 or the position at which the OIS moving unit is positioned as the result of the support board being elastically deformed due only to the weight of the OIS moving unit. In addition, the initial position of the OIS moving unit may be the position at which the OIS moving unit is positioned when gravity acts in the direction from the first board unit 1255 to the second board unit 1800 or when gravity acts in the direction from the second board unit 1800 to the first board unit 1255.

In order to improve the linearity of the relationship between displacement of the OIS moving unit and the output of the second position sensor 1240, each of the sensor units 1240A, 1240B and 1240C may overlap a corresponding one of the magnet units 1071B1, 1071B2 and 1027B3 in the optical axis direction within the stroke range of the OIS moving unit.

For example, the controllers 1830 and 780 may control rolling of the OIS moving unit using at least one of the first output voltage of the first sensor 1240A, the second output voltage of the second sensor 1240B and the third output voltage of the third sensor 1240C. For example, the controllers 1830 and 780 may control rolling of the OIS moving unit using the first output voltage and the third output voltage.

For example, the controller 1830 and 780 may control or adjust movement or displacement of the OIS moving unit in the first horizontal direction (for example, in the Y-axis direction) or in the second horizontal direction (for example, in the X-axis direction) using at least one of the first to third output voltages. For example, the controllers 1830 and 780 may control or adjust movement or displacement of the OIS moving unit in the first horizontal direction (for example, in the Y-axis direction) using the first output voltage of the first sensor 1240A, and may control or adjust movement or displacement of the OIS moving unit in the second horizontal direction using the second output voltage of the second sensor 1240B.

Each of the first to third sensors 1240A, 1240B and 1240C may be a Hall sensor. In another embodiment, each of the first to third sensors may be a driver IC including a Hall sensor. In a further embodiment, each of the first and second sensors 1240A and 1240B may be a Hall sensor, and the third sensor 1240C may be a tunnel magnetoresistance (TMR) sensor. Here, the tunnel magnetoresistance (TMR) sensor may be a TMR magnetic angle sensor.

In still a further embodiment, each of the first to third sensors 1240A, 1240B and 1240C may be a tunnel magnetoresistance (TMR) sensor. Here, the TMR sensor may be a TMR linear magnetic field sensor in which the output according to displacement (or stroke) of the OIS moving unit is linear.

The base 1210 may be disposed below the first board unit 1255. The base 1210 may be spaced apart from the first board unit 1255. The base 1210 may have a polygonal shape, for example, a quadrilateral shape, which coincides with or corresponds to the cover member 1300 or the first board unit 1255.

For example, the base 1210 may have the bore 1210A which corresponds to or faces the first board unit 1255. The bore 1210A in the base 1210 may be a through hole which is formed through the base 1210 in the optical axis direction. In another embodiment, the base may not have the bore.

For example, the base 1210 may be coupled to the side plate 1302 of the cover member 1300. The side portion or the outer surface of the base 1210 may include a step 1211 (see FIG. 14) to which an adhesive is applied when the side portion or the outer surface is bonded to the side plate 1302 of the cover member 1300. Here, the step 1211 may guide the side plate 1302 of the cover member 1300 which is coupled to the upper side thereof. The step 1211 of the base 1210 and the lower end of the side plate 1302 of the cover member 1300 may be bonded or fixed to each other using an adhesive or the like.

The base 1210 may include one or more projections 1216A and 1216B projecting from the upper surface thereof. For example, the projections 1216A and 1216B may project upwards from the outer surface of the base 1210. For example, the base 1210 may include two projections 1216A and 1216B which face or overlap each other in the first horizontal direction (for example, in the Y-axis direction).

For example, the base 1210 may include four side portions (or side plates), and the projections 1216A and 1216B may be formed at two of the four side portions. For example, the projections 1216A and 1216B may be disposed or positioned in the center of the side portion (or the side plate) of the base 1210.

The base 210 may include a groove 341B. The groove 341b may be an adhesive-receiving groove. The groove 341b may be formed in the outer surface of a corresponding one of the projections 216A and 216B of the base 210. The groove 1341b may be formed in the upper surface of a corresponding one of the projections 1216A and 1216B of the base 1210. The groove 1341b may be formed from the upper surface to the lower surface of a corresponding one of the projections 1216A and 1216B. An adhesive may be disposed in the groove 1341b in order to bond the support board 1310 to the base 1210. The groove 1341b may include a plurality of grooves. For example, the groove 1341b may extend in the optical axis direction. In another embodiment, the groove formed in a corresponding one of the projections 1216A and 1216B of the base 1210 may extend in a direction perpendicular to the optical axis.

For example, the second board unit 1800 may be disposed below the base 1210. For example, the second board unit 1800 may be disposed so as to be spaced apart from the OIS moving unit, for example, the first board unit 1255 and the first heat radiating member 1280 in the optical axis direction.

For example, the second board unit 800 may be disposed below the lower surface of the base 1210. The second board unit 1800 may be coupled to the base 1210. For example, the second board unit 1800 may be coupled to the lower surface of the base 1210.

The second board unit 1800 may serve to supply a signal to the image sensor unit 1350 from the outside or to output the signal transmitted from the image sensor unit 1350 to the outside.

The second board unit 1800 may include a first region 1801 (or a first board), which corresponds to, faces or overlaps the AF operation unit 1100 or the image sensor 1810 in the optical axis direction, a second region 1802 (or a second board) on which a connector 1804 is disposed, and a third region 1803 (or a third board) connecting the first region 1801 to the second region 1802. The connector 1804 may include a port which is to be electrically connected both to the second region 1802 of the second board unit 1800 and to an external device (for example, the optical instrument 200A). The bore 1210A in the base 1210 may be closed or blocked by the first region 1801 of the second board unit 1800.

The first region 1801 of the second board unit 1800 may correspond to, face or overlap at least one of the cover member 1300 or the base 1210 in the optical axis direction. For example, the first region 1801 may overlap the upper plate 1301 and the side plate 1302 of the cover member 1300 in the optical axis direction.

Each of the first region 1801 and the second region 1802 of the second board unit 1800 may include a rigid substrate. The third region 1803 may include a flexible substrate. Each of the first region 1801 and the third region 1802 may further include a flexible substrate.

In another embodiment, at least one of the first to third regions 1801 to 1803 of the circuit board 1800 may include at least one of a rigid substrate or a flexible substrate.

The second board unit 1800 may be disposed behind the first board unit 1255. For example, the first board unit 1255 may be disposed between the AF operation unit 1100 and the second board unit 1800. In another embodiment, the second board unit may be disposed between the AF operation unit and the first board unit.

Although the first region 1801 of the second board unit 1800 may have a polygonal shape (for example, a quadrilateral shape, a square shape or a rectangular shape) when viewed from above, the disclosure is not limited thereto. In another embodiment, the first region 801 may have a circular shape or the like.

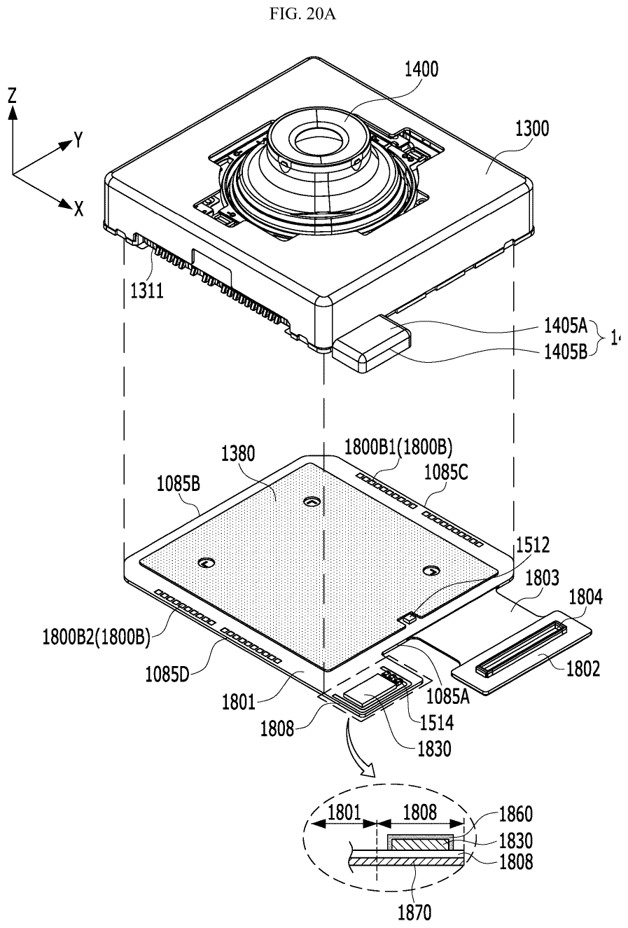

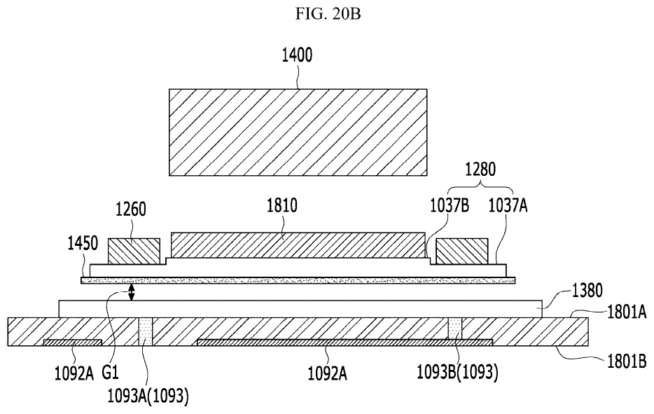

FIG. 20A illustrates disposition of the first to third regions 1801 to 1803 of the second board unit 1800, an extension region 1808, the AF moving unit, the OIS moving unit, and the controller 1830 according to an embodiment.

Referring to FIG. 20A, the first region 1801 may include four side portions 1085A to 1085D (or side surfaces). For example, the first region 1801 may include first and second side portions 1085A and 1085B, which face each other or are opposed to each other in the second horizontal direction (for example, in the X-axis direction), and third and fourth side portions 1085C and 1085D, which face each other or are opposed to each other in the first horizontal direction (for example, in the Y-axis direction).

The second region 1802 may be disposed adjacent to the first side portion 1085A of the first region 1801, and the third region 1803 may be connected to the first side portion 1085A of the first region 1801. For example, the third region 1803 may extend from the first region 1801 and may be connected to one side of the second region 1802 that is opposed to the first side portion 1085A.

The second board unit 1800 may include a plurality of terminals 1800B corresponding to terminals 1311 of the support board 1310. The plurality of terminals 1800B may be formed in the first region 1801 of the second board unit 1800. For example, the second board unit 1800 may include first terminals 800B1, which are disposed or arranged so as to be spaced apart from each other along one side of the third side portion 1085C of the first region 1801 in the second horizontal direction (for example, in the X-axis direction), and second terminals 800B2, which are disposed or arranged so as to be spaced apart from each other along one side of the fourth side portion 1085D of the first region 1801 in the second horizontal direction.

For example, the plurality of terminals 1800B may be formed on a first surface (for example, the upper surface) of the second board unit 1800 (for example, the first region 1801) which faces the first board unit 1255.

For example, the controller 1830 may be disposed on the extension region which extends from one of the third and fourth side portions 1085C and 1085D of the first region 1801 of the second board unit 1800. In another embodiment, the controller may be disposed on the extension region which extends from the side portion of the first region 1801 of the second board unit 1800 on which the plurality of terminals are formed.

The first region 1801 may have formed therein a coupling hole (not shown), and the base 1210 may have formed thereon a coupling protrusion (not shown) to be coupled to the coupling hole in the first region 1801.

The camera device 1010 may further a heat radiating member 1380 which is disposed, coupled or fixed to the second board unit 1800. For example, the heat radiating member 1380 may be disposed on, coupled or fixed to the upper surface of the first region 1801 of the second board unit 1800. In another embodiment, the heat radiating member 1380 may be omitted.

The camera device 1010 may further include a third radiating member (not shown) which is disposed on, coupled or fixed to a second surface (for example, the lower surface) of the second board unit 1800.

For example, the heat radiating member 1380 may be a plate-shaped member having predetermined thickness and hardness. The heat radiating member 1380 may face or overlap the first heat radiating member 1280 in the optical axis direction.

Although the controller 1830 is disposed or coupled to the upper surface of the extension region 1808 in FIG. 20A, the controller may also be disposed or coupled to the lower surface of the extension region 1808 in another embodiment.

Although the controller 1830 is disposed on the extension region 1808 of the second board unit 1800 which is positioned outside the cover member 1300 in FIG. 20A, the controller may also be disposed in the first region of the second board unit 1800 which is positioned outside the base 1210 in another embodiment.

In a further embodiment, the controller may be disposed or mounted on the second circuit board 1260 which is a sensor board. In another embodiment, for example, the controller may be disposed or mounted on the upper surface of the second circuit board 1260. Because the heat radiating member 1280 is disposed on or coupled to the lower surface of the second circuit board 1260, when the controller is disposed on the second circuit board 1260, the heat generated by the controller may be easily radiated by means of the heat radiating member 1280, thereby improving heat radiation efficiency and radiation performance.

FIG. 20B is a schematic cross-sectional view of the lens module 1400, the first board unit 1255, the image sensor 1810, and the second board unit 1800.

Referring to FIG. 20B, the image sensor 1810 may be disposed in the bore 1260A (or the hole) in the second circuit board 1260, and may be coupled to the first heat radiating member 1280.

For example, the first heat radiating member 1280 may include a body 1037A, which is disposed below the second circuit board 1260, and a projection 1037B (or a projection region), which is disposed in the bore 1260A in the second circuit board 1260.

The image sensor 1810 may be disposed, coupled or fixed to the projection 1037B. For example, the image sensor 1810 may be disposed, coupled or attached to the upper surface of the projection 1037B. For example, the upper surface of the projection 1037B may be positioned lower than the upper surface of the second circuit board 1260. In another embodiment, the upper surface of the projection 1037B may be flush with the upper surface of the second circuit board 1260.

The heat radiating member 1380 may be disposed on the first surface 1801A (or the upper surface) of the first region 1801 of the second board unit 1800 which faces the first heat radiating member 1280 in the optical axis direction.

The distance G1 (or the gap) between the first board unit 1255 and the second board unit 1800 in the optical axis direction may be 0.05 mm to 0.7 mm. For example, the distance G1 may be the distance between the lower surface of the heat radiating member 1280 and the upper surface of the heat radiating member 1380.

In another embodiment, the distance G1 may be 0.15 mm to 0.5 mm. In a further embodiment, the distance G1 may be 0.15 mm to 0.3 mm. In still a further embodiment, the distance G1 may be 0.2 mm to 0.3 mm.

The second board unit 1800 may include a first conductive layer 1093 which is exposed from the first surface 1801A and is in contact with the heat radiating member 1380, for example, the lower surface of the heat radiating member 1380. For example, the first conductive layer 1093 may be heat-fused to the lower surface of the heat radiating member 1380 or may be coupled to the lower surface of the heat radiating member 1380 using a conductive adhesive, for example, solder or the like. For example, the first conductive layer 1093 may be electrically connected to the heat radiating member 1380.

The second board unit 1800 may include a second conductive layer 1092A which is connected to the first conductive layer 1093 and is exposed from the second surface 1801B (or the lower surface) of the second board unit 1800 that is the surface opposite the first surface 1801A of the second board unit 1800. For example, the second conductive layer 1092A may be electrically connected to the ground of the second board unit 1800.

The first conductive layer 1093 may be a via which is formed through at least a portion of the second board unit 1800. For example, the first conductive layer 1093 may include a first via 1093A which is formed through the second board unit 1800 and is open or exposed at the second surface 1801B of the second board unit 1800. Furthermore, the first conductive layer 1093 may include a second via 1093B one end of which is in contact with the lower surface of the heat radiating member 1380 and the other end of which is in contact with or coupled or connected to the second conductive layer 1092A.

In FIG. 20B, the second conductive layer 1092A may be disposed in or coupled or attached to a groove formed in the second surface 1801B of the second board unit 1800. In another embodiment, the second conductive layer may be disposed in or coupled or attached to the second surface 1801B of the second board unit 1800 without the groove formed in the second surface 1801B.

The first conductive layer 1093 and the second conductive layer 1092A may serve as radiating patterns or radiating pads for heat radiation of the second board unit 1800. In other words, because the first conductive layer 1093 and the second conductive layer 1092A are merely intended to radiate heat, they need not be electrically connected to other wires of the second board unit 1800 except for the ground of the second board unit 1800. Here, the other wires may be wires electrically connected to an electronic element (or a circuit element), such as the image sensor 1810, or the support board 1310.

The second conductive layer 1092A may be electrically connected to the cover member 1300 (for example, the side plate 1302) via solder, a conductive adhesive or conductive tape. In another embodiment, the second conductive layer 1092A, which is connected to the ground of the second board unit 1800, may be electrically connected to the cover member 1300 by means of a bracket. The bracket may be a structure which receives or accommodates the camera device therein in order to protect the camera device. For example, the bracket may be made of a conductive member. Since the ground of the second board unit 1800 and the heat radiating member 1380 are electrically connected to the cover member 1300, it is possible to protect the camera device 1010 from static electricity and to improve efficiency of heat radiation.

In another embodiment, the first conductive layer and the second conductive layer of the second board unit 1800 may be applied to the second circuit board 1260 with or without modification. For example, the second circuit board 1260 according to another embodiment may include at least one third conductive layer which is in contact with the first heat radiating member 1280, and at least a portion of the third conductive layer may be exposed from the second circuit board 1260.

Since the heat radiating member 1380 is disposed on the first surface of the second board unit 1800, it is possible to reduce the distance between the heat radiating member 1280 and the heat radiating member 1380 and thus to improve efficiency of heat radiation.

The heat radiated from the first heat radiating member 1280 may be transmitted to the heat radiating member 1380 through convection or radiation, and the transmitted heat may be radiated to the outside through the heat radiating member 1380, thereby improving efficiency of heat radiation. Since the upper surface of the heat radiating member 1380 and the lower surface of the first heat radiating member 1280 are disposed so as to face or overlap each other in the optical axis direction, heat may be efficiently transmitted to the heat radiating member 1380 from the first heat radiating member 1280.

For example, the heat radiating member 1280 and the heat radiating member 1380 may be made of the same material. In another embodiment, the first heat radiating member 1280 and the heat radiating member 1380 may be made of different materials. For example, the thermal conductivity of the first heat radiating member 1280 may be applied to the heat radiating member 1380 with or without modification.

Furthermore, the heat radiating member 1380 may stably support the second board unit 1800, and may serve as a reinforcing member configured to suppress breakage of the second board unit 1800 attributable to external shock or contact.

In another embodiment, the heat radiating member 1380 may be made of a radiating member having high thermal conductivity, for example, exothermic epoxy, exothermic plastic, or exothermic synthetic resin.

The heat radiating member 1380 may include at least one groove or unevenness in order to improve efficiency of radiation. For example, a groove or unevenness having a predetermined pattern may be formed on at least one of the upper surface or the lower surface of the heat radiating member 1380.

In another embodiment, the heat radiating member 1380 may have a hole or a through hole in place of the groove. For example, the heat radiating member 1380 according to another embodiment may have a plurality of through holes. The description of the predetermined pattern of the heat radiating member 1280 may be applied to the heat radiating member 1380 with or without modification.

The camera device according to another embodiment may include a heat radiating member disposed below the second board unit 1800. Here, the description of the material of the heat radiating member 1280 or 1380 may be applied to the heat radiating member with or without modification.

The support board 1310 may support the OIS moving unit such that the OIS moving unit is movable relative to the stationary unit in a direction perpendicular to the optical axis direction, and may electrically connect the first board unit 1255 to the second board unit 1800.

The support board 1310 may alternatively be referred to as a “support member”, a “connecting board”, or a “connecting portion”. Alternatively, the support board 1310 may alternatively be referred to as an “interposer”. Alternatively, the interposer may include the first circuit board 1250 and the support board 1310 which are integrally formed.

In another embodiment, in place of the support board 1310, a support unit, which is connected at one end thereof to the moving unit, for example, the first board unit 1255 and at the other end thereof to the stationary unit, for example, the second board unit 1800, may be provided. For example, the support unit may include at least one of a leaf spring or a suspension wire. For example, the support unit may electrically connect the first board unit 1255 to the second board unit 1800.

The support board 1310 may include a flexible substrate or may be a flexible substrate. For example, the support board 1310 may include a flexible printed circuit board (FPCB). At least a portion of the support board 1310 may be flexible. The first circuit board 1250 may be connected to the support board 1310.

Referring to FIG. 16, for example, the support board 1310 may include a connecting portion 1320 connected to the first circuit board 150. For example, the first circuit board 1250 and the support board 1310 may be integrally formed. In another embodiment, the first circuit board 1250 and the support board 1310 may not be integrally formed but may be separately formed. The first circuit board 1250 and the support board 1310 may be connected to each other via the connecting portion 1320, and may be electrically connected to each other. In another embodiment, the connecting portion 1320 may be integrally formed with at least one of the support board 1310 or the first circuit board 1250.

The support board 1310 may be electrically connected to the first circuit board 1250. The support board 1310 may be electrically connected to the second board unit 1800. For example, one end of the support board 1310 may be connected or coupled to the first board unit 1255 (for example, the second circuit board 1250). The other end of the support board 1310 may be connected or coupled to the second board unit 1800.

The support board 1310 may support the OIS moving unit with regard to the stationary unit. The support board 1310 may guide movement of the OIS moving unit. The support board 1310 may guide the OIS moving unit such that the OIS moving unit is movable in a direction perpendicular to the optical axis direction. The support board 1310 may guide the OIS moving unit such that the OIS moving unit is rotated, tilted or rolled relative to the optical axis. The support board 1310 may restrict movement of the OIS moving unit in the optical axis direction.

A portion of the support board 1310 may be coupled, attached or fixed to the base 1210 which is the stationary unit, and another portion of the support board 1310 may be coupled, attached or fixed to the holder 1270 which is the OIS moving unit.

For example, portions of the bodies 1086 and 1087 of the support board 1310 may be coupled to the base 1210 (for example, the projections 1216A and 1216B) which is the stationary unit, and other portions of the bodies 1086 and 1087 may be coupled to the holder 1270 (for example, the projections 1027A and 1027B) which is the OIS moving unit.

The connecting portion 1320 of the support board 1310 may be connected to the first board unit 1255 (for example, the first circuit board 1250) and may be electrically connected thereto. Extensions 1007A to 1007D of the support board 1310 may be coupled to the second board unit 1800 (for example, the terminals 1800B) and may be electrically thereto.

The support board 1310 may include the circuit board and an elastic portion coupled to the circuit member. The elastic portion, which serves to flexibly support the OIS moving unit, may be embodied as an elastic body, for example, a spring. The elastic portion may include metal or may be made of an elastic material. The circuit member, which serves to electrically connect the first circuit board 1250 to the second board unit 1800, may be a flexible substrate or may include at least one of a flexible substrate or a rigid substrate. For example, the circuit member may be a flexible printed circuit board (FPCB).

For example, the support board 1310 may include one or more connectors 1320A and 1320B, which is connected to the first board unit 1255 (for example, the first circuit board 1250) and which is electrically connected to the first board unit 1255 (for example, the first circuit board 1250).

Furthermore, the support board 1310 may include one or more extensions 1007A to 1007D which are connected to the second board unit 1800 and which are electrically connected to the second board unit 1800. The one or more extensions 1007A to 1007D may include a plurality of terminals 1311.

For example, the support board 1310 may be disposed so as to surround the OIS moving unit, for example, the first board unit 1255. For example, the support board 1310 may be disposed so as to surround the four side portions 1033A to 1033D (see FIG. 16) of the first circuit board 1250 or to surround the outer surfaces thereof.

For example, the support board 1310 may not overlap the OIS moving unit, for example, the first board unit 1255 in the optical axis direction, and at least a portion of the support board 1310 may overlap the OIS moving unit, for example, the first board unit 1255 in a direction perpendicular to the optical axis direction.

For example, the support board 1310 may include a plurality of support boards which are separated or spaced apart from each other. In another embodiment, the support board 1310 may be formed to have a single integrated structure.

The support board 1310 may include the bodies 1086 and 1087. For example, the bodies 1086 and 1087 may be disposed so as to surround the OIS moving unit, for example, the first board unit 1255. For example, the bodies 1086 and 1087 may not overlap the OIS moving unit, for example, the first board unit 1255 in the optical axis direction, and at least a portion of each of the bodies 1086 and 1087 may overlap the OIS moving unit, for example, the first board unit 1255 in a direction perpendicular to the optical axis direction.

For example, each of the bodies 1086 and 1087 may have the form of a plate which is flat in the optical axis direction or in a direction parallel to the optical axis direction. When viewed from above, for example, each of the bodies 1086 and 1087 may have a contour having a polygonal shape, for example, a quadrilateral shape, or a circular shape.

For example, each of the bodies 1086 and 1087 may include a plurality of portions which are separated or spaced apart from each other. In another embodiment, each of the bodies may be formed to have an integrated structure.

The support board 1310 may include an extension which extends from each of the bodies 1086 and 1087 and is coupled to the second board unit 1800. For example, the extension of the support board 1310 may extend toward the second board unit 1800, and one end of the extension of the support board 1410 may be coupled to the second board unit 1800. One end of the extension of the support board 1310 may be provided with a plurality of terminals which are electrically connected to the second board unit 1800 using a solder or a conductive adhesive. For example, the extension of the support board 1310 may alternatively be referred to as a “terminal portion”, a “projecting portion” or a “leg portion”.

For example, each of extensions 1007A to 1007D of the support board 1310 may include a first portion, which extends from a corresponding one of the bodies 1086 and 1087 in the optical axis direction, and a second portion, which extends from the first portion in a direction perpendicular to the optical axis. For example, the extensions 1007A to 1007D of the support board 1310 may be fixed or coupled to the stationary unit (for example, the base 1210). For example, when the OIS moving unit moves, the bodies 1086 and 1087 of the support board 1310 is movable but the extensions 1007A to 1007D of the support board 1310 may be fixed so as to be immovable.

For example, the support board 1310 may include a first support board 1310-1 and a second support board 1310-2 which are spaced apart from each other. The first and second support boards 1310-1 and 1310-2 may be line-symmetrically formed. In another embodiment, the first support board 1310-1 and the second support board 1310-2 may be integrally formed into a single board. In a further embodiment, the support board 1310 may include three or more support boards.

For example, the first and second support boards 1310-1 and 1310-2 may be disposed so as to surround the four side portions 1033A to 1033D of the first circuit board 1250.

For example, the first support board 1310-1 may include the first body 1086 and one or more extensions 1007A and 1007B which extend from the first body 1086. The one or more extensions 1007A and 1007B of the first support board 1310-1 may include a plurality of terminals 1311.

The second support board 1310-2 may include the second body 1087 and one or more extensions 1007C and 1007D which extend from the second body 1087. The one or more extensions 1007C and 1007D of the second support board 1310-2 may include a plurality of terminals 1311.

The first circuit board 1250 may include the first side portion 1033A and the second side portion 1033B, which are positioned opposite each other, and the third side portion 1033C and the fourth side portion 1033D, which are positioned between the first side portion 1033A and the second side portion 1033B and are positioned opposite each other.

For example, the first connector 1320A may connect the first body 1086 to the first side portion 1033A of the first circuit board 1250. The second connector 1320B may connect the second body 1087 to the second side portion 1033B of the first circuit board 1250.

The first body 1086 may include a first portion 1006A, which corresponds to or faces the first side portion 1033A of the first circuit board 1250, a second portion 1006B, which corresponds to a portion (or a side) of the third side portion 1033C of the first circuit board 1250, and a third portion 1006C, which corresponds to a portion (or a side) of the fourth side portion 1033D of the first circuit board 1250. Furthermore, the first body 1086 may include a first bent portion 1006D, which connects one end of the first portion 1006A to the second portion 1006B and is bent at the one end of the first portion 1006A, and a second bent portion 1006E, which connects the other end of the first portion 1006A to the third portion 1006C and is bent at the other end of the first portion 1006A. For example, the first body 1086 may have a “U” shape.

For example, the first support board 1310-1 may include the extensions 1007A and 1007B. For example, the extension 1007A may be connected to one side of the first body 1086, and the extension 1007B may be connected to the other side of the first body 1086.

For example, the extension 1007A may extend or project toward the second board unit 1800 from the first portion 1006B of the first body 1086, and the extension 1007B may extend or project toward the second board unit 1800 from the third portion 1006C of the first body 1086. The extension 1007B may be positioned opposite the extension 1007A with the first board unit 1255 (for example, the first circuit board 1250) interposed therebetween.

For example, the first connector 1320A may connect the first portion 1006A of the first body 1086 to the first side portion 1033A of the first circuit board 1250. The first connector 1320A may include a bent portion. For example, the first connector 1320A may connect the central region of the first portion 1006A of the first body 1086 to the central region of the first side portion 1033A of the first circuit board 1250.

The second body 1087 may include a first portion 1009A, which corresponds to or faces the second side portion 1033B of the first circuit board 1250, a second portion 1009B, which corresponds to or faces another portion (or the other side) of the third side portion 1033C of the first circuit board 1250, and a third portion 1009C, which corresponds to or faces another portion (or the other side) of the fourth side portion 1033D of the first circuit board 1250. Furthermore, the second body 1087 may include a first bent portion 1009D, which connects one end of the first portion 1009A to the second portion 1009B and is bent at the one end of at the first portion 1009A, and a second bent portion 1009E, which connects the other end of the first portion 1009A to the third portion 1009C and is bent at the other end of the first portion 1009A. For example, the second body 1087 may have a “U” shape. For example, the second body 1087 may have a shape symmetrical with the first body 1086 based on the optical axis. For example, the second body 1087 may be symmetrical with the first body 1086 based on the optical axis.

For example, the second support board 1310-2 may include the extensions 1007C and 1007D. For example, the extension 1007C may be connected to one side of the second body 1087, and the extension 1007D may be connected to the other side of the second body 1086.

The extension 1007C may extend or project toward the second board unit 1800 from the second portion 1009B of the second body 1087, and the extension 1007D may extend or project toward the second board unit 1800 from the third portion 1009C of the second body 1087. The extension 1007D may be positioned opposite the extension 1007C with the first board unit 1255 (for example, the first circuit board 1250) interposed therebetween.

For example, the extension 1007A and the extension 1007C may be line-symmetrical with each other when viewed from the front. In another embodiment, the extension 1007A and the extension 1007C may not be line-symmetrical with each other.

For example, the extension 1007B and the extension 1007D may be line-symmetrical with each other when viewed from the front. In another embodiment, the extension 1007B and the extension 1007D may not be line-symmetrical with each other.

For example, the second connector 1320B may connect the first portion 1009A of the second body 1087 to the second side portion 1033B of the first circuit board 1250. The second connector 1320B may include a bent portion. For example, the second connector 1320B may connect the central region of the first portion 1009A of the second body 1087 to the central region of the second side portion 1033B of the first circuit board 1250.

Referring to FIG. 16, the terminal members (for example, 1007A and 1007C) of the support board 1310 may be provided with terminals P1 to P4 which are electrically connected to the terminals B1 to B4 of the terminal member 1095 of the circuit board 1190 of the AF operation unit 1100. The terminals B1 to B4 of the terminal member 1095 of the circuit board 1190 and the terminals P1 to P4 of the extensions 1007A and 1007C of the support board 1310 may be respectively connected to each other using a solder or a conductive adhesive. In other words, the circuit board 1190 of the AF operation unit 1100 may be electrically connected to the second board unit 1800 via the support board 1310.

Referring to FIG. 16, the support board 1310 may include the conductive layer 1093-1. Furthermore, the support board 1310 may include the first insulating layer 1094-1 disposed on one surface (or a first surface) or one side of the conductive layer 1093-1. Furthermore, the support board 1310 may include the second insulating layer 1094-2 disposed on the other surface (or a second surface) or the other side of the conductive 1093-1. In another embodiment, for example, the support board 1310 may include at least one of the first insulating layer 1094-1 or the second insulating layer 1094-2. The support board 1310 may include a protective layer 1096 disposed on the first insulating layer 1094-1. For example, the protective layer 1096 may be an EMI member (for example, an EMI tape). Alternatively, for example, the protective layer 1096 may be a heat radiating member, for example, graphite. Alternatively, for example, the protective layer 1096 may be an elastic material. Alternatively, for example, the projective layer 1096 may be a conductive member. Alternatively, for example, the protective layer 1096 may be an insulation member.

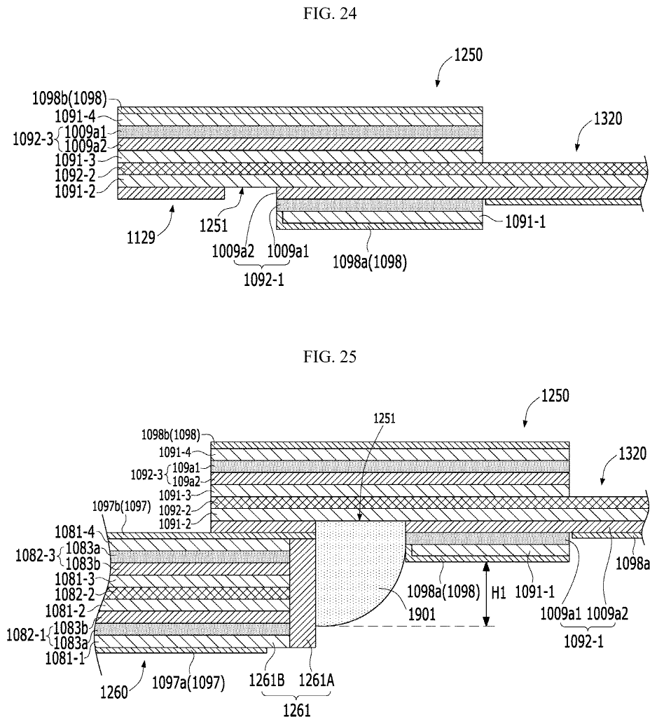

For example, the conductive layer 1093-1 may correspond to a conductive layer 1091-2 shown in FIG. 24 which will be described later, the first insulating layer 1094-1 may correspond to an insulating layer 1092-1 shown in FIG. 24, and the second insulating layer 1094-2 may correspond to an insulating layer 10902-2 shown in FIG. 24. For example, the protective layer 1096 may include a cover layer 1098a shown in FIG. 24.

FIG. 17A is a first perspective view of the support board 1310 coupled to the holder 1270 and the base 1210. FIG. 17B is a second perspective view of the support board 1310 coupled to the holder 1270 and the base 1210.

Referring to FIGS. 17A and 17B, the holder 1270 may include first to fourth side portions 1064A to 1064D, which correspond to or face the first to fourth side portions 1033A to 1033D of the first circuit board 1250.

First and second side portions 1064A and 1064B of the holder 1270 may be disposed so as to face or be opposite to each other in the second horizontal direction (for example, in the X-axis direction). Third and fourth side portions 1064C and 1064D of the holder 1270 may be disposed so as to face or be opposite to each other in the first horizontal direction (for example, in the Y-axis direction).

At least a portion of the support board 1310 may be attached or coupled to the holder 1270. For example, one or more connectors 1320A and 1320B of the support board 1310 may be coupled to at least one of the first to fourth side portions 1064A to 1064D of the holder 1270 using an adhesive. For example, the first connector 1320A may be coupled, attached or fixed to the first side portion 1064A of the holder 1270 using an adhesive, and the second connector 1320B may be coupled, attached or fixed to the second side portion 1064B of the holder 1270 using an adhesive.

The first projection 1027A may be formed at the first side portion 1064A of the holder 1270, and the second projection 1027B may be formed at the second side portion 1064B of the holder 1270.

The support board 1310 may be coupled, attached or fixed to the projections 1027a and 1027B of the holder 1270. The support board 1310 may be coupled, attached or fixed to the outer surfaces (or the inner surfaces) of the projections 1027A and 1027B of the holder 1270.

For example, a portion of the support board 1310 may be coupled, attached or fixed to the first projection 1027A and the second projection 1027B of the holder 1270. The bodies 1086 and 1087 of the support board 1310 may be coupled, attached or fixed to the first and second projections 1027A and 1027B of the holder 1270.

For example, the first support board 1310-1 may be coupled, attached or fixed to the first projection 1027a, and the second support board 1310-2 may be coupled, attached or fixed to the second projection 1027B. For example, the first portion 1006A of the first body 1086 may be coupled, attached or fixed to the outer surface (or the inner surface) of the first projection 1027A, and the first portion 1009A of the second body 1087 may be coupled, attached or fixed to the outer surface (or the inner surface) of the second projection 1027B.

The base 1210 may include first to fourth side portions 1065A to 1065D (see FIG. 14) which correspond to or face the first to fourth side portions 1033A to 1033D of the first circuit board 1250. The first to fourth side portions 1065A to 1065D of the base 1210 may correspond to or face the first to fourth side portions 1064A to 1064D of the holder 1270.

The first and second side portions 1065A and 1065B of the base 1210 may be disposed so as to face or be opposite to each other in the first horizontal direction (for example, in the Y-axis direction). Furthermore, the third and fourth side portions 1065C and 1065D of the base 1210 may be disposed so as to face or be opposite to each other in the second horizontal direction (for example, in the X-axis direction).

At least a portion of the support board 1310 may be coupled, attached or fixed to the base 1210. For example, the bodies 1086 and 1087 of the support board 1310 may be coupled to the base 1210 using an adhesive. For example, portions of the bodies 1086 and 1087 of the support board 1310 connected to the extensions 107A to 1007D may be coupled to the base 1210.

For example, at least a portion of the support board 1310 may be coupled, attached or fixed to the projections 1216A and 1216B formed at the base 1210. For example, the support board 1310 may be coupled, attached or fixed to the outer surfaces (or the inner surfaces) of the projections 1216A and 1216B of the base 1210. The first projection 1216A may be formed at the third side portion 1065C of the base 1210, and the second projection 1216B may be formed at the fourth side portion 1065D of the base 1210.

For example, the bodies 1086 and 1087 of the support board 1310 may be coupled, attached or fixed to the first and second projections 1216A and 1216B of the base 1210.

For example, one end (for example, the second portion 1006B) of the first support board 1310-1 may be coupled, attached or fixed to one region of the first projection 1216A of the base 1210, and the other end (for example, the third portion 1006C) of the first support board 1310-1 may be coupled, attached or fixed to one region of the second projection 1216B of the base 1210.

For example, one end (for example, the second portion 1009B) of the second support board 1310-2 may be coupled, attached or fixed to another region of the first projection 1216A of the base 1210, and the other end (for example, the third portion 1009C) of the second support board 1310-2 may be coupled, attached or fixed to another region of the second projection 1216B of the base 1210.

A first coupling region 1069A may be formed between the first body 1086 of the first support board 1310-1 and the first projection 1027A of the holder 1270, and a second coupling region 1069B may be formed between the second body 1087 of the second support board 1310-2 and the second projection 1027B of the holder 1270.

Furthermore, a third coupling region 1059A may be formed between one end of each of the first and second support boards 1310-1 and 1310-2 and the first projection 1216A of the base 1210. A fourth coupling region 1059B may be formed between the other end of each of the first and second support boards 1310-1 and 1310-2 and the second projection 1216B of the base 1210.

By virtue of the support board 1310 and the first to fourth coupling regions 1069A, 1069B, 1059A and 1059B, the OIS moving unit may be flexibly supported with respect to the stationary unit. The terminals 1311 of the support board 1310 may be coupled and electrically connected to the terminals 1800B of the second board unit 1800 using a solder 1902 (see FIGS. 17A and 17B) or a conductive adhesive.

In another embodiment, for example, the support member may be an elastic member excluding the board, for example, a spring, a wire, shape-memory alloy or a ball member. For example, when the support member is made of a wire, a plurality of wires may be disposed on at least one of the corners and side portions of the base 1210 or the second board unit 1800 in order to connect the first board unit 1255 (for example, the second circuit board 1260) to the second board unit 1800 (or the base 1210). For example, one end of each of the plurality of wires may be coupled to the first board unit 1255 (for example, the second circuit board 1260), and the other end of each of the plurality of wires may be coupled to the second board unit 1800 (or the base 1210).

The image sensor unit 1350 may include at least one of the controller 1830, a memory 1512 or a capacitor 1514.

The controller 1830 may be disposed so as to be spaced apart from the first board unit 1255. For example, the controller 1830 may be disposed on the second board unit 1800.

The memory 1512 may be disposed on one of the first board unit 1255 and the second board unit 1800. For example, the memory 1512 may be disposed or mounted on the first region 1801 of the second board unit 1800. For example, the memory 1512 may avoid spatial interference with the heat radiating member 1380 or may be spaced apart from the heat radiating member 1380. For example, the heat radiating member 1380 may include an escape groove or opening for avoiding spatial interference with the memory 1512, and the memory 1512 may be disposed in the escape groove or opening in the heat radiating member 1380. The capacitor 1514 may be disposed on at least one of the first board unit 1255 or the second board unit 1800.

The memory 1512 may store a first data value (or a code value) corresponding to the output of the second position sensor 1240 according to displacement (or stroke) of the OIS moving unit in a direction perpendicular to the optical axis (for example, in the X-axis direction or in the Y-axis direction) for OIS feedback operation. Furthermore, the memory 1512 may store a first data value (or a code value) corresponding to the output of the first position sensor 1170 according to displacement (or stroke) of the bobbin 1110 in the first direction (for example, in the optical axis direction or in the Z-axis direction) for AF feedback operation.

For example, each of the first and second data values may be stored in the memory 1512 as a look-up table. Furthermore, the memory 1512 may store a mathematical formula, an algorithm or a program for operation of the controller 1830. For example, memory 1512 may be a non-volatile memory, for example, an electrically erasable programmable read-only memory (EEPROM).

The controller 1830 may be positioned outside of the cover member 1300 or may be disposed on one region of the second board unit 1800 which is positioned outside the cover member 1300.

Referring to FIG. 20A, the second board unit 1800 may include the extension region 1808 which is connected to the first region 1801 and extends therefrom. The extension region 1808 may extend from the first side portion 1085A of the first region 1801. For example, the extension region 1808 may project from the outer surface of the first side portion 1085A of the first region. For example, the extension region 1808 may project from the outer surface of the first side portion 1085A of the first region. For example, the extension region 1808 may extend or project in the second horizontal direction (for example, in the X-axis direction).

The extension region 1808 may be positioned outside the cover member 1300 or may be positioned at an outer side of the cover member 1300.

The extension region 1808 may alternatively be referred to as a “fourth region”, a “projecting region”, an “extension portion”, or a “projecting portion”. The extension region 1808 may not overlap the AF moving unit and the OIS moving unit in the optical axis direction. For example, the extension region 1808 may extend in the same direction (for example, in the second horizontal direction) as the third region 1803.

The controller 1830 may be disposed in the extension region 1808 of the second board unit 1800. For example, the controller 1830 may be disposed or mounted on the upper surface of the extension region 1808 of the second board unit 1800. In another embodiment, the controller 1830 may be disposed or mounted on the lower surface of the extension region 1808. For example, the controller 1830 may not overlap the cover member 1300 in the optical axis direction. For example, the extension region 1808 may not overlap the cover member 1800 in the optical axis direction. For example, the surface area of the upper surface of the extension region 1808 may be equal to or larger than the surface area of the lower surface of the controller 1830.

Because the extension region 1808 and the third region 1803 are connected to the first side portion 1085A of the second board unit 1800, it is possible to reduce the surface area that is occupied by the camera device 1010 in a direction perpendicular to the optical axis. Therefore, the embodiment is able to reduce increase in the size of the camera device 1010 attributable to the extension region 1808.

In another embodiment, the extension region may be connected to one of second to fourth side portions 1085B, 1085C and 1085D of the first region 1801 of the second board unit 1800, and may project from one of the second to fourth side portions 1085B, 1085C and 1085D of the first region 1801.

The controller 1830 may be positioned outside the cover member 1300 or may be positioned at the outer side of the cover member 1300. For example, the controller 1830 may be positioned outside the space defined between the cover member 1300, the base 1210 and the first region 1801 of the second board unit 1800.

For example, the controller 1830 may not overlap the lens module 1400, the AF moving unit, the OIS moving unit, and the first region 1801 of the second board unit 1255 in the optical axis direction. At least one capacitor 1514 may be disposed or mounted on the upper surface of the extension region 1808.

Because the OIS moving unit including the image sensor and the first board unit is disposed so as to be spaced apart from the stationary unit including the second board unit in a sensor-shift-type camera device in which the image sensor is moved for hand tremor correction, it may be insufficient to radiate heat generated by the OIS moving unit to the outside through the stationary unit. In addition, the sensor-shift-type camera device may have a structure in which the AF operation unit and the OIS operation unit are confined in the cover member in order to inhibit malfunction caused by foreign substances, and thus it may not be easy to radiate heat to the outside of the camera device.

The image sensor, the second coil, and the controller may correspond to the heat-generating source. Here, the “controller” may be a driver IC configured to control AF operation and/or OIS operation.

The camera device 1010 may include a radiating member 1870 which is disposed, coupled or attached to the extension region 1808 in order to improve efficiency of heat radiation. The radiating member 1870 may be in contact with the extension region 1808. For example, the radiating member 1870 may be disposed below the extension region 1808. For example, the radiating member 1870 may be disposed, coupled or fixed to the lower surface of the extension region 1808. The radiating member 1870 may be a plate-shaped member, and the description of the material of the heat radiating member 1280 may be applied to the radiating member 1870 with or without modification. At least a portion of the radiating member 1870 may overlap the controller 1830 in the optical axis direction.

The camera device 1010 may include a cover can 1405 which is disposed in the extension region 1808 and accommodates the controller 1830 therein in order to protect the controller 1830 from external shock. The cover can 1405 may include an upper plate 1405A and a side plate 1405B which is connected to the upper plate 1405A and extends toward the extension region 1808 from the upper plate 1405A.

The cover can 1405 may be disposed, coupled or fixed to the upper surface of the extension region 1808. For example, the lower portion, the lower end or the lower surface of the side plate 1405B of the cover can 1405 may be coupled, attached or fixed to the upper surface of the extension region 1808.

Because the cover can 1405 accommodates the controller 1830 therein, it is possible to inhibit the heat generated by the controller 1830 from being radiated to the outside and being transmitted to the image sensor. The description of the material of the heat radiating member 1280 or the cover member 1300 may be applied to the cover can 1405 with or without modification.

The camera device 1010 may further include a heat radiating layer 1860 disposed on the controller 1830. The heat radiating layer 1860 may cover the surface of the controller 1830. For example, the heat radiating layer 1860 may be disposed so as to surround the surface of the controller 1830. For example, the heat radiating layer 1860 may be in contact with the upper surface and the side surface of the controller 1830 so as to surround the surfaces. The heat radiating layer 1860 may be made of exothermic plastic or radiating resin, for example, exothermic epoxy. The heat radiating layer 1860 may improve efficiency and performance of heat radiation of the controller 1830.

In another embodiment, the radiating layer may be disposed on at least one of the upper surface or the side surface of the controller 1830. For example, the radiating layer may expose at least a portion of the controller 1830.

The controller 1830 may be electrically connected to the second position sensor 1240. The controller 1830 may adjust or control the drive signal supplied to the second coil 1230 and may perform feedback OIS operation using the output signal received from the sensors 1240A, 1240B and 1240C of the second position sensor 1240 and the first data value stored in the memory 1512.

Furthermore, the controller 1830 may be electrically connected to the first position sensor 1170. For example, when the first position sensor 1170 is embodied as a Hall sensor alone, the first position sensor 1170 may be electrically connected to the controller 1830. Here, the controller 1830 may control the drive signal supplied to the first coil 1120 and thus perform feedback autofocusing operation using the output signal of the first position sensor 1170 and the second data value stored in the memory 1512.

Although the controller 1830 may be embodied as a driver IC, the disclosure is not limited thereto. For example, the controller 1830 may be electrically connected to the terminals 1800B of the second board unit 1800.

The controller 1830 may control the first position sensor, which is embodied as a Hall sensor alone, and the second position sensor, which is embodied as a Hall sensor alone. For example, the controller 1830 may supply a drive signal to the first position sensor, which is embodied as a Hall sensor alone, and/or the second position sensor, which is embodied as a Hall sensor alone, and may receive the output signal of the first position sensor and/or the output signal of the second position sensor.

In another embodiment, the first position sensor may be embodied as a Hall sensor alone, and the second position sensor may be embodied as a drive IC including a Hall sensor. Here, the controller 1830 may be electrically connected to the first position sensor, may supply a drive signal to the first position sensor, and may receive the output signal from the first position sensor.

For example, the controller 1830 may include a driver configured to drive at least one of the first position sensor or the second position sensor.

The image sensor unit 1350 may further include a motion sensor (not shown) which is disposed on one of the first board unit 1255 and the second board unit 1800. The motion sensor may be electrically connected to the controller 1830. The motion sensor may output rotational angular velocity information corresponding to movement of the camera device 1010. For example, the motion sensor may be embodied as a biaxial or triaxial gyro sensor or an angular velocity sensor. For example, the motion sensor may output information on amount of movement in the X-axis direction and the Y-axis direction and an amount of rotation caused by movement of the camera device 1010.

In another embodiment, the motion sensor may be omitted from the camera device 1010. In the case in which the motion sensor is omitted from the camera device, the camera device 1010 may receive position information about movement of the camera device 1010 from the motion sensor provided at the optical instrument 200A.

The image sensor unit 1350 may further include the filter 1610 disposed between the lens module 1400 and the image sensor 1810. The image sensor unit 1350 may further include the filter holder 1600 in which the filter is disposed, seated or received. The filter holder 1600 may alternatively be referred to as a “sensor base”.

The filter 1610 may serve to inhibit light within a specific frequency band that passes through the lens barrel 1400 from being introduced into the image sensor 1810. The filter 1610 may be, for example, an infrared-light-blocking filter. For example, the filter 1610 may be oriented parallel to the X-Y plane perpendicular to the optical axis OA. The filter 1610 may be disposed below the lens module 1400.

The filter holder 1600 may be disposed under the AF operation unit 1100. For example, the filter holder 1600 may be disposed on the first board portion 1255. For example, the filter holder 1600 may be disposed on the upper surface of the second circuit board 1260 of the first board unit 1255.

The filter holder 1600 may be coupled to one region of the second circuit board 1260 around the image sensor 1810 using an adhesive, and may be exposed through the bore 1250A in the first circuit board 1250. For example, the bore 1250A in the circuit board 1250 may expose the filter holder 1600 disposed on the second circuit board 1260 and the filter 1610 disposed on the filter holder 1600 therethrough. The filter holder 1600 may have therein a bore 1061A, which is formed in a region thereof in which the filter 1610 is mounted or disposed, so as to allow the light that has passed through the filter 1610 to enter the image sensor 1810. The bore 1061A in the filter holder 1600 may be configured to have the form of a through hole, which is formed through the filter holder 1600 in the optical axis direction. For example, the bore 1061A in the filter holder 1600 may be formed through the center of the filter holder 1600, and may be disposed so as to correspond to or face the image sensor 1810.

The filter holder 1600 may have a seating portion 1500, which is depressed from the upper surface thereof and in which the filter 1610 is seated. The filter 610 may be disposed, seated or mounted in the seating portion 1500. The seating portion 1500 may be formed so as to surround the bore 1061A. In another embodiment, the seating portion of the filter holder may be configured to have the form of a projection, which projects from the upper surface of the filter.

The image sensor unit 1350 may further include an adhesive disposed between the filter 1610 and the seating portion 1500. By virtue of the adhesive, the filter 1610 may be coupled or attached to the filter holder 1600.

In another embodiment, the filter holder may be coupled to the holder 1270 or the AF operation unit 1100.

Referring to FIG. 3, the cover member 1300 may have the form of a box which is open at the lower portion thereof and includes the upper plate 1301 and the side plate 1302. The lower portion of the side plate 1302 of the cover member 1300 may be coupled to the base 1210. The upper plate 1301 of the cover member 1300 may have a polygonal shape, for example, a quadrilateral shape or an octagonal shape. For example, the side plate 1302 may include four side plates which are connected to each other. The upper plate 1301 of the cover member 1300 may have formed therein a bore 1303 through which the lens of the lens module 1400 coupled to the bobbin 1110 is exposed to external light.

Referring to FIGS. 1 and 3, the side plate 1302 of the cover member 1300 may have formed therein a groove 1304 through which the terminal 1095 of the circuit board 1190 and the terminal 800B of the second board unit corresponding to the terminal 1095 are exposed.

For example, the cover member 1300 may be made of metal. For example, the cover member 1300 may be made of SUS (steel use stainless, for example, SUS4 series). Furthermore, the cover member 1300 may be made of steel plate cold commercial (SPC). For example, the cover member 1300 may be made of SUS containing 50% or more of Fe. In order to inhibit oxidization, antioxidizing metal, for example, nickel may be plated on the surface of the cover member 1300. In another embodiment, for example, the cover member 1300 may be made of a magnetic material or magnetic metal.

In a further embodiment, the cover member 1300 may be injection molded from, for example, plastic or resin. Furthermore, the cover member 1300 may be made of an insulative material or a material capable of shielding electromagnetic waves.

The cover member 1300 and the base 1210 may accommodate therein the AF operation unit 1100 and the OIS moving unit. The cover member 1300 and the base 1210 may protect the AF operation unit 1100 and the OIS moving unit from external shock, and may inhibit introduction of foreign substances from the outside.

For example, at the initial position of the OIS moving unit, the outer surface of the holder 1270 may be spaced apart from the inner surface of the base 1210 by a predetermined distance. For example, at the initial position of the OIS moving unit, the lower surfaces of the holder 1270 and the first board unit 1255 may be spaced apart from the base 1210 by a predetermined distance.

The controller 1830 may supply at least one drive signal to at least one of the first to fourth coil units 1230-1 to 1230-4, and may control the at least one drive signal to move the OIS moving unit in the X-axis direction and/or in the Y-axis direction or to rotate, tilt or roll the OIS moving unit relative to the optical axis within a predetermined angle range.

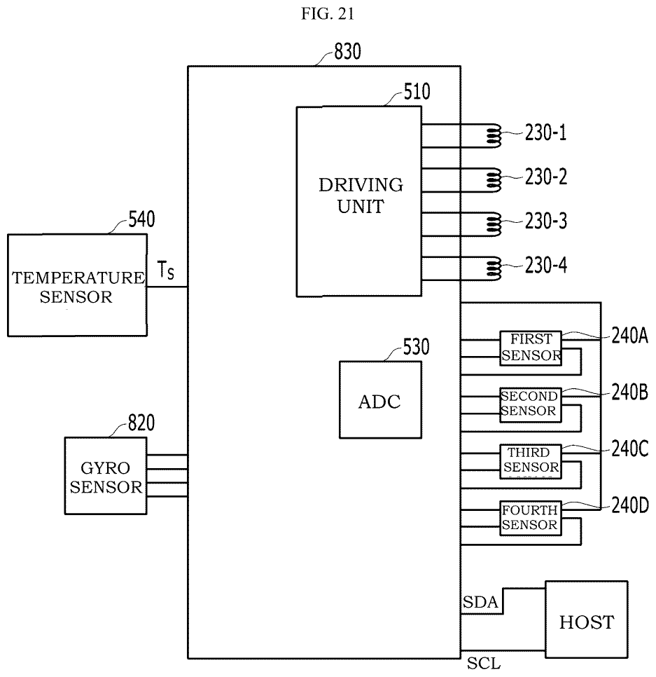

FIG. 21 is a block diagram illustrating the configuration of the controller 1830 and the first to third sensors 1240A, 1240B and 1240C. The controller 1830 may perform communication of transmitting and receiving data with respect to the host using a clock signal SCL and a data signal SDA, for example, I2C communication. For example, the host may be the controller 780 of the optical instrument 200A.

The controller 1830 may be electrically connected to the second coil 1230. The controller 1830 may include a driving unit 1510 configured to supply a drive signal for driving the first to fourth coil units 1230-1 to 1230-4. For example, the driving unit 1510 may include an H bridge circuit or an H bridge driver capable of changing the polarity of the drive signal. Here, the drive signal may be a PWM signal for reduction of current consumption, and the drive frequency of the PWM signal may be 20 kHz or higher which exceeds an audible frequency range. In another embodiment, the drive signal may be a DC signal.

Each of the first to third sensors 1240A, 1240B and 1240C may include two input terminals and two output terminals. The controller 1830 may supply power or a drive signal to the two input terminals of each of the first to third sensors 1240A to 1240C. For example, first input terminals of the first to third sensors 1240A to 1240C may be connected to one another in common. For example, the two input terminals may be a (+) input terminal and a (−) input terminal (for example, a ground terminal).

For example, the controller 1830 may receive the first output voltage of the first sensor 1240A, the second output voltage of the second sensor 1240B and the third output voltage of the third sensor 1240C, and may control movement (or displacement) of the OIS moving unit in the X-axis direction or in the Y-axis direction using the received first to third output voltages. Furthermore, the controller 1830 may control rotation, tilting or rolling of the OIS moving unit relative to the optical axis using the received first to third output voltages.

Furthermore, the controller 1830 may include an analog-to-digital converter 1530 configured to receive the output voltages output from the two output terminals of each of the first to third sensors 1240A to 1240C and to output data values, digital values or code values corresponding to the results of analog-to-digital conversion of the received output voltages. The controller 1830 may control movement (or displacement) of the OIS moving unit in the X-axis direction or in the Y-axis direction and rotation, tilting or rolling of the OIS moving unit relative to the optical axis.

A temperature sensor 1540 may measure an ambient temperature (for example, the temperatures of the first to third sensors 1240A, 1240B and 1240C), and may output a temperature detection signal Ts corresponding to the result of the measurement. For example, the temperature sensor 1540 may be a thermistor.

The resistance value of the resistor included in the temperature sensor 1540 may vary according to an ambient temperature, and thus the value of the temperature detection signal Ts may vary according to an ambient temperature. A mathematical formula or a look-up table relating to an ambient temperature and the temperature detection signal Ts, which is established through calibration, may be stored in the memory or the controllers 1830 and 1780.

Because the output values of the first to third sensors 1240A, 1240B and 1240C are also affected by temperature, it is necessary to compensate the output values of the first to third sensors 1240A, 1240B and 1240C according to an ambient temperature for the purpose of accurate and reliable OIS feedback operation.

To this end, for example, the controllers 1830 and 780 are able to compensate the output values (or data values corresponding to the output) of the first to third sensors 1240A, 1240B and 1240C using the ambient temperature measure by the temperature sensor 1540 and a temperature compensation algorithm or a compensation formula. The temperature compensation algorithm or the compensation formula may be stored in the controllers 1830 and 780 or the memory.

The camera device may further include a fourth sensor 1240D which corresponds to or faces the fourth magnet unit 1130-4 in the optical axis direction. The fourth sensor 1240D may be disposed on the first board unit 1255 (for example, the first circuit board 1250). For example, the fourth sensor 1240D may be disposed adjacent to one corner of the first circuit board 1250 on which the first to third sensors 1240A to 1240C are not disposed. The description of the dispositional relationship between the first sensor 1240A and the first coil unit 1230-1 may be applied to the dispositional relationship between the fourth sensor 1240D and the fourth coil unit 1230-4 with or without modification.

For example, the fourth sensor 1240D may be positioned so as to face the second sensor 1240B in a diagonal direction. For example, the output voltage of the fourth sensor 1240D may also be used in detection of movement of the OIS moving unit in the X-axis direction or in the Y-axis direction.

In another embodiment, the fourth sensor 1240D may correspond to the first position sensor 1170 of the AF operation unit 1100.

The controller 1830 may be electrically connected to at least one of the first position sensor 1170, the second coil 1230 or the second position sensor 1240 via the second board unit 1800, the support board 1310 and the first board unit 1255.

In another embodiment, the controller 1830 may be disposed on the first board unit 1255. In another embodiment, for example, the controller 1830 may be disposed on the first circuit board 1250.

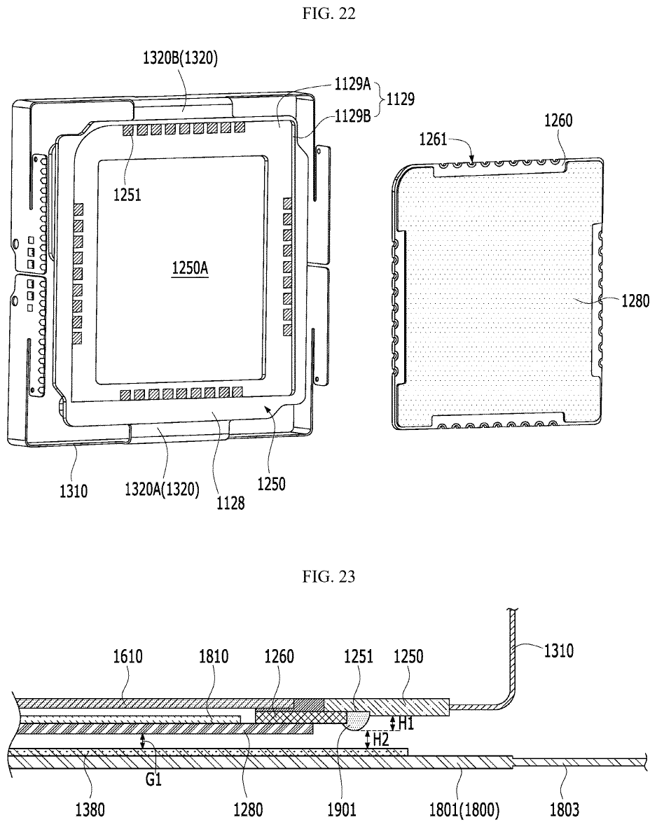

FIG. 22 is a perspective view of the first circuit board 1250, the support board 1310, the second circuit board 1260, and the heat radiating member 1280. FIG. 23 is a fragmentary enlarged view of FIG. 4B. FIG. 24 is a fragmentary cross-sectional view of the first circuit board 1250 and the connectors 1320 of the support board 1310. FIG. 25 is a cross-sectional view of the first circuit board 1250, the second circuit board 1260, and the solder 1901.

Referring to FIGS. 22 to 25, a seating groove 1129 in which the second circuit board 1260 is disposed or seated may be formed in the lower surface 1128 of the first circuit board 1250.

For example, the seating groove 1129 may be a groove depressed from the lower surface 1128 of the first circuit board 1250. For example, the shape of the seating groove 1129 may correspond to or coincide with the shape of the outer circumferential surface of the second circuit board 1260. For example, the seating groove 1129 may have a polygonal shape, for example, a quadrilateral shape.

The seating groove 1129 may include a bottom surface 1129A which defines a height difference with respect to the lower surface 1128 of the first circuit board 1250. For example, the bottom surface 1129A may be positioned higher than the lower surface 1128 of the first circuit board 1250. For example, the upper surface of the first circuit board 1250 may be positioned closer to the bottom surface 1129A than the lower surface 1128 of the first circuit board 1250. For example, the seating groove 1129 may include a side surface 1129B which is disposed between the lower surface 1128 of the first circuit board 1250 and the bottom surface 1129A so as to connect the lower surface 1128 of the circuit board 1250 to the bottom surface 1129A.

For example, the terminal 1251 of the first circuit board 1250 may be disposed in the seating groove 1129 in the first circuit board 1250. For example, the terminal 1251 of the first circuit board 1250 may be disposed on the bottom surface 1129B of the seating groove 1129 in the first circuit board 1250.

Referring to FIG. 24, the bottom surface 1129A of the seating groove 1129 in the first circuit board 1250 may be the first insulating layer 1092-1. For example, the bottom surface 1129A may be a coverlay 1009a2.

For example, at least a portion of the terminal 1251 of the first circuit board 1250 may be open or exposed from the bottom surface 1129A of the seating groove 1129. For example, at least a portion of the terminal 1251 may be open or exposed from the coverlay 1009a2 which is the bottom surface 1129A. For example, the coverlay 1009a2 may be a transparent ink type material. The coverlay 1009a2 may be used in a flexible substrate.

The terminal 1251 of the first circuit board 1250 may be positioned higher than the lower surface 1128 of the first circuit board 1250. For example, the upper surface of the first circuit board 1250 may be positioned closer to the terminal 1251 than the lower surface 1128 of the first circuit board 1250.

For example, the second circuit board 1260 may be coupled to the seating groove 1129 in the first circuit board 1250 using an adhesive. For example, the upper surface of the second circuit board 1260 may be coupled or attached to the bottom surface 1129A of the seating groove 1129 in the first circuit board 1250 using an adhesive.

At least a portion of the terminal 1261 of the second circuit board 1260 may be disposed in the seating groove 1129 in the first circuit board 1250.

The second circuit board 1260 and the seating groove 1129 in the first circuit board 1250 may overlap each other in the optical axis direction. Because at least a portion of the second circuit board 1260 is disposed in the seating groove 1129 in the first circuit board 1250, at least a portion of the second circuit board 1260 may overlap the first circuit board 1250 in a direction perpendicular to the optical axis. The length or thickness of the first board unit 1255 in the optical axis direction may be decreased by the thickness that the first circuit board 1250 overlaps the second circuit board 1260. Consequently, according to the embodiment, it is possible to reduce the length of the first board unit 1255 in the optical axis direction and the size of the camera module in the optical axis direction.

Referring to FIG. 24, the first circuit board 1250 may include a plurality of conductive layers 1091-1 to 1091-m (m being a natural number greater than 1). Although FIG. 24 illustrates four conductive layers 1091-1 to 1091-4 which are sequentially layered in the optical axis direction, the present disclosure is not limited thereto. In another embodiment, the number of the conductive layers of the first circuit board 1250 may be two or more. Each of the conductive layers may include a copper foil, a wire, a terminal or a conductive pattern layer for transmission of an electrical signal or may include a ground layer. For example, each of the conductive layers 1091-1 to 1091-4 may be made of a conductive metal, for example, copper, aluminum, gold, silver or an alloy including at least one thereof. For example, each of the conductive layers 1091-1 to 1091-4 may be formed to include at least one of a pattern layer, a wire or a terminal (or a pad).

For example, the first circuit board 1250 may include the insulating layers 1092-1 to 1092-3 disposed between the plurality of conductive layers 1091-1 to 1091-4. The insulating layers 1092-1 to 1092-3, which serve to electrically insulate the conductive layers 1091-1 to 1091-4 from one another, may inhibit electrical short between the conductive layers 1091-1 t0 1091-4.

Although FIG. 24 illustrates three insulating layers disposed between the conductive layers, the present disclosure is not limited thereto. The number of insulating layers may be determined according to the number of conductive layers, and may be one or more. The insulating layer may alternatively be referred to as “insulating foil” or “insulating film”.

The first circuit board 250 may include at least one of a rigid insulating layer made of a rigid material or a flexible insulating layer made of a flexible material. Here, the flexible insulating layer may have a property of being bendable, and the rigid insulating layer may have a higher strength or hardness than the flexible insulating layer.

For example, the flexible insulating layer may include a flexible resin, for example, polyimide. For example, the rigid insulating layer may include rigid resin, for example, prepreg. For example, the rigid insulating layer may include at least one of prepreg and coverlay. For example, the coverlay may include resin. Furthermore, for example, the coverlay may include resin and an adhesive. For example, the resin may be polyimide. For example, the coverlay may be formed into a film or a sheet.

For example, at least one of the plurality of insulating layers 1092-1 to 1092-3 of the first circuit board 1250 may be a rigid insulating layer, and at least one of the plurality of insulating layers 1092-1 to 1092-3 may be a flexible insulating layer.

For example, the first circuit board 1250 may include the first insulating layer 1092-1 disposed between the first conductive layer 1091-1 and the second conductive layer 1091-2, the second insulating layer 1092-2 disposed between the second conductive layer 1091-2 and the third conductive layer 1091-3, and the third insulating layer 1092-3 disposed between the third conductive layer 1091-3 and the fourth conductive layer 1091-4.

For example, each of the first insulating layer 1092-1 and the third insulating layer 1092-3 may be a rigid insulating layer. For example, each of the first insulating layer 1092-1 and the third insulating layer 1092-3 may include a prepreg 9a1. Alternatively, for example, each of the first insulating layer 1092-1 and the third insulating layer 1092-3 may include the prepreg 9al and the coverlay 1009a2.

The second insulating layer 1092-2 may be a flexible insulating layer. For example, the second insulating layer 1092-2 may include polyimide.

The first circuit board 1250 may include the cover layer 1098 disposed on the outermost conductive layer (for example, 1091-1 and 1091-4) in order to protect the conductive layers 1091-1 to 1091-4 from external impact or the like. For example, the cover layer 1098 may include a first cover layer 1098a disposed beneath the first conductive layer 1091-1 that is the lowermost conductive layer, and a second cover layer 1098b disposed on the fourth conductive layer 1091-4 that is the uppermost conductive layer.

The cover layer 1098 may be formed of an insulative material, for example, a solder resist (SR). For example, the cover layer 1098 may be a photo solder resist (PSR) or dry-film type solder resist (DFSR). For example, the cover layer 1098 may be made of an opaque ink type material or a translucent film type material. The cover layer 1098 may serve to protect the inner conductive layers of the first circuit board 1250.

For example, the conductive layer 1091-2 of the first circuit board 1250 may include a portion or a region which is open or exposed from the first insulating layer 1092-1. Here, the portion that is open or exposed from the first insulating layer 1092-1 may be formed as the terminal 1251. For example, the conductive layer 1091-2 may include the terminal 1251.

The terminal 1251 may be positioned higher than the lowermost conductive layer (for example, 1091-1) of the first circuit board 1250. For example, the terminal 1251 may be positioned higher than the lowermost conductive layer (for example, 1091-1) of the first circuit board 1250.

For example, the terminal 1251 may not be formed at the lowermost conductive layer (for example, 1091-1) of the first circuit board 1250.

For example, the terminal 1251 may be formed at another conductive layer (for example, 1091-2) disposed on the lowermost conductive layer (for example, 1091-1) of the first circuit board 1250.

For example, the terminal 1251 may be formed at a conductive layer (for example, 1091-2) positioned directly on the lowermost conductive layer (for example, 1091-1) of the first circuit board 1250. For example, the terminal 1251 may be formed at the second lowermost conductive layer (for example, 91-21091-2) of the first circuit board 1250.

In another embodiment, the terminal 1251 may be formed at the third lowermost conductive layer (for example, 1091-3) of the first circuit board 1250.

In another embodiment, the terminal 1251 may be formed at a conductive layer positioned between the lowermost conductive layer (for example, 109-1) and the uppermost conductive layer (for example, 1091-4) of the first circuit board 1250. In another embodiment, the terminal 1251 may be formed at the uppermost conductive layer (for example, 1091-4) of the first circuit board 1250.

The side surface between the upper surface and the lower surface of the first circuit board 1250 may be insulated by means of an insulating layer, for example, a cover layer. For example, the insulating layer (for example, the cover layer) may be disposed or formed on the outer surfaces of the outermost ones among the conductive layers 1091-1 to 1091-4 and the insulating layers 1092-1 to 1092-3 of the first circuit board 1250.

For example, the lowermost layer of the first circuit board 1250 may be the first insulating layer, for example, the first cover layer 1098a and the first conductive layer 1091-1 may be disposed on the first insulating layer (for example, the first cover layer 1098a).

Referring to FIG. 25, the second circuit board 1260 may include a rigid substrate. For example, the second circuit board 1260 may include a plurality of conductive layers 1081-1 to 1081-m (m being a natural number greater than 1). For example, the second circuit board 1260 may include four conductive layers 1081-1 to 1081-4 which are sequentially layered in the optical axis direction. In another embodiment, the number of conductive layers which can be included in the second circuit board 1260 may be two or more. Each of the conductive layers of the second circuit board 1260 may include a copper foil, a wire, a conductive pattern layer or a ground layer for transmission of an electrical signal.

For example, the conductive layers 1081-1 to 1081-4 may be made of a conductive metal, for example, copper, aluminum, gold, silver or an alloy including at least one thereof. For example, the conductive layers 1081-1 to 1081-4 may include at least one of a pattern layer, a wire or a terminal (or a pad).

Furthermore, the second circuit board 1260 may include a plurality of insulating layers 1092-1 to 1082-3.

For example, the second circuit board 1260 may include insulating layers 1082-1 to 1082-3 disposed between the plurality of conductive layers 1081-1 to 1081-4. The insulating layers 1082-1 to 1082-3, which serve to electrically insulate the conductive layers 1081-1 to 1081-4 from one another, may inhibit electrical short between the conductive layers 1081-1 to 1081-4.

For example, although the second circuit board 1260 is illustrated as including three insulating layers disposed between the conductive layers 1081-1 to 1081-4, the number of insulating layers of the second circuit board 1260 may be determined according to the number of conductive layers and may be one or more in another embodiment. The insulating layer may alternatively be referred to as “insulating foil” or “insulating film”.

For example, the second circuit board 1260 may include at least one of a rigid insulating layer made of a rigid material or a flexible insulating layer made of a flexible material. The description of the rigid insulating layer and the flexible insulating layer of the first circuit board 1250 may be applied to the second circuit board 1260 with or without modification.

For example, at least one of the plurality of insulating layers 1082-1 to 1082-3 of the second circuit board 1260 may be a rigid insulating layer, and at least one of the plurality of insulating layers 1082-1 to 1082-3 may be a flexible insulating layer.

For example, the second circuit board 1260 may include a first insulating layer 1082-1 disposed between the first conductive layer 1081-1 and the second conductive layer 1081-2, a second insulating layer 1082-2 disposed between the second conductive layer 1081-2 and the third conductive layer 1081-3, and a third insulating layer 1082-3 disposed between the third conductive layer 1081-3 and the fourth conductive layer 1081-4.

For example, each of the first insulating layer 1082-1 and the third insulating layer 1082-3 may be a rigid insulating layer. For example, each of the first insulating layer 1082-1 and the third insulating layer 1082-3 may include a prepreg 83a. Alternatively, for example, each of the first insulating layer 1082-1 and the third insulating layer 1082-3 may include a prepreg 83a and a coverlay 83b. The second insulating layer 1082-2 may be a flexible insulating layer. For example, the second insulating layer 1082-2 may include polyimide.

The second circuit board 1260 may include an insulating layer 1097 disposed on the outermost conductive layers (for example 1081-1 and 1081-4) in order to protect the conductive layers 1081-1 to 1081-4 from external impact or the like. Here, the insulating layer 1087 may be referred to as a “cover layer”, and reference numeral “1097” denotes the cover layer hereinafter.

For example, the cover layer 1087 may include a first cover layer 1097a disposed beneath the first conductive layer 1081-1 which is the lowermost conductive layer, and a second cover layer 1097b disposed on the fourth conductive layer 1081-4 which is the uppermost conductive layer.

The cover layer 1087 may be formed of an insulative material, for example, a solder resist SR. For example, the cover layer 1087 may be a photo solder resist (PSR) or dry-film solder resist (DFSR).

The side surface between the upper surface and the lower surface of the second circuit board 1260 may be insulated by an insulating layer, for example, a cover layer. For example, the insulating layer (for example, the cover layer) may be disposed or formed on the outermost surfaces of the conductive layers 1081-1 to 1081-4 and the insulating layers 1082-1 to 1082-3.

For example, the lowermost layer of the second circuit board 1260 may be a first insulating layer, for example, a first cover layer 1097a, and the conductive layer 1081-1 may be disposed on the first insulating layer (for example, the first cover layer 1097a).

Referring to FIGS. 13 and 25, at least a portion of the terminal 1261 of the second circuit board 1260 may be disposed in the seating groove 1129 in the first circuit board 1250. At least a portion of the solder 1901 may be disposed in the seating groove 1129 in the first circuit board 1250. For example, the solder 1901 may include a first portion disposed in the seating groove 1129 in the first circuit board 1250 and a second portion projecting outwards from the seating groove 1129.

The terminal 1261 of the second circuit board 1260 may be disposed on at least one of the upper surface, the side surface or the lower surface of the second circuit board 1260. For example, the terminal 1261 may be disposed or formed on at least one of the uppermost conductive layer, the lowermost conductive layer or the side surfaces of the conductive layers of the second circuit board 1260.

The terminal 1261 of the second circuit board 1260 may be electrically connected to at least one of the plurality of conductive layers 1081-1 to 1081-4 of the second circuit board 1260. For example, the terminal 1261 may include a first pad 1261A (or a “first portion”) which is formed at the side surface of the second circuit board 1260 so as to be connected to at least one of the plurality of conductive layers 1081-1 to 1081-4.

For example, the first pad 1261A of the terminal 1261 may extend parallel to the optical axis direction. For example, the first pad 1261A may include a portion (for example, a groove) depressed from the side surface of the second circuit board 1260. For example, the first pad 1261A may have a curved shape depressed from the side surface of the second circuit board 1260. Alternatively, for example, the first pad 1261A may be a conductive layer, a plated layer or a metal layer which is formed on the side surface of the second circuit board 1260 so as to have the form of a semicircular via or a semi-elliptical via. The reason for this is to increase a contact area with solder to improve solderability and reliability of electrical connection.

For example, the first pad 1261A may be connected to at least one of the first to fourth conductive layers 1081-1 to 1081-4. For example, the first pad 1261A may be positioned higher than the first cover layer 1097a but lower than the second cover layer 1097b.

For example, the first pad 1261A may be connected or coupled to one end of at least one of the first to fourth conductive layers 1081-1 to 1081-4. For example, the first pad 1261A may be a plated layer. The first pad 1261A may be the same material as the conductive layers 1081-1 to 1081-4. For example, the first pad 1261A may include a gold plated layer or a copper plated layer including gold.

For example, the first pad 1261A may be disposed at a position corresponding to the terminal of the first circuit board 1250 in a direction parallel to the optical axis. For example, at least a portion of the first pad 1261A may overlap at least a portion of the terminal 1251 of the first circuit board 1250 in a direction parallel to the optical axis.

For example, the first pad 1261A may overlap two or more conductive layers (for example, 1081-1 to 1081-4) of the second circuit board 1260 in a direction perpendicular to the optical axis. For example, the first pad 1261A may include a portion overlapping the terminal 1251 of the first circuit board 1250 in the optical axis direction. For example, the first pad 1261A may include a portion which does not overlap the terminal 1251 of the first circuit board 1250 in the optical axis direction.

For example, the terminal 1261 of the second circuit board 1260 may include a second pad 1261B (or a “second portion”) connected to the first pad 1261A. For example, the second pad 1261B may be connected to the lower portion or a lower end of the first pad 1261A.

For example, the second pad 1261B may be perpendicular to the optical axis direction. For example, the upper surface (or the lower surface) of the second pad 1261B may be perpendicular to the optical axis direction. For example, the second pad 1261B may include a portion which does not overlap the terminal 1251 of the first circuit board 1250. Furthermore, for example, the second pad 1261B may include a portion overlapping the terminal 1251 of the first circuit board 1250 in the optical axis direction.

For example, the solder 1901 or the conductive adhesive may be coupled, attached or fixed to the terminal 1251 of the first circuit board 1250 and the terminal 1261 of the second circuit board 1260.

For example, because the terminal 1251 is not formed at the lowermost conductive layer 1091-1 of the first circuit board 1250, the solder 1901 may not be disposed on the lowermost conductive layer 1091-1 of the first circuit board 1250. For example, the solder 1901 may be spaced apart from the lowermost conductive layer 1091-1 of the first circuit board 1250.

For example, the solder 1901 may be disposed on the first pad 1261A of the terminal 1261 of the second circuit board 1260. For example, the solder 1901 may be coupled or fixed to the outer surface of the first pad 1261A of the terminal 1261 of the second circuit board 1260.

For example, the solder 1901 may be in contact with or coupled to the portion of the first pad 1261A that does not overlap the terminal 1251 of the first circuit board 1250 in the optical axis direction. Alternatively, the solder 1901 may be disposed on another portion of the first pad 1261A overlapping the terminal 1251 of the first circuit board 1250 in the optical axis direction.

The solder 1901 may be coupled or fixed to the terminal 1251 of the first circuit board 1250. For example, the solder 1901 may be coupled or fixed to a region of the second conductive layer 1091-2, for example, the terminal 1251 which is open or exposed from the second insulating layer 1092-1 of the first circuit board 1250. For example, the solder 1901 may be coupled or fixed to a region of the second conductive layer 1091-2, for example, the terminal 1251 which is open or exposed from the coverlay 1009a2 of the second insulating layer 1092-1.

For example, the coupling surface or the attachment surface between the terminal 1251 and the solder 1901 may be positioned higher than the lowermost conductive layer (for example, 1091-1) of the first circuit board 1260. For example, the coupling surface or the attachment surface between the terminal 1251 and the solder 1901 may be positioned higher than the lowermost conductive layer (for example, 1091-1) of the first circuit board 1260. For example, the coupling surface between the terminal 1251 and the solder 1901 may be formed at another conductive layer (for example, 1091-2) disposed on the lowermost conducting layer (for example, 1091-1). For example, the coupling surface between the terminal 1251 and the solder 1901 may be formed at a conductive layer (for example, 1091-2 which corresponds to the layer immediately on the lowermost conductive layer (for example, 1091-1) of the first circuit board 1250. In another embodiment, the coupling surface between the terminal 1251 and the solder 1910 may be formed at a conductive layer positioned between the lowermost conductive layer 92-11092-1 and the uppermost conductive layer 1092-4 of the first circuit board 1250.

Referring to FIG. 25, for example, at least a portion of the solder 1901 of the solder 1901 may be disposed between the second lowermost conductive layer 1091-2 of the first circuit board 1250 and the lowermost conductive layer 1091-1 of the second circuit board 1260.

Furthermore, for example, at least a portion of the solder 1901 may be disposed between the second lowermost conductive layer 1091-2 of the first circuit board 1250 and the cover layer 1098a of the first circuit board 1250.

Furthermore, for example, at least another portion of the solder 1901 may be positioned below the cover layer 1098a of the first circuit board 1250.

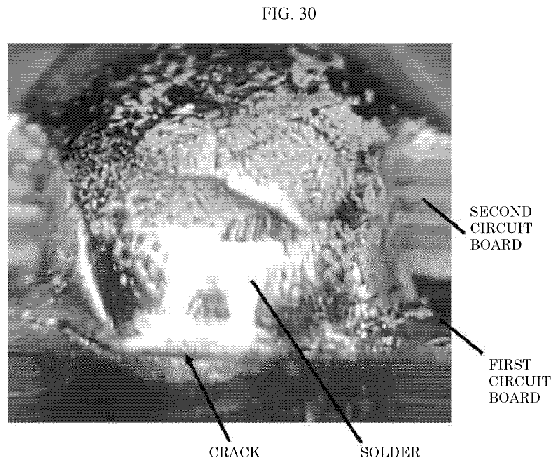

FIG. 30 illustrates a crack produced in an impact experiment for a solder according to a comparative example. The comparative example corresponds to a case in which the terminal 1251 of the first circuit board 1250 is formed at the lowermost conductive layer 1091-1 of the first circuit board 1250.

Referring to FIG. 30, in a comparative example, when impact is applied to the solder, the solder coupled to the terminal cannot endure the impact and thus a crack may occur in the solder. The crack may deteriorate reliability of the electrical connection between the terminal of the first circuit board 1250 and the terminal of the second circuit board 1260.

In the comparative example, since the length of the solder projecting beyond the lower surface of the first circuit board 1250 is long, the distance between the solder and the heat radiating member 1380 of the first board unit 1255 may be less than a predetermined distance. Here, the predetermined distance (or the gap) may be a distance defined between the OIS moving unit and the stationary unit so as to allow easy and normal OIS operation. For example, the predetermined distance may be the distance (for example, 210 μm) between the lowermost end of the moving unit (for example, the heat radiating member 1280) and the first board unit 1255 (for example, the heat radiating member 1380), which is the stationary unit, for OIS operation.

For example, in the comparative example, the lowermost end of the solder may be positioned lower than the lowermost end of the OIS moving unit (for example, the heat radiating member 1280), and the solder may collide with the heat radiating member 1380 of the first board unit 1255 due to an impact and thus a crack may occur in the solder.

In the embodiment, because the coupling surface between the solder 1901 and the terminal 1251 of the first circuit board 1250 is positioned higher than the lowermost conductive layer (for example, 1091-1) of the first circuit board 1250, the length H1 of the solder 1901 projecting from the lower surface of the first circuit board 1250 may be reduced, and the distance H2 between the solder and the heat radiating member 1380 of the first board unit 1255 may be greater than the distance in the comparative example. In the embodiment, it is possible to position the lowermost end of the solder higher than the lowermost end of the OIS moving unit (for example, the heat radiating member 1280) and to inhibit collision of the solder with the heat radiating member 1380 of the first board unit 1255, thereby inhibiting occurrence of a crack in the solder caused by an impact.

For example, the lowermost surface (or the lowermost end) of the solder 1901 may be disposed higher than the lowermost surface of the second circuit board 1260. In another embodiment, the lowermost surface (or the lowermost end) of the solder 1901 may be positioned at the same height as the lowermost surface of the second circuit board 1260.

In another embodiment, the lowermost surface (or the lowermost end) of the solder 1901 may be disposed lower than the lowermost surface of the second circuit board 1260. For example, the lowermost surface (or the lowermost end) of the solder 1901 may be disposed lower than the cover layer 1097a of the second circuit board 1260. For example, the lowermost surface (or the lowermost end) of the solder 1901 may be positioned at a height equal to or higher than the lower surface of the heat radiating member 1280. For example, the projecting length of the lowermost surface (or the lowermost end) of the solder 1901 based on the lowermost surface of the second circuit board 1260 may be equal to or less than the sum of the thickness of the heat radiating member 1280 and the thickness of the adhesive. Here, the adhesive may be disposed between the heat radiating member 1280 and the second circuit board 1260 so as to couple, attach or fix the heat radiating member 1280 to the second circuit board 1260.

The projecting length of the lowermost surface (or the lowermost end) of the solder 1901 based on the lowermost surface of the second circuit board 1260 may be greater than 0 but be equal to or less than 140 μm. The reason for this is because a crack may occur in the solder 1901 due to an impact caused by collision between the solder 1901 and the heat radiating member 1380 when the projecting length of the lowermost surface (or the lowermost end) of the solder 1901 based on the lowermost surface of the second circuit board 1260 exceeds 140 μm.

Referring to FIG. 23, for example, the lowermost surface (or the lowermost end) of the solder 1901 may be positioned higher than the lower surface of the heat radiating member 1280. For example, the lowermost surface (or the lowermost end) of the solder 1901 may be positioned higher than the lower surface of the heat radiating member 1280.

For example, by positioning the terminal 1251 of the first circuit board 1250 higher than the first conductive layer 1091-1, the terminal 1251 in the embodiment may be disposed higher than the comparative example by a predetermined height. For example, the predetermined height may be about 92 μm. Accordingly, it is possible to further assure the distance between the solder and the heat radiating member 1380 of the stationary unit by the predetermined height (for example, about 92 μm). For example, the predetermined height may be the depth or the height difference of the seating groove 1129 shown in FIG. 22. Therefore, according to the embodiment, it is possible to reduce the size of the camera module in the optical axis direction within such a range that the solder 1901 does not extend downwards beyond the lowermost end of the OIS moving unit.

In comparison with the comparative example, the position of the image sensor 1810 may be raised upwards toward the lens module 1400 in the embodiment. The distance between the lens module 1400 and the image sensor 1810 may be adjusted according to a conventional design specification by raising the position of the lens module 1400 upwards.

In the comparative example, the thickness (or the length in the optical axis direction) of the heat radiating member 1380 may be about 140 μm. For example, the thickness of the heat radiating member 1380 may include the thickness of the adhesive configured to couple or attach the heat radiating member 1380 to the second board unit 1800.

It is advantageous to increase the thickness of the heat radiating member 1380 from the point of view of heat radiation. In the embodiment, because the height of the second circuit board 1260 and the heat radiating member 1280 is increased by the height difference or the depth of the seating groove 1129, the predetermined distance (or the gap) between the OIS moving unit and the stationary unit may be increased. Accordingly, according to the embodiment, it is possible to increase the thickness of the heat radiating member 1380 while maintaining the predetermined distance and thus to improve heat radiating efficiency for heat generated by the heat radiating source (for example, the image sensor 1810) of the OIS moving unit. For example, the thickness of the heat radiating member 1380 may be 180 μm to 230 μm. For example, the thickness of the heat radiating member 1380 may be 200 μm to 220 μm. When the thickness of the heat radiating member 1380 is less than 180 μm, improvement in heat radiation may be low, compared to the comparative example. Meanwhile, when the thickness of the heat radiating member 1380 exceeds 230 μm, the thickness may exceed the predetermined distance (or the gap) between the OIS moving unit and the stationary unit, thus causing collision between the OIS moving unit and the stationary unit, and a crack may occur in the solder 1901 due to collision or impact.

For example, the heat radiating member 1380 of the stationary unit a first region, which overlaps the heat radiating member 1280 (or the second circuit board 1260) of the OIS moving unit in the optical axis direction, and a second region, which does not overlap the heat radiating member 1280 (or the second circuit board 1260) of the OIS moving unit in the optical axis direction. For example, the first region of the heat radiating member 1380 may project upwards based on the second region. For example, the heat radiating member 1380 may have a general hat shape. The shape of the first region of the heat radiating member 1380 may be a polygonal shape (for example, a quadrilateral shape), a circular shape, an elliptical shape or the like.

For example, the thickness of the first region of the heat radiating member 1380 may be greater than the thickness of the second region. For example, the thickness of the second region of the heat radiating member 1380 according to the embodiment may be equal to the thickness (for example, 140 μm) of the heat radiating member 1380 according to the comparative example, and the thickness of the first region of the heat radiating member according to the embodiment may be 180 μm to 230 μm as described above.

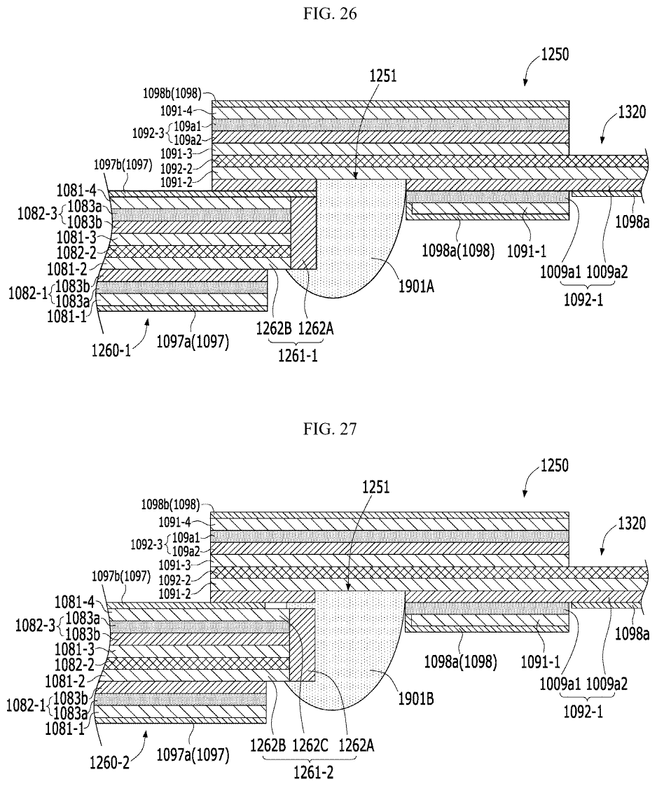

FIG. 26 is a cross-sectional view of the second circuit board 1260-1, the first circuit board 1250 and the solder 1901A according to another embodiment. The same reference numerals as those in FIG. 25 denote the same components and description of the same components is omitted.

Referring to FIG. 26, the terminal 1261-1 of the second circuit board 1260-1 may be positioned higher than the lowermost conductive layer (for example, 1081-1) among the plurality of conductive layers 1081-1 to 1081-4 of the second circuit board 1260-1. For example, the terminal 1261-1 may be positioned above the lowermost conductive layer (for example, 1081-1). For example, the lowermost conductive layer (for example, 1081-1) may be positioned lower than the lowermost conductive layer 1091-1 of the first circuit board 1250.

For example, the terminal 1261-1 may be electrically connected to at least one of the plurality of conductive layers 1081-1 to 1081-4 of the second circuit board 1260.

The terminal 1261-1 may include a first pad 1262A. The first pad 1262A may include a portion which does not overlap the terminal 1251 of the first circuit board 1250 in the optical axis direction. Furthermore, for example, the first pad 1262A may include a portion which overlaps the terminal 1251 of the first circuit board 1250 in the optical axis direction.

The first pad 1262A may be positioned higher than the lowermost conductive layer (for example, 1081-1) of the second circuit board 1260. For example, the first pad 1262A may be formed at another conductive layer (for example, 1081-2) disposed on the lowermost conductive layer (for example, 1081-1). For example, the first pad 1262A may be formed at a conductive layer (for example, 1081-2) which corresponds to the layer immediately on the lowermost conductive layer (for example, 1081-1). For example, the first pad 1262A may be formed at the second lowermost conductive layer (for example, 1081-2).

For example, the first pad 1262A may extend parallel to the optical axis direction. The description of the shape of the first pad 1261A shown in FIG. 25 may be applied to the shape of the first pad 1262A with or without modification. For example, the first pad 1262A may be positioned lower than the second cover layer 1097b.

The first pad 1262A may be connected or coupled to one end of at least one of the second to fourth conductive layers 1081-2 to 1081-4. The first pad 1262A may be electrically connected to one end of at least one of the second to fourth conductive layers 1081-2 to 1081-4.

The terminal 1261-1 may include a second pad 1262B connected to the first pad 1262A.

For example, the second pad 1262B may be positioned higher than the lowermost conductive layer (for example, 1081-1) of the second circuit board 1260. For example, the second pad 1262B may be formed at another conductive layer (for example, 1081-2) disposed on the lowermost conductive layer (for example, 1081-1). For example, the second pad 1262B may be formed at a conductive layer (for example, 1081-2) which corresponds to the layer immediately on the lowermost conductive layer (for example, 1081-1). For example, the second pad 1262B may be a portion of the conductive layer (for example, 1081-2) disposed on the lowermost conductive layer (for example, 1081-1). For example, the second pad 1261B may extend parallel to the lower surface of the second circuit board 1260.

For example, the lower surface of the second pad 1262B may be positioned higher than the upper surface of the lowermost conductive layer 1081-1. For example, the second pad 1262B may be positioned higher than the upper surface of the lowermost conductive layer 1081-1. For example, the first pad 1262A and the second pad 1262B may be positioned higher than the upper surface of the first insulating layer 1082-1.

For example, the second cover layer 1097b may be disposed between the first pad 1262A and the first circuit board 1250. For example, a portion of the second cover layer 1097b may be disposed between the first pad 1262A and a region of the terminal 1251 of the first circuit board 1250. For example, a portion of the second cover layer 1097b may be in contact with the first pad 1262A and a region of the terminal 1251 of the first circuit board 1250.

The solder 1901A may be disposed on at least one of the first pad 1262A and the second pad 1262B of the terminal 1261-1 of the second circuit board 1260, and may contact, be bonded or be coupled to at least one of first pad 1262A and the second pad 1261B.

For example, the solder 1901A may contact, be bonded or be coupled to the terminal 1251 of the first circuit board 1250 and the first pad 1262A of the terminal 1261-1 of the second circuit board 1260. Furthermore, the solder 1901A may contact, be bonded or be coupled to the second pad 1262B of the terminal 1261-1 of the second circuit board 1260.

For example, the distance between the upper surface of the second circuit board 1260 and the second pad 1262B in the optical axis direction may be greater than the distance between the lower surface of the second circuit board 1260 and the second pad 1262B in the optical axis direction.

For example, the distance between the upper surface of the second circuit board 1260 and the lower surface of the second pad 1262B in the optical axis direction may be greater than the distance between the lower surface of the second circuit board 1260 and the lower surface of the second pad 1262B in the optical axis direction.

Referring to FIG. 26, for example, at least a portion of the solder 1901A may be disposed between the cover layer 1098a of the first circuit board 1250 and the second lowermost conductive layer 1081-2 of the second circuit board 1260. For example, at least another portion of the solder 1901A may be positioned below the second lowermost conductive layer 1081-2 of the second circuit board 1260.

In another embodiment, the terminal 1261-1 of the second circuit board 1260-1 may be in direct contact with the terminal 1251 of the first circuit board 1250. For example, one end of the terminal 1261-1 of the second circuit board 1260-1 may be in direct contact with a portion of the uppermost insulating layer (for example, the second cover layer 1097b) and the terminal 1251 of the first circuit board 1250. For example, the first pad 1262A of the terminal 1261-1 of the second circuit board 1260-1 may extend to the terminal 1251 of the first circuit board 1250 and may then contact the lower surface of the terminal 1251 of the first circuit board 1250.

In the embodiment shown in FIG. 26, because the solder 1901A may be in contact with or coupled to the second pad 1262B of the terminal 1261-1, the contact area between the solder 1901A and the terminal 1261-1 may be increased, thereby improving solderability between the terminal 1251 of the first circuit board 1250 and the terminal 1261-1 of the second circuit board 1260.

FIG. 27 is a cross-sectional view of the second circuit board 1260-2, the first circuit board 1250, and the solder 1901B according to a further embodiment. The same reference numerals as those of FIG. 26 denote the same components, the description of the same components is omitted.

Referring to FIG. 27, the terminal 1261-2 of the second circuit board 1260-2 may include the first pad 1262A, the second pad 1262B, and a third pad 1262C.

For example, the third pad 1262C may be formed at the uppermost conductive layer (for example, 1081-4). For example, the third pad 1262C may be formed at the conductive layer (for example, 1081-4) closest to the terminal 1251 of the first circuit board 1250 among the plurality of conductive layers 1081-1 to 1081-4 of the second circuit board 1260. Alternatively, for example, the third pad 1262C may be a portion of the uppermost conductive layer (for example, 1081-4). For example, the third pad 1262C may extend parallel to the upper surface (or the lower surface) of the second circuit board 1260-2).

For example, the third pad 1262C may be open or exposed from the cover layer (for example, 1097b). For example, the third pad 1262C may be connected to the upper portion of the first pad 1262A, and may be parallel to the second pad 1262B.

A height difference may be formed between the upper surface of the third pad 1262C and the upper surface of the second circuit board 1260-2 in a direction parallel to the optical axis direction. For example, the upper surface of the third pad 1262C may be positioned lower than the upper surface of the second circuit board 1260. For example, the upper surface of the second circuit board 1260-2 may include the upper surface of the second cover layer 1097b. Alternatively, for example, the upper surface of the second circuit board 1260-2 may be the upper surface of the second cover layer 1083B.

For example, when the second circuit board 1260-2 is viewed from above, the third pad 1262C may have the same or similar curved line as or to the curved line of the via of the first pad 1262A. Although the curvature of the curved line of the via of the second pad 1262B may be identical to the curvature of the curved line of the first pad 1262A, the latter may be greater than the former in another embodiment. In a further embodiment, the latter may be less than the former.

At least a portion of the third pad 1262C may overlap the terminal 1251 of the first circuit board 1250 in a direction parallel to the optical axis. For example, the third pad 1262C, the solder 1901B, and the terminal 1251 of the first circuit board 1250 may overlap one another in a direction parallel to the optical axis. Furthermore, the third pad 1262C may include a portion which does not overlap the terminal 1251 of the first circuit board 1250 in a direction parallel to the optical axis. For example, the solder 1901B may be disposed on the portion which does not overlap the terminal 1251 of the first circuit board 1250 in a direction parallel to the optical axis. For example, the solder 1901B may be in contact with or coupled to the portion which does not overlap the terminal 1251 of the first circuit board 1250 in a direction parallel to the optical axis.

For example, the solder 1901B may be disposed between the third pad 1262C and the first circuit board 1250. For example, at least a portion of the solder 1901B may be in contact with the third pad 1262C. For example, the third pad 1262C may be in contact with or connected to the first pad 1262A. For example, the third pad 1262C may be connected to the upper portion or the upper end of the first pad 1262A.

The solder 1901B may be in contact with, bonded or coupled to the terminal 1251 of the first circuit board 1250 and the third pad 1262C of the terminal 1261-2 of the second circuit board 1260-2.

In the embodiment shown in FIG. 27, because the solder 1901B is in contact with or coupled to the first pad 1262A, the second pad 1262B, and the third pad 1262C, it is possible to increase the contact and coupling area, to thus improve solderability and electrical connection properties, and to more efficiently inhibit occurrence of cracks in the solder, compared to the embodiment shown in FIGS. 25 and 26.

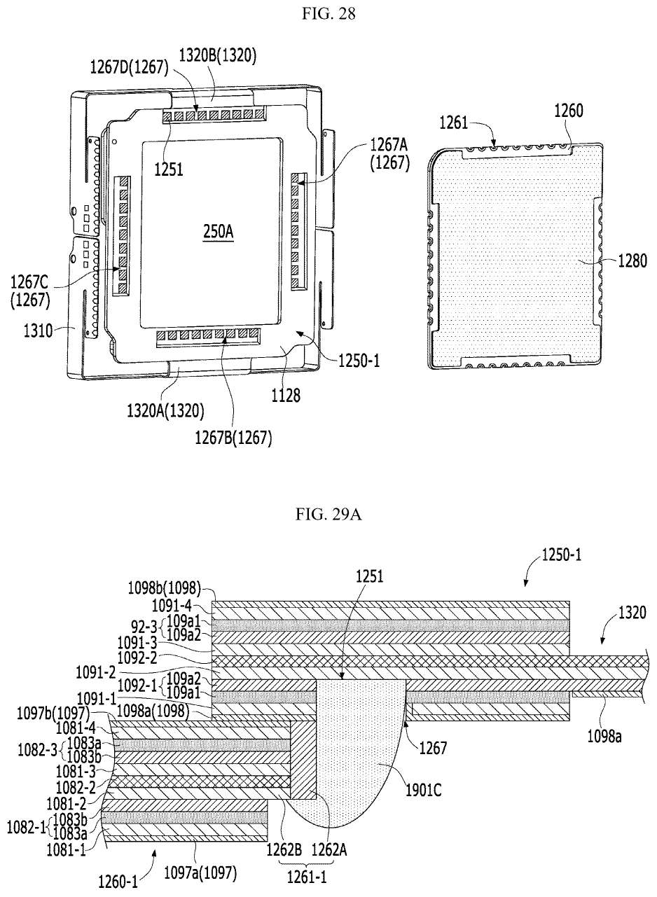

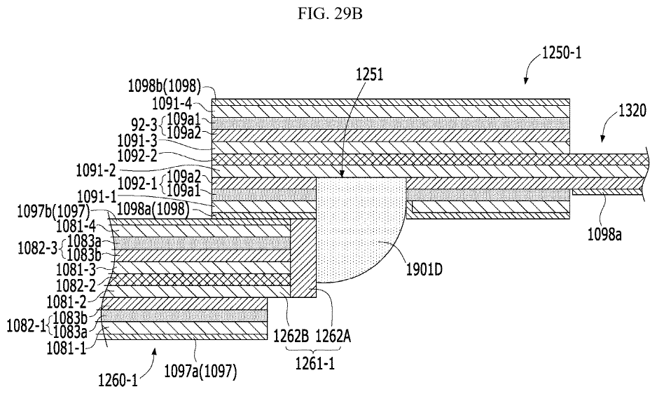

FIG. 28 is a perspective view of the first circuit board 1250-1 and the second circuit board 1260-1 according to another embodiment. FIG. 29A is a cross-sectional view of the first circuit board 1250-1, the second circuit board 1260-1, and the solder 1901C shown in FIG. 28.

The first circuit board 1250-1 shown in FIG. 28 is a modification of the first circuit board 1250 shown in FIG. 22. The first circuit board 1250-1 shown in FIG. 28 may not include the seating groove 1129 in the first circuit board 1250.

The first circuit board 1250-1 may include a groove 1267 positioned at a portion at which the terminal 1251 is formed. The groove 1267 may be a groove depressed from the lower surface 1128 of the first circuit board 1250-1. For example, the groove 1267 may not overlap the second circuit board 1260-1 in the optical axis direction. When viewed from above, the groove 1267 may have a polygonal shape, for example, a quadrilateral shape.

For example, the groove 1267 may include a bottom surface which defines a height difference with respect to the lower surface 1128 of the first circuit board 1250-1. For example, the bottom surface of the groove 1267 may be positioned higher than the lower surface 1128 of the first circuit board 1250-1. For example, the upper surface of the first circuit board 1250-1 may be positioned closer to the bottom surface of the groove 1267 than the lower surface 1128 of the first circuit board 1250-1. For example, the groove 1267 in the first circuit board 1250-1 may include a side surface which is positioned between the lower surface 1128 and the bottom surface 1129A of the first circuit board 1250 so as to connect the lower surface 1128 and the bottom surface 1129A of the circuit board 1250 to each other.

In FIG. 28, a plurality of terminals may be arranged in a line adjacent to each of four sides of the lower surface of the first circuit board 1250-1, and the first circuit board 1250-1 may include four grooves 1267A to 1267D positioned at the four sides of the lower surface. In another embodiment, the number of grooves 1267 may be determined according to the shapes of the terminals disposed along the sides of the first circuit board 1250-1. For example, when the terminals are arranged along two sides of the lower surface of the first circuit board 1250-1 which are opposed to each other, the first circuit board 1250-1 may include two grooves positioned at two sides of the first circuit board 1250-1 which are positioned opposite each other.

The groove 1267 may include an opening at the outer surface of the first circuit board 1250-1. For example, at least one (for example, 1267D) among the grooves 1267A to 1267D may include an opening at the outer surface of the first circuit board 1250-1.

For example, the terminal 1251 of the first circuit board 1250-1 may be disposed in the groove 1267 in the first circuit board 1250-1. For example, the terminal 1251 of the first circuit board 1250-1 may be disposed on the bottom surface of the groove 1267 in the first circuit board 1250. The description of the position of the terminal 1251 shown in FIG. 22 may be applied to the terminal 1251 of the first circuit board 1250-1 with or without modification. Furthermore, the description of the solder 1901A shown in FIG. 26 may be applied to the solder 1901C shown in FIG. 29A with or without modification.

Referring to FIG. 29A, because the terminal 1251 of the first circuit board 1250-1 is positioned higher than the lowermost conductive layer 1091-1 of the first circuit board 1250-1, it is possible to reduce the length of the portion of the solder 1901C projecting from the lower surface of the circuit board 1250-1 and to increase the distance between the solder 1901C and the heat radiating member 1380 of the first board unit 1255. Consequently, the embodiment is able to inhibit the solder 1901C from colliding with the heat radiating member 1380 of the first board unit 1255 and thus to inhibit occurrence of a crack in the solder 1901C caused by an impact.

FIG. 29B is a cross-sectional view of the solder 1901D according to another embodiment. The solder 1901D shown in FIG. 29B may be a modification of the solder 1901C shown in FIG. 29A.

The solder 1901C shown in FIG. 29A may be in contact with, or be coupled, attached or fixed to the first pad 1262A and the second pad 1262B of the terminal 1261-1 of the second circuit board 1260-1.

Referring to FIG. 29B, the solder 1901D may be in contact with or be coupled, attached or fixed to the terminal 1251 of the first circuit board 1250-1 and the first pad 1262A of the terminal 1261-1 of the second circuit board 1260-1. For example, the solder 1901D may be spaced apart from the second pad 1262B of the terminal 1261-1 of the circuit board 1260-1. Furthermore, for example, the solder 1901D may not be in direct contact with the second pad 1262B of the terminal 1261-1 of the circuit board 1260-1.

Although FIGS. 28, 29A and 29B illustrate the embodiment to which the second circuit board 1260-1 shown in FIG. 26 is applied, the second circuit boards 260 and 260-2 according to the embodiments shown in FIGS. 25 and 27 may be applied to the embodiments shown in FIGS. 28, 29A and 29B with or without modification in another embodiment.

According to the embodiment, in coupling between the terminal 1251 of the first circuit board 1250 and the terminal 1261 of the second circuit board 1260 through a soldering process, the terminal 1251 of the first circuit board 1250 may be positioned higher than the lowermost conductive layer of the first circuit board 1250. Consequently, it is possible to increase the distance between the solder coupled to the terminal 1251 and the stationary unit (for example, the heat radiating member 1380 disposed on the stationary unit), thus inhibiting occurrence of cracks in the solder caused by collision between the solder and the stationary unit, and to improve reliability of electrical connection between the terminal 1251 of the first circuit board 1250 and the terminal 1261 of the second circuit board 1260.

In addition, because the second circuit board 1260 is disposed in the seating groove 1129 formed in the first circuit board 1250, the embodiment is able to increase the height of the image sensor 1810 disposed on the heat radiating member 1280 coupled the second circuit board 1260 and to increase the thickness of the heat radiating member 1380 of the stationary unit within a range which satisfies the predetermined distance between the OIS moving unit and the stationary unit, thereby improving efficiency of heat radiation.

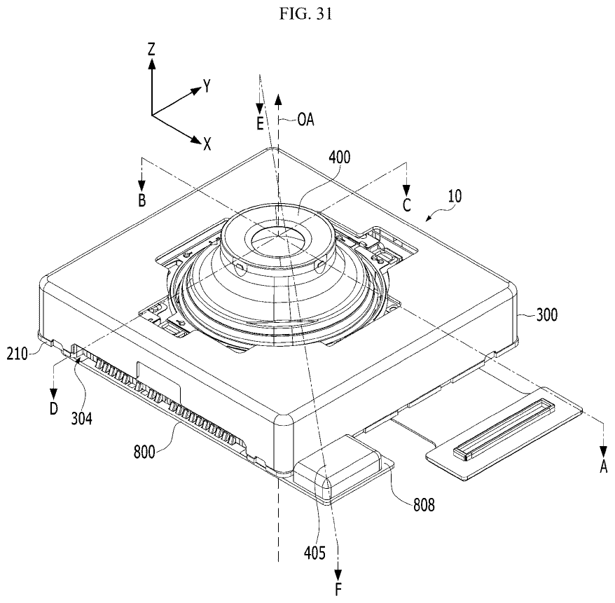

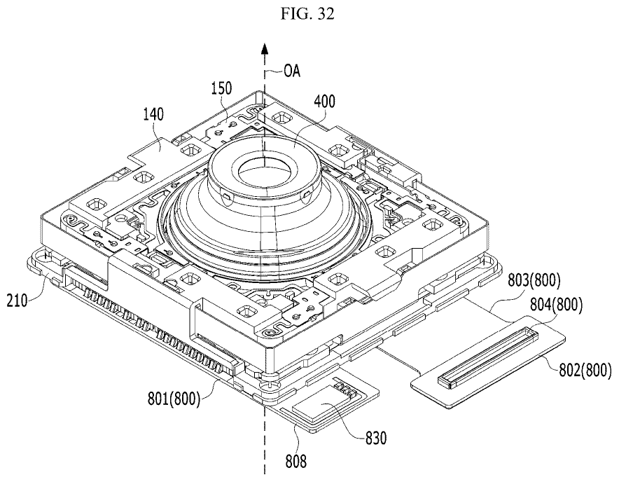

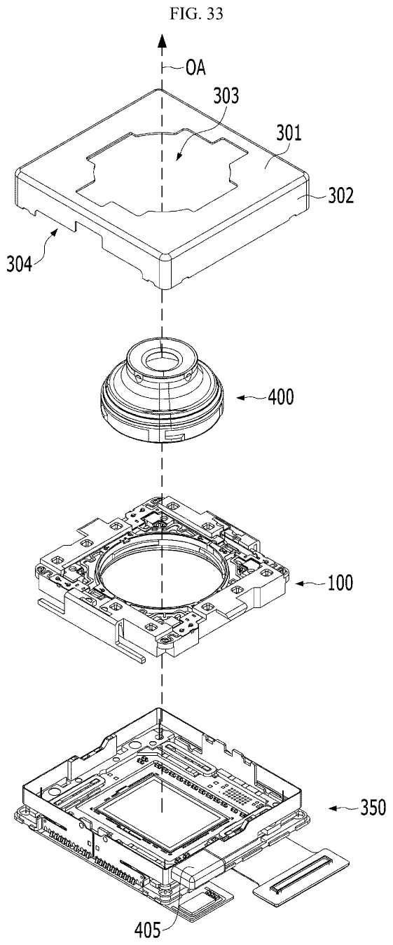

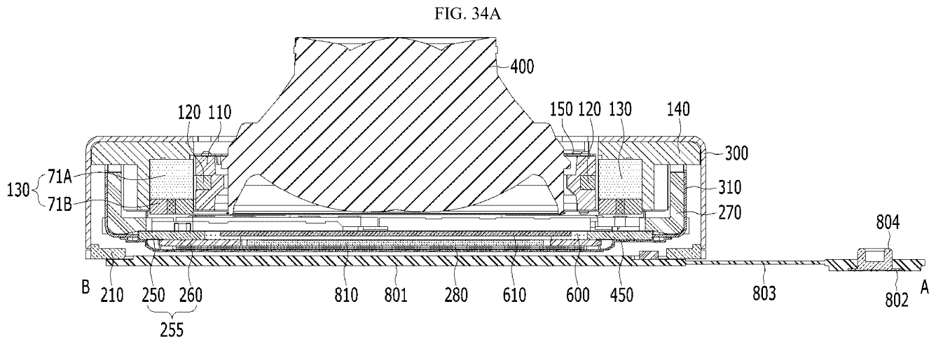

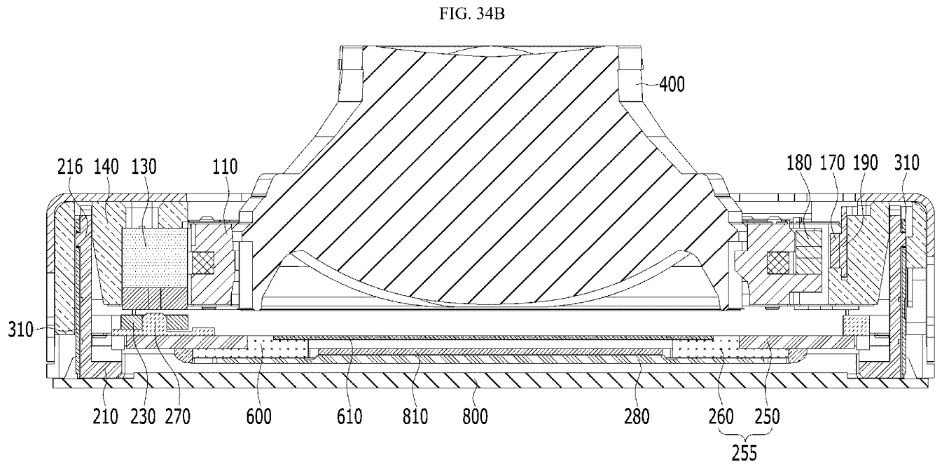

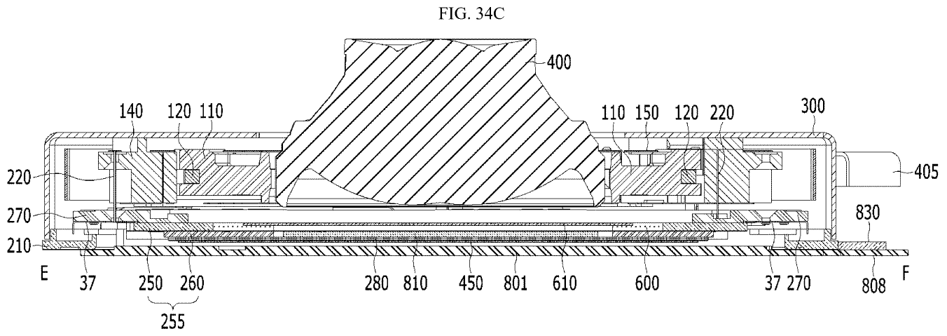

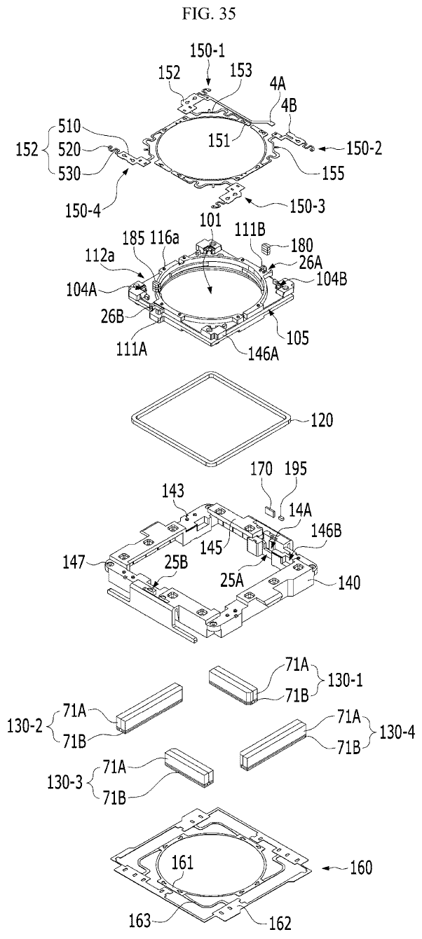

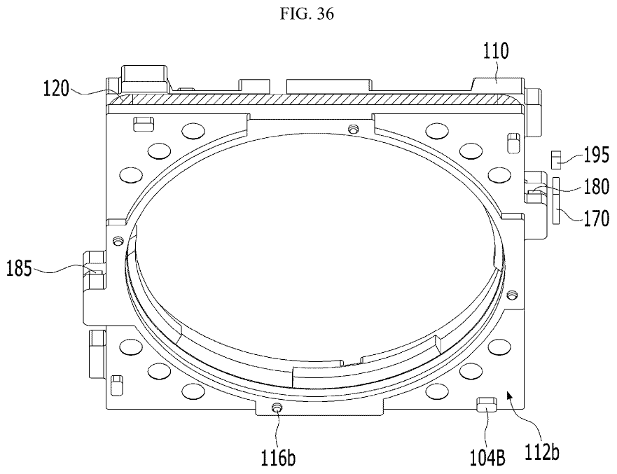

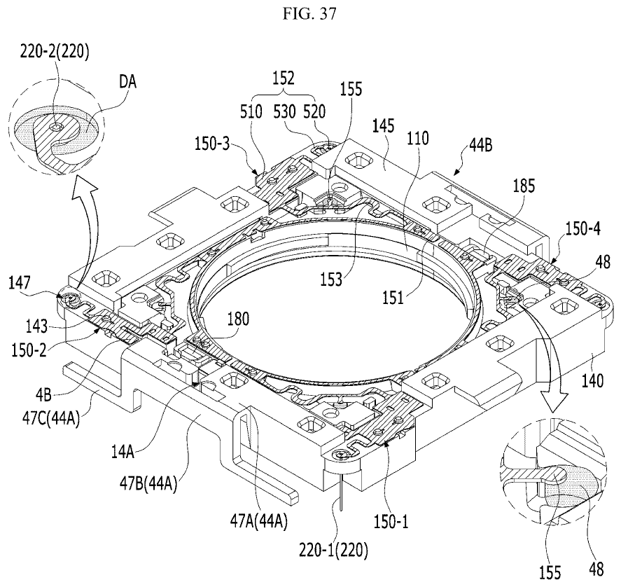

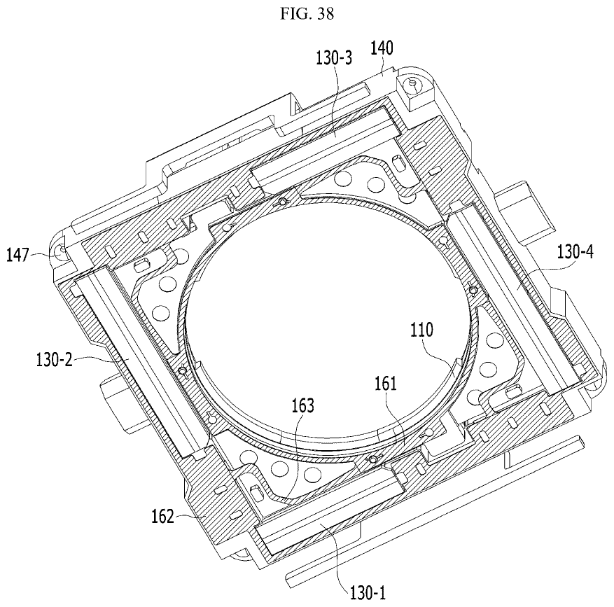

FIG. 31 is a perspective view of the camera device 10 according to an embodiment. FIG. 32 is a perspective view of the camera device 10 from which the cover member 300 is removed. FIG. 33 is an exploded perspective view of the camera device 10 shown in FIG. 31. FIG. 34A is a cross-sectional view of the camera device 10 taken along line A-B in FIG. 31. FIG. 34B is a cross-sectional view of the camera device 10 taken along line C-D in FIG. 31. FIG. 34C is a cross-sectional view of the camera device 10 taken along line E-F in FIG. 31. FIG. 35 is an exploded perspective view of the AF operation unit 100 shown in FIG. 33. FIG. 36 is a perspective view of the bobbin 110, the sensing magnet 180, the balancing magnet 185, the first coil 120, the first position sensor 170, and the capacitor 195. FIG. 37 is a perspective view of the bobbin 110, the circuit board 190, the wire 220, the damper DA, the upper elastic member 150, the sensing magnet 180, and the balancing magnet 185. FIG. 38 is a bottom perspective view of the housing 140, the bobbin 110, the lower elastic member 160, the magnet 130, and the lower elastic member 160.

Referring to FIGS. 31 to 38, the camera device 10 may include an AF operation unit 100 and an image sensor unit 350. The AF operation unit 100 may include an AF moving unit. The image sensor unit 350 may include an OIS moving unit. One of the AF moving unit and the OIS moving unit may be a first moving unit, and the other of the AF moving unit and the OIS moving unit may be a second moving unit.

The camera device 10 may further include at least one of the cover member 300 and a lens module 400. The cover member 300 and the base 210 to be described later may define the case.

The AF operation unit 100 may be coupled to the lens module 400, and may move the lens module 400 in the direction of the optical axis OA or in a direction parallel to the optical axis in order to perform an autofocus function of the camera device 10.

The image sensor unit 350 may include an image sensor 810. For example, the image sensor unit 350 (or the OIS operation unit) may include an OIS moving unit including the image sensor 810. For example, the image sensor unit 350 may move the OIS moving unit (for example, the image sensor 810) in a direction perpendicular to the optical axis. Furthermore, the image sensor unit 350 may cause tilting or rotation (or rolling) relative to or about the optical axis. The image sensor unit 350 may perform hand tremor correction for the camera device 10.

For example, the image sensor 810 may include an imaging area configured to detect light having passed through the lens module 400. Here, the imaging area may alternatively be referred to as an effective area, a light-receiving area, an active area, or a pixel area. For example, the imaging area of the image sensor 810 may be an area on which an image included in light that has passed through a filter 610 and is then incident on the imaging area, and may include at least one unit pixel. For example, the imaging area may include a plurality of unit pixels.

The AF operation unit 100 may alternatively be referred to as a “lens moving unit” or a “lens moving apparatus”. Alternatively, the AF operation unit 100 may alternatively be referred to as a “first moving unit (or a second moving unit)”, a “first actuator (or a second actuator)” or an “AF operation unit”.

The image sensor unit 350 may alternatively be referred to as an “image-sensor moving unit” or an “image-sensor shift unit”, a “sensor moving unit” or a “sensor shift unit”. Alternatively, the image sensor unit 350 may alternatively be referred to as a “second moving unit (or a first moving unit) or a “second actuator (or a first actuator)”.

The AF operation unit 100 may move the lens module 400 in the optical axis direction. For example, the AF operation unit 100 may move the bobbin 110 in the optical axis direction. For example, the AF operation unit 100 may include the bobbin 110, the first coil 120, the magnet 130, and the housing 140. The AF operation unit 100 may further include the upper elastic member 150 and the lower elastic member 160.

The AF operation unit 100 may further include a first position sensor 170, and the sensing magnet 180 for AF feedback operation. The AF operation unit 100 may further include at least one of the balancing magnet 185 and the capacitor 195.

The bobbin 110 may be disposed in the housing 140 so as to be movable in the optical axis direction OA or the first direction (for example, the Z-axis direction) by the electromagnetic interaction between the first coil 120 and the magnet 130.

The bobbin 110 may have a bore to which a lens module 400 is coupled or mounted. For example, the bore in the bobbin 110 may be a through hole formed through the bobbin 110 in the optical axis direction, and may have a circular shape, an elliptical shape or a polygonal shape, without being limited thereto.

The lens module 400 may include at least one lens and/or a lens barrel. For example, the lens module 400 may include at least one lens and a lens barrel receiving the at least one lens. However, the configuration of the lens module is not limited to the lens barrel, and the lens module may have any configuration, as long as the configuration is capable of supporting the at least one lens.

For example, the lens module 400 may be threadedly engaged with the bobbin 110. Alternatively, the lens module 400 may be coupled to the bobbin 110 using, for example, an adhesive (not shown). The light that has passed through the lens module 400 may be radiated to the image sensor 810 through a filter 610.

The bobbin 110 may include one or more projections 111A and 111B provided on the outer surface thereof. For example, although the one or more projections 111A and 111B may project in a direction that is parallel to a line perpendicular to the optical axis OA, the disclosure is not limited thereto. For example, the bobbin 110 may include two projections 111A and 111B, which are positioned opposite each other.

The projections 111A and 111B of the bobbin 110 may correspond to grooves 25A and 25B in the housing 140, and may be disposed in the grooves 25A and 25B in the housing 140 so as to minimize or inhibit rotation of the bobbin 110 about the optical axis beyond a predetermined range.

The bobbin 110 may include a projection 146A which projects in a direction perpendicular to the optical axis. For example, the projection 146A of the bobbin 110 may be disposed on a corner portion of the bobbin 110.

The housing 140 may include a groove 146b which corresponds, faces, or overlaps the projection 146A of the bobbin 110. At least a portion of the projection 146A of the bobbin 110 may be disposed in the groove 146B in the housing 140.

Furthermore, the projection 146A of the bobbin 110 may serve as a stopper configured to cause the bobbin 110 to move within a predetermined range in the optical axis direction (for example, in a direction toward the lower elastic member 160 from the upper elastic member 150) in response to an external impact or the like.

The bobbin 110 may have formed in the upper surface thereof a first escape groove 112a for avoiding spatial interference with a first frame connector 153 of the upper elastic member 150. The bobbin 110 may have formed in the lower surface thereof a second escape groove 112b for avoiding spatial interference with a second frame connector 163 of the lower elastic member 160.

The bobbin 110 may include a first coupler 116a, configured to be coupled and fixed to the upper elastic member 150. For example, although the first coupler 116a of the bobbin 110 may have the form of a protrusion, the disclosure is not limited thereto. In another embodiment, the first coupler 116a of the bobbin 110 may have the form of a flat surface or a groove. Furthermore, the bobbin 110 may include a second coupler 116b configured to be coupled and fixed to the lower elastic member 160. Although the second coupler 116b may have, for example, the form of a protrusion, the disclosure is not limited thereto. In another embodiment, the second coupler 116b may have the form of a flat surface or a groove.

The outer surface of the bobbin 110 may have formed therein a groove 105 in which the first coil 120 is seated, fitted or disposed. For example, the groove 105 in the bobbin 110 may have a shape corresponding to the shape of the first coil 120, that is, a closed curve shape (for example, a ring shape).

The bobbin 110 may be provided therein with a first seating groove 26a in which the sensing magnet 180 is seated, fitted, fixed, or disposed. Furthermore, the bobbin 110 may be provided in the outer surface thereof with a second seating groove 26b in which the balancing magnet 185 is seated, fitted, fixed or disposed.

For example, the first and second seating grooves 26a and 26b in the bobbin 110 may be formed in outer surfaces of the bobbin 110, which are opposed to each other. For example, the first seating groove 26a may be formed in the first projection 111A of the bobbin 110, and the second seating groove 26b may be formed in the second projection 111B of the bobbin 110.

The bobbin 110 may include a guide protrusion 104A configured to guide a portion of the first frame connector 153 of the upper elastic member 150. For example, the guide protrusion 104A may project from the bottom surface of the escape portion 112a in the bobbin 110.

A damper 48 may be disposed between the bobbin 110 and the upper elastic member 150. For example, the damper 48 may be disposed between the bobbin 110 and the first frame connector 153 of the upper elastic member 150, and may be in contact therewith or be coupled or attached thereto.

For example, the upper elastic member 150 may include an extension (or a projection) which extends from the first frame connector 153. The extension 155 may be spaced apart from both the outer frame 152 and the inner frame 151. Furthermore, the extension 155 may be spaced apart from both one end of the first frame connector 153 connected to the inner frame 151 and the other end of the first frame connector 153 connected to the outer frame 152. For example, the extension 155 may extend beyond the upper surface of the bobbin 110.

For example, a portion (or the end) of the extension 155 may be disposed on the damper 48 disposed on the upper surface of the bobbin 110 so as to overlap the damper 48. For example, the bobbin 110 may include a reception portion 104B in which the damper 48 is received or disposed. For example, the reception portion 104B may be a groove. The reception portion 104B may have a structure that is depressed from the bottom surface of the escape portion 112a in the bobbin 110.

For example, the damper 48 may be disposed between the reception portion 104B and the extension 155 of the upper elastic member 150, and may be in contact therewith or be coupled or attached thereto. The damper 48 may be in contact with or attached to the extension 155 and the reception portion 104B in the bobbin 110 so as to serve to damper or absorb vibration of the bobbin 110. For example, the damper 48 may be made of a damping member (for example, silicone).

The first coil 120 may be disposed on or coupled to the bobbin 110. For example, the first coil 120 may be disposed on or coupled to the outer surface of the bobbin 110. For example, the first coil 120 may surround the outer surface of the bobbin 110 about the optical axis OA in a winding direction, without being limited thereto.

Although the first coil 120 may be directly wound around the outer surface of the bobbin 110, the disclosure is not limited thereto. In another embodiment, the first coil 120 may be embodied as a coil ring, which is wound around the bobbin 110, or as a coil block having an angled shape.

A power or drive signal may be supplied to the coil 120. The power or drive signal supplied to the first coil 120 may be a DC signal, an AC signal or a signal containing both DC and AC components, and may be of a voltage type or a current type.

When a drive signal (for example, drive current) is supplied to the first coil 120, it is possible to create electromagnetic force resulting from the electromagnetic interaction with the first magnet, thereby moving the bobbin 110 in the direction of the optical axis OA by virtue of the created electromagnetic force.

At the initial position of the AF operation unit, the bobbin 110 may be moved upwards or downwards, which is referred to as bidirectional driving of the AF operation unit. Alternatively, at the initial position of the AF operation unit, the bobbin 110 may be moved upwards, which is referred to as unidirectional driving.

At the initial position of the AF operation unit, the first coil 120 may be disposed so as to correspond to the magnet 130 disposed on the housing 140 in a direction parallel to a line which is perpendicular to the optical axis OA and extends through the optical axis.

For example, the AF operation unit may include the bobbin 110 and the components (for example, the first coil 120, the sensing magnet 180 and the balancing magnet 185) coupled to the bobbin 110. The AF operation unit may further include the lens module 400.

The initial position of the AF operation unit may be the original position of the AF operation unit in the state in which no electric power is applied to the first coil 120 or the position at which the AF operation unit is located as the result of the upper and lower elastic members 150 and 160 being elastically deformed due only to the weight of the AF operation unit. In addition, the initial position of the bobbin 110 may be the position at which the AF operation unit is located when gravity acts in the direction from the bobbin 110 to the base 210 or when gravity acts in the direction from the base 210 to the bobbin 110.

The sensing magnet 180 may provide a magnetic field, which is detected by the first position sensor 170, and the balancing magnet 185 may serve to cancel out the influence of the magnetic field of the sensing magnet 180, and establishes weight equilibrium with respect to the sensing magnet 180.

The sensing magnet 180 may alternatively be referred to as a “sensor magnet” or a “second magnet”. The sensing magnet 180 may be disposed on the bobbin 110, or may be coupled to the bobbin 110. The sensing magnet 180 may be disposed so as to face the first position sensor 170.

The balancing magnet 185 may be disposed on the bobbin 110, or may be coupled to the bobbin 110. For example, the balancing magnet 185 may be disposed opposite the sensing magnet 180.

Although each of the sensing magnet and the balancing magnet 180 and 185 may be a monopolar magnetized magnet having one N pole and one S pole, the disclosure is not limited thereto. In another embodiment, each of the sensing magnet and the balancing magnet 180 and 185 may be a bipolar magnetized magnet, which has two N poles and two S poles, or a tetrapolar magnetized magnet.

The sensing magnet 180 may be moved together with the bobbin 110 in the optical axis direction.

The first position sensor 170 may detect displacement of the bobbin 110 in the optical axis direction or displacement of the lens module 400 in the optical axis direction. Alternatively, the first position sensor 170 may detect the sensing magnet 180.

The first position sensor 170 may detect the intensity or magnetic force of the magnetic field of the sensing magnet 180, which is moved in the optical axis direction, and may output an output signal corresponding to the result of the detection

For example, in accordance with displacement of the bobbin 110 in the optical axis direction, the intensity or magnetic force of the magnetic field detected by the first position sensor 170 may vary. Consequently, the first position sensor 170 may output an output signal proportional to the detected intensity of the magnetic field, and the displacement of the bobbin 110 in the optical axis direction may be detected using the output signal from the first position sensor 170.

The housing 140 may be disposed in the cover member 300. For example, the housing 140 may be disposed on the image sensor unit 350.

The housing 140 may accommodate therein the bobbin 110, and may support the magnet 130 and the first position sensor 170.

The housing 140 may be configured to have a hollow column shape. For example, the housing 140 may have a polygonal (for example, a rectangular or octagonal) or circular bore, and the bore in the housing 140 may be a through hole, which is formed through the housing 140 in the optical axis direction.

The housing 140 may include side portions, which correspond to or face the side plate 302 of the cover member 300, and corners, which correspond to or face the corners of the cover member 300.

In order to inhibit a direct collision with the inner surface of the upper plate 301 of the cover member 300, the housing 140 may include a stopper 145 provided at the upper portion, the upper surface or the upper end thereof.

The housing 140 may include a mounting groove (or a groove) 14A configured to receive a portion of the support board 310 therein. For example, the housing 140 may include the mounting groove (or the groove) 14A configured to receive an extension region 190 of the support board 310 in which the first position sensor 170 is disposed. For example, the mounting groove 14A may have a shape identical to the shape of the extension region 190 of the support board 310.

The housing 140 may include projections 44A and 44B which surround at least a portion of the extension region 190 of a support board 310. For example, the projections 44A and 44B may be disposed or formed on the outer surface of the housing 140. For example, the projections 44A and 44B may be disposed or formed on the outer surface of the side portion of the housing 140. The projections 44A and 44B may alternatively be referred to as “protection portions”, “support portions”, “extension portions”, or “guide portions”.

The projections 44A and 44B of the housing 140 may surround at least a portion of the extension region 190 of the support board 310 and another region of the support board 310 excluding the extension region 190. For example, the housing 140 may include a first projection 44A disposed on the first side portion of the housing and a second projection 44B disposed on the second side portion of the housing 140. The first projection 44A and the second projection 44B may be positioned opposite each other relative to the optical axis OA or the bobbin 110. In another embodiment, the second projection 44B may be omitted.

For example, the extension region 190 of the support board 310 may be disposed in the first projection 44A. For example, the mounting groove 14A may be formed in the first projection 44A.

For example, each of the first projection 44A and the second projection 44B may include a first portion 47A connected to the upper surface of the housing 140 and a second portion 47B which is connected to the first portion 47A and is spaced apart from the side portion of the housing 140. For example, the first portion 47A of the first projection 44A may be connected to the upper surface of the first side portion of the housing 140, and the first portion 47A of the second projection 44B may be connected to the upper surface of the second side portion of the housing 140. For example, the first portion 47A may project in the optical axis direction or toward the inner surface of the upper plate 301 of the cover member 300 from the upper surface of the second side portion of the housing 140.

For example, at least a portion of the extension region 190 of the support board 310 may be positioned between the first portion 47A and the second portion 47B of the first projection 44A. Furthermore, for example, another region of the support board 310 excluding the extension region 190 may be positioned between the first portion 47A and the second portion 47B of the first projection 44A.

Each of the first projection 44A and the second projection 44B of the housing 140 may include a third portion 37C which extends from the second portion 47B. For example, the third portion 37C may extend or project in a direction (for example, a second horizontal direction) parallel to the outer surface of the first side portion (or the second side portion) of the housing 140 from the lower portion or lower end of the second portion 47B.

For example, the third portion 37C may include a third-first portion, which extends from one end of the second portion 47B, and a third-second portion, which extends from the other end of the second portion. The third-first portion and the third-second portion may extend or project in opposite directions.

An adhesive or a sealing member may be disposed between the projections 44A and 44B of the housing 140 and the cover member 300. For example, the adhesive (or the sealing member) may be disposed between the projections 44A and 44B of the housing 140 and the side plate 302 of the cover member 300, and may couple both portions to each other. The projections 44A and 44B may increase a surface area in which the projections 44A and 44B are coupled to the cover member 300, and may stably couple the housing 140 to the cover member 300 without interference with the support board 310.

The upper portion, the upper end or the upper surface of the housing 140 may be provided with at least one first coupler 143, which is to be coupled to a first outer frame 152 of the upper elastic member 150. The lower portion, the lower end or the lower surface of the housing 140 may be provided with a second coupler, which is to be coupled and fixed to a second outer frame 162 of the lower elastic member 160. For example, each of the first and second couplers of the housing 140 may have the shape of a flat surface, a protrusion, or a groove.

The corner of the housing 140 may have formed therein a hole 147 which is a path through which the wire 220 extends. The hole 147 may be a through hole which is formed through the housing 140 in the optical axis direction. In another embodiment, the hole may have a structure that is depressed from the outer surface of the corner portion of the housing 140, and at least a portion of the hole may be exposed from the outer surface of the corner portion. The hole 147 in the housing 140 may include the same number of holes as the number of support members.

The magnet 130 may be disposed on, coupled to or fixed to the housing 140, which is a stationary component. For example, the magnet 130 may be disposed on, coupled to or fixed to the side portion of the housing 140. The magnet 130 may include an AF operation magnet 71A for AF operation. The magnet 130 may include an OIS operation magnet 71B for OIS operation. Hereinafter, the AF operation magnet 71A may be referred to as one of first and second magnets, and the OIS operation magnet 71B may be referred to as the other of the first and second magnets.

In another embodiment, the magnet 130 may be disposed, coupled or fixed to the corner portion of the housing.

For example, the magnet 130 may include a plurality of magnet units. For example, the magnet 130 may include first to fourth magnet units 130-1 to 130-4 which are disposed on the housing 140. In another embodiment, the magnet 130 may include two or more magnet units.

The magnet 130 may be disposed on at least one of the side portion or the corner of the housing 140. For example, at least a portion of the magnet 130 may be disposed on the side portion or the corner of the housing 140. Alternatively, for example, at least a portion of the magnet 130 may be disposed on the side portion of the housing 140, and the remaining portion of the magnet 130 may be disposed at the corner of the housing 140.

For example, each of the magnet units 130-1 to 130-4 may include a first portion which is disposed on a corresponding one of the four corners of the housing 130. Furthermore, each of the magnet units 130-1 to 130-4 may include a second portion which is disposed on a side portion of the housing 140 adjacent to the one corner of the housing 140.

For example, the first magnet unit 130-1 and the third magnet unit 130-3 may be positioned at opposite sides of the housing 140 in the first horizontal direction (for example, the Y-axis direction). For example, the second magnet unit 130-2 and the fourth magnet unit 130-4 may be positioned at opposite sides of the housing 140 in the second horizontal direction (for example, the X-axis direction).

For example, the first magnet unit 130-1 and the third magnet unit 130-3 may be disposed parallel to each other in the second horizontal direction (for example, the X-axis direction), and the second magnet unit 130-2 and the fourth magnet unit 130-4 may be disposed parallel to each other in the first horizontal direction (for example, the Y-axis direction).

At the initial position of the AF operation unit, the magnet 130 may be disposed on the housing so as to partially overlap the first coil 120 in a direction parallel to a line which is perpendicular to the optical axis OA and extends through the optical axis OA.

The magnet 130 may include a monopolar magnetized magnet or a dipole magnet, which includes one N pole and one S pole. In another embodiment, the magnet 130 may include a bipolar magnetized magnet or a quadrupole magnet, which includes two N poles and two S poles. In a further embodiment, the magnet 130 may include both a monopolar magnetized magnet and a bipolar magnetized magnet.

For example, the magnet 130 may include an AF magnet (or an AF operation magnet) for AF operation and an OIS magnet (or an OIS operation magnet) for OIS operation. In another embodiment, for example, the magnet 130 may be a common magnet for AF operation and OIS operation.

In FIGS. 19A and 19B, the description of the magnet 1130 may be applied to the magnet 130 with or without modification.

The extension region 190 of the support board 310 may be disposed on the stationary unit. For example, the extension region 190 of the support board 310 may be disposed on the housing 140.

The first position sensor 170 may be disposed or mounted in the extension region 190 of the support board 310, and may be electrically connected to the extension region 190.

The first position sensor 170 may be disposed on the housing 140. The first position sensor 170 may be disposed in the extension region 190 of the support board 310. For example, the first position sensor 170 may be disposed on a first surface 19A (see FIG. 22) of the extension region 190. For example, the first surface 19A of the extension region 190 may be one surface of the extension region 190 that faces the bobbin 110 or the sensing magnet 180. The first position sensor 170 may be electrically connected to the extension region 190 of the support board 310.

For example, at the initial position of the AF operation unit, at least a portion of the first position sensor 170 may face or overlap the sensing magnet 180 in a direction parallel to a straight line which is perpendicular to the optical axis OA and extends through the optical axis OA. In another embodiment, at the initial position of the AF operation unit, the first position sensor may not face or overlap the sensing magnet.

The first position sensor 170 may serve to detect movement, displacement or position of the bobbin 110 in the optical axis direction. The first position sensor 170 may detect the magnetic field or the intensity of the magnetic field of the sensing magnet 180 mounted on the bobbin 110 during movement of the bobbin 110, and may output an output signal corresponding to the result of the detection. Consequently, it is possible to detect movement, displacement or position of the bobbin 110 in the optical axis direction using the output of the first position sensor 170.

The capacitor 195 may be disposed in the extension region 190 of the support board 310. A description thereof will be given later.

In another embodiment, the sensing magnet 180 may be disposed on the housing 140, and the first position sensor 170 may be disposed on the bobbin 110. In another embodiment, the balancing magnet 185 may be omitted.

The upper elastic member 150 and the lower elastic member 160 may be coupled to the bobbin 110 and the housing 140. For example, the upper elastic member 150 may be coupled to the upper portion, the upper end or the upper surface of the bobbin 110 and the upper portion, the upper end or the upper surface of the housing 140, and the lower elastic member 160 may be coupled to the lower portion, the lower end or the lower surface of the bobbin 110 or the upper portion, the upper end or the upper surface of the housing 140. The upper elastic member 150 and the lower elastic member 160 may elastically support the bobbin 110 relative to the housing 140.

The upper elastic member 150 may include a plurality of upper elastic units (for example, 150-1 to 150-4) which are electrically separated or spaced apart from each other. Although the lower elastic member 160 is embodied as a single elastic unit, the lower elastic member 160 may include a plurality of lower elastic units which are electrically separated or spaced apart from each other in another embodiment. In another embodiment, at least one of the upper elastic member and the lower elastic member may be embodied as a single unit or a single structure.

The upper elastic member 150 may further include a first inner frame 151 coupled or fixed to the upper portion, the upper surface or the upper end of the bobbin 110, a second inner frame 152 coupled or fixed to the upper portion, the upper surface or the upper end of the housing 140, and a first frame connector 153 connecting the first inner frame 151 to the first outer frame 152. Furthermore, the upper elastic member 150 may include the above-mentioned extension 155.

The lower elastic member 160 may include a second inner frame 161 coupled or fixed to the lower portion, the lower surface or the lower end of the bobbin 110, a second outer frame 162 coupled or fixed to the lower portion, the lower surface or the lower end of the housing 140, and a second frame connector 163 connecting the second inner frame 161 to the second outer frame 162. The inner frame may alternatively be referred to as an inner portion, the outer frame may alternatively be referred to as an outer portion, and the frame connector may alternatively be referred to as a connecting portion.

Each of the first and second frame connectors 153 and 163 may be bent or curved (or may be formed into a curved line) at least once so as to define a predetermined pattern.

Each of the upper elastic member 150 and the lower elastic member 160 may be made of a conductive material, for example, a metal material. Furthermore, each of the upper elastic member 150 and the lower elastic member 160 may be made of an elastic member, for example, a leaf spring or the like.

For example, the second outer frame 152 of the first upper elastic unit 150-1 may include a first bonding portion 4A coupled or electrically connected to the pad 5A of the extension region 190 of the support board 310 using a solder or a conductive adhesive. The second outer frame 152 of the second upper elastic unit 150-2 may include a second bonding portion 4B electrically connected to the pad 5B of the extension region 190 of the support board 310 using a solder or a conductive adhesive.

In another embodiment, at least one of the upper elastic member 150 or the lower elastic member 160 may include two elastic members. For example, each of the two lower elastic members of one of the upper elastic member 150 and the lower elastic member 160 may be coupled or electrically connected to a corresponding one of the first and second pads 5a and 5b of the circuit board 190. The first coil 120 may be electrically connected to the two elastic members.

The first outer frame 152 of the upper elastic member 150 may include a first coupler 510 coupled to the housing 140, a second coupler 520 coupled to the wire 220, and a connector 530 connecting the first coupler 510 to the second coupler 520. The first coupler 510 may have a through hole or a hole to be coupled to the first coupler 143 of the housing 140. The second coupler 520 may have a through hole or a hole to be coupled to the wire 220. For example, the second coupler 520 may be coupled to the wire 220 using a conductive adhesive or solder. For example, although the connector 530 may include a bent portion, which is bent at least once, or a curved portion, which is curved at least once, the disclosure is not limited thereto. In another embodiment, the connector 530 may have a linear shape.

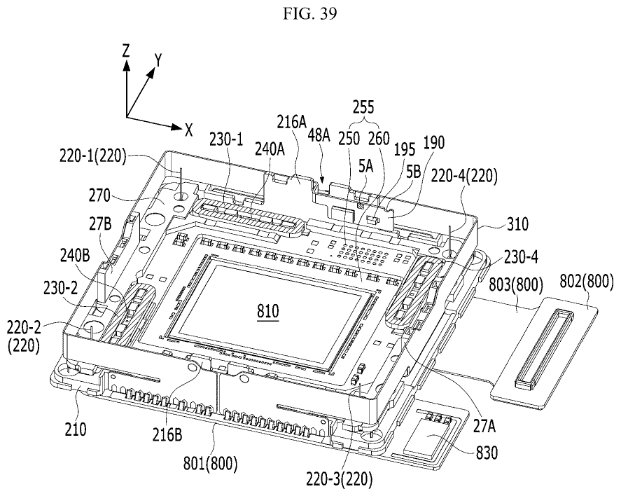

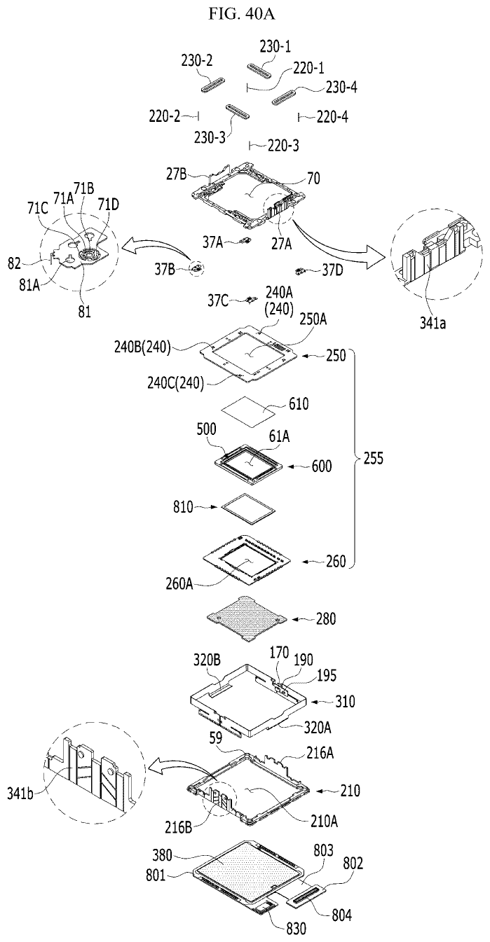

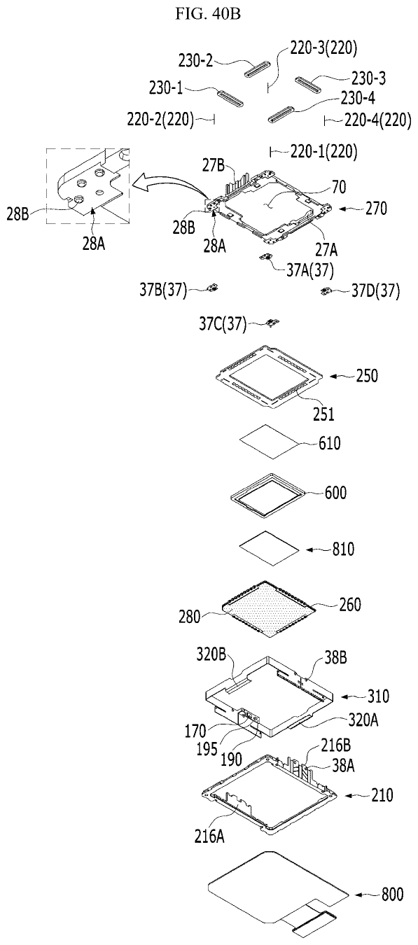

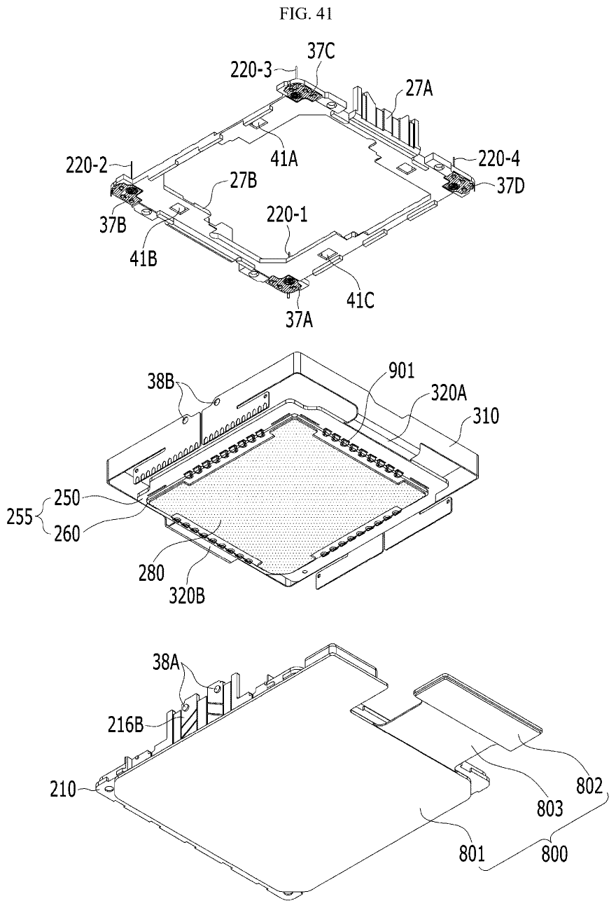

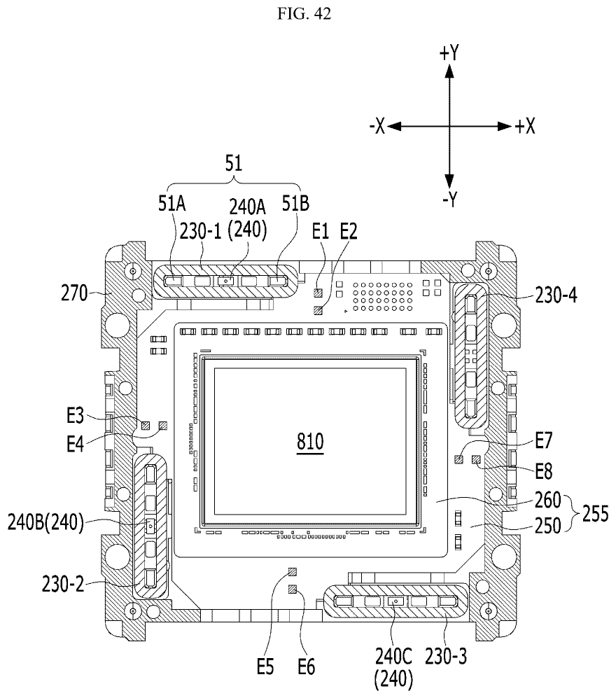

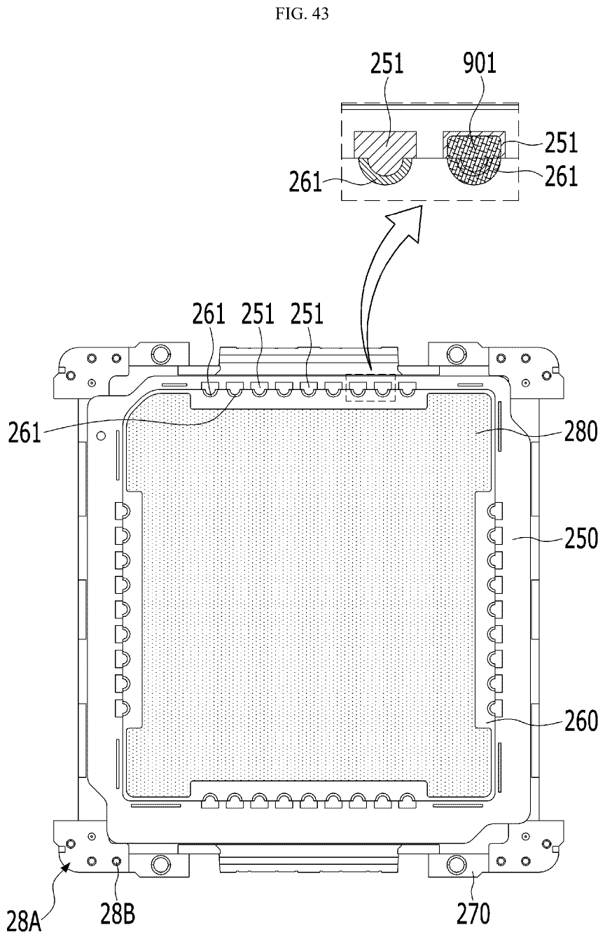

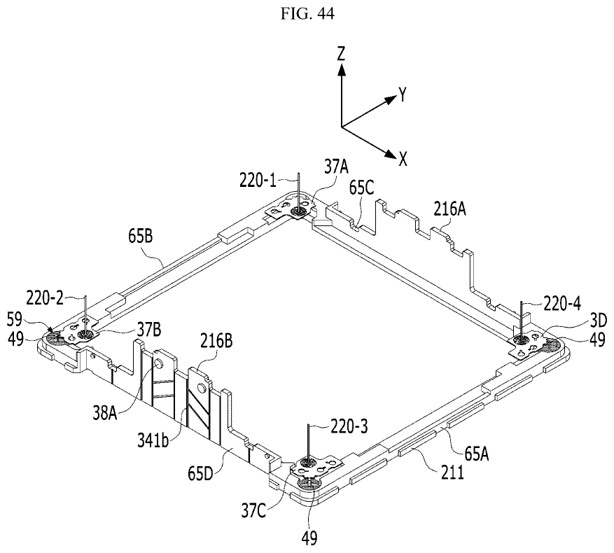

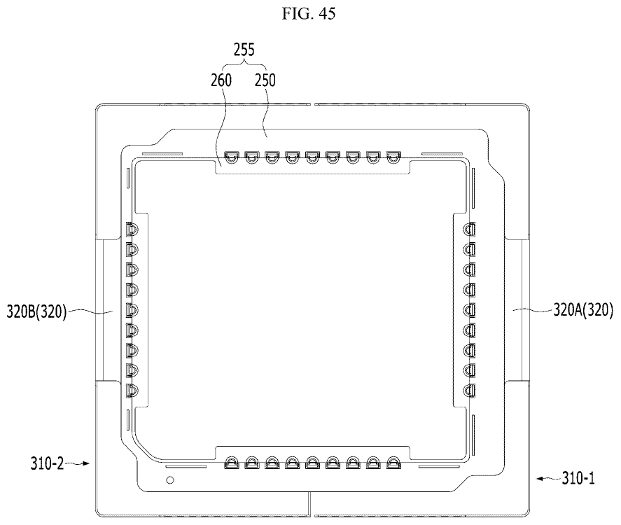

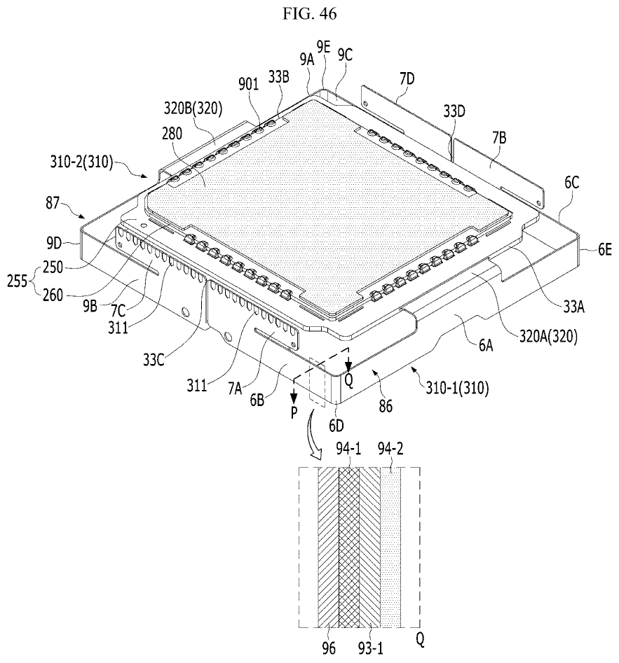

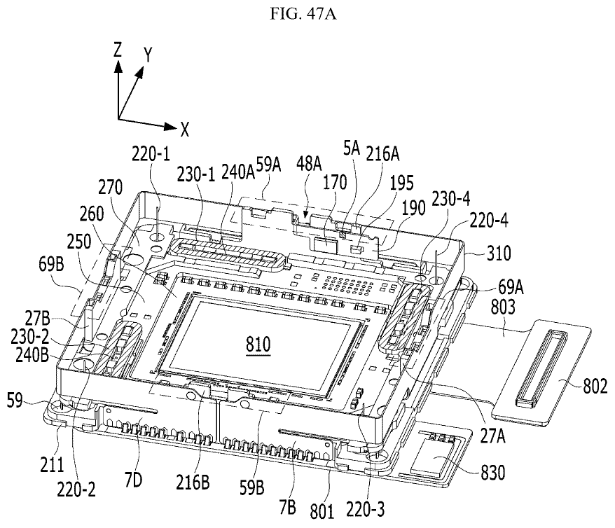

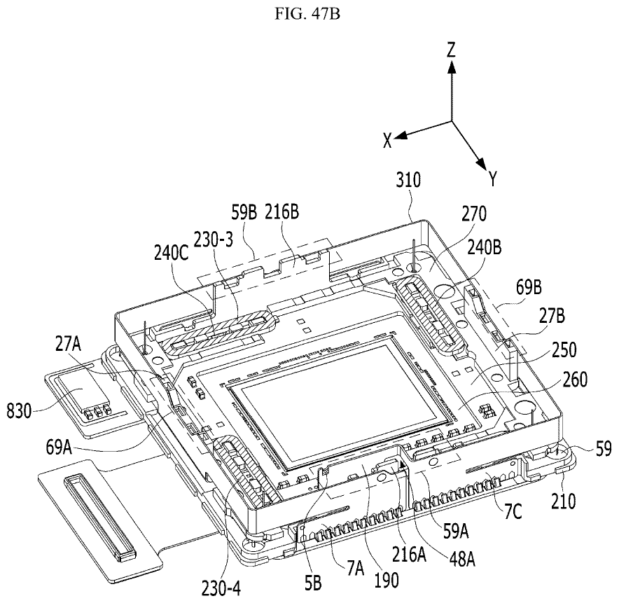

FIG. 39 is a perspective view of the image sensor unit 350. FIG. 40A is a first exploded perspective view of the image sensor unit 350 shown in FIG. 39. FIG. 40B is a second exploded perspective view of the image sensor unit 350 shown in FIG. 39. FIG. 41 is a bottom perspective view of the holder 270, the terminal member 37, the first board unit 255, the support board 310, the heat radiating member 280, the base 210, and the second board unit 800, which are shown in FIG. 40A. FIG. 42 is a plan view of the holder 270, the first board unit 255, the image sensor 810, the second coil 230, and the OIS position sensor 240. FIG. 43 is a rear perspective view of the holder 270 and the first board unit 255. FIG. 44 is a perspective view of the base 210, the terminal member 37, and the wire 220. FIG. 45 is a bottom view of the first board unit 255, the support board 310, and the heat radiating member 280. FIG. 46 is a perspective view of the first board unit 255, the support board 310, and the heat radiating member 280. FIG. 47A is a first perspective view of the support board 310 coupled to the holder 270 and the base 210. FIG. 47B is a second perspective view of the support board 310 coupled to the holder 270 and the base 210. The description given with reference to FIGS. 10C to 10F may be applied to the embodiment shown in FIGS. 31 to 53.

Referring to FIGS. 39 to 47B, the image sensor unit 350 may include a stationary unit and the OIS moving unit which is disposed so as to be spaced apart from the stationary unit. The image sensor unit 350 may include a support unit connecting the stationary unit to the OIS moving unit.

For example, the support unit may include the support board 310. Alternatively, for example, the support unit may be the support board 310. In another embodiment, the support unit may include an elastic member, for example, a leaf spring or a suspension wire in place of the support board 310.

The stationary unit may be a portion of the camera device 10 which is immovable during OIS operation. For example, the stationary unit may include the board unit 800. For example, the stationary unit may include a component coupled to the second board unit 800. The board unit 255 or 800 may alternatively be referred to as a “board” or a “circuit board”.

For example, the stationary unit may include the base 210 coupled to the second board unit 800. For example, the stationary unit may include the housing 140 of the AF operation unit, and components disposed on the housing 140, for example, the magnet 130, the first position sensor 170 and the circuit board 180. Furthermore, the stationary unit may include the cover member 300 coupled to the base 210. The OIS moving unit may be disposed in the cover member 300. For example, the cover member 300 may accommodate therein the OIS moving unit and the support board 310.

The OIS moving unit may include the image sensor 810. The OIS moving unit may further include the first board unit 255, which is spaced apart from the second board unit 800 and is electrically connected to the second board unit 800. For example, the OIS moving unit may include components disposed on the first board unit 255, for example, at least one of the heat radiating member 280, the holder 270, the second coil 230, and the second position sensor 340. The holder 270 may alternatively be referred to as a “spacer member”. In another embodiment, the holder 270 may be omitted, and the second coil 230 may be disposed on the first board unit 255, for example, the first circuit board 250.

For example, the camera device 10 may include the stationary unit, the moving unit including the first heat radiating member 280 disposed on the stationary unit and the image sensor 810 disposed in the first heat radiating member 280, and the support unit (for example, 310) configured to support the moving unit while allowing the moving unit to be movable in a direction perpendicular to the optical axis direction. The support unit (for example, 310) may be connected between the moving unit and the stationary unit.

The moving unit may include the first board unit 255 on which the image sensor 810 is disposed, the stationary unit may include the second board unit 800 which is disposed so as to be spaced apart from the first board unit 255, and the support unit may connect the first board unit 255 to the second board unit 800.

The support board 310 may include a conductive layer 93-1, a first insulating layer 94-1 disposed below the conductive layer 93-1, and a second insulating layer 94-2 disposed on the conductive layer 93-1. The support unit may be constructed such that a portion of the first insulating layer 94-1 is removed so as to expose an area of the conductive layer 93-1 through the removed portion.

The first board unit 255 may include the first circuit board 250, a second circuit board 260 electrically connected to the image sensor 810, and a solder 901 electrically connecting the first circuit board 250 to the second circuit board 260.

The camera device 10 may include an elastic member 220 (referred to hereinafter as a “wire”) configured to flexibly support the OIS moving unit. The elastic member 220 may have the form of a wire or a spring.

For example, one end of the wire 220 may be coupled to the upper elastic member 150 (or the housing 140), and the other end of the wire 220 may be coupled to the holder 270. For example, one end of the wire 220 may be coupled to the first outer frame 152 (for example, the second coupler 520) of the upper elastic member 150 using solder or a conductive adhesive. For example, the other end of the wire 220 may be coupled to the terminal member 37, and the terminal member 37 may be disposed on or coupled to the holder 270 using solder or a conductive adhesive.

A damper DA may be disposed between one end of the wire 220, which extends through the hole 147 in the housing 140, and the hole 147 in the housing 140. For example, at least a portion of the damper DA may be disposed in the hole 147 in the housing 140, and may be couple or attached both to at least a portion of the wire 220 and to the housing 140.

For example, the wire 220 may be disposed parallel to the optical axis direction. For example, the wire 220 may be disposed at the corner of the housing 140 and/or the corner of the holder 270. For example, the wire 220 may include four wires 220-1 to 220-4. Each of the four wires 220-1 to 220-4 may be disposed on a corresponding one of the four corners of the housing 140 and/or the four corners of the holder 270.

The holder 270 may have formed therein a hole 271 through which at least a portion of the wire 220 extends. For example, the corner of the holder 270 may have formed therethrough the hole 271 through which the other end of the wire 220 extends. For example, each of the four corners of the holder 270 may have formed therein the hole 271. For example, although the hole 271 may be a through hole which is formed through the holder 270 in the optical axis direction, the hole 271 may have the form of an escape groove in another embodiment.

For example, the terminal member 37 may be disposed on or coupled to the upper surface or the lower surface of the holder 270. For example, the terminal member 37 may be disposed or coupled to the lower surface of the corner of the holder 270. The holder 270 may have formed therein a groove 28A in which the terminal member 37 is disposed. For example, the groove 28A may be formed in the lower surface of the corner of the holder 270.

The holder 270 may include at least one protrusion 28B, and the terminal member 37 may have at least one hole 81A to be coupled to the at least one protrusion 28B of the holder 270. The terminal member 37 and the holder 270 may be coupled to each other using an adhesive or through heat fusion. The terminal member 37 may have a hole 71B to which the other end of the wire 220 is inserted or coupled. For example, each of the holes 81A and 71B may be a through hole.

For example, the terminal member 37 may include a body 81 coupled to the holder 270. The body 81 may include a coupler 71 coupled to the wire 220. The coupler 71 may include a coupling region 71A coupled to the wire 220 and a hole 71B formed in the first coupling region 71A. The coupling region 71A may be a region of the body 81 which is coupled to the wire 220 using solder or a conductive adhesive. For example, the other end of the wire 220 that has passed through the hole 71B may be coupled to the lower portion or the lower surface of the coupling region 71A using solder or a conductive adhesive.

For example, the body 81 may have at least one hole 71C formed around the coupling region 71A. For example, the body 81 may have a plurality of holes 71C surrounding the coupling region 71A. For example, the plurality of holes 71C may be spaced apart from the hole 71B.

The body 81 may include a support portion which is positioned between the plurality of holes 71C so as to support the coupling region 71A. The support portion 71D may alternatively be referred as a “connector” or a “bridge”. The support portion 71D may include a plurality of support portions that are spaced apart from each other. The support portion 71D may be connected to the coupling region 71A.

The at least one hole 71C may serve to enable solder to be mainly formed only in the coupling region 71A by virtue of interfacial tension (for example, surface tension) at the peripheral area of the coupling region 71A during soldering.

The coupling region 71A must be heated in order to perform soldering. Here, the at least one hole 71C may suppress or block transmission of heat of the coupling region 71A to another region while inhibiting a soldered portion from being formed in the remaining region of the body 81. In other words, the at least one hole 71C is able to improve soldering efficiency.

The terminal member 37 may include an extension 82 which extends from the body 81. The extension 82 may be bent downwards at the body 81 and may extend downwards. For example, the extension 82 may extend toward a hole 59 in the base 210. The extension 82 may alternatively be referred to as a “bent portion”.

For example, the terminal member 37 may include four terminals 37A to 37D corresponding to the four wires 220-1 to 220-4 of the terminal member 37. Each of the terminals 37A to 37D may be disposed on a corresponding one of the corners of the holder 270, and may be coupled to a corresponding one of the wires 220-1 to 220-4. The description of FIG. 10A may be applied to the structure of each of the terminals 37A to 37D with or without modification. The terminal member 37 may be made of a conductive material, for example, metal. In another embodiment, the terminal member 37 may be omitted, and the wire 220 may be directly coupled to the holder 270.

A damper or adhesive 49 may be disposed between the terminal member 37 and the base 210, and may be in contact with or coupled or attached both to the terminal member 37 and to the base 210. For example, the base 210 may have the hole 59 (or the groove) formed at a location which corresponds to or faces the terminal member 37. For example, the hole 59 (or the groove) may be formed in the corner of the base 210.

For example, the damper 59 may be disposed in the hole 59 in the base 210. Alternatively, at least a portion of the extension 82 of the terminal member 37 may be disposed in the hole 59 in the base 210, and the damper 59 may be in contact with or coupled or attached to the extension 82. The damper 59 may serve to absorb or mitigate vibration of the OIS moving unit, thereby inhibiting or suppressing oscillation of the OIS moving unit during OIS operation.

In another embodiment, the extension 82 may be omitted from the terminal member 37, and the camera device 10 may not include the damper 49 shown in FIG. 14.

The support board 310 may support the OIS moving unit with regard to the stationary unit such that the OIS moving unit is moved in a direction perpendicular to the optical axis, is tilted relative to the optical axis, or is rotated within a predetermined range.

For example, one end of the support board 310 may be connected or coupled to the first board unit 255, and another end of the support board 310 may be connected or coupled to the second board unit 800.

The holder 270 may be disposed below the AF operation unit. For example, the holder 270 may be made of a non-conductive member. For example, the holder 270 may be made of an injection-moldable material which is easily shaped through an injection molding process. Furthermore, the holder 270 may be made of an insulative material. Furthermore, for example, the holder 270 may be made of resin or plastic.

The holder 270 may include an upper surface, a lower surface which is opposed to the upper surface, and a side surface (for example, an outer surface) connecting the upper surface to the lower surface. For example, the lower surface of the holder 270 may be opposed to or face the second board unit 800.

The holder 270 may support the first board unit 255, and may be coupled to the first board unit 255. For example, the first board unit 255 may be disposed below the holder 270. The lower portion, the lower surface or the lower end of the holder 270 may be coupled to the upper portion, the upper surface or the upper end of the first board unit 255. For example, the holder 270 may be coupled to the first board unit 255 using an adhesive. In another embodiment, for example, the first board unit 255 may be disposed above the holder 270.

The holder 270 may accommodate or support the second coil 230. The holder 270 may support the second coil 230 in the state of being spaced apart from the first board unit 255. For example, at least a portion of the holder 270 may be disposed between the second coil 230 and the first board unit 255.

The holder 270 may have a bore 70 corresponding to one area of the first board unit 255. For example, the bore 70 in the holder 270 may be a through hole which is formed through the holder 270 in the optical axis direction. For example, the bore 70 in the holder 270 may correspond to, face or overlap the image sensor 810 in the optical axis direction.

Although the bore 70 in the holder 270 may have a polygonal shape, for example, a quadrangular shape, a circular shape, or an elliptical shape when viewed from above, the disclosure is not limited thereto. The bore 70 may have any of various shapes.

For example, the bore 70 in the holder 270 may be configured to have such a shape or a size as to expose the image sensor 810, a portion of the upper surface of the first circuit board 250, a portion of the upper surface of the second circuit board 260, and the elements. For example, the surface area of the bore 70 in the holder 270 may larger than the surface area of the image sensor 810, and may be smaller than the surface area of the bore 250A in the first circuit board 250.

The holder 270 may have therein the holes 41A, 41B and 41C corresponding to the second position sensors 240. For example, the holder 270 may have therein the holes 41A, 41B and 41C, which are formed at positions respectively corresponding to the first to third sensors 240A, 240B and 240C.

For example, the holes 41A, 41B and 41C may be positioned adjacent to the corners of the holder 270. The holder 270 may further have a dummy hole 41D formed adjacent to the corner of the holder 270, which does not correspond to any of the second position sensors 240. The dummy hole 41D may serve to achieve weight equilibrium of the OIS moving unit during OIS operation. The dummy hole 41D may be a through hole. In another embodiment, the dummy hole 41D may not be formed. The holes 41A, 41B and 41C may be formed through the holder 270 in the optical axis direction. In another embodiment, the holes 41A, 41B and 41C in the holder 270 may be omitted.

The upper surface of the holder 270 may be provided with at least one coupling protrusion 51, configured to be coupled to the second coil 230. The coupling protrusion 51 may project from the upper surface of the holder 270 in an upward direction or in a direction toward the AF operation unit. For example, the coupling protrusion 51 may be formed adjacent to each of the holes 41A to 41D in the holder 270.

For example, two coupling protrusions 51A and 51B may be disposed or arranged at the holder 270 so as to correspond to each of the holes 41A to 41D in the holder 270. For example, each of the holes 41A, 41B, 41C and 41D in the holder 270 may be positioned between the two coupling protrusions 51A and 51B.

The holder 270 may include one or more projections 27A and 27B. The projections 27A and 27B may project from the upper surface of the holder 270. For example, the projections 27A and 27B may project from the outer surface of the holder 270 in the optical axis direction or in an upward direction.

For example, the holder 270 may include the two projections 27A and 27B which face or overlap each other in the second horizontal direction (for example, in the X-axis direction).

For example, the holder 270 may include four side portions (or side plates), and the projections 27A and 27B may be respectively formed at two side portions among the four side portions. For example, each of the projections 27A and 27B may be disposed or positioned in the center of a corresponding side portion (or side plate) of the holder 270.

The holder 270 may include a groove 341a. The groove 341a may be an adhesive-receiving groove. The groove 341a may be formed in the outer surface of each of the projections 27A and 27B. The groove 341a may be formed in the upper surface of each of the projections 27A and 27B. The groove 341a may be formed from the upper surface to the lower surface of each of the projections 27A and 27B. An adhesive for bonding the support board 310 to the holder 270 may be disposed in the groove 341a. The groove 341a may include a plurality of grooves. For example, the groove 341a may extend in the optical axis direction. In another embodiment, the groove in the holder 270 may extend in a direction perpendicular to the optical axis.

The first board unit 255 may include the first circuit board 250 and the second circuit board 260 which are electrically connected to each other. The second circuit board 260 may alternatively be referred to as a “sensor board”. In another embodiment, the heat radiating member 280 may be included in the first board unit 255.

The first board unit 255 may be disposed on the lower surface of the holder 270. For example, the first board unit 255 may be coupled to the lower surface of the holder 270. For example, the first circuit board 250 may be disposed on and/or coupled to the lower surface of the holder 270. For example, a first surface of the first circuit board 250 may be coupled or attached to the lower surface of the holder 270 using an adhesive member.

Here, the first surface of the first circuit board 250 may be opposed to or face the AF operation unit, and may be a surface on which the second position sensor 240 is disposed. The second surface of the first circuit board 250 may be a surface opposite the first surface of the first circuit board 250.

The first circuit board 250 may alternatively be referred to as a “sensor board”, a “main board”, a “main circuit board”, a “sensor circuit board”, a “moving circuit board” or the like. In all the embodiments, the first circuit board 250 may alternatively be referred to as a “second board” or a “second circuit board”, and the second circuit board 260 may alternatively be referred to as a “first board” or a “first circuit board”.

The second position sensor 240 (240A, 240B and 240C) may be disposed on the first circuit board 250 in order to detect movement of the OIS moving unit in a direction perpendicular to the optical axis and/or rotation, tilting or rolling of the OIS moving unit relative to the optical axis. Furthermore, a controller 830 and/or a circuit element (for example, a capacitor) may be disposed on the first circuit board 250.

The first circuit board 250 may include first terminals E1 to E8 to be electrically connected to the second coil 230. Here, the first terminals E1 to E8 may alternatively be referred to as “first pads” or “first bonding portions”. The first terminals E1 to E8 of the first circuit board 250 may be disposed or arranged on a first surface 60A of the first circuit board 250. For example, the first circuit board 250 may be a printed circuit board or a flexible printed circuit board (FPCB).

The first circuit board 250 may have the bore 250A which corresponds to or faces the bores of the lens module 400 and the bobbin 110. For example, the bore 250A in the first circuit board 250 may be a through hole or a cavity which is formed through the first circuit board 250 in the optical axis direction, and may be formed in the center of the first circuit board 250.

When viewed from above, the shape of the first circuit board 250, for example, the outer peripheral shape of the first circuit board 250 may have a shape which coincides with or corresponds to the holder 270, for example, a quadrilateral shape. When viewed from above, the bore 250A in the first circuit board 250 may have a polygonal shape, for example, a quadrilateral shape, a circular shape or an elliptical shape. For example, the bore 250a in the first circuit board 250 may open or expose the image sensor 810 and/or the bore 260A in the second circuit board 260.

The first circuit board 250 may include at least one terminal 251 to be electrically connected to the second circuit board 260. The terminal 251 of the first circuit board 250 may alternatively be referred to as a “pad” or a “bonding portion”. The terminal 251 of the first circuit board 250 may be disposed or arranged on the lower surface of the first circuit board 250.

For example, the terminal 251 may include a plurality of terminals, and the plurality of terminals 251 may be disposed and arranged in a region between the bore 250A in the first circuit board 250 and one side of the first circuit board 250 in a direction parallel to the one side. For example, the plurality of terminals 251 may be arranged so as to surround the bore 250A.

The second circuit board 260 may be disposed below the first circuit board 250. The second circuit board 260 may be electrically connected to the image sensor 810.

When viewed from above, although the second circuit board 260 may have a polygonal shape (for example, a quadrilateral shape, a square shape, or a rectangular shape), the disclosure is not limited thereto. In another embodiment, the second circuit board 260 may have a circular shape or an elliptical shape.

For example, the surface area of the outer periphery of the second circuit board 260 may be larger than the surface area of the bore 250A in the first circuit board 250. For example, the lower side of the bore 250A in the first circuit board 250 may be shielded or blocked by means of the second circuit board 260.

For example, when viewed from above or underneath, the outer surface (or outer side) of the second circuit board 260 may be positioned between the outer surface (or side) of the first circuit board 250 and the bore 250A in the first circuit board 250.

For example, the second circuit board 260 may have the bore 260A corresponding to the bore 250A in the first circuit board 250 and/or the image sensor 810. The bore 260A in the second circuit board 260 may be a hole or a cavity which is formed through the second circuit board 260, and may be formed in the center of the second circuit board 260.

For example, the bore 260A in the second circuit board 260 may open or expose the image sensor 810. For example, the image sensor 810 may be disposed in the bore 260A in the second circuit board 260, and may be electrically connected to the second circuit board 260. For example, the image sensor 810 may be electrically connected to the second circuit board 260 via a wire.

In another embodiment, the bore 260A may not be formed in the second circuit board 260, and the image sensor 810 may be disposed on the upper surface of the second circuit board 260.

In another embodiment, the heat radiating member 280 may be omitted. In the embodiment in which the heat radiating member 280 is omitted, the bore 260A may not be formed in the second circuit board 260 and the image sensor 810 may be disposed on the upper surface of the second circuit board 260.

In the embodiment in which the heat radiating member 280 is omitted, for example, the image sensor 810 may be disposed on the upper surface of a single board in which the first circuit board and the second circuit board are integrally formed.

The second circuit board 260 may include at least one terminal 261 which is electrically connected to the at least one terminal 251 of the first circuit board 250. For example, the terminal 261 of the second circuit board 260 may include a plurality of terminals.

For example, at least one terminal 261 of the second circuit board 260 may be formed on the side surface or the outer surface of the second circuit board 260 which connects the upper surface and the lower surface of the second circuit board 260 to each other. The upper surface of the second circuit board 260 may be a surface that faces the first circuit boar 250, and the lower surface of the second circuit board 260 may be a surface opposite the upper surface of the second circuit board. For example, the terminal 261 may have the form of a groove having a structure that is depressed from the side surface of the second circuit board 260. Alternatively, for example, the terminal 261 may have the form of a circular or semielliptical via formed in the side surface of the second circuit board 260. In another embodiment, at least one terminal of the second circuit board 260 that is electrically connected to the second terminal 251 of the first circuit board 250 may be formed on the upper surface of the second circuit board 260.

For example, the terminal 261 of the second circuit board 260 may be coupled to the terminal 251 of the first circuit board 250 by means of the solder 901 or the conductive adhesive member. Although only one solder 901 configured to couple one terminal of the second circuit board 260 to one terminal 251 of the first circuit board is illustrated in the enlarged dotted portion in FIG. 43, a solder configured to couple another terminal of the second circuit board 260 to a terminal of the first circuit board 250 corresponding to the other terminal of the second circuit board 260 may also be provided.

For example, each of the first and second circuit boards 250 and 260 may be a printed circuit board or a flexible printed circuit board (FPCB). At least one of the first and second circuit boards 250 and 260 may be an organic substrate or a ceramic board.

The heat radiating member 280 may be disposed on or coupled to the first board unit 255. For example, the heat radiating member 280 may be disposed on or coupled to the second circuit board 260. For example, the heat radiating member 280 may be disposed below the second circuit board 260. For example, the heat radiating member 280 may be coupled or fixed to the lower surface of the second circuit board 260. For example, at least a portion of the upper surface of the heat radiating member 280 may be coupled or fixed to the lower surface of the second circuit board 260.

The term “heat radiating member” may be used interchangeably with “heat radiating sheet”, “heat radiating tape”, “heat radiating layer”, “heat radiating film”, “heat radiating board”, “heat radiating plate”, or “heat radiating body”.”

In another embodiment, the heat radiating member 280 may be included in the first board unit 255, and the image sensor 810 may be disposed on the first board unit 255.

The bore 260A in the second circuit board 260 may open or expose at least a portion of the heat radiating member 280. The image sensor 810 may be disposed on or attached or coupled to at least a portion of the heat radiating member 280 that is exposed through the bore 260A. For example, the image sensor 810 may be fixed, attached or coupled to the heat radiating member 280 using an adhesive. For example, the image sensor 810 may be disposed on the first board unit 255.

For example, at least an area of the upper surface of the heat radiating member 280 may be exposed through the bore 260A, and the image sensor 810 may be disposed on or attached or coupled to the at least an area of the upper surface of the heat radiating member 280 that is exposed through the bore 260A.

In another embodiment, the second circuit board 260 may include a groove formed in the lower surface thereof in order to receive or dispose the heat radiating member 280 therein.

In another embodiment, the second circuit board 260 may not have formed therein the bore 260A, and the heat radiating member 280 may be fixed, attached or coupled to the lower surface of the second circuit board 260. In a further embodiment, the heat radiating member 280 may be omitted.

For example, the heat radiating member 280 may be a plate-shaped member having predetermined thickness and hardness. The heat radiating member 280 may improve an effect of radiating heat, generated from the heat source of the first board unit 255, toward the outside. Here, the heat source of the first board unit 255 may be an electronic element (or a circuit element) disposed on the first board unit 255, for example, the image sensor 810, the controller 830, the second position sensor 240 and/or the capacitor.

For example, the heat radiating member 280 may include a metal material which has high thermal conductivity and high heat radiation efficiency, for example, at least one of stainless steel, aluminum, nickel, phosphorus, bronze, or copper.

The heat radiating member 280 may serve to stably support the image sensor 810, and may serve as a reinforcing material for suppressing breakage of the image sensor 810 attributable to external shock or contact.

In another embodiment, the heat radiating member 280 may be made of a heat radiating member having high thermal conductivity, for example, exothermic epoxy, exothermic plastic (for example, polyimide), or exothermic synthetic resin.

In an embodiment, for example, the term “heat radiating member” may be used interchangeably with “heat radiating body”, “heatsink”, “heat radiating plate”, “heat radiating sheet”, “plate”, “metal plate”, “reinforcing material”, or “stiffener”.

In order to improve heat radiation efficiency, the heat radiating member 280 may include a predetermined pattern having at least one groove or at least one unevenness. For example, a groove or an unevenness having a predetermined pattern may be formed in the lower surface of the heat radiating member 280.

For example, the predetermined pattern may include a plurality of grooves which are spaced apart from each other at a predetermined interval. For example, the predetermined pattern may have the shape of a stripe. In another embodiment, the predetermined pattern may have the shape of a net or a mesh. In a further embodiment, the predetermined pattern may have a shape having dots which are spaced apart from each other. For example, each of the dots may have a circular shape, an elliptical shape or a polygonal shape (for example, a quadrilateral shape).

In another embodiment, the predetermined pattern may be formed on at least one of the upper surface, the lower surface or the outer surface of the heat radiating member 280. In a further embodiment, the radiating member 280 may include a hole or a through hole in place of the groove or the unevenness. Because the heat radiating member 280 moves together with the OIS moving unit, the heat radiating member 280 may be spaced apart from the stationary unit, for example, the second board unit 800. The heat radiating member 280 may include at least one escape groove 281 (see FIG. 10A) for avoidance of spatial interference with the solder 901.

Although the first circuit board 250 and the second circuit board 260 are electrically coupled to each other using the solder 901, the first board and the second board may be embodied as a single integrated circuit board in another embodiment.

The second coil 230 may be disposed on or coupled to the OIS moving unit. For example, the second coil 230 may be disposed on the holder 270. The second coil 230 may be disposed on the upper surface of the holder 270. The second coil 230 may be disposed below the magnet 130.

The second coil 230 may be coupled to the holder 270. For example, the second coil 230 may be coupled or attached to the upper surface of the holder 270. For example, the second coil 230 may be coupled to the coupling protrusion 51 of the holder 270. The second coil 230 may move the OIS moving unit by virtue of the interaction with the magnet 130.

For example, the second coil 230 may correspond to, face or overlap the magnet 130 disposed on the stationary unit in the direction of the optical axis OA. In another embodiment, the stationary unit may include a dedicated OIS magnet independent of the magnet of the AF operation unit, and the second coil may correspond to, face or overlap the dedicated OIS magnet. Here, the OIS magnet may include the same number of OIS magnets as the number of coil units included in the second coil 230.

In a further embodiment, the OIS magnet may be disposed on the stationary unit of the second coil 230, and the OIS magnet 71B of the magnet 130 may be disposed on the OIS moving unit. Here, the second coil 230 may be electrically connected to the support board 310 and/or the second board unit 800 via a conductive member.

For example, the second coil 230 may include a plurality of coil units 230-1 to 230-4. For example, the second coil 230 may include four coil units 230-1 to 230-4 disposed on the four corners of the holder 270. For example, at least a portion of each of the coil units 230-1 to 230-4 may be disposed on a corresponding one of the corners of the holder 270. A portion of each of the coil units 230-1 to 230-4 may be disposed on a side portion adjacent to a corresponding one of the corners of the holder 270.

Each of the coil units 230-1 to 230-4 may have the form of a coil block having a closed loop or ring shape. For example, each of the coil units may have a cavity or a hole. For example, each of the coli units may be composed of a fine pattern (FP) coil, a wound coil or a coil block. For example, the cavity or the hole in each of the coil units 230-1 to 230-4 may be fitted over or coupled to the protrusion 51 of the holder 270.

In another embodiment, the second coil 230 may be disposed on the first circuit board 250, and may be coupled to the first circuit board 250.

The second coil 230 may be electrically connected to the first circuit board 250. For example, the first coil unit 230-1 may be conductively connected to two terminals E1 and E2 of the first circuit board 250, and the second coil unit 230-2 may be electrically connected to two other terminals E3 and E4. Furthermore, the third coil unit 230-2 may be electrically connected to two other terminals E5 and E6 of the first circuit board 250, and the fourth coil unit 230-4 may be electrically connected to the two other terminals E7 and E8 of the first circuit board 250.

Power or drive signals may be supplied to the first to fourth coil units 230-1 to 230-4 through the first circuit board 250. The power or drive signal supplied to the second coil 230 may be a DC signal, an AC signal or a signal containing both DC and AC components, and may be of a voltage type or a current type.

By virtue of the interaction between the first to fourth magnet units 130-1 to 130-4 and the first to fourth coil units 230-1 to 230-4, the OIS moving unit may be moved in the first horizontal direction or in the second horizontal direction or may be rolled relative to the optical axis.

For example, current may be independently applied to at least three coil units among the four coil units 230-1 to 230-4. In another embodiment, current may be independently applied to at least two coil units among the four coil units 230-1 to 230-4.

For example, an independent drive signal, for example, independent drive current, may be supplied to each of the four coil units 230-1 to 230-4.

The controller 830 and 70 may supply at least one drive signal to at least one of the first to fourth coil units 230-1 to 230-4, and may move the OIS moving unit in the X-axis direction and/or in the Y-axis direction or may rotate the OIS moving unit within a predetermined angle range about the optical axis by controlling the at least one drive signal. Hereinafter, the “controller” may be at least one of the controller 830 of the camera device 10 or the controller 780 of the optical instrument 200A.

When the second coil 230 is driven through three channels, three independent drive signals may be supplied to the second coil 230. For example, among the four coil units, two coil units (for example, 230-2 and 230-4 or 230-1 and 230-3), which are diagonally opposed to each other, may be connected to each other in series, and one drive signal may be supplied to the two coil units, which are connected to each other in series. Independent drive signals may be respectively supplied to the two other coil units among the four coil units.

Alternatively, when the second coil 230 is driven through four channels, independent drive signals may be respectively supplied to the four coil units 230-1 to 230-4, which are separated from each other.

The description of FIGS. 18A to 18D may be applied to the embodiment shown in FIGS. 31 to 53 with or without modification. The description of the second sensor 240 shown in FIGS. 1 to 30 may be applied to the embodiment shown in FIGS. 31 to 53 with or without modification.

The base 210 may be disposed below the first board unit 255. The base 210 may be spaced apart from the first board unit 255. The base 210 may have a polygonal shape, for example, a quadrilateral shape, which coincides with or corresponds to the cover member 300 or the first board unit 255.

For example, the base 210 may have the bore 210A which corresponds to or faces the first board unit 255. The bore 210A in the base 210 may be a through hole which is formed through the base 210 in the optical axis direction. In another embodiment, the base may not have the bore.

For example, the base 210 may be coupled to the side plate 302 of the cover member 300. The side portion or the outer surface of the base 210 may include a step 211 (see FIG. 14) to which an adhesive is applied when the side portion or the outer surface is bonded to the side plate 302 of the cover member 300. Here, the step 211 may guide the side plate 302 of the cover member 300 which is coupled to the upper side thereof. The step 211 of the base 210 and the lower end of the side plate 302 of the cover member 300 may be bonded or fixed to each other using an adhesive or the like.

The base 210 may include one or more projections 216A and 216B projecting from the upper surface thereof. For example, the projections 216A and 216B may project upwards from the outer surface of the base 210. For example, the base 210 may include two projections 216A and 216B which face or overlap each other in the first horizontal direction (for example, in the Y-axis direction).

For example, the base 210 may include four side portions (or side plates), and the projections 216A and 216B may be formed at two of the four side portions. For example, the projections 216A and 216B may be disposed or positioned in the center of the side portion (or the side plate) of the base 210.

The base 210 may include a groove 341B. The groove 341b may be an adhesive-receiving groove. The groove 341b may be formed in the outer surface of a corresponding one of the projections 216A and 216B of the base 210. The groove 341b may be formed in the upper surface of a corresponding one of the projections 216A and 216B of the base 210. The groove 341b may be formed from the upper surface to the lower surface of a corresponding one of the projections 216A and 216B. An adhesive may be disposed in the groove 341b in order to bond the support board 310 to the base 210. The groove 341b may include a plurality of grooves. For example, the groove 341b may extend in the optical axis direction. In another embodiment, the groove formed in a corresponding one of the projections 216A and 216B of the base 210 may extend in a direction perpendicular to the optical axis.

The second board unit 800 may be disposed below the base 210. For example, the second board unit 800 may be disposed so as to be spaced apart from the OIS moving unit, for example, the first board unit 255 and the heat radiating member 280 in the optical axis direction.

For example, the second board unit 800 may be disposed below the lower surface of the base 210. The second board unit 800 may be coupled to the base 210. The second board unit 800 may be coupled to the base 210. For example, the second board unit 800 may be coupled to the lower surface of the base 210.

The second board unit 800 may serve to supply a signal to the image sensor unit 350 from the outside or to output the signal transmitted from the image sensor unit 350 to the outside.

The second board unit 800 may include a first region 801 (or a first board), which corresponds to, faces or overlaps the AF operation unit 100 or the image sensor 810 in the optical axis direction, a second region 802 (or a second board) on which a connector 804 is disposed, and a third region 803 (or a third board) connecting the first region 801 to the second region 802. The connector 804 may include a port which is to be electrically connected both to the second region 802 of the second board unit 800 and to an external device (for example, the optical instrument 200A). The bore 210A in the base 210 may be closed or blocked by the first region 801 of the second board unit 800.

The first region 801 of the second board unit 800 may correspond to, face or overlap at least one of the cover member 300 or the base 210 in the optical axis direction. For example, the first region 801 may overlap the upper plate 301 and the side plate 302 of the cover member 300 in the optical axis direction.

Each of the first region 801 and the second region 802 of the second board unit 800 may include a rigid substrate. The third region 803 may include a flexible substrate. Each of the first region 801 and the third region 802 may further include a flexible substrate.

In another embodiment, at least one of the first to third regions 801 to 803 of the circuit board 800 may include at least one of a rigid substrate or a flexible substrate.

The second board unit 800 may be disposed behind the first board unit 255. For example, the first board unit 255 may be disposed between the AF operation unit 100 and the second board unit 800. In another embodiment, the second board unit may be disposed between the AF operation unit and the first board unit.

Although the first region 801 of the second board unit 800 may have a polygonal shape (for example, a quadrilateral shape, a square shape or a rectangular shape) when viewed from above, the disclosure is not limited thereto. In another embodiment, the first region 801 may have a circular shape or the like.

The description of FIGS. 20A and 20B may be applied to the embodiment shown in FIGS. 31 to 53 with or without modification.

The support board 310 may support the support unit such that the OIS moving unit is movable relative to the stationary unit in a direction perpendicular to the optical axis direction, and may electrically connect the first board unit 255 to the second board unit 800.

The support board 310 may alternatively be referred to as a “support member”, a “connecting board” or a “connector”. Furthermore, the support board 310 may alternatively be referred to as an “interposer”. Alternatively, the “interposer” may include the first circuit board 250 and the support board 310 which are formed integrally with each other.

In another embodiment, in place of the support board 310, a support, which is connected at one end thereof to the moving unit, for example, the first board unit 255 and at the other end thereof to the stationary unit, for example, the second board unit 800, may be provided. For example, the support may include at least one of a leaf spring or a suspension wire. For example, the support may electrically connect the first board unit 255 to the second board unit 800.

The support board 310 may include a flexible substrate or may be a flexible substrate. For example, the support board 310 may include a flexible printed circuit board (FPCB). At least a portion of the support board 310 may have flexibility. The first circuit board 250 and the support board 310 may be connected to each other.

For example, the support board 310 may include a connector 320 connected to the first circuit board 250. For example, the first circuit board 250 and the support board 310 may be formed integrally with each other. In another embodiment, the first circuit board 250 and the support board 310 may not be integrally formed but be separate components, and may be connected to each other via the connector 320 and be electrically connected to each other. In another embodiment, the connector 320 may be formed integrally with at least one of the support board 310 or the first circuit board 250.

The support board 310 may be electrically connected to the first circuit board 250. The support board 310 may be electrically connected to the second board unit 800. For example, one end of the support board 310 may be connected or coupled to the first board unit 255 (for example, the second circuit board 260). The other end of the support board 310 may be connected or coupled to the second board unit 800.

The support board 310 may support the OIS moving unit with respect to the stationary unit. Furthermore, the support board 310 may guide movement of the OIS moving unit. The support board 310 may guide the OIS moving unit such that the OIS moving unit is movable in a direction perpendicular to the optical axis direction. The support board 310 may guide the OIS moving unit such that the OIS moving unit is rotated, tilted or rolled about the optical axis. The support board 310 may restrict movement of the OIS moving unit in the optical axis direction.

A portion of the support board 310 may be coupled, attached or fixed to the base 210 which is the stationary unit, and another portion of the support board 310 may be coupled, attached or fixed to the holder 270 which is the OIS moving unit.

For example, portions of bodies 86 and 87 of the support board 310 may be coupled to the base 210 (for example, the projections 216A and 216B which are the stationary unit, and other portions of the bodies 86 and 87 may be coupled to the holder 270 (for example, the projections 27A and 27B) which are the OIS moving unit.

The connector 320 of the support board 310 may be connected to the first board unit 255 (for example, the first circuit board 250), and may be electrically connected to the first board unit 255. The extensions 7A to 7D of the support board 310 may be coupled to the second board unit 800 (for example, the terminals 800B), and may be electrically connected to the second board unit 800.

For example, the support board 310 may include a circuit member and an elastic portion coupled to the circuit member. The elastic portion may serve to flexibly support the OIS moving unit, and may be embodied as an elastic body, for example, a spring. The elastic portion may include metal or may be made of an elastic material. The circuit member may serve to electrically connect the first circuit board 250 to the second board unit 800, and may be a flexible substrate or may include at least one of a flexible substrate or a rigid substrate. For example, the circuit member may be an FPCB.

For example, the support board 310 may include one or more connectors 320A and 320B which are connected to the first board unit 255 (for example, the first circuit board 250) and are electrically connected to the first board unit 255 (for example, the first circuit board 250).

The support board 310 may include one or more extensions 7A to 7D which are connected to the second board unit 800 and are electrically connected to the second board unit 800, and the one or more extensions 7A to 7D may include a plurality of terminals 311.

For example, the support board 310 may be disposed so as to surround the OIS moving unit, for example, the first board unit 253. For example, the support board 310 may be disposed so as to surround the four side portions 33A to 33D of the first circuit board 250 or the outer surfaces of the side portions.

For example, the support board 310 may not overlap the OIS moving unit, for example, the first board unit 255 in the optical axis direction, and at least a portion of the support board 310 may overlap the OIS moving unit, for example, the first board unit 255 in a direction perpendicular to the optical axis direction.

For example, the support board 310 may include a plurality of support boards which are separated or spaced apart from each other. In another embodiment, the support board 310 may be formed to have a single integrated form.

The support board 310 may include the bodies 86 and 87. For example, the bodies 86 and 87 may be disposed so as to surround the OIS moving unit, for example, the first board unit 255. For example, the bodies 86 and 87 may be disposed so as to surround the holder 270.

For example, the bodies 86 and 87 may not overlap the OIS moving unit, for example, the first board unit 255 in the optical axis direction, and at least portions of the bodies 86 and 87 may overlap the OIS moving unit, for example the first board unit 255 in a direction perpendicular to the optical axis direction.

For example, each of the bodies 86 and 87 may have a plate shape which is flat in the optical axis direction or in a direction parallel to the optical axis direction. For example, the outer shape of each of the bodies 86 and 87 may have a polygonal shape, for example, a quadrilateral shape or a circular shape when viewed from above.

For example, the bodies 86 and 87 may include a plurality of parts which are separated or spaced apart from each other. In another embodiment, the bodies may be integrated into a single structure.

The support board 310 may include the extensions which extend from the bodies 86 and 87 and are coupled to the second board unit 800. For example, each of the extensions of the support board 310 may extend toward the second board unit 800, and one end of each of the extensions of the support board 310 may be coupled to the second board unit 800. The one end of the each of the extensions of the support board 310 may be provided with a plurality of terminals which are electrically connected to the second board unit 800 using a solder or a conductive adhesive. For example, each of the extensions of the support board 310 may alternatively be referred to as a “terminal member”, a “projection” or a “leg member”.

For example, each of the extensions 7A to 7D of the support board 310 may include a first portion, which extends from a corresponding one of the bodies 86 and 87 in the optical axis direction, and a second portion, which extends from the first portion in a direction perpendicular to the optical axis. For example, the extensions 7A to 7D of the support board 310 may be fixed or coupled to the stationary unit (for example, the base 210). For example, when the OIS moving unit moves, the bodies 86 and 87 of the support board 310 are movable while the extensions 7A to 7D of the support board 310 are stationary.

For example, the support board 310 may include a first support board 310-1 and a second support board 310-2 which are spaced apart from each other. The first and second support boards 310-1 and 310-2 may be line-symmetrically formed. In another embodiment, the first support board 310-1 and the second support board 310-2 may be integrally formed into a single board. In a further embodiment, the support board 310 may include three or more support boards.

For example, the first and second support boards 310-1 and 310-2 may be disposed so as to surround the four side portions 33A to 33D of the first circuit board 250.

For example, the first support board 310-1 may include the first body 86 and one or more extensions 7A and 7B which extend from the first body 86. The one or more extensions 7A and 7B of the first support board 310-1 may include a plurality of terminals 311.

The second support board 310-2 may include the second body 87 and one or more extensions 7C and 7D which extend from the second body 87. The one or more extensions 7C and 7D of the second support board 310-2 may include a plurality of terminals 311.

The first circuit board 250 may include the first side portion 33A and the second side portion 33B, which are positioned opposite each other, and the third side portion 33C and the fourth side portion 33D, which are positioned between the first side portion 33A and the second side portion 33B and are positioned opposite each other.

For example, the first connector 320A may connect the first body 86 to the first side portion 33A of the first circuit board 250. The second connector 320B may connect the second body 87 to the second side portion 33B of the first circuit board 250.

The first body 86 may include a first portion 6A, which corresponds to or faces the first side portion 33A of the first circuit board 250, a second portion 6B, which corresponds to a portion (or a side) of the third side portion 33C of the first circuit board 250, and a third portion 6C, which corresponds to a portion (or a side) of the fourth side portion 33D of the first circuit board 250. Furthermore, the first body 86 may include a first bent portion 6D, which connects one end of the first portion 6A to the second portion 6B and is bent at the one end of the first portion 6A, and a second bent portion 6E, which connects the other end of the first portion 6A to the third portion 6C and is bent at the other end of the first portion 6A. For example, the first body 86 may have a “U” shape.

For example, the first support board 310-1 may include the extensions 7A and 7B. For example, the extension 7A may be connected to one side of the first body 86, and the extension 7B may be connected to the other side of the first body 86.

For example, the extension 7A may extend or project toward the second board unit 800 from the first portion 6B of the first body 86, and the extension 7B may extend or project toward the second board unit 800 from the third portion 6C of the first body 86. The extension 7B may be positioned opposite the extension 7A with the first board unit 255 (for example, the first circuit board 250) interposed therebetween.

For example, the first connector 320A may connect the first portion 6A of the first body 86 to the first side portion 33A of the first circuit board 250. The first connector 320A may include a bent portion. For example, the first connector 320A may connect the central region of the first portion 6A of the first body 86 to the central region of the first side portion 33A of the first circuit board 250.

The second body 87 may include a first portion 9A, which corresponds to or faces the second side portion 33B of the first circuit board 250, a second portion 9B, which corresponds to or faces another portion (or the other side) of the third side portion 33C of the first circuit board 250, and a third portion 9C, which corresponds to or faces another portion (or the other side) of the fourth side portion 33D of the first circuit board 250. Furthermore, the second body 87 may include a first bent portion 9D, which connects one end of the first portion 9A to the second portion 9B and is bent at the one end of at the first portion 9A, and a second bent portion 9E, which connects the other end of the first portion 9A to the third portion 9C and is bent at the other end of the first portion 9A. For example, the second body 87 may have a “U” shape. For example, the second body 87 may have a shape symmetrical with the first body 86 based on the optical axis. For example, the second body 87 may be symmetrical with the first body 86 based on the optical axis.

For example, the second support board 310-2 may include the extensions 7C and 7D. For example, the extension 7C may be connected to one side of the second body 87, and the extension 7D may be connected to the other side of the second body 86.

The extension 7C may extend or project toward the second board unit 800 from the second portion 9B of the second body 87, and the extension 7D may extend or project toward the second board unit 800 from the third portion 9C of the second body 87. The extension 7D may be positioned opposite the extension 7C with the first board unit 255 (for example, the first circuit board 250) interposed therebetween.

For example, the extension 7A and the extension 7C may be line-symmetrical with each other when viewed from the front. In another embodiment, the extension 7A and the extension 7C may not be line-symmetrical with each other.

For example, the extension 7B and the extension 7D may be line-symmetrical with each other when viewed from the front. In another embodiment, the extension 7B and the extension 7D may not be line-symmetrical with each other.

For example, the second connector 320B may connect the first portion 9A of the second body 87 to the second side portion 33B of the first circuit board 250. The second connector 320B may include a bent portion. For example, the second connector 320B may connect the central region of the first portion 9A of the second body 87 to the central region of the second side portion 33B of the first circuit board 250.

Referring to FIG. 46, the first position sensor 170 of the AF operation unit 100 may be electrically connected to the support board 310 and be electrically connected to the second board unit 800 via the extension region 190.

Referring to FIG. 46, the support board 310 may include the conductive layer 93-1. Furthermore, the support board 310 may include the first insulating layer 94-1 disposed on one surface (or the first surface) or one side of the conductive layer 93-1. Furthermore, the support board 310 may include the second insulating layer 94-2 disposed on the other surface (or the second surface) or the other side of the conductive layer 93-1. In another embodiment, for example, the support board 310 may include at least one of the first insulating layer 94-1 or the second insulating layer 94-2.

The support board 310 may include the protective layer 96 disposed on the first insulating layer 94-1. For example, the protective layer 96 may be an EMI member (for example, an EMI tape). In another embodiment, the first insulating layer 94-1 may be omitted, and the protective layer 96 may be disposed so as to contact the conductive layer 93-1.

For example, the protective layer 96 may be a heat radiating member, for example, graphite. Alternatively, for example, the protective layer 96 may be an elastic material. Alternatively, for example, the protective layer 96 may be a conductive member. Alternatively, for example, the protective layer 96 may be an insulating member.

For example, the support board 310 may have a single conductive layer structure including one conductive layer. For example, the support board 310 may be constructed such that a single conductive layer, rather than two or more layered conductive layers, may be disposed between the first insulating layer 94-1 and the second insulating layer 94-2.

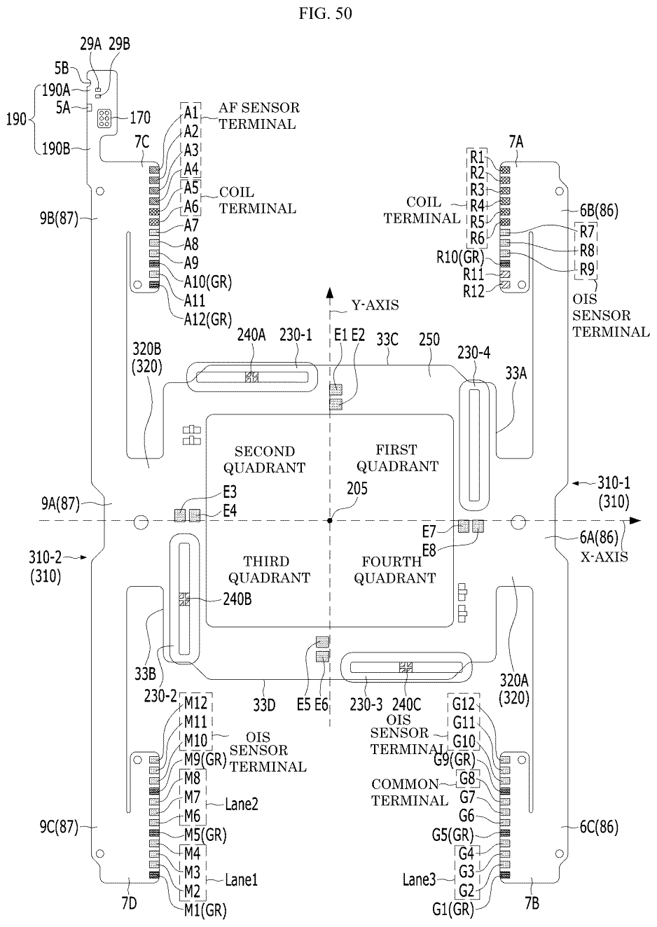

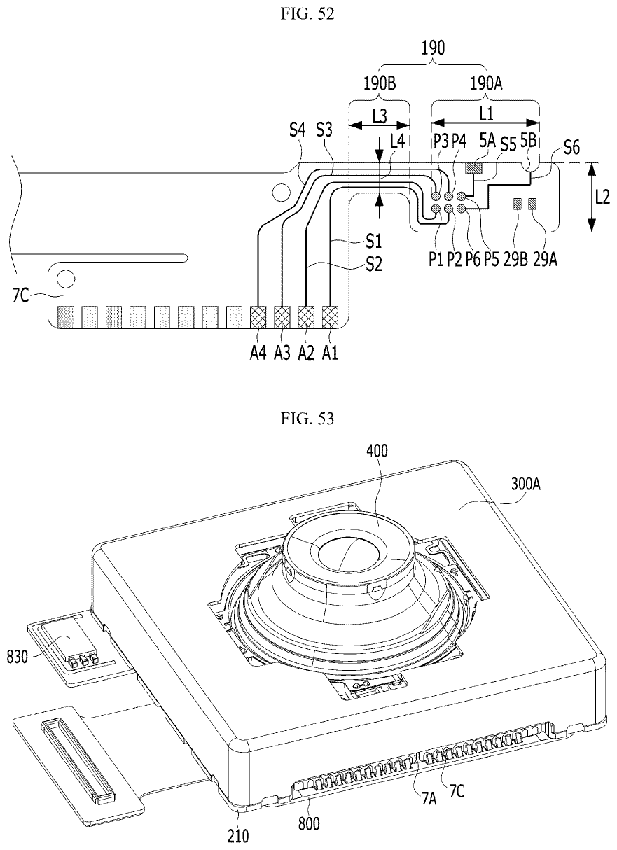

For example, the terminals of the extensions 7A to 7D and the pads P1 to P6, 5A and 5B of the extension region 190 shown in FIG. 50 and the wires S1 to S6 shown in FIG. 52 may be patterned. In another embodiment, the support board 310 may include a structure in which two or more conductive layers are layered.

The layered structure of the above-mentioned support board 310 may also be applied to the extension region 190 of the support board 310 with or without modification.

FIG. 47A is a first perspective view of the support board 310 coupled both to the holder 270 and to the base 210. FIG. 47B is a second perspective view of the support board 310 coupled both to the holder 270 and to the base 210.

Referring to FIGS. 47A and 47B, the holder 270 may include first to fourth side portions 64A to 64D (see FIG. 18A) which correspond to or face the first to fourth side portions 33A to 33D of the first circuit board 250.

The first and second side portions 64A and 64B of the holder 270 may be opposed to each other or may be disposed on opposite sides in the second horizontal direction (for example, in the X-axis direction). Furthermore, the third and fourth side portions 64C and 64D of the holder 270 may face each other or may be positioned at opposite sides in the first horizontal direction (for example, in the Y-axis direction).

The support board 310 may include first portions (or first regions) 59A and 59B coupled to the stationary unit (for example, the base 210), and second portions (or a second regions) (for example, 69A and 69B) coupled to the moving unit (for example, the holder 270).

At least a portion of the support board 310 may be attached or coupled to the holder 270. For example, at least one of the connecting portions 320A and 320B of the support board 310 may be coupled to at least one of the first to fourth side portions 64A to 54D of the holder 270 using an adhesive. For example, the first connecting portion 320A may be coupled, attached or fixed to the first side portion 64A of the holder 270 using an adhesive, and the second connecting portion 320B may be coupled, attached or fixed to the second side portion 64B of the holder 270.

The first side portion 64A of the holder 270 may be provided with the first projection 27A, and the second side portion 64B of the holder 270 may be provided with the second projection 27B.

The support board 310 may be coupled, attached or fixed to the projections 27A and 27B of the holder 270. The support board 310 may be coupled, attached or fixed to the outer surfaces (or the inner surfaces) of the projections 27A and 27B of the holder 270.

For example, a portion of the support board 310 may be coupled, attached or fixed to the first projection 27A and the second projection 27B of the holder 270. The bodies 86 and 87 of the support board 310 may be coupled, attached or fixed to the first and second projections 27A and 27B of the holder 270.

For example, the first support board 310-1 may be coupled, attached or fixed to the first projection 27A, and the second support board 310-2 may be coupled, attached or fixed to the second projection 27B. For example, the first portion 6A of the first body 86 may be coupled, attached of fixed to the outer surface (or the inner surface) of the first projection 27A, and the first portion 9A of the second body 87 may be coupled, attached or fixed to the outer surface (or the inner surface) of the second projection 27B.

The base 210 may include first to fourth side portions 65A to 65D (see FIG. 14) which correspond to or face the first to fourth side portions 33A to 33D of the first circuit board 250. The first to fourth side portions 65A to 65D of the base 210 may correspond to or face the first to fourth side portions 64A to 64D of the holder 270.

The first and second side portions 65A and 65B of the base 210 may face each other or may be disposed on opposite sides in the first horizontal direction (for example, in the Y-axis direction). Furthermore, the third and fourth side portions 65C and 65D of the base 210 may face each other or may be disposed on opposite sides in the second horizontal direction (for example, in the X-axis direction).

At least a portion of the support board 310 may be coupled, attached or fixed to the base 210. For example, the bodies 86 and 87 of the support board 310 may be coupled to the base 210 using an adhesive. For example, portions of the bodies 86 and 87 of the support board 310, which are connected to the extensions 7A to 7D, may be coupled to the base 210.

For example, at least a portion of the support board 310 may be coupled, attached or fixed to the projections 216A and 216B formed on the base 210. For example, the support board 310 may be coupled, attached or fixed to the outer surfaces (or the inner surfaces) of the projections 216A and 216B of the base 210. The first projection 216A may be formed on the third side portion 65C of the base 210, and the second projection 216B may be formed on the fourth side portion 65D of the base 210.

For example, the bodies 86 and 87 of the support board 310 may be coupled, attached or fixed to the first and second projections 216A and 216B of the base 210.

For example, one end (for example, the second portion 6B) of the first support board 310-1 may be coupled, attached or fixed to one area of the first projection 216A of the base 210, and the other end (for example, the third portion 6C) of the first support board 310-1 may be coupled, attached or fixed to one area of the second projection 216B of the base 210.

For example, one end (for example, the second portion 9B) of the second support board 310-2 may be coupled, attached or fixed to another area of the first projection 216A of the base 210, and the other end (for example, the third portion 9C) of the second support board 310-2 may be coupled, attached or fixed to another area of the second projection 216B of the base 210.

A first coupling area 69A may be defined between the first body 86 of the first support board 310-1 and the first projection 27A, and a second coupling area 69B may be defined between the second body 87 of the second support board 310-2 and the second projection 27B of the holder 270.

Furthermore, a third coupling area 59A may be defined between one end of each of the first and second support boards 310-1 and 310-2 and the first projection 216A of the base 210. A fourth coupling area 59B may be defined between the other end of each of the first and second support boards 310-1 and 310-2 and the second projection 216B of the base 210.

By virtue of the support board 310 and the first to fourth coupling areas 69A, 69B, 59A and 59B, the OIS moving unit may be flexibly supported with regard to the stationary unit. The terminals 311 of the support board 310 may be coupled to and electrically connected to the terminals 800B of the second board unit 800 using solder 902 (see FIGS. 17A and 17B) or a conductive adhesive.

In another embodiment, for example, the support member may be an elastic member excluding the board, for example, a spring, a wire, shape-memory alloy or a ball member. For example, when the support member is made of a wire, a plurality of wires may be disposed on at least one of the corners and side portions of the base 210 or the second board unit 800 in order to connect the first board unit 255 (for example, the second circuit board 260) to the second board unit 800 (or the base 210). For example, one end of each of the plurality of wires may be coupled to the first board unit 255 (for example, the second circuit board 260), and the other end of each of the plurality of wires may be coupled to the second board unit 800 (or the base 210).

The image sensor unit 350 may include at least one of the controller 830, a memory 512 or a capacitor 514.

The controller 830 may be disposed so as to be spaced apart from the first board unit 255. For example, the controller 830 may be disposed on the second board unit 800.

The memory 512 may be disposed on one of the first board unit 255 and the second board unit 800. For example, the memory 512 may be disposed or mounted on the first region 801 of the second board unit 800. For example, the memory 512 may avoid spatial interference with the heat radiating member 380 or may be spaced apart from the heat radiating member 380. For example, the heat radiating member 380 may include an escape groove or opening for avoiding spatial interference with the memory 512, and the memory 512 may be disposed in the escape groove or opening in the heat radiating member 380. The capacitor 514 may be disposed on at least one of the first board unit 255 or the second board unit 800.

The memory 512 may store a first data value (or a code value) corresponding to the output of the second position sensor 240 according to displacement (or stroke) of the OIS moving unit in a direction perpendicular to the optical axis (for example, in the X-axis direction or in the Y-axis direction) for OIS feedback operation. Furthermore, the memory 512 may store a first data value (or a code value) corresponding to the output of the first position sensor 170 according to displacement (or stroke) of the bobbin 110 in the first direction (for example, in the optical axis direction or in the Z-axis direction) for AF feedback operation.

For example, each of the first and second data values may be stored in the memory 512 in a look-up table format. Furthermore, the memory 512 may store a mathematical formula, an algorithm or a program for operation of the controller 830. For example, the memory 512 may be a non-volatile memory, for example, an electrically erasable programmable read-only memory (EEPROM).

The controller 830 may be positioned outside of the cover member 300 or may be disposed on one region of the second board unit 800 which is positioned outside the cover member 300.

The second board unit 800 may include the extension region 808 which is connected to the first region 801 and extends therefrom. The extension region 808 may extend from the first side portion 85A of the first region 801. For example, the extension region 808 may project from the outer surface of the first side portion 85A of the first region. For example, the extension region 808 may project from the outer surface of the first side portion 85A of the first region. For example, the extension region 808 may extend or project in the second horizontal direction (for example, in the X-axis direction).

The extension region 808 may be positioned outside the cover member 300 or may be positioned at an outer side of the cover member 300.

The extension region 808 may alternatively be referred to as a “fourth region”, a “projecting region”, an “extension portion”, or a “projecting portion”. The extension region 808 may not overlap the AF moving unit and the OIS moving unit in the optical axis direction. For example, the extension region 808 may extend in the same direction (for example, in the second horizontal direction) as the third region 803.

The controller 830 may be disposed in the extension region 808 of the second board unit 800. For example, the controller 830 may be disposed or mounted on the upper surface of the extension region 808 of the second board unit 800. In another embodiment, the controller 830 may be disposed or mounted on the lower surface of the extension region 808. For example, the controller 830 may not overlap the cover member 300 in the optical axis direction. For example, the extension region 808 may not overlap the cover member 800 in the optical axis direction. For example, the surface area of the upper surface of the extension region 808 may be equal to or larger than the surface area of the lower surface of the controller 830.

Because the extension region 808 and the third region 803 are connected to the first side portion 85A of the second board unit 800, it is possible to reduce the surface area that is occupied by the camera device 10 in a direction perpendicular to the optical axis. Therefore, the embodiment is able to reduce increase in the size of the camera device 10 attributable to the extension region 808.

In another embodiment, the extension region may be connected to one of second to fourth side portions 85B, 85C and 85D of the first region 801 of the second board unit 800, and may project from one of the second to fourth side portions 85B, 85C and 85D of the first region 801.

The controller 830 may be positioned outside the cover member 300 or may be positioned at the outer side of the cover member 300. For example, the controller 830 may be positioned outside the space defined between the cover member 300, the base 210 and the first region 801 of the second board unit 800.

For example, the controller 830 may not overlap the lens module 400, the AF moving unit, the OIS moving unit, and the first region 801 of the second board unit 255 in the optical axis direction. At least one capacitor 514 may be disposed or mounted on the upper surface of the extension region 808.

Because the OIS moving unit including the image sensor and the first board unit is disposed so as to be spaced apart from the stationary unit including the second board unit in a sensor-shift-type camera device in which the image sensor is moved for hand tremor correction, it may be insufficient to radiate heat generated by the OIS moving unit to the outside through the stationary unit. In addition, the sensor-shift-type camera device may have a structure in which the AF operation unit and the OIS operation unit are confined in the cover member in order to inhibit malfunction caused by foreign substances, and thus it may not be easy to radiate heat to the outside of the camera device.

The image sensor, the second coil, and the controller may correspond to the heat-generating source. Here, the “controller” may be a driver IC configured to control AF operation and/or OIS operation.

The camera device 10 may include a radiating member 870 which is disposed, coupled or attached to the extension region 808 in order to improve efficiency of heat radiation. The radiating member 870 may be in contact with the extension region 808. For example, the radiating member 870 may be disposed below the extension region 808. For example, the radiating member 870 may be disposed, coupled or fixed to the lower surface of the extension region 808. The radiating member 870 may be a plate-shaped member, and the description of the material of the heat radiating member 280 may be applied to the radiating member 870 with or without modification. At least a portion of the radiating member 870 may overlap the controller 830 in the optical axis direction.

The camera device 10 may include a cover can 405 which is disposed in the extension region 808 and accommodates the controller 830 therein in order to protect the controller 830 from external shock. The cover can 405 may include an upper plate 405A and a side plate 405B which is connected to the upper plate 405A and extends toward the extension region 808 from the upper plate 405A.

The cover can 405 may be disposed, coupled or fixed to the upper surface of the extension region 808. For example, the lower portion, the lower end or the lower surface of the side plate 405B of the cover can 405 may be coupled, attached or fixed to the upper surface of the extension region 808.

Because the cover can 405 accommodates the controller 830 therein, it is possible to inhibit the heat generated by the controller 830 from being radiated to the outside and being transmitted to the image sensor. The description of the material of the heat radiating member 280 or the cover member 300 may be applied to the cover can 405 with or without modification.

The camera device 10 may further include a heat radiating layer 860 disposed on the controller 830. The heat radiating layer 860 may cover the surface of the controller 830. For example, the heat radiating layer 860 may be disposed so as to surround the surface of the controller 830. For example, the heat radiating layer 860 may be in contact with the upper surface and the side surface of the controller 830 so as to surround the surfaces. The heat radiating layer 860 may be made of exothermic plastic or radiating resin, for example, exothermic epoxy. The heat radiating layer 860 may improve efficiency and performance of heat radiation of the controller 830.

In another embodiment, the radiating layer may be disposed on at least one of the upper surface or the side surface of the controller 830. For example, the radiating layer may expose at least a portion of the controller 830.

The controller 830 may be electrically connected to the second position sensor 240. The controller 830 may adjust or control the drive signal supplied to the second coil 230 and may perform feedback OIS operation using the output signal received from the sensors 240A, 240B and 240C of the second position sensor 240 and the first data value stored in the memory 512.

Furthermore, the controller 830 may be electrically connected to the first position sensor 170. For example, when the first position sensor 170 is embodied as a Hall sensor alone, the first position sensor 170 may be electrically connected to the controller 830. Here, the controller 830 may control the drive signal supplied to the first coil 120 and thus perform feedback autofocusing operation using the output signal of the first position sensor 170 and the second data value stored in the memory 512.

Although the controller 830 may be embodied as a driver IC, the disclosure is not limited thereto. For example, the controller 830 may be electrically connected to the terminals 800B of the second board unit 800.

The controller 830 may control the first position sensor, which is embodied as a Hall sensor alone, and the second position sensor, which is embodied as a Hall sensor alone. For example, the controller 830 may supply a drive signal to the first position sensor, which is embodied as a Hall sensor alone, and/or the second position sensor, which is embodied as a Hall sensor alone, and may receive the output signal of the first position sensor and/or the output signal of the second position sensor.

In another embodiment, the first position sensor may be embodied as a Hall sensor alone, and the second position sensor may be embodied as a drive IC including a Hall sensor. Here, the controller 830 may be electrically connected to the first position sensor, may supply a drive signal to the first position sensor, and may receive the output signal from the first position sensor.

For example, the controller 830 may include a driver configured to drive at least one of the first position sensor or the second position sensor.

The image sensor unit 350 may further include a motion sensor (not shown) which is disposed on one of the first board unit 255 and the second board unit 800. The motion sensor may be electrically connected to the controller 830. The motion sensor may output rotational angular velocity information corresponding to movement of the camera device 10. For example, the motion sensor may be embodied as a biaxial or triaxial gyro sensor or an angular velocity sensor. For example, the motion sensor may output information on amount of movement in the X-axis direction and the Y-axis direction and an amount of rotation caused by movement of the camera device 10.

In another embodiment, the motion sensor may be omitted from the camera device 10. In the case in which the motion sensor is omitted from the camera device, the camera device 10 may receive position information about movement of the camera device 10 from the motion sensor provided at the optical instrument 200A.

The image sensor 350 may further include the filter 610 disposed between the lens module 400 and the image sensor 810. The image sensor unit 350 may further include a filter holder 600 in which the filter is disposed, seated or received. The filter holder 600 may alternatively be referred to as a “sensor base”.

The filter 610 may serve to block or allow light of a specific frequency band in the light passing through the lens barrel 400 entering the image sensor 810. For example, the filter 610 may be an infrared-shielding filter. For example, the filter 610 may be disposed parallel to the x-y plane perpendicular to the optical axis OA. The filter 610 may be disposed below the lens module 400.

The filter holder 600 may be disposed under the AF operation unit 100. For example, the filter holder 600 may be disposed on the first board portion 255. For example, the filter holder 600 may be disposed on the upper surface of the second circuit board 260 of the first board unit 255.

The filter holder 600 may be coupled to one area of the second circuit board 260 around the image sensor 810 using an adhesive, and may be exposed through the bore 250A in the first circuit board 250. For example, the bore 250A in the circuit board 250 may expose the filter holder 600 disposed on the second circuit board 260 and the filter 610 disposed on the filter holder 600 therethrough. The filter holder 600 may have therein a bore 61A, which is formed in a region thereof in which the filter 610 is mounted or disposed, so as to allow the light that has passed through the filter 610 to enter the image sensor 810. The bore 61A in the filter holder 600 may be configured to have the form of a through hole, which is formed through the filter holder 600 in the optical axis direction. For example, the bore 61A in the filter holder 600 may be formed through the center of the filter holder 600, and may be positioned so as to correspond to or face the image sensor 810.

The filter holder 600 may have a seating portion 500, in which the filter 610 is seated. The filter 610 may be disposed, seated or mounted in the seating portion 500. The seating portion 500 may be formed so as to surround the bore 61A. In another embodiment, the seating portion 500 of the filter holder 600 may be configured to have the form of a projection, which projects from the upper surface of the filter 610.

The image sensor unit 350 may further include an adhesive disposed between the filter 610 and the seating portion 500, and the filter 610 may be coupled or attached to the filter holder 600 via the adhesive.

In another embodiment, the filter holder may be coupled to the holder 270 or the AF operation unit 100.

The cover member 300 may have the form of a box which is open at the lower portion thereof and includes the upper plate 301 and the side plate 302. The lower portion of the side plate 302 of the cover member 300 may be coupled to the base 210. The upper plate 301 of the cover member 300 may have a polygonal shape, for example, a quadrilateral shape or an octagonal shape. For example, the side plate 302 may include four side plates which are connected to each other. The upper plate 301 of the cover member 300 may have formed therein a bore 303 through which the lens of the lens module 400 coupled to the bobbin 110 is exposed to external light.

The side plate 302 of the cover member 300 may be provided with an opening 304 through which the terminal 800B of the second board unit 800B is exposed. For example, the opening 304 may be formed at the lower end of the side plate 302 of the cover member 300.

Furthermore, the cover member 300 may have openings 305 through which at least portions of the projections 44A and 44B of the housing 140 are exposed. The opening 305 may be positioned above the opening 304 in the cover member 300. The opening 305 and the opening 304 may communicate with each other. For example, the openings 304 and 305 may be formed in each of two side plates of the cover member 300 which are positioned opposite each other. An adhesive (or a sealing member) may be injected between projections 44A and 44B of the housing 140 and the side plate 302 of the cover member 300 through the opening 305.

For example, the cover member 300 may be made of metal. For example, the cover member 300 may be made of SUS (steel use stainless, for example, SUS4 series). Furthermore, the cover member 300 may be made of steel plate cold commercial (SPC). For example, the cover member 300 may be made of SUS containing 50% or more of Fe. In order to inhibit oxidization, antioxidizing metal, for example, nickel may be plated on the surface of the cover member 300. In another embodiment, for example, the cover member 300 may be made of a magnetic material or magnetic metal.

In a further embodiment, the cover member 300 may be made of an injection molding material, for example, plastic or resin. Furthermore, the cover member 300 may be made of an insulative material or a material capable of shielding electromagnetic waves.

The cover member 300 and the base 210 may accommodate therein the AF operation unit 100 and the OIS moving unit. The cover member 300 and the base 210 may protect the AF operation unit 100 and the OIS moving unit from external shock, and may inhibit introduction of foreign substances from the outside.

For example, at the initial position of the OIS moving unit, the outer surface of the holder 270 may be spaced apart from the inner surface of the base 210 by a predetermined distance. For example, at the initial position of the OIS moving unit, the lower surfaces of the holder 270 and the first board unit 255 may be spaced apart from the base 210 by a predetermined distance.

The controller 830 may supply at least one drive signal to at least one of the first to fourth coil units 230-1 to 230-4, and may control the at least one drive signal to move the OIS moving unit in the X-axis direction and/or in the Y-axis direction or to rotate, tilt or roll the OIS moving unit relative to the optical axis within a predetermined angle range.

The description of FIG. 21 may be applied to the embodiment shown in FIGS. 31 to 53 with or without modification.

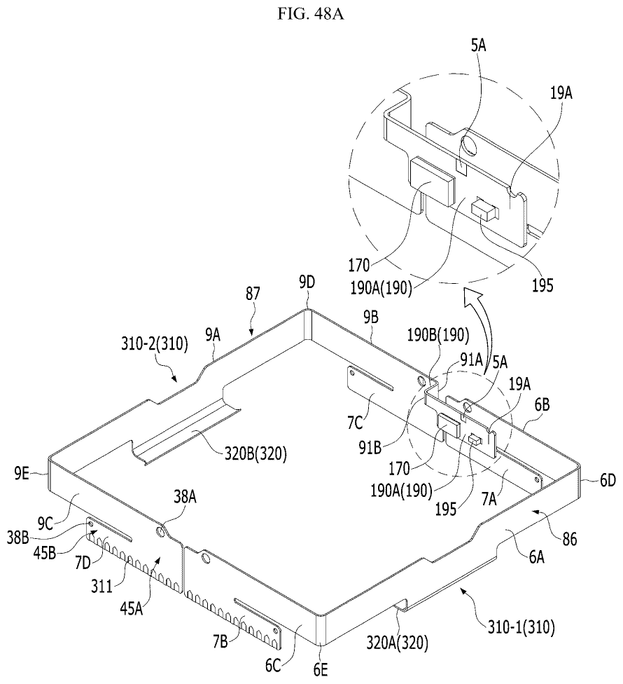

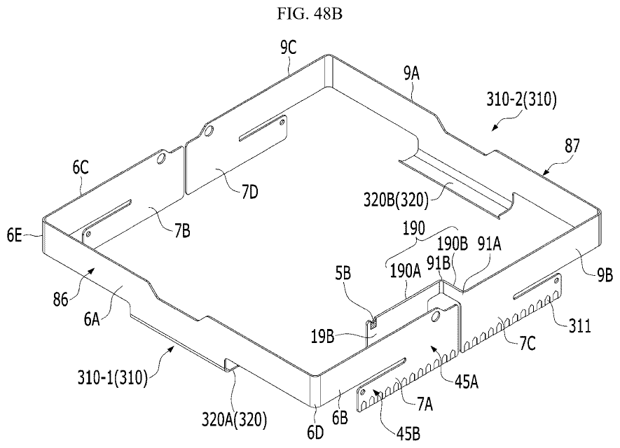

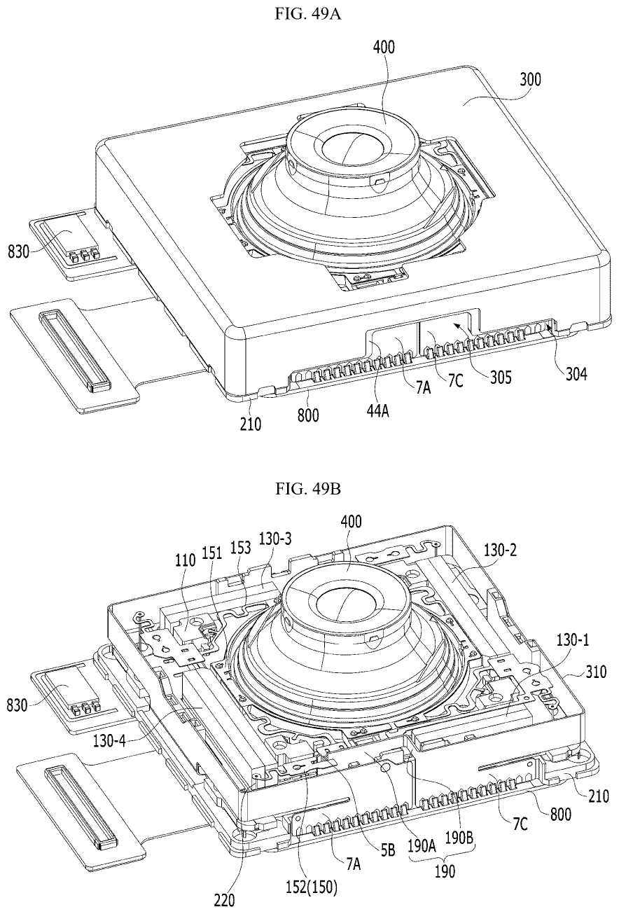

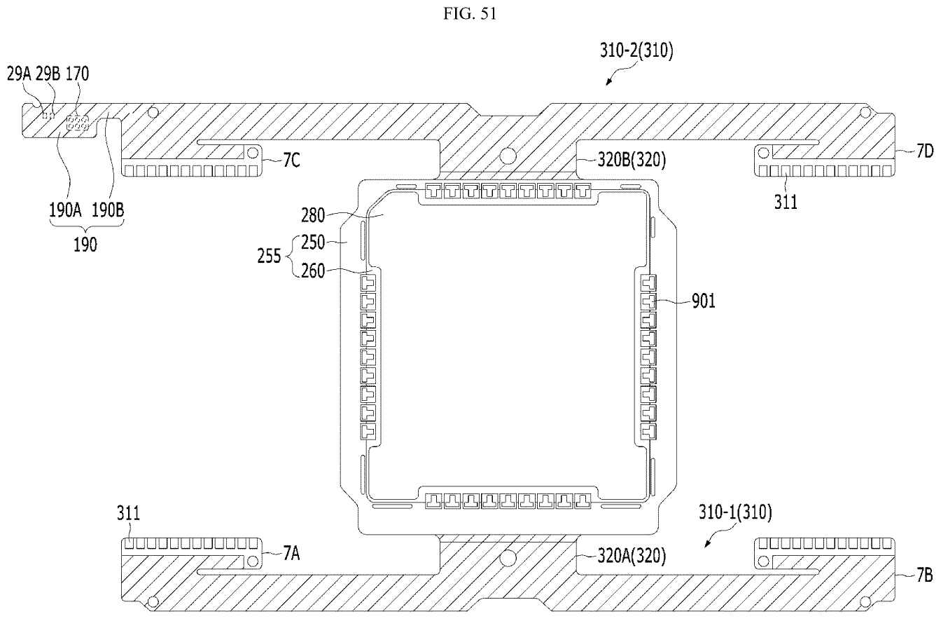

FIG. 48A is a first perspective view of the support board 310, the first position sensor 170, and the capacitor 195. FIG. 48B is a second perspective view of the support board 310, the first position sensor 170, and the capacitor 195. FIG. 49A is another perspective view of the camera device. FIG. 49B is a perspective view of the camera device shown in FIG. 49A from which the cover member 300 and the housing 140 are removed. FIG. 50 illustrates the arrangement of the terminals of the extensions 7A to 7D of the support board 310. FIG. 51 is a bottom view of the support board 310 and the first board unit 255. FIG. 52 illustrates the pads P1 to P6, 29A and 29B of the extension region 190 of the support board 310 and the wires S1 to S6.

Referring to FIGS. 48A to 52, for example, the extensions 7A to 7D may extend toward the second board unit 800. For example, the extensions 7A to 7D may extend from the bodies 86 and 87 in the first direction. Furthermore, the extensions 7A to 7D may extend in the second horizontal direction (in the X-axis direction).

The extension 7D may include a first extension (or a first portion) 45A, which extends toward the second board unit 800 from the bodies 86 and 87, and a second extension (or a second portion) 45B, which extends in a direction different from the direction in which the first extension extends.

For example, the first extension 45A may extend in the first direction (for example, in the Z-axis direction). For example, the second extension 45B may extend in the second horizontal direction (for example, in the X-axis direction). For example, the second extension 45B may extend in a leftward direction or in a rightward direction based on one end of each of the bodies 86 and 87 or the central line of the bodies 86 and 87. Here, the central line may be an imaginary line which extends through the middle point between two adjacent extensions (for example, 7D and 7C or 7A and 7C).

For example, the second extension 45B may extend in a leftward direction or in a rightward direction from the first extension 45A. When viewed from the front, the overall shape of the extension 7D may have an “L” shape or a “ [symbol] ” shape which is line-symmetrical with the “L” shape.

For example, the horizontal length of the extension 7D may be greater than the vertical length of the extension 7D. The reason for this is to allow the terminals to be easily disposed or arranged in the second horizontal direction.

For example, the horizontal length of the first extension 45A may be greater than the length of the bodies 86 and 87 in the first direction. In another embodiment, the former may be equal to or less than the latter. For example, the horizontal direction of the extension 7D may be the second horizontal direction (the X-axis direction), and the vertical direction of the extension 7D may be the first direction (for example, the Z-axis direction) which is the optical axis direction.

For example, the vertical length of the extension 7D may be less than the horizontal length of the first extension 45A. In another embodiment, the former may be equal to or greater than the latter.

The extension 7D may include a first hole 38A formed in each of the bodies 86 and 87 and a second hole 38B formed in the extension 7D. The first hole 38A may be positioned adjacent to a portion at which each of the bodies 86 and 87 and the extension 7D are connected to each other, and the second hole 38B may be formed adjacent to the distal end of the extension 7D. For example, each of the first and second holes 38A and 38B may be a through hole.

The first hole 38A may be a hole through which an adhesive configured to couple the base 210 to the bodies 86 and 87 is injected, and the second hole 38B may be a hole through which an adhesive configured to couple the base 210 to the extension 7D is injected. In another embodiment, at least one of the first hole 38A or the second hole 38B may be omitted.

In another embodiment, the first hole 38A and the second hole 38B may be coupling holes to be coupled to the base 210, and the base 210 may be provided with coupling protrusions to be coupled to the first hole 38A and the second hole 38B.

Each of the extensions 7A to 7D may include a plurality of terminals 311. For example, the plurality of terminals 311 may be disposed on the lower portion or the lower end of each of the extensions 7A to 7D. For example, the plurality of terminals 311 may be disposed so as to abut the lower end or the lower surface of each of the extensions 7A to 7D. For example, the plurality of terminals 311 may be disposed or arranged so as to be spaced apart from each other in the second horizontal direction (or in the X-axis direction). For example, the support board 310 may include wires electrically connected to the plurality of terminals 311.

The plurality of terminals 311 may include at least one ground terminal and a plurality of signal terminals. For example, the signal terminals may be terminals which are electrically connected to the second position sensor 240, the second coil 230 or the image sensor 810. For example, the signal terminals may include a terminal for a signal supplied from the second position sensor 240 or a signal output from the second position sensor. For example, the signal terminals may include a terminal for a drive signal (for example, drive current) supplied to the second coil 230. Furthermore, the signal terminals may include a terminal for supply of power associated with the image sensor 810 and/or a terminal for a data signal, a control signal or other signals associated with the image sensor 810. For example, the data signal associated with the image sensor 810 may be a signal used in a communication protocol. For example, the communication protocol may be a mobile protocol, for example, a mobile industry processor interface (MIPI).

For example, the support board 310 may include the extension region 190 which extends from a portion of a body (for example, 87) adjacent to one (for example, 7C) of the extensions 7A to 7D. For example, the extension region 190 may be a portion the body (for example, 87). For example, the extension region 190 and the bodies 86 and 87 may be formed integrally with each other. The extension region 190 may alternatively be referred to as a “projection” or a “first region”.

The extension region 190 may be coupled to the stationary unit, for example, the housing 140 and/or the base 210. The first position sensor 170 may be disposed on or coupled to the extension region 190.

In another embodiment, the first position sensor 170 may be connected to a movable portion of the support board 310. In another embodiment, for example, the first position sensor 170 may be disposed on a movable portion of each of the bodies 86 and 87 of the support board 310.

The extension region 190 may include at least one pad (for example, P1 to P6) which is to be electrically connected to the first position sensor 170. For example, the extension region 190 may include one or more bent portions 91A and 91B.

For example, the support board 310 may include the first portions (or the first regions) (for example, 59A and 59B) coupled to the stationary unit, for example, the base 210, and the second portions (or the second regions) (for example, 69A and 69B) coupled to the moving unit, for example, the holder 270. For example, the bodies 86 and 87 may include the first portions (for example, 59A and 59B) and the second portions (for example, 69A and 69B).

For example, the extension region 190 may be connected to the first portions (for example, 59A and 59B) of the bodies 86 and 87. The extension region 190 may extend toward the lens module 400 from the first portions (for example, 59A and 59B) of the bodies 86 and 87.

The extension region 190 may be disposed or positioned closer to the first portions (or the first regions) (for example, 59A and 59B) than to the second portions (or the second regions) (for example, 69A and 69B) of the support board 310.

In another embodiment, the extension region 190 may be connected to the second portions (for example, 69A and 69B) of the bodies 86 and 87.

For example, the extension region 190 may be disposed higher than the terminal members 7A to 7D of the support board 310.

The extension region 190 may include a first region 190A on which the first position sensor 170 is disposed and a second region 190B connecting the bodies 86 and 87 to the first region 190A. The length L1 of the first region 190A in the crosswise direction or in the second horizontal direction (for example, in the X-axis direction) may be greater than the length L2 of the first region 190A in the optical axis direction. In another embodiment, the horizontal length of the first region 190A may be equal to or less than the length of the first region 190A in the optical axis direction.

The extension region 190 may include one or more bent portions 91A and 91B. For example, the second region 190B may include one or more bent portions 91A and 91B.

For example, the second region 190B may include a first bent portion 91A, which is bent at the body (for example, 87), and a second bent portion 91B, which is bent at the first region 190A.

For example, at least a portion of the position sensor 170 may overlap at least a portion of the extension region 190 in the first horizontal direction (for example, in the Y-axis direction). For example, at least a portion of the position sensor 170 may overlap the body 86 (for example, the second portion 6b) in the first horizontal direction (for example, in the Y-axis direction).

For example, among the position sensor 170 and the capacitor 195, the position sensor 170 may be disposed closer to the bent portions 91 and 91B. In another embodiment, among the position sensor and the capacitor, the capacitor may be disposed closer to the bent portions 91A and 91B.

The base 210 may include an escape portion 48A for avoidance of spatial interference with the extension region 190. For example, the projection (for example, 216A) of the base 210 may include the escape portion 48A for avoidance of spatial interference with the extension region 190. For example, the escape portion 48A may be disposed or formed on the upper portion or the upper surface of the projection 216A of the base 210. The escape portion 48A may be an opening, a recess, a hole, or a through hole. For example, the escape portion 48A may be a groove which is depressed from the upper surface of the projection 216A and is open at the inner surface and the outer surface of the projection.

For example, the extension region 190 may be connected to a portion (for example, the second portion) of the body (for example, 87) coupled to the projection (for example, 216A) of the base 210, and at least a portion of the extension region 190 may pass through the escape portion 48A of the base 210.

For example, at least a portion of the second region 190B of the extension region 190 may be disposed in the escape portion 48A of the base 210, and may pass through the escape portion 48A.

For example, a portion (for example, the second portion) of the body (for example, 87) of the support board 310 may be disposed outside the projection 216A, and the first region 190A of the extension region may be positioned inside the projection 216A of the base 210.

For example, among a portion (for example, the second portion) of the body (for example, 87) and the first region 190A of the extension region 190, the first region 190A may be positioned closer to the lens module 400 or the sensing magnet 180.

For example, the horizontal length L3 of the second region 190B may be less than the horizontal length L1 of the first region. Furthermore, for example, the length L4 of the second region 190B in the optical axis direction may be less than the length L2 of the first region 190A in the optical axis direction. The reason for this is to allow the second region 190B to be easily bent and to allow easy spatial disposition of the base 210 and the housing 140.

The first position sensor 170 may be a driver IC including a Hall sensor and a driver. The position sensor 170 may include first to fourth terminals for transmitting and receiving data to and from an external device through data communication using a protocol, such as I2C communication, and fifth and sixth terminals for directly supplying a drive signal to the coil 120.

For example, each of the first to fourth terminals of the first position sensor 170 may be electrically connected to a corresponding one of the first to fourth pads P1 to P4 (see FIG. 26) of the extension region 190 using a solder or a conductive adhesive. For example, each of the fifth and sixth terminals of the first position sensor 170 may be electrically connected to a corresponding one of the fifth and sixth pads P5 and P6 of the extension region 190 of the support board 310.

For example, the first position sensor 170 may be electrically connected to the first coil 120 via at least one of the upper elastic member 150 and the lower elastic member 160 so as to supply a drive signal to the first coil 120.

For example, by means of a solder or a conductive adhesive, one end of the first coil 120 may be electrically connected to the first upper elastic member 150-1, and the other end of the first coil 120 may be electrically connected to the second upper elastic member 150-2.

For example, the extension region 190 may include the pad 5A, electrically connected to the first upper elastic unit 150-1 using a solder or a conductive adhesive, and the pad 5B, electrically connected to the second upper elastic unit 150-2 using a solder or a conductive adhesive. The pad 5B may be formed on the second surface 19B of the extension region 190. The second surface 19B may be the opposite surface of the first surface 19A of the extension region 190.

For example, the pad 5A may be electrically connected to the fifth pad P5 via a wire S5 formed in the extension region 190, and the pad 5B may be electrically connected to the sixth pad P6 via a wire S6 formed in the extension region 190. In other words, the fifth and sixth terminals of the first position sensor 170 may be electrically connected to two upper elastic units 150-1 and 150-2, and may be electrically connected to the first coil 120.

For example, the wires S5 and S6 may be disposed in the first region 190A of the extension region 190. For example, the pads P1 to P6 may be disposed or formed in the extension region 190A of the extension region 190. Furthermore, the pads 5A and 5B may be disposed or formed in the first region 190A of the extension region 190. For example, the pads 5A and 5B may be disposed higher than the first position sensor 170. Furthermore, for example, the pads 5A and 5B may be disposed higher than the pads P1 to P6.

The extension (for example, 7C) of the support board 310 may include terminals A1 to A4 which are electrically connected to the pads P1 to P4 of the extension region 190. For example, the support board 310 may include the wires S1 to S4 which conductively connect the terminals A1 to A4 of the support board 310 to the pads P1 to P4 of the extension region 190. By virtue of the wires S1 to S4, the first to fourth terminals of the first position sensor 170 may be electrically connected to the terminals A1 to A4 of the support board 310. For example, the term “wire” may be used interchangeably with “conductive layer”, “conductive line”, “conductive pattern”, or “circuit pattern”.

In another embodiment, the first coil 120 may be electrically connected to the extension region 190 of the support board 310 and the fifth and sixth terminals of the first position sensor 170 by means of two lower elastic units.

For example, in an embodiment in which the first position sensor 170 is a driver IC, the two pads P1 and P2 of the extension region 190 may be power pads for supply of power. For example, the third and fourth pads P3 and P4 of the extension region 190 may be terminals through which a clock signal CLK and a data signal SDA for data communication using a protocol, for example, I2C communication are transmitted and received. For example, the third pad P3 of the extension region 190 may be a terminal through which a clock signal is transmitted and received, and the fourth pad P4 of the extension region 190 may be a terminal through which a data signal is transmitted and received.

In another embodiment, the first position sensor 170 may be a Hall sensor. In another embodiment, the first position sensor 170 may include two input terminals to which two output terminals a drive signal or power is supplied and two output terminals from which a sensing voltage (or an output voltage) is output. In another embodiment, for example, the extension region 190 may include four pads (for example, P1 to P4) which are to be electrically connected to the two input terminals and the two output terminals of the first position sensor 170, and the pads P5 and P6 may be omitted. In another embodiment, two pads 5A and 5B of the extension region 190 may be electrically connected to two terminals (for example, 311) of the extension 7C of the support board 310, and a drive signal may be supplied to the first coil 120 via the two terminals (for example, 311).

For example, a ground terminal among the power terminals of the first position sensor 170 may be electrically connected to the cover member 300.

The capacitor 195 may be disposed or mounted on the first surface 19A of the extension region 190 of the support board 310. The capacitor 195 may be configured to have a chip shape. Here, the chip may include a first terminal, which corresponds to one end of the capacitor 195, and a second terminal, which corresponds to the other end of the capacitor 195. The capacitor 195 may alternatively be referred to as a “capacitive element” or “condenser”.

The capacitor 195 may be electrically connected to two power terminals (for example, the first and second terminals) of the first position sensor 170 in parallel from the outside. Alternatively, the capacitor 195 may be electrically connected to the first and second pads P1 and P2 of the extension region 190 in parallel.

For example, the extension region 190 may include the pad 29A to which one end of the capacitor 195 is electrically connected using a solder or a conductive adhesive, and the pad 29B to which the other end of the capacitor 195 is electrically connected using a solder or a conductive adhesive. For example, the pad 29A may be electrically connected to one of the first and second terminals of the first position sensor 170, and the pad 29B may be electrically connected to the other of the first and second terminals of the first position sensor 170. Alternatively, the pad 29A may be electrically connected to one of the first and second pads P1 and P2 of the extension region 190, and the pad 29B may be electrically connected to the other of the first and second pads P1 and P2.

The capacitor 195 may be electrically connected to the first and second pads P1 and P2 of the extension region 190 or the power terminals of the first position sensor 170 in parallel so as to serve as a smoothing circuit configured to eliminate ripple components included in power signals GND and VDD supplied to the first position sensor 170 from the outside, thereby providing the first position sensor 170 with a stable and constant power signal.

FIG. 50 may be a development view of the bodies 86 and 87, the extensions 7A to 7D, and the extension region 190 which are spread when viewed from above. FIG. 50 illustrates an X-Y coordinate system which is perpendicular to the optical axis and the origin (0, 0) of which corresponds to the center 205. For example, the center 205 may be the center of the first circuit board 250, the center of the image sensor 810, or a point at which the optical axis meets the plane of the X-Y coordinate system.

Referring to FIG. 50, the support board 310 may include a plurality of terminals through which data signals associated with the image sensor 810 are transmitted and received.

For example, in a case in which an MIPI communication protocol is of a C-PHY type, a total of nine terminals is required. In the C-PHY type, a trio structure may be used, and one unit lane may include three terminals. In the C-PHY type, three unit lanes are required.

For example, in a case in which the MIPI communication protocol is of a D-PHY type, a total of ten terminals is required. In the D-PHY type, a dual structure may be used, and one unit lane may include two terminals. In the D-PHY type, a total of five unit lanes is required. Although the MIPI communication protocol is of the C-PHY type in the embodiment, the D-PHY type may be applied in another embodiment.

At least one unit lane, which is configured to transmit and receive a data signal associated with the image sensor 810, may be disposed on at least one of the extensions 7A to 7D of the support board 310. For example, at least one unit lane may be disposed on each of the four extensions 7A to 7D. Furthermore, for example, at least one unit lane may be disposed on each of two adjacent extensions (for example, 7D and 7B or 7A and 7C) among the four extensions 7A to 7D.

For example, the number of unit lanes disposed on one of the extensions 7A to 7D may be different from the number of unit lanes disposed on another of the extensions 7A to 7D. For example, two unit lanes Lane1 and Lane2 may be disposed on one (for example, 7D) of two extensions 7D and 7B, and one unit lane Lane3 may be disposed on the other of the two extensions 7D and 7B. In another embodiment, the number of unit lanes disposed on at least one of the extensions 7A to 7D may be equal to the number of unit lanes disposed on the other of the extensions 7A to 7D.

Ground terminals GR may be disposed at two opposite sides of each unit lane Lane1, Lane2 or Lane3. Furthermore, ground wires may be disposed at two opposite sides of each unit lane Lane1, Lane2 or Lane3. For example, the ground wire may be a wire connected to the ground terminal GR.

At least one of the extensions 7A to 7D may include one or more ground terminals GR. For example, the extension 7D may include two or more ground terminals GR. For example, the ground terminals of the extension 7A to 7D may be coupled to the ground terminals among the terminals of the second board unit 800 using a solder.

The embodiment is able to inhibit noise generated in the outside from being transferred to the terminal included in the lane Lane1, Lane2 or Lane3 by surrounding and shielding the lane Lane1, Lane2 or Lane 3 by the ground terminal GR.

For example, the lanes Lane1, Lane2 and Lane3 may be disposed on two adjacent extensions (for example, 7D and 7B). For example, the lanes Lane1, Lane2 and Lane3 may be disposed on two extensions (for example, 7D and 7B) which correspond to, face or overlap one side portion (for example, 33D) of the first circuit board 250. Furthermore, for example, the lanes Lane1, Lane2 and Lane3 may be disposed on third and fourth quadrants (or first and second quadrants). For example, at least one of the three unit lanes Lane1, Lane2 or Lane3 may be disposed on the third quadrant (or the first quadrant), and at least another of the three unit lanes Lane1, Lane2 or Lane3 may be disposed on the fourth quadrant (or the second quadrant).

The lanes Lane1, Lane2 and Lane3 may be disposed on two extensions (for example, 7D and 7B) which correspond to, face or overlap one side portion of the first circuit board 250. Furthermore, for example, the lanes Lane1, Lane2 and Lane3 may be disposed on two extensions (for example, 7D and 7B) coupled to one side portion (or one outer surface), for example, one projection 216A or 216B of the base 210.

Accordingly, the embodiment is able to uniform the lengths of the wires connected to the unit lanes or to reduce the difference between the lengths of the wires connected to the unit lanes. Consequently, it is possible to reduce the difference between resistance values of the wires connected to the lanes and to improve performance of the image sensor 810. In another embodiment to which the D-PHY type is applied, the description of the C-PHY type may also be applied with or without modification.

The support board 310 may include a plurality of terminals (for example, A5 and A6 and R1 to R6, referred to hereinafter as “coil terminals”) electrically connected to the plurality of coil units 240-1 to 230-4. For example, two terminals may be connected to each of the coil units.

For example, the coil terminals A5 and A6 and R1 to R6 may be disposed on two adjacent extensions (for example, 7A and 7C). For example, the coil terminals A5 and A6 may be disposed on one (for example, 7C) of the two adjacent extensions (for example, 7A and 7C), and the coil terminals R1 to R6 may be disposed on the other (for example, 7A) of the two adjacent extensions (for example, 7A and 7C).

For example, the coil terminals A5 and A6 and R1 to R6 may be disposed on two extensions (for example, 7A and 7C) which correspond to, face or overlap one side surface of the first circuit board 250. Furthermore, for example, the coil terminals A5 and A6 and R1 to R6 may be disposed on two extensions (for example, 7C and 7A) coupled to another side portion (or another outer surface) of the base 210, for example, the projection 216A or 216B.

For example, the coil terminals A5 and A6 and R1 to R6 and the lanes Lane1, Lane2 and Lane3 may be positioned opposite each other based on the optical axis. For example, the coil terminals A5 and A6 and R1 to R6 and the lanes Lane1, Lane2 and Lane3 may be positioned opposite each other based on the first circuit board 250.

Accordingly, the embodiment is able to reduce the lengths of the wires between the coil terminals and the coil units 230-1 to 230-4 and to reduce power consumption. Furthermore, the embodiment is able to reduce influence caused by noises and to improve OIS performance.

Consequently, the embodiment is able to uniformize the lengths of the wires between the coil terminals and the coil units 230-1 to 230-4 or to reduce the difference (or deviation) between the lengths of the wires. Furthermore, it is possible to reduce the difference between the resistance values of the wires connected to the coil units 240-1 to 230-4 and to improve OIS performance.

In another embodiment, two coil terminals corresponding to each of the four coil units 230-1 to 230-4 may be disposed on a corresponding one of the four extensions 7A to 7D. For example, the coil terminals may be disposed on the extension of the support board 310 that is positioned closest to the coil unit 230-1.

In another embodiment, the four coil terminals electrically connected to two coil units (for example, 230-1 and 230-2) may be disposed on one of the four extensions 7A to 7D. For example, the four coil terminals may be disposed on an extension which is positioned closest to one of two coil units 230-1 and 230-2.

The four coil terminals electrically connected to the other coil units (for example, 230-3 and 230-4) may be disposed on another of the four extensions 7A to 7D. For example, the four coil terminals may be disposed on an extension which is positioned closest to one of the two coil units 230-3 and 230-4.

The support board 310 may include a plurality of terminals R7 to R9, M10 to M12 and G8 to G12 (referred to hereinafter as “OIS sensor terminals”) which are electrically connected to the first to third sensors 240A to 240C.

Each of the sensors 240A to 240C may include two output terminals through which an output signal is output and two input terminals through which drive power (or a drive signal) is input. One of the input terminals of each of the sensors 240A to 240C may be connected in common. Here, the terminal, which is connected in common, may be referred to as a “common terminal”, and may be ground in common. Accordingly, three separate terminals may be allocated to each of the sensors, and the three sensors may share one common terminal.

The “OIS sensor terminals” may be disposed on each of the three extensions (for example, 7A, 7B and 7D) selected from the four extensions 7A to 7D of the support board 310. Each of the OIS sensor terminals may include three terminals. For example, the three terminals of each of the OIS sensor terminals may be sequentially disposed. In another embodiment, the three terminals of the OIS sensor terminal may not be sequentially disposed. The common terminal (for example, G8) may be disposed on one of the selected three extensions (for example, 7A, &B and 7D).

The ground terminal G9 may be disposed on the common terminal (for example, G8) and the sensor terminal for ground shielding.

For example, the sensor terminals (for example, M10 to M12 and G10 to G12) for the sensor 240B or 240C may be disposed on the extensions (for example, 7D and 7B) of the support board 310 which is positioned closest to the sensor 240B or 240C among the extensions 7A to 7D of the support board 310. Although the sensor terminals R7 to R9 for the sensor 240A are disposed on the extension 7A of the support board 310 in FIG. 24, the sensor terminal for the sensor 240A may be disposed on the extension 7C which is positioned closest to the sensor 240A in another embodiment.

The support board 310 may include a plurality of terminals A1 to A4 (referred to hereinafter as a “AF sensor terminals”) which are electrically connected to the first position sensor 170. The AF sensor terminals may be disposed or formed on one extension (for example, 7C) selected from the plurality of extensions 7A to 7D of the support board 310. Here, because the first position sensor 170 is disposed in the extension region 190 extending from a portion the bodies (for example, 86 and 87) adjacent to the extension (for example, 7C), wiring for connecting the first position sensor to the terminals A1 to A4 can be easily designed and the length of the wire when the terminals A1 to A4 are disposed on the extension region (for example, 7C) of the support board 310 closest to the extension region 190 can be reduced.

In a comparative example in which the AF operation unit includes an additional circuit board on which the AF position sensor is disposed, it is necessary to provide an additional assembly process of connecting and coupling the additional circuit board to the support board, for example, a soldering process. In the comparative example, there are needs for designing of the additional circuit board for disposition of the AF position sensor and for management of component tolerance and assembly tolerance required for manufacture of the additional circuit board.

According to the embodiment, because the board on which the first position sensor 170 is disposed and the support board 310 are integrally formed, there is no need for an additional AF sensor board. Accordingly, the embodiment does not require design of an additional circuit board on which the AF position sensor is disposed and management of component tolerance and assembly tolerance required for manufacture of the additional circuit board. Consequently, the embodiment is able to simplify the assembly process of the camera device and to reduce manufacturing cost.

Furthermore, the embodiment is able to inhibit deterioration of reliability of electrical connection caused by defective soldering of the AF position sensor and the circuit board and to inhibit malfunction of the AF operation or deterioration of reliability of autofocus operation caused by defective soldering.

Meanwhile, in the comparative example, in order to perform a soldering process for coupling the printed circuit board on which the AF position sensor is disposed to the support board after a process of assembling the cover member, an opening through which a portion of the printed circuit board and a portion of the support board are exposed is required. In other words, in the comparative example, in order to perform a soldering process of coupling the printed circuit board on which the AF position sensor is disposed to the support board after the process of assembling the cover member, the opening in the cover member 300 shown in FIG. 49A is required. However, foreign substances may be introduced into the camera device through the opening 305, thus causing performance degradation or disabled operation of the camera device.

In contrast, because the board on which the first position sensor 170 is disposed is formed integrally with the support board 310 in the embodiment, the opening 305 in the cover member 300 through which the soldering process is performed is not necessarily required.

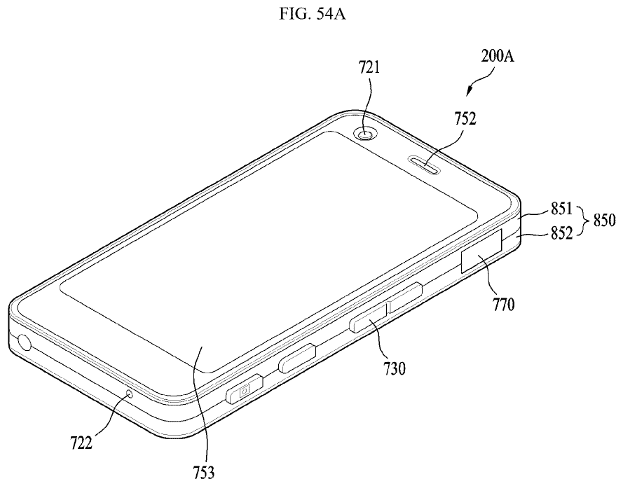

FIG. 53 is a perspective view of the camera device 10 including the cover member 300A according to another embodiment.

Referring to FIG. 53, the cover member 300A shown in FIG. 53 may be a modification of the cover member 300 shown in FIG. 49A. The cover member 300A shown in FIG. 53 may not include the opening 305 shown in FIG. 49A. The cover member 300A may not expose the projections 44A and 44B of the housing 140. Because the embodiment shown in FIG. 53 does not include the opening 305, it is possible to suppress introduction of foreign substances into the camera device 10 through the cover member 300A.

The description given with reference to FIGS. 22 to 30 may be applied to the embodiment shown in FIGS. 31 to 53 with or without modification. Furthermore, the description given with reference to FIGS. 48A to 53 may be applied to the embodiment shown in FIGS. 1 to 30 with or without modification.

Furthermore, the camera device according to the embodiment may be included in an optical instrument, which is designed to form the image of an object in a space using reflection, refraction, absorption, interference, diffraction or the like, which are characteristics of light, to extend eyesight, to record an image obtained through a lens or to reproduce the image, to perform optical measurement, or to propagate or transmit an image. For example, although the optical instrument according to the embodiment may be a mobile phone, a cellular phone, a smart phone, a portable smart instrument, a digital camera, a laptop computer, a digital broadcasting terminal, a PDA (Personal Digital Assistant), a PMP (Portable Multimedia Player), navigation device, or the like, the disclosure is not limited thereto. Furthermore, any device capable of capturing images or taking photographs is possible.

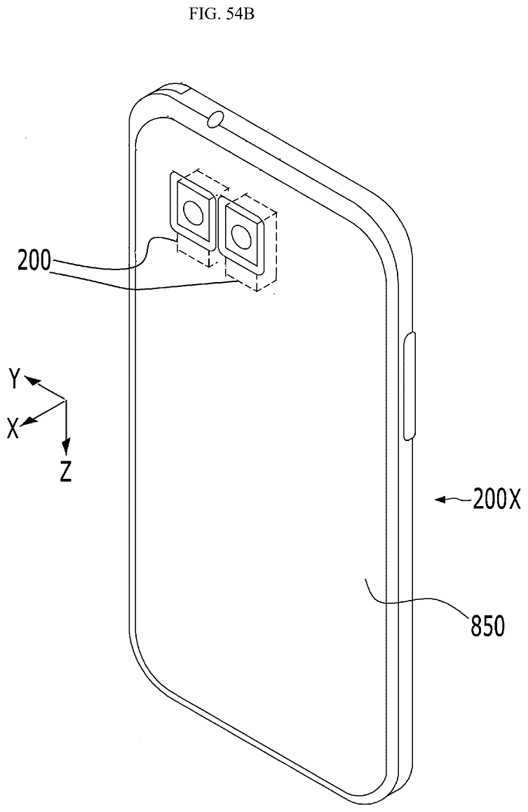

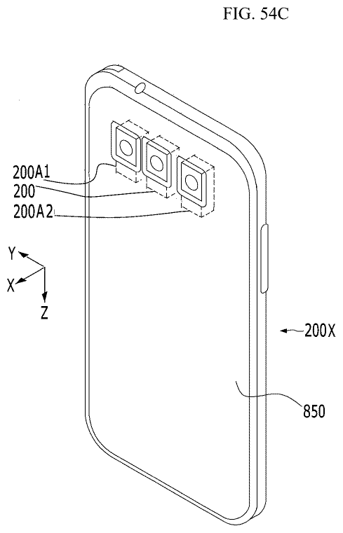

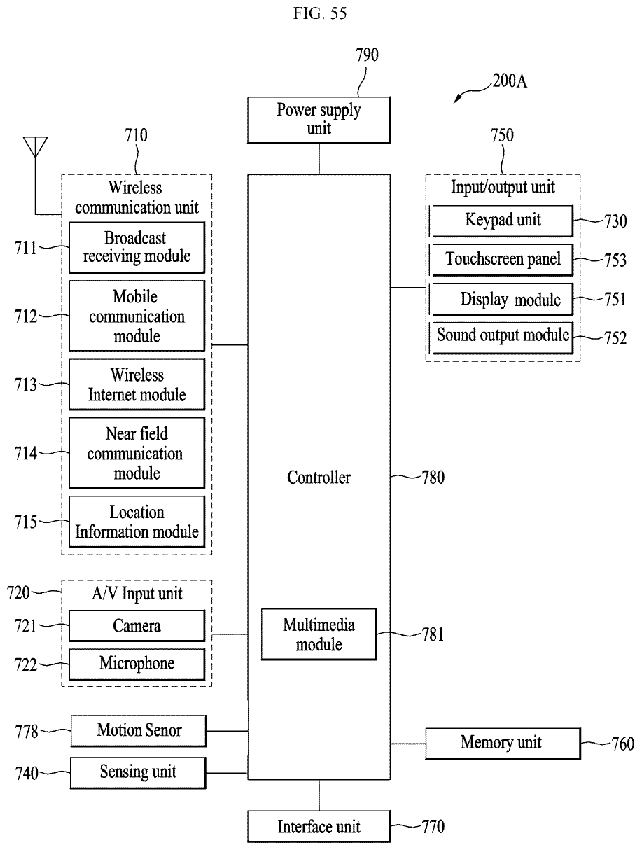

FIG. 54A is a perspective view of an optical instrument 200A according to an embodiment. FIG. 54B is a perspective view of an optical instrument 200X according to another embodiment. FIG. 54C is a perspective view of an optical instrument 200X according to a further embodiment. FIG. 55 is a view illustrating the configuration of the optical instrument 200A or 200X illustrated in FIGS. 54A to 54C.

For example, the embodiment shown FIG. 54A may be a front camera of an optical instrument 200A in which the lens module 400 of the camera device 10 is disposed so as to face in a forward direction of the body 850, and the embodiment shown FIGS. 54B and 54C may be a rear camera of an optical instrument 200A in which the lens module 400 of the camera device 10 faces in a backward direction of the body 850.

The optical instrument 200X shown in FIG. 54B may include two rear camera devices 200, and the optical instrument 200X shown in FIG. 54C may include three rear camera devices. Here, at least one of the two rear camera devices shown in FIG. 54B or at least one of the three camera devices shown in FIG. 54C may be the camera device 10 according to the embodiment. The two camera devices or the three camera devices may be camera devices which have different angles of view. For example, one of the rear camera devices may be one of an AF camera device, an OIS camera device or a zooming camera device, and another of the three camera devices may be another of an AF camera device, an OIS camera device or a zooming camera device. Here, the AF camera device may be a camera device configured to perform an autofocus function, the OIS camera device may be a camera device configured to perform autofocus and OIS functions, and the zooming camera device may be a camera device configured to perform a zooming function or to perform both zooming function and OIS function.

In another embodiment, two or four or more rear camera devices may be provided. For example, although the rear camera devices is disposed or arranged in a line in a direction in which the short sides of the optical instrument 200X face each other, the rear camera devices may be disposed or arranged in a line in a direction in which the long sides of the optical instrument 200X face each other in another embodiment. In a further embodiment, the rear camera devices may be disposed or arranged in a triangular shape.

In another embodiment, the camera devices 200 may correspond to the front camera device and the rear camera device of the optical instrument 200A.

The optical device 200A may include a body 850, a wireless communication unit 710, an audio/video (A/V) input unit 720, a sensing unit 740, an input/output unit 750, a memory unit 760, an interface unit 770, a controller 780, and a power supply unit 790.

The body 850 has a bar shape, without being limited thereto, and may be any of various types, such as, for example, a slide type, a folder type, a swing type, or a swivel type, in which two or more sub-bodies are coupled so as to be movable relative to each other.

The body 850 may include a case (a casing, housing, cover or the like) defining the external appearance of the terminal. For example, the body 850 may be divided into a front case 851 and a rear case 852. Various electronic components of the terminal may be accommodated in the space defined between the front case 851 and the rear case 852.

The wireless communication unit 710 may include one or more modules, which enable wireless communication between the optical device 200A and a wireless communication system or between the optical device 200A and a network in which the optical device 200A is located. For example, the wireless communication unit 710 may include a broadcast-receiving module 711, a mobile communication module 712, a wireless Internet module 713, a nearfield communication module 714, and a location information module 715.

The A/V input unit 720 serves to input audio signals or video signals, and may include, for example, a camera 721 and a microphone 722.

The camera 721 may include the camera device 100 according to the embodiment.

The sensing unit 740 may sense the current state of the optical device 200A, such as, for example, opening or closing of the optical device 200A, the location of the optical device 200A, the presence of a user's touch, the orientation of the optical device 200A, or the acceleration/deceleration of the optical device 200A, and may generate a sensing signal to control the operation of the optical device 200A. When the optical device 200A is, for example, a slide-type cellular phone, the sensing unit 740 may sense whether the slide-type cellular phone is opened or closed. Furthermore, the sensing unit 740 may sense the supply of power from the power supply unit 790, coupling of the interface unit 770 to an external device, and the like.

The input/output unit 750 serves to generate, for example, visual, audible, or tactile input or output. The input/output unit 750 may generate input data to control the operation of the optical device 200A, and may display information processed in the optical device 200A.

The input/output unit 750 may include a keypad unit 730, a display module 751, a sound output module 752, and a touchscreen panel 753. The keypad unit 730 may generate input data in response to input to a keypad.

The display module 751 may include a plurality of pixels, the color of which varies depending on the electrical signals applied thereto. For example, the display module 751 may include at least one among a liquid crystal display, a thin-film transistor liquid crystal display, an organic light-emitting diode display, a flexible display and a 3D display.

The sound output module 752 may output audio data received from the wireless communication unit 710 in, for example, a call-signal reception mode, a call mode, a recording mode, a voice recognition mode, or a broadcast reception mode, or may output audio data stored in the memory unit 760.

The touchscreen panel 753 may convert variation in capacitance, caused by a user's touch on a specific region of a touchscreen, into electrical input signals.

The memory unit 760 may temporarily store programs for the processing and control of the controller 780, and input/output data (for example, telephone numbers, messages, audio data, still images, moving images and the like). For example, the memory unit 760 may store images captured by the camera 721, for example, pictures or moving images. For example, the memory unit 760 may store therein software, algorithm or mathematical formulae for the above-mentioned hand tremor correction.

The interface unit 770 serves as a path through which the lens moving apparatus is connected to an external device connected to the optical device 200A. The interface unit 770 may receive power or data from the external component, and may transmit the same to respective constituent elements inside the optical device 200A, or may transmit data inside the optical device 200A to the external component. For example, the interface unit 770 may include a wired/wireless headset port, an external charger port, a wired/wireless data port, a memory card port, a port for connection to a device equipped with an identification module, an audio input/output (I/O) port, a video input/output (I/O) port, an earphone port and the like.

The controller 780 may control the general operation of the optical device 200A. For example, the controller 780 may perform control and processing related to, for example, voice calls, data communication, and video calls.

The controller 780 may include a multimedia module 781 for multimedia playback. The multimedia module 781 may be embodied in the controller 180, or may be embodied separately from the controller 780.

The controller 780 may perform a pattern recognition process capable of recognizing writing input or drawing input carried out on a touchscreen as a character and an image, respectively.

The power supply unit 790 may supply power required to operate the respective constituent elements upon receiving external power or internal power under the control of the controller 780.

The features, configurations, effects and the like described above in the embodiments are included in at least one embodiment, but the invention is not limited only to the embodiments. In addition, the features, configurations, effects and the like exemplified in the respective embodiments may be combined with other embodiments or modified by those skilled in the art. Accordingly, content related to these combinations and modifications should be construed as falling within the scope of the disclosure.

### INDUSTRIAL APPLICABILITY

The embodiments may be used in camera devices and optical instruments, which are capable of improving reliability of electrical connection between a terminal of a first circuit board and a terminal of a second circuit board of a moving unit.

Furthermore, the embodiments may be used in camera devices and optical instruments, which are capable of improving efficiency of radiation of heat generated by a heat generation source of an OIS moving unit.

1. A camera device comprising:
a stationary unit; and
a moving unit comprising a first circuit board, a second circuit board disposed under the first circuit board, and an image sensor, and being movable in a direction perpendicular to an optical axis direction with respect to the stationary unit,
wherein the first circuit board includes a plurality of conductive layers,
wherein the first circuit board comprises a terminal coupled to the second circuit board via a solder, and
wherein the terminal is positioned higher than a lowermost conductive layer among the plurality of conductive layers of the first circuit board.

2. The camera device according to claim 1, wherein the terminal is positioned between the lowermost conductive layer and an uppermost conductive layer among the plurality of conductive layers of the first circuit board.

3. The camera device according to claim 1, wherein the terminal is formed at another conductive layer disposed on the lowermost conductive layer among the plurality of conductive layers.

4. The camera device according to claim 1, wherein the terminal is formed at a second lowermost conductive layer among the plurality of conductive layers.

5. The camera device according to claim 1, wherein a lowermost surface of the solder is disposed higher than a lowermost surface of the second circuit board.

6. The camera device according to claim 1, wherein the plurality of conductive layers are disposed so as to be spaced apart from each other in the optical axis direction, and
wherein the first circuit board includes a plurality of insulating layers disposed between the plurality of conductive layers.

7. A camera device comprising:
a stationary unit; and
a moving unit comprising a first circuit board, a second circuit board disposed under the first circuit board, and an image sensor, and being movable in a direction perpendicular to an optical axis direction with respect to the stationary unit,
wherein the first circuit board comprises a seating groove depressed from a lower surface thereof,
wherein the second circuit board is disposed in the seating groove in the first circuit board, and
wherein the first circuit board comprises a first terminal disposed in the seating groove and coupled to the second circuit board via a solder.

8. The camera device according to claim 7, wherein the second circuit board comprises a second terminal disposed at at least a portion thereof in the seating groove and coupled to the first terminal via the solder.

9. The camera device according to claim 7, wherein at least a portion of the solder is disposed in the seating groove in the first circuit board.

10. The camera device according to claim 7, wherein the first circuit board comprises a plurality of conductive layers arranged in the optical axis direction, and
the first terminal is positioned higher than a lowermost conductive layer among the plurality of conductive layers of the first circuit board.

11. The camera device according to claim 7, wherein the first terminal is positioned between a lowermost conductive layer among the plurality of conductive layers of the first circuit board and an uppermost conductive layer among the plurality of conductive layers of the first circuit board.

12. The camera device according to claim 7, wherein the first terminal is formed at another conductive layer disposed on the lowermost conductive layer among the plurality of conductive layers of the first circuit board.

13. The camera device according to claim 7, wherein the second terminal is formed on a side surface of the second circuit board.

14. The camera device according to claim 7, wherein the second circuit board comprises a plurality of conductive layers arranged in the optical axis direction, and the second terminal is positioned higher than a lowermost conductive layer among the plurality of conductive layers of the second circuit board.

15. The camera device according to claim 7, wherein the second terminal comprises a first pad formed on a side surface of the second circuit board and a second pad connected to a lower portion of the first pad.

16. The camera device according to claim 15, wherein the second circuit board comprises a plurality of conductive layers arranged in the optical axis direction, and the first pad and the second pad are disposed higher than a lowermost conductive layer among the plurality of conductive layers of the second circuit board.

17. The camera device according to claim 14, wherein the lowermost conductive layer of the second circuit board is positioned lower than the lowermost conductive layer of the first circuit board.

18. The camera device according to claim 16, wherein the solder is coupled to at least one of the first pad or the second pad.

19. The camera device according to claim 7, wherein the moving unit comprises a first heat radiating member disposed below the second circuit board and on which the image sensor is disposed, and the stationary unit comprises a second heat radiating member disposed so as to be spaced apart from the first heat radiating member.

20. The camera device according to claim 19, wherein the second heat radiating member comprises:
a first region overlapped with the first heat radiating member in the optical axis direction; and
a second region not overlapped with the first heat radiating member in the optical axis direction,
wherein the first region projects toward the first heat radiating member based on the second region.
